(19) United States
(12) Patent Application Publication
(10) Pub. No.: US 2014/0172727 A1
(43) Pub. Date: Jun. 19, 2014

(54) SHORT-TERM AUTOMOBILE RENTALS IN A GEO-SPATIAL ENVIRONMENT

(71) Applicants: Raj V. Abhyanker, Cupertino, CA (US); Warren H. Myer, San Jose, CA (US)

(72) Inventors: Raj V. Abhyanker, Cupertino, CA (US); Warren H. Myer, San Jose, CA (US)

(21) Appl. No.: 14/183,549

(22) Filed: Feb. 19, 2014

Related U.S. Application Data
(63) Continuation-in-part of application No. 11/318,214, filed on Dec. 23, 2005, now abandoned.
Application No. 11/318,214 is a continuation-in-part of application No. 11/603,442, filed on Nov. 22, 2006, now abandoned.
Application No. 11/603,442 is a continuation-in-part of application No. 11/653,194, filed on Jan. 12, 2007.
Application No. 11/653,194 is a continuation-in-part of application No. 11/827,774, filed on Jul. 13, 2007, now abandoned.
Application No. 11/827,774 is a continuation-in-part of application No. 13/242,303, filed on Sep. 23, 2011, now abandoned.
Application No. 13/242,303 is a continuation-in-part of application No. 14/102,474, filed on Dec. 10, 2013.
Application No. 14/102,474 is a continuation-in-part of application No. 14/142,764, filed on Dec. 28, 2013.

(51) Int. Cl. G06Q 50/30; G06Q 30/06

(52) U.S. Cl. CPC G06Q 50/30; G06Q 30/0645
USPC 705/307

(57) ABSTRACT

A method, device, and system of a short-term automobile renting system and method are disclosed. In one embodiment, a method of a dispatch server includes associating a user with a ride request system and determining that the user has requested to be picked-up at a geo-spatial location associated with a pick-up address of the user. The geo-spatial location is determined based on any of a current geo-spatial location of a mobile device through which the user requests the pick-up and/or a manually entered address in the mobile device of the user that is communicatively coupled with the dispatch server in this aspect. A private vehicle is automatically dispatched in the geo-spatial vicinity of the geo-spatial location associated with the pick-up address of the user using a processor and a memory.

### CLAIMS OF PRIORITY

This patent application is a continuation in part, claims priority from the cases below, and hereby incorporates by reference the entirety of the disclosures and priority claims of:
(1) U.S. Utility patent application Ser. No. 11/318,214 titled ‘REAL ESTATE VEHICLE AND METHOD’ filed on Dec. 23, 2005.
(2) U.S. Provisional patent application No. 60/783,226, titled ‘TRADE IDENTITY LICENSING IN A PROFESSIONAL SERVICES ENVIRONMENT WITH CONFLICT’ filed on Mar. 17, 2006.
(3) U.S. Provisional patent application No. 60/817,470, titled ‘SEGMENTED SERVICES HAVING A GLOBAL STRUCTURE OF NETWORKED INDEPENDENT ENTITIES’, filed Jun. 28, 2006.
(4) U.S. Provisional patent application No. 60/853,499, titled ‘METHOD AND APPARATUS OF NEIGHBORHOOD EXPRESSION AND USER CONTRIBUTION SYSTEM’ filed on Oct. 19, 2006.
(5) U.S. Provisional patent application No. 60/854,230, titled ‘METHOD AND APPARATUS OF NEIGHBORHOOD EXPRESSION AND USER CONTRIBUTION SYSTEM’ filed on Oct. 25, 2006.
(6) U.S. Utility patent application Ser. No. 11/603,442 titled ‘MAP BASED NEIGHBORHOOD SEARCH AND COMMUNITY CONTRIBUTION’ filed on Nov. 22, 2006.
(7) U.S. Utility patent application Ser. No. 11/653,194 titled ‘LODGING AND REAL PROPERTY IN A GEO-SPATIAL MAPPING ENVIRONMENT’ filed on Jan. 12, 2007.
(8) U.S. Utility patent application Ser. No. 11/827,774 titled ‘SHORT TERM RESIDENTIAL SPACES IN A GEO-SPATIAL ENVIRONMENT’ filed on Jul. 13, 2007.
(9) U.S. Provisional patent application No. 61/526,693 titled ‘GEOSPATIAL CONSTRAINT AROUND BIDDABILITY OF A GASTRONOMICAL ITEM’ filed on Aug. 24, 2011.
(10) U.S. Utility patent application Ser. No. 13/242,303 titled ‘GEOSPATIALLY CONSTRAINED GASTRONOMIC BIDDING’ filed on Sep. 23, 2011.
(11) U.S. Utility patent application Ser. No. 14/102,474 titled ‘SHORT TERM RESIDENTIAL SPACES IN A GEO-SPATIAL ENVIRONMENT’ filed on Dec. 10, 2013.
(12) U.S. Utility patent application Ser. No. 14/142,764, titled ‘DRIVERLESS VEHICLE COMMERCE NETWORK AND COMMUNITY’ filed on Dec. 28, 2013.

### FIELD OF TECHNOLOGY

This disclosure relates generally to data processing devices and, more particularly, to a method and/or a system of short-term automobile in a geo-spatial environment are disclosed.

### BACKGROUND

An individual (e.g., or group) may need transportation from one location to another. The individual may consult a phone book and call a private cab company (e.g., a taxi cab company, a limousine rental company) and/or a shuttle bus service. The private cab company and/or the shuttle bus service may not have any automobiles available. As a result, the individual may need to consult the phone book again and call a different private cab company and/or a different shuttle bus service. The different private cab company and/or the different shuttle bus service may have automobiles available, but none may be near where the individual has requested a pick-up location.

Frustrated, the individual may contact yet another private cab service and/or shuttle bus service. Relieved, the individual may be told that he/she will finally be picked up at the pick up location in 30 minutes. Tick, tock. The individual may get frustrated waiting. The 30 minutes may feel like six hours. Even when a private car of the private cab company and/or the shuttle bus service arrives, a driver of the private car may not find the individual because they may not know what the person they are to pick up looks like. As a result, the individual may find herself running behind the private car just as it leaves the pick up location to catch it. Then, the driver of the private car may start a meter. The meter may run up exorbitantly, much to the chagrin of the individual. The private car may smell like dirty clothes and smoke. The operator may ask too many personal questions of the individual. The individual may feel like they had a terrible experience upon arriving at her destination. The individual may feel helpless and at the mercy of fate.

### SUMMARY

A method, device, and system of a short-term automobile in a geo-spatial environment are disclosed.

In one aspect, a method of a dispatch server includes associating a user with a ride request system, determining that the user has requested to be picked-up at a geo-spatial location associated with a pick-up address of the user, wherein the geo-spatial location is determined based on a current geo-spatial location of a mobile device through which the user requests the pick-up and a manually entered address through the mobile device of the user, wherein the mobile device is communicatively coupled with the dispatch server using a processor and a memory, automatically associating a set of private vehicles in a geo-spatial vicinity of the geo-spatial location associated with the pick-up address of the user, dispatching a private vehicle of the set of private vehicles in a the geo-spatial vicinity of the geo-spatial location associated with the pick-up address of the user, and permitting the user to track an arrival of the private vehicle through the mobile device.

The method may include automatically determining which of the set of private vehicles in the geo-spatial vicinity of the geo-spatial location associated with the pick-up address of the user are available. The method may include automatically selecting the private vehicle in the geo-spatial vicinity of the geo-spatial location associated with the pick-up address based on a geo-spatial distance from the geo-spatial location associated with the pick-up address of the user and an available status of the private vehicle as registered through a mobile device in the private vehicle that is communicatively coupled with the dispatch server.

In addition, the method may include automatically generating a push notification to the mobile device of the user that private vehicle has arrived at the pick-up address of the user. The method may determine which of the set of private vehicles are optimal based on the geo-spatial location associated with the pick-up address of the user. In addition, the method may automatically generate a graphical representation of available ones of the set of private vehicles on the mobile device and the data processing system of the user based on positioning information wirelessly transmitted by the available ones of the set of private vehicles. A message may be communicated to the mobile device and/or the data processing system of the user based on an acceptance by the private vehicle of the set of private vehicles.

The message may include an estimated time of arrival of the private vehicle to the geo-spatial location, an identifier of an operator of the private vehicle, and/or an estimated time to a destination address associated with a real property address to where the user wishes to travel to from the geo-spatial location associated with the pick-up address of the user. Certain ones of the set of private vehicles may be unavailable based on an indicator visually displayed on the dispatch server, the mobile device, the data processing system, and/or physically on certain ones of the plurality of vehicles.

The certain ones of the set of private vehicles may wirelessly communicate unavailability to the dispatch server. The unavailability may indicate that certain ones of the unavailable vehicles are currently occupied by other riders and that the operators of the certain vehicles are presently unavailable for dispatching. A determination of which of the set of private vehicles are optimal to the request may be based on a location of the user communicated in the request, a physical position of each the set of private vehicles, and/or a budget range of the user. A view of feedback may be provided that is generated by a number of users about rides received in at least some of the set of private vehicles when the users elect to publish their own feedback on the ride request system with other users of the ride request system. A routing data to a location of the user on a car navigation system of the private vehicle may be displayed based on information provided through the dispatch server. The information may include identification information of the user who is physically present at the geo-spatial address associated with the pick-up location of the user. The information may include a picture of the user, a rental history of the user, and/or a budget of the user. The information may be presented to the operator of the private vehicle in transit to the geo-spatial location of the user through a mobile device of the operator.

An availability indicator of the private vehicle may be toggled based the communication through the dispatch module. An estimated time of arrival to a destination associated with the user may be calculated. An identifier of an operator of the private vehicle may be transmitted to the mobile device and/or the data processing system of the user such that the user knows who and which vehicle is picking them up. The driver module of the ride request system may generate a transaction document based on a communication through the passenger module to the driver module. Data including a rental price may be communicated through the passenger module to the driver module.

The driver module may electronically process an electronic signature of the transaction document by the prospective renter who executes the transaction document through an electronic signature means on the passenger module, and wherein the driver module to subsequently communicate the transaction document to a renter device, a driver device, and a dispatch server. The attribute ranking may be generated into a ride scorecard prioritized based on at least one predefined ideal attribute definition provided by the prospective renter. The route of the private vehicle may be adjusted based on a command processed of a passenger module of the ride request system when the user requests a different destination address than an initial destination address. A credit may be provided to the prospective renter when the prospective renter refers a friend to the ride request system.

The credit may enable the prospective renter to request future rides in the ride request system. The user may be permitted automatically pay the operator of the vehicle a consideration upon reaching the destination through the ride request system. A gratuity may be automatically provided to the operator of the private vehicle from the consideration provided by the user to the operator. The gratuity may be a percentage of the consideration provided in a manner such that an additional gratuity amount is not required beyond the consideration tendered when the user automatically pays the operator the vehicle the consideration upon reaching the destination through the ride request system. The user may be permitted to provide a gift certificate in a form of rental credit to friends of the user, such that the friends can redeem the gift certificate through the ride request system.

In another aspect, a method of a mobile device includes requesting to be picked-up at a geo-spatial location associated with a pick-up address of a user of the mobile device, wherein the geo-spatial location is determined based on a current geo-spatial location of the mobile device through which the user requests the pick-up and a manually entered address in the mobile device, tracking an arrival of a private vehicle through the mobile device when a dispatch server summons a closest private vehicle in a geo-spatial vicinity of the mobile device, and communicating a payment of a fare from the mobile device to an operator of the private vehicle when the user of the mobile device is picked up at the pick up address and arrives at a destination desired by the user.

The dispatch server may automatically determine which of the set of private vehicles in the geo-spatial vicinity of the geo-spatial location associated with the pick-up address of the user are available, automatically select the private vehicle of the set of private vehicles in the geo-spatial vicinity of the geo-spatial location associated with the pick-up address based on a geo-spatial distance from the geo-spatial location associated with the pick-up address of the user and/or an available status of the private vehicle as registered through a mobile device in the private vehicle that is communicatively coupled with the dispatch server, determine which of the set of private vehicles are optimal based on the geo-spatial location associated with the pick-up address of the user, and automatically generate a graphical representation of available ones of the set of private vehicles on the mobile device of the user based on positioning information wirelessly transmitted by the available ones of the set of private vehicles.

The mobile device may automatically process a push notification that the private vehicle has arrived at the pick-up address of the user, and/or receive a message from the dispatch server that includes an estimated time of arrival of the private vehicle to the geo-spatial location, an identifier of an operator of the private vehicle, and/or an estimated time to the destination address associated with a real property address to where the user wishes to travel to from the geo-spatial location associated with the pick-up address of the user.

In yet aspect, a system includes a mobile device through which a user requests a private vehicle at a pick-up address associated with a current geospatial location of the mobile device and a dispatch server communicatively coupled with the mobile device through a network. The dispatch server may automatically determine which of the set of private vehicles in the geo-spatial vicinity of the current geospatial location of the mobile device are available, may automatically select a private vehicle of the set of private vehicles in a geo-spatial vicinity of the current geo-spatial location of the mobile device based on a geo-spatial distance from the geo-spatial location associated with the pick-up address of the user and an available status of the private vehicle, and may automatically dispatch the private vehicle in the geo-spatial vicinity of the mobile device based on a closest of the geo-spatial distance of the private vehicle from the current geospatial location of the mobile device.

The dispatch server may process a payment of the user to an operator of the private vehicle when the private vehicle completes a ride to a destination originating at a current location of the mobile device to the destination on behalf of the user of the mobile device.

The methods and systems disclosed herein may be implemented in any means for achieving various aspects, and may be executed in a form of a machine-readable medium embodying a set of instructions that, when executed by a machine, cause the machine to perform any of the operations disclosed herein. Other features will be apparent from the accompanying drawings and from the detailed description that follows.

### BRIEF DESCRIPTION OF THE DRAWINGS

The embodiments of this disclosure are illustrated by way of example and not limitation in the figures of the accompanying drawings, in which like references indicate similar elements and in which:

FIG. 1 is a network view of a dispatch server having a radial distribution module communicating with a device that generates a radial broadcast through an internet protocol network using a radial algorithm of the radial distribution module of the dispatch server, according to one embodiment.

FIG. 2 is an exploded view of the radial distribution module of FIG. 1 that applies the radial algorithm, according to one embodiment.

FIG. 3 is a broadcast view that demonstrates how the radial distribution module of FIG. 1 is used to communicate an automotive listing data to claimed user profiles, pre-seeded user profiles, and to telephone devices or internet-enabled devices of private vehicles through a heterogeneous network formed through the internet protocol network of FIG. 1 and through a cellular network, according to one embodiment.

FIG. 4 is a radial operation view that illustrates an expansion of a threshold radial distance based on a claimed neighborhood at a radial boundary surrounding an epicenter formed by geospatial coordinates of the device of FIG. 1, according to one embodiment.

FIG. 5 illustrates a remote association view in which a renter device receives the automotive listing data from a mobile device based on a non-transitory claimed address associated with a profile of the renter even when the mobile device is outside a threshold radial distance of a broadcast, according to one embodiment.

FIG. 6A is an automobile dispatch broadcast user interface view of the mobile device of FIG. 3 that shows how the user can generate and broadcast the broadcast data, according to one embodiment.

FIG. 6B is a private vehicle renter user interface view of the renter device of FIG. 5, in which a broadcast data generated through the user interface of FIG. 6A enables the user to request a rental of the private vehicle, according to one embodiment.

FIG. 6C is a broadcast renter user interface view of the renter device of FIG. 5 in which the renter device is receiving a live broadcast, according to one embodiment.

FIG. 6D is a summary data user interface view of the mobile device of FIG. 3 in which the user may see the renters of the broadcast and the renters viewing the live broadcast of FIG. 6C, according to one embodiment.

FIG. 7 is a claimed location user interface view that explains how a claimed user reviews their broadcasts that they made and manages the neighborhoods that they have claimed, according to one embodiment.

FIG. 8 is a pushpin user interface view that explains how a user drags pushpins to a map including a broadcast pushpin, which is different than other pushpins in that a time and a location of the broadcast pushpin is fixed based on a set of geospatial coordinates associated with a mobile device of the claimed user of FIG. 7, according to one embodiment.

FIG. 9 is a process flow of radially distributing the automotive listing data 102 of FIG. 1 as a notification data around an epicenter defined at the set of geospatial coordinates of FIG. 1 associated with the automotive listing data, according to one embodiment.

FIG. 10 is a table view illustrating data relationships between users, locations, and with a set of notification types needed to generate a broadcast, according to one embodiment.

FIG. 11 is a critical path view illustrating a flow based on time in which critical operations in establishing a bi-directional session between a verified renter and those individuals receiving the automotive listing data of FIG. 3 is established, according to one embodiment.

FIG. 12 is an automobile dispatch broadcast response view illustrating a response being generated and broadcast by renters in response to an automobile dispatch broadcast made from the mobile device of FIG. 3, according to one embodiment.

FIG. 13 is a social community view of a social community module, according to one embodiment.

FIG. 14 is a profile view of a profile module, according to one embodiment.

FIG. 15 is a contribute view of a neighborhood network module, according to one embodiment.

FIG. 16 is a diagrammatic system view of a data processing system in which any of the embodiments disclosed herein may be performed, according to one embodiment.

FIG. 17A is a user interface view of mapping user profile of the geographical location, according to one embodiment.

FIG. 17B is a user interface view of mapping of the unclaimed profile, according to one embodiment.

FIG. 18A is a user interface view of mapping of the unclaimed profile of the commercial user, according to one embodiment.

FIG. 18B is a user interface view of mapping of customizable business profile of the commercial user, according to one embodiment.

FIG. 19 is a user interface view of a group view associated with particular geographical location, according to one embodiment.

FIG. 20 is a user interface view of claim view, according to one embodiment.

FIG. 21 is a user interface view of a building builder, according to one embodiment.

FIG. 22 is a systematic view of communication of wiki data, according to one embodiment.

FIG. 23 is a systematic view of a network view, according to one embodiment.

FIG. 24 is a block diagram of a database, according to one embodiment.

FIG. 25 is an exemplary graphical user interface view for data collection, according to one embodiment.

FIG. 26 is an exemplary graphical user interface view of image collection, according to one embodiment.

FIG. 27 is an exemplary graphical user interface view of an invitation, according to one embodiment.

FIG. 28 is a flowchart of inviting the invitee(s) by the registered user, notifying the registered user upon the acceptance of the invitation by the invitee(s) and, processing and storing the input data associated with the user in the database, according to one embodiment.

FIG. 29 is a flowchart of adding the neighbor to the queue, according to one embodiment.

FIG. 30 is a flowchart of communicating brief profiles of the registered users, processing a hyperlink selection from the verified registered user and calculating and ensuring the Nmax degree of separation of the registered users away from verified registered users, according to one embodiment.

FIG. 31 is an N degree separation view, according to one embodiment.

FIG. 32 is a user interface view showing a map, according to one embodiment.

FIG. 33 is a private vehicle sharing view of the private vehicle listing map of FIG. 6A in which users may indicate to other users of the geospatially constrained social network that the user's private vehicle is available for rent and may view the locations of other private vehicles for rent in the user's claimed neighborhood, according to one embodiment.

FIG. 34 is a private vehicle social connection view of a social connection between passengers of the private vehicles in a traffic jam, according to one embodiment.

FIG. 35 is a verified renter profile view of updates sent to the profile of the operator of the private vehicle, according to one embodiment.

FIG. 36A is a private vehicle view of a private vehicle, according to one embodiment.

FIG. 36B is a private vehicle interior view of the private vehicle of FIG. 36A showing an on board computer system, according to one embodiment.

FIG. 36C is an on board computer system view of the on board computer system of FIG. 36B showing an auto navigation system, rental details and payment information, according to one embodiment.

FIG. 37A is a ride request user interface view of a ride request being broadcast, according to one embodiment.

FIG. 37B is a driver interface view of the ride request of FIG. 37A being received by a driver, according to one embodiment.

FIG. 38 is a block diagram of a dispatch server that communicates with a mobile device and a vehicle through a network, according to one embodiment.

FIG. 39 is an exploded view of the dispatch server of FIG. 38, having a search module, a destination property module, a set of property databases, a vehicle scheduler module, a shuttle scheduler module, a vehicle positioning module, a contract module, a signature authentication module, a destination scoring module, a ranking generator module and a route generator module, according to one embodiment.

FIG. 40 is a system view of the vehicle of FIG. 38, having a driver module, a passenger module, a display, an input device, and an availability indicator, according to one embodiment.

FIG. 41 is a user interface view of the mobile device of FIG. 38, according to one embodiment.

FIG. 42 is a table view of content referenced by the property database of FIG. 39, according to one embodiment.

FIG. 43 is a diagrammatic representation of a data processing system capable of processing a set of instructions to perform any one or more of the methodologies herein, according to one embodiment.

FIG. 44 is a process flow to determine which vehicles are optimal to a request to view a property communicated by a mobile device to the dispatch server of FIG. 38, according to one embodiment.

FIG. 45 is a process flow to generate a route to at least one available property based on communication through a dispatch server, and to automatically prepare a form to transact real estate based on a selection of an available property by a prospective renter, according to one embodiment.

FIG. 46 is a process flow to communicate a view request of a selected property and a pick-up location to a dispatch server after registering on a real estate portal, to display a map of vehicles in proximity to the pick-up location, and to provide a view feedback of the selected property prepared by previous viewers of the selected property, according to one embodiment.

Other features of the present embodiments will be apparent from the accompanying drawings and from the detailed description that follows.

### DETAILED DESCRIPTION

A method, device, and system of a private automobile commerce network and community are disclosed. Example embodiments, as described below, may be used to provide a method, a system and/or a device of automotive listing data 102 generation and publication in a constrained geospatial vicinity around a broadcast location of a neighborhood social network. Although the present embodiments have been described with reference to specific example embodiments, it will be evident that various modifications and changes may be made to these embodiments without departing from the broader spirit and scope of the various embodiments.

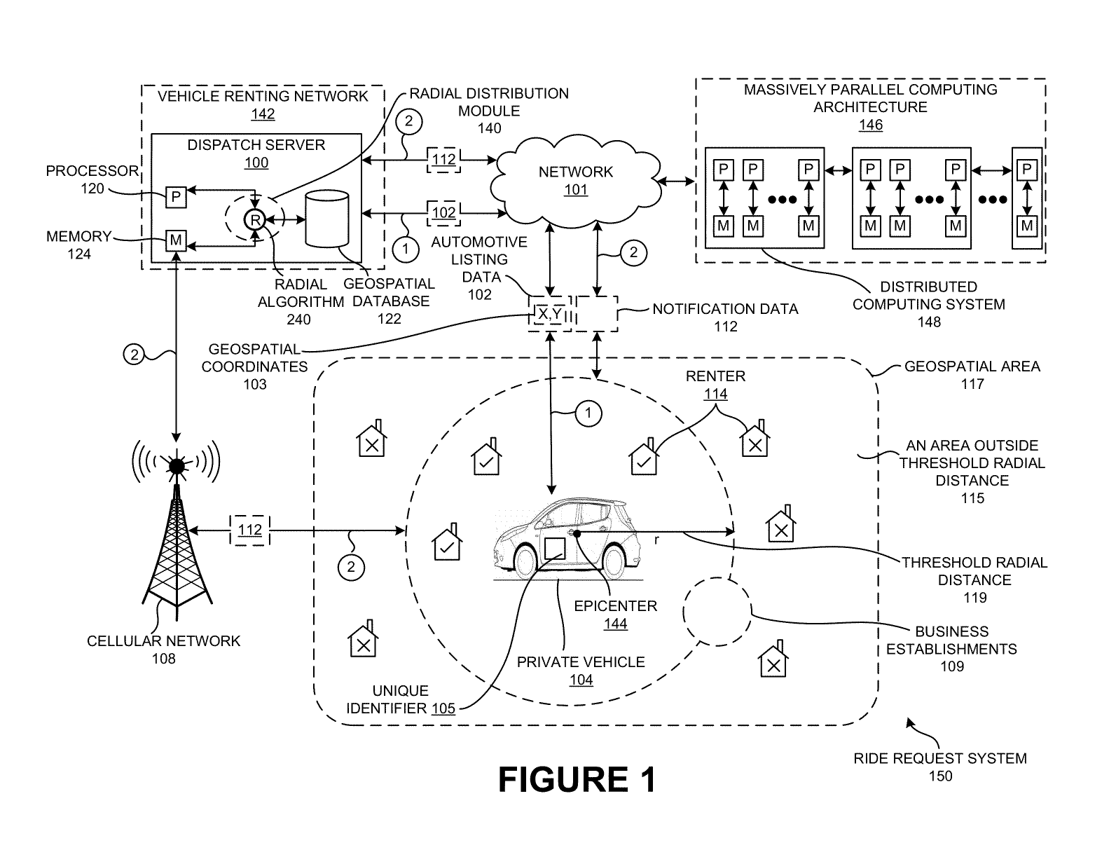

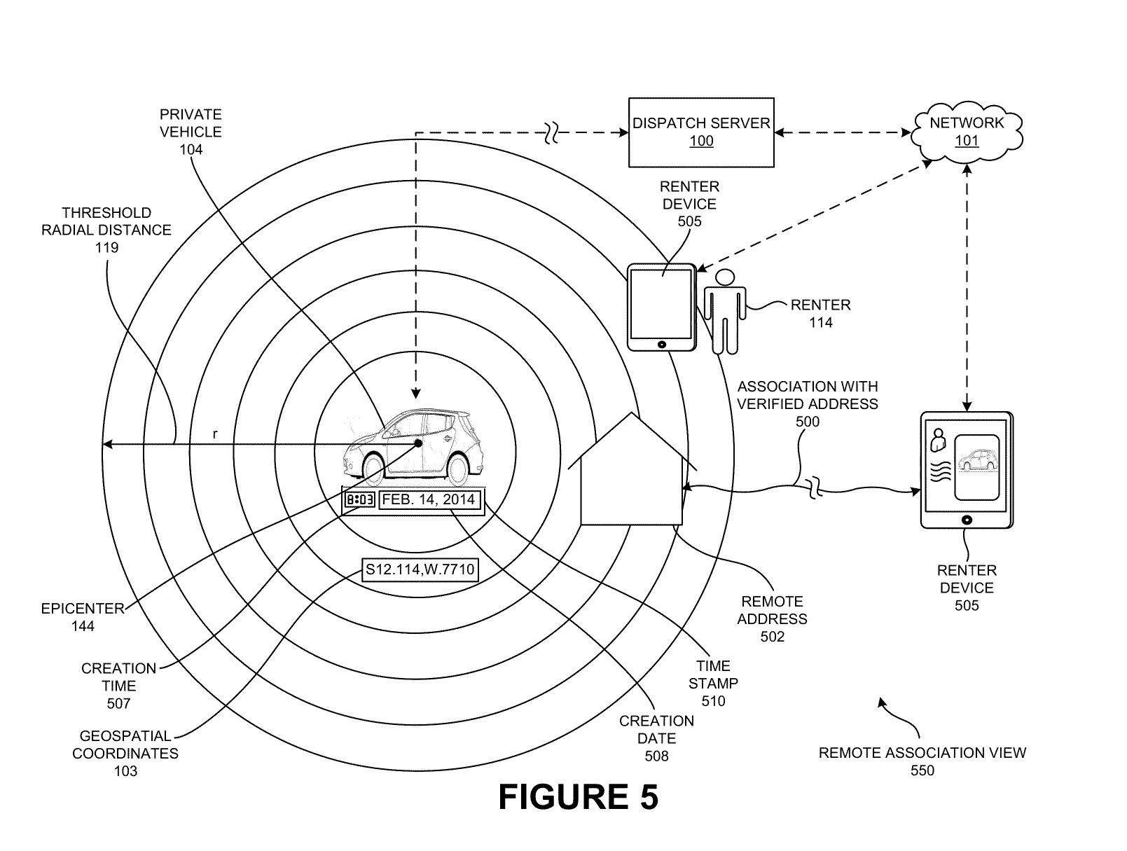

In one embodiment, a method of a dispatch server 100 of FIG. 1 includes associating a prospective renter (e.g., the renter 114 of FIG. 1) with ride request system 150 of FIG. 1 and determining that the prospective renter (e.g., the renter 114 of FIG. 1) has requested to be picked-up at a geo-spatial location (e.g., a location of the renter device 505 of FIG. 5 calculated based on a set of geospatial coordinates captured by the present location of the renter device 505 of FIG. 5 and/or a manually inputted location by the renter 114 of FIG. 1 associated with a pick-up address). The geo-spatial location is determined based on any of a current geo-spatial location of the renter device 505 of FIG. 5 (e.g., a mobile device and/or a wearable geo-spatial device) through which the renter 114 of FIG. 1 requests the pick-up and/or a manually entered address (e.g., in the renter device 505 of FIG. 5) that is communicatively coupled with the dispatch server 100 of FIG. 1 through the network 101 of FIG. 1. The dispatch server 100 may be a system of electronics and/or hardware that associates a user with a mobile device and/or enables the user to connect with other users in a geo-spatial area using the mobile device to at least engage in the requesting of a ride and/or providing a ride to a user that requests it.

A set of private vehicles (e.g., such as the vehicle 104) in a geo-spatial vicinity of the geo-spatial location associated with the pick-up address of the renter 114 of FIG. 1 are automatically associated. A private vehicle 104 is automatically dispatched in the geo-spatial vicinity of the geo-spatial location associated with the pick-up address of the renter 114 of FIG. 1 using a processor 120 and a memory 124. Further, in this embodiment, the renter 114 of FIG. 1 tracks an arrival of the private vehicle 104 through the mobile device (e.g., the renter device 505 of FIG. 5) and/or different type of data processing system (e.g., a wearable device such as a smart watch, a smart glasses, a tablet, a laptop, a desktop computer owned by the renter 114 of FIG. 1). The renter 114 of FIG. 1 may become an actual renter of the private vehicle 104 after securing a ride in the private vehicle 104 through their mobile phone (e.g., the renter device 505 of FIG. 5).

The method may include automatically determining which of the set of private vehicles (e.g., such as the vehicle 104) in the geo-spatial vicinity of the geo-spatial location associated with the pick-up address of the renter 114 of FIG. 1 are available. The method may include automatically selecting the private vehicle 104 in the geo-spatial vicinity of the geo-spatial location associated with the pick-up address based on a geo-spatial distance from the geo-spatial location associated with the pick-up address of the renter 114 of FIG. 1 and an available status of the private vehicle 104 as registered through a mobile device (e.g., the renter device 505 of FIG. 5) in the private vehicle 104 that is communicatively coupled with the dispatch server 100 of FIG. 1.

In addition, the method may include automatically generating a push notification to the renter device 505 of FIG. 5 of the renter 114 of FIG. 1 that private vehicle 104 has arrived at the pick-up address of the renter 114 of FIG. 1. The method may determine which of the set of private vehicles (e.g., the renter 114 of FIG. 1) are optimal based on the geo-spatial location associated with the pick-up address of the renter 114 of FIG. 1. In addition, the method may automatically generate a graphical representation of available ones of the set of private vehicles on the renter device 505 of FIG. 5 and the data processing system of the renter 114 of FIG. 1 based on positioning information wirelessly transmitted by the available ones of the set of private vehicles (e.g., renter 114 of FIG. 1). A message may be communicated to the renter device 505 of FIG. 5 based on an acceptance by the private vehicle 104 of the set of private vehicles (e.g., the vehicle 104).

The message may include an estimated time of arrival of the private vehicle 104 to the geo-spatial location, an identifier of an operator 301 (e.g., a driver, an owner, a proprietor, a leasee, a leasor) of the private vehicle 104, and/or an estimated time to a destination address associated with a real property address to where the renter 114 of FIG. 1 wishes to travel to from the geo-spatial location associated with the pick-up address of the renter 114 of FIG. 1. Certain ones of the set of private vehicles (e.g., the vehicle 104) may be unavailable based on an indicator visually displayed on at least one of the dispatch server 100 of FIG. 1, the renter device 505 of FIG. 5 and/or physically on certain ones of the plurality of vehicles (e.g., the vehicle 104).

The certain ones of the set of private vehicles (e.g., the vehicle 104) may wirelessly communicate unavailability to the dispatch server 100 of FIG. 1. The unavailability may indicate that at least one of certain ones of the unavailable vehicles are currently occupied by other riders and that the operator 301 (e.g., a driver, an owner, a proprietor, a leasee, a leasor) of the private vehicles of the certain vehicles are presently unavailable for dispatching. A determination of which of the set of private vehicles (e.g., the vehicle 104) are optimal to the request may be based on a location of the renter 114 of FIG. 1 communicated in the request, a physical position of each the set of private vehicles (e.g., the vehicle 104), and/or a budget range of the renter 114 of FIG. 1. A view of feedback may be provided that is generated by a number of renters about rides received in at least some of the set of private vehicles (e.g., the vehicle 104) when the renters elect to publish their own feedback on the ride request system 150 of FIG. 1 with other renters of the ride request system 150 of FIG. 1. In one embodiment, the ride request system 150 may be a web address and/or website through which operators (e.g., driver users) and/or renters (e.g., users requesting a ride) in a geo-spatial area communicate and/or are connected through a network.

A routing data to a location of the renter 114 of FIG. 1 on a car navigation system of the private vehicle 104 may be displayed based on information provided through the dispatch server 100 of FIG. 1. The information may include identification information of the renter 114 of FIG. 1 who is physically present at the geo-spatial address associated with the pick-up location of the renter 114 of FIG. 1 (e.g., a user of the ride request system 150 of FIG. 1. The information may include a picture of the renter 114 of FIG. 1, a rental history of the renter 114 of FIG. 1, and/or a budget of the renter 114 of FIG. 1. The information may be presented to the operator 301 (e.g., a driver, an owner, a proprietor, a leasee, a leasor) of the private vehicle 104 in transit to the geo-spatial location of the renter 114 of FIG. 1 through a mobile device of the operator 301 (e.g., a driver, an owner, a proprietor, a leasee, a leasor) of the private vehicle 104.

An availability indicator of the private vehicle 104 may be toggled based the communication through the dispatch module. An estimated time of arrival to a destination associated with the renter 114 of FIG. 1 may be calculated. An identifier of an operator 301 (e.g., a driver, an owner, a proprietor, a leasee, a leasor) of the private vehicle 104 may be transmitted to the mobile device and/or the data processing system of the renter 114 of FIG. 1 such that the renter 114 of FIG. 1 knows who and which vehicle is picking them up. The driver module 3804 of the ride request system 150 of FIG. 1 may generate a transaction document based on a communication through the passenger module 3808 to the driver module 3804. Data including a rental price may be communicated through the passenger module 3808 to the driver module 3804.

The driver module 3804 may electronically process an electronic signature of the transaction document by the prospective renter who executes the transaction document through an electronic signature means on the passenger module 3808, and wherein the driver module 3804 to subsequently communicate the transaction document to a renter device, a driver device, and a dispatch server 100 of FIG. 1. An attribute ranking may be generated into a ride scorecard prioritized based on at least one predefined ideal attribute definition provided by the prospective renter. The route of the private vehicle 104 may be adjusted based on a command processed of a passenger module 3808 of the ride request system 150 of FIG. 1 when the renter 114 of FIG. 1 requests a different destination address than an initial destination address. A credit may be provided to the prospective renter when the prospective renter refers a friend to the ride request system 150 of FIG. 1.

The credit may enable the prospective renter to request future rides in the ride request system 150 of FIG. 1. The renter 114 of FIG. 1 may be permitted automatically pay the operator 301 (e.g., a driver, an owner, a proprietor, a leasee, a leasor) of the private vehicle 104 of the vehicle a consideration upon reaching the destination through the ride request system 150 of FIG. 1. A gratuity may be automatically provided to the operator 301 (e.g., a driver, an owner, a proprietor, a leasee, a leasor) of the private vehicle 104 from the consideration provided by the renter 114 of FIG. 1 to the operator 301 (e.g., a driver, an owner, a proprietor, a leasee, a leasor) of the private vehicle 104. The gratuity may be a percentage of the consideration provided in a manner such that an additional gratuity amount is not required beyond the consideration tendered when the renter 114 of FIG. 1 automatically pays the operator 301 (e.g., a driver, an owner, a proprietor, a leasee, a leasor) of the private vehicle 104 the vehicle the consideration upon reaching the destination through the ride request system 150 of FIG. 1. The renter 114 of FIG. 1 may be permitted to provide a gift certificate in a form of rental credit to friends of the renter 114 of FIG. 1, such that the friends can redeem the gift certificate through the ride request system 150 of FIG. 1.

FIG. 1 is a network view of as dispatch server 100 having a radial distribution module 140 communicating with a device that generates a radial broadcast through an internet protocol network using a radial algorithm of the radial distribution module of the dispatch server 100, according to one embodiment.

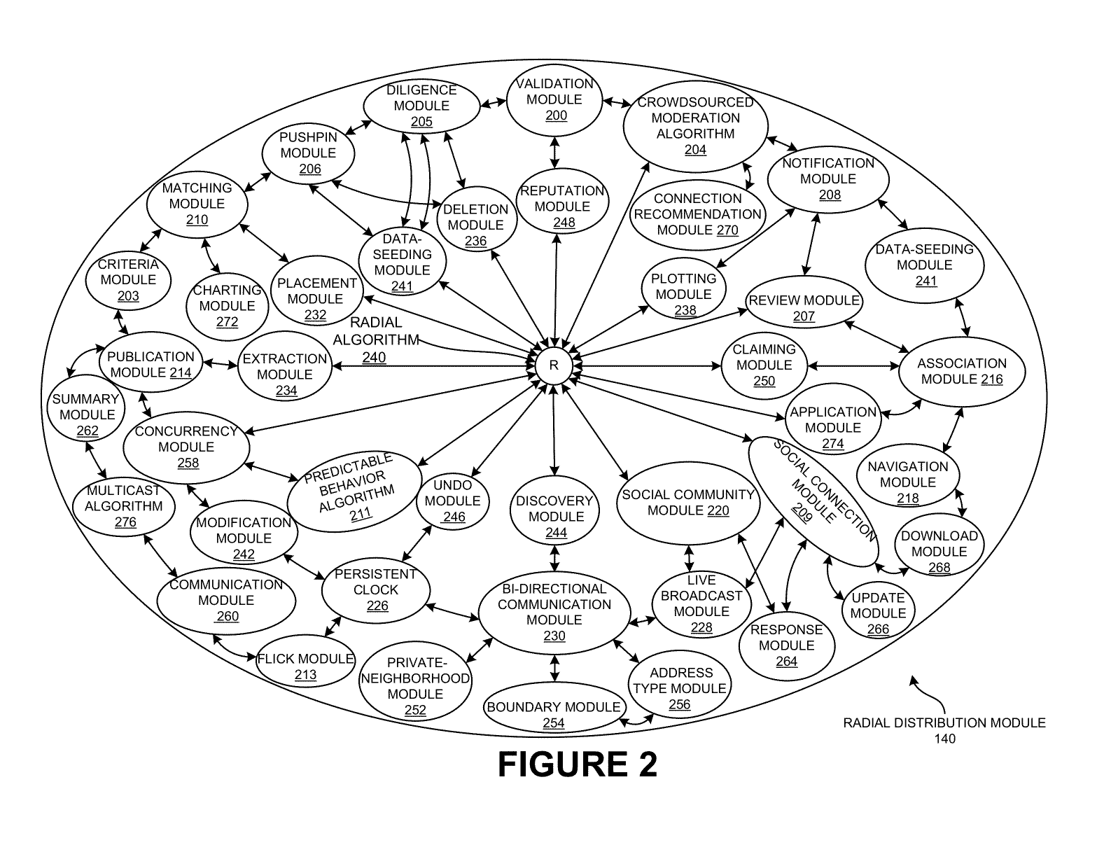

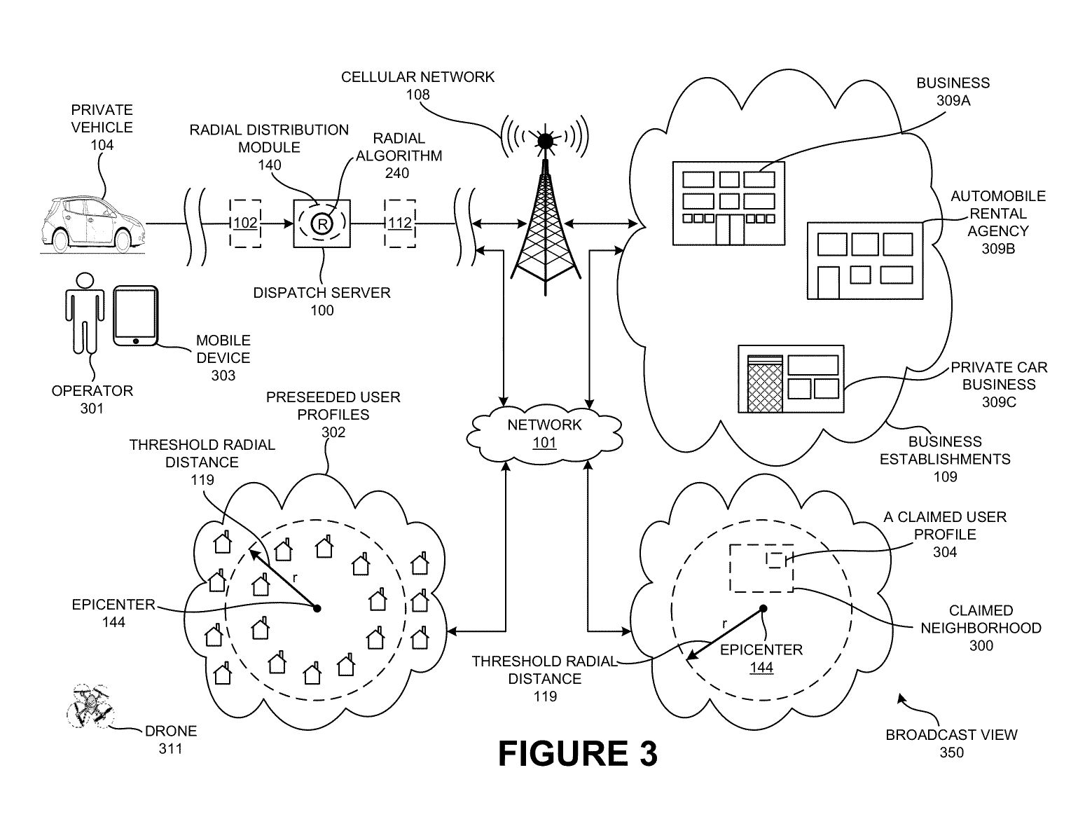

Particularly, FIG. 1 illustrates a ride request system 150, according to one embodiment. The embodiment of FIG. 1 describes an dispatch server 100, a network 101, an automotive listing data 102, a set of geospatial coordinates 103, a private vehicle 104, a cellular network 108, a business establishment 109 (including a business 309A, an automobile rental agency 309B and a private car business 309C as will be described in FIG. 3), a notification data 112, a set of renters 114, an area outside the threshold radial distance 115, a geospatial area 117, a threshold radial distance 119, a processor 120, a geospatial database 122, a memory 124, a radial distribution module 140 (e.g., that applies a radial algorithm 240 of FIG. 2 using a series of modules working in concert as described in FIG. 2), a vehicle renting network 142, an epicenter 144, a massively parallel computing architecture 146, and a distributed computing system 148.

The dispatch server 100 includes a processor 120, a memory 124, and a geospatial database 122, according to the embodiment of FIG. 1. The dispatch server 100 may be one or more server side data processing systems (e.g., web servers operating in concert with each other) that operate in a manner that provide a set of instructions to any number of client side devices (e.g., the private vehicle 104, a mobile device 303) communicatively coupled with the dispatch server 100 through the network 101. For example, the dispatch server 100 may be a computing system (e.g., or a group of computing systems) that operates in a larger client-server database framework (e.g., such as in a social networking software such as OiaCab.org, Fatdoor.com, Facebook.com, etc.).

The private vehicle 104 (e.g., private car, private motorcycle, private aerial vehicle, private vehicle) may access the dispatch server 100 through the network 101 using a browser application of the mobile device and/or through a client-side application downloaded to the private vehicle 104 (e.g., a OiaCab.org mobile application, a Fatdoor.com mobile application). The private vehicle 104 may be a hybrid can an electric car, a luxury vehicle (e.g., a Lincoln Towncar), a bus, a shared ride vehicle, a personal vehicle, and/or a taxi. In one embodiment, a software developer of the ride request system 150 may not own any vehicles themselves, and therefore may not be responsible for its own fleet of vehicles. In this embodiment, partner taxi and/or limo companies may work with the software developer by performing services in exchange for a percentage of fees collected through the ride request system 150. Alternatively, the software developer of the ride request system 150 may have his/her own fleet of vehicles. In an alternate embodiment, a mobile device (e.g., a mobile device 303, renter device 505) may access the dispatch server 100 through the network 101 using a browser application of the mobile device and/or through a client-side application downloaded to the private vehicle 104 (e.g., a OiaCab.org mobile application, a Fatdoor.com mobile application). In another embodiment, a non-mobile computing device, such as a desktop computer (not shown) may access the dispatch server 100 through the network 101.

The automotive listing data 102 may be communicated from the private vehicle 104 and/or mobile device to the dispatch server 100 through the network 101. The automotive listing data 102 may include information about a rental status of a private vehicle to renters 114 and/or the private vehicles 104 through the network 101. For example, the automobile dispatch broadcast may relate to an availability of the vehicle, a price of rental, a conditions of rental, an operating radius, a description of the vehicle etc.

The automotive listing data 102 may be generated and distributed through an application of the radial distribution module 140 (e.g., that applies the radial algorithm 240 of FIG. 2 using a series of modules working in concert as described in FIG. 2) of the dispatch server 100. The radial distribution module 140 (e.g., that applies the radial algorithm 240 of FIG. 2 using a series of modules working in concert as described in FIG. 2) may be a series of software functions/processes that simulates the experience of transmitting and receiving local broadcasts for the verified renter, according to one embodiment.

Using an internet protocol based network (e.g., the network 101), the dispatch server 100 may be able to use the radial distribution module 140 (e.g., that applies the radial algorithm 240 of FIG. 2 using a series of modules working in concert as described in FIG. 2) to simulate a radio frequency (RF) based communication network using an IP network topology of the network 101. Therefore, the automotive listing data 102 can be distributed using the dispatch server 100 to a geo-constrained area (e.g., the renters 114 in the geospatial area 117 and/or the private vehicles 104 in a geo-constrained area around an area in which the private vehicle 104 operates without requiring expensive broadcast towers, transceivers, transmitters, amplifiers, antennas, tuners and/or wave generating and interpreting hardware (e.g., as may be required in local ham radio communication, frequency modulation (FM) audio systems, etc.).

The radial distribution module 140 (e.g., that applies the radial algorithm 240 of FIG. 2 using a series of modules working in concert as described in FIG. 2) may recreate an experience of communication between parties in a geospatially restricted area (e.g., for example in the same city, in the surrounding neighborhood, in the same zip code, in the same building, in the same claimed neighborhood) through the use of an Internet protocol network. The dispatch server 100 may overcome technical challenges of determining a user's geospatial location, calculating distance to other verified renters based on relative geospatial locations, and/or coordinating information with a database of geo-coded information of interest (e.g., using the geospatial database 122) using the radial distribution module 140 (e.g., that applies the radial algorithm 240 of FIG. 2 using a series of modules working in concert as described in FIG. 2).

The radial distribution module 140 (e.g., that applies the radial algorithm 240 of FIG. 2 using a series of modules working in concert as described in FIG. 2), as a function/module of the dispatch server 100, may determine the location of the user, the distance between the user and/or the private vehicle 104 and/or other verified renters, and the distance between the user and locations of interest. With that information, the radial distribution module 140 (e.g., that applies the radial algorithm 240 of FIG. 2 using a series of modules working in concert as described in FIG. 2) may further determine which verified renters are within a predetermined vicinity of a user and/or private vehicle 104. This set of verified renters within the vicinity of another verified renter and/or private vehicle 104 may then be determined to be receptive to broadcasts transmitted by the user and to be available as transmitters of broadcasts to the user.

The radial distribution module 140 (e.g., that applies the radial algorithm 240 of FIG. 2 using a series of modules working in concert as described in FIG. 2) in effect may create a link between verified renters and/or private vehicles 104 of the network 101 that allows the users and/or private vehicles 104 to communicate with each other, and this link may be based on the physical distance between the users as measured relative to a current geospatial location of the private vehicle 104 and/or mobile device with a claimed and verified (e.g., through a verification mechanism such as a postcard verification, a utility bill verification, and/or a vouching of the user with other users) available state (e.g., a home location, a work location) of the user and/or other users. In an alternate embodiment, the transitory location of the user (e.g., their current location, a current location of their vehicle and/or mobile phone) and/or the private vehicle 104 and/or the other users may also be used by the radial algorithm to determine an appropriate threshold distance for broadcasting a message.

Furthermore, the radial distribution module 140 (e.g., that applies the radial algorithm 240 of FIG. 2 using a series of modules working in concert as described in FIG. 2) may automatically update a set of pages associated with profiles of individuals and/or businesses that have not yet joined the network based on preseeded address information. In effect, the radial distribution module 140 (e.g., that applies the radial algorithm 240 of FIG. 2 using a series of modules working in concert as described in FIG. 2) may update preseeded pages in a geo-constrained radial distance from where a broadcast originates (e.g., using an epicenter 144 calculated from the current location of the private vehicle 104 and/or a mobile device 303 (e.g., the mobile device of the operator 301 of the vehicle) and/or the renter device 505 with information about the automotive listing data 102. In effect, through this methodology, the radial distribution module 140 (e.g., that applies the radial algorithm 240 of FIG. 2 using a series of modules working in concert as described in FIG. 2) may leave ‘inboxes’ and/or post ‘alerts’ on pages created for users that have not yet signed up based on a confirmed address of the users through a public and/or a private data source (e.g., from Infogroup®, from a white page directory, etc.).

The radial distribution module 140 (e.g., that applies the radial algorithm 240 of FIG. 2 using a series of modules working in concert as described in FIG. 2) of the dispatch server 100 may be different from previous implementations because it is the first implementation to simulate the experience of local radio transmission between individuals using the internet and non-radio network technology by basing their network broadcast range on the proximity of verified renters to one another, according to one embodiment.

FIG. 1 illustrates a number of operations between the private vehicle 104 and the renters 114 and/or the private vehicles 104. Particularly, circle ‘1’ of FIG. 1 illustrates that the user of the private vehicle 104 communicates the automotive listing data 102 to the dispatch server 100 using the network 101. Then, after applying the radial algorithm 240 utilizing the radial distribution module 140, the dispatch server 100 generates and communicates an appropriate notification data (e.g., the notification data 112) associated with the automotive listing data 102 to a geospatially distributed set of renters 114 in a radial area (radius represented as ‘r’ of FIG. 1) in a geospatial vicinity from an epicenter 144 associated a present geospatial location with the private vehicle 104 as illustrated as circle ‘2’ in FIG. 1.

The radial algorithm 240 may operate as follows, according to one embodiment. The radial algorithm may utilize a radial distribution function (e.g., a pair correlation function)

g(r)

in the ride request system 150. The radial distribution function may describe how density varies as a function of distance from a user, according to one embodiment.

If a given user is taken to be at the origin O (e.g., the epicenter 144), and if

ρ=N/V

is the average number density of renters 114 in the ride request system 150, then the local time-averaged density at a distance r from O is

ρg(r)

according to one embodiment. This simplified definition may hold for a homogeneous and isotropic type of renters 114, according to one embodiment of the radial algorithm 240.

A more anisotropic distribution (e.g., exhibiting properties with different values when measured in different directions) of the renters 114 will be described below, according to one embodiment of the radial algorithm 240. In simplest terms it may be a measure of the probability of finding a renter at a distance of r away from a given user, relative to that for an ideal distribution scenario, according to one embodiment. The anisotropic algorithm involves determining how many renters 114 are within a distance of r and r+dr away from the user, according to one embodiment. The radial algorithm 240 may be determined by calculating the distance between all user pairs and binning them into a user histogram, according to one embodiment.

The histogram may then be normalized with respect to an ideal user at the origin o, where user histograms are completely uncorrelated, according to one embodiment. For three dimensions (e.g., such as a building representation in the vehicle renting network 142 in which there are multiple residents in each floor), this normalization may be the number density of the system multiplied by the volume of the spherical shell, which mathematically can be expressed as

g(r)ₓ=4πr³ρdr,

where ρ may be the user density, according to one embodiment of the radial algorithm 240.

The radial distribution function of the radial algorithm 240 can be computed either via computer simulation methods like the Monte Carlo method, or via the Ornstein-Zernike equation, using approximative closure relations like the Percus-Yevick approximation or the Hypernetted Chain Theory, according to one embodiment.

This may be important because by confining the broadcast reach of a verified renter in the ride request system 150 to a specified range, the radial distribution module 140 (e.g., that applies the radial algorithm 240 of FIG. 2 using a series of modules working in concert as described in FIG. 2) may replicate the experience of local radio broadcasting and enable verified renters to communicate information to their immediate neighbors as well as receive information from their immediate neighbors in areas that they care about, according to one embodiment. Such methodologies can be complemented with hyperlocal advertising targeted to potential users of the dispatch server 100 on preseeded profile pages and/or active user pages of the dispatch server 100. Advertisement communications thus may become highly specialized and localized resulting in an increase in their value and interest to the local verified renters of the network through the dispatch server 100. For example, advertisers may wish to communicate deals on private vehicles and/or taxi services to frequent users.

The radial distribution module 140 (e.g., that applies the radial algorithm 240 of FIG. 2 using a series of modules working in concert as described in FIG. 2) may also have wide application as it may solve the problem of trying to locate a receptive audience to a verified renter's broadcasts, whether that broadcast may be a request to rent, a one's personal music, an advertisement for a vehicle for rent, a solicitation for a new employee, and/or a recommendation for a good restaurant in the area. This radial distribution module 140 (e.g., that applies the radial algorithm 240 of FIG. 2 using a series of modules working in concert as described in FIG. 2) may eliminate unnecessarily broadcasting that information to those who are not receptive to it, both as a transmitter and as a renter of the broadcast. The radial algorithm saves both time (which may be limited in a situation in which a user requires transportation) and effort of every user involved by transmitting information only to areas that a user cares about, according to one embodiment.

In effect, the radial algorithm of the dispatch server 100 enables users to notify people around locations that are cared about (e.g., around where they live, work, and/or where they are physically located). In one embodiment, the user can be provided ‘feedback’ and/or a communication that the renter 114 may be responding to the broadcast after the automotive listing data 102 may be delivered to the renters 114 and/or to the private vehicles 104 using the radial distribution module 140 (e.g., that applies the radial algorithm 240 of FIG. 2 using a series of modules working in concert as described in FIG. 2) of the dispatch server 100. For example, after the automotive listing data 102 may be delivered, the private vehicle 104 and/or mobile device may display a message saying: “3256 neighbors around a 1 radius from you have been notified on their profile pages of your automobile dispatch broadcast in Menlo Park and 4 people are responding” and/or “8356 neighbors around a 2.7 radius from you have been notified of your live broadcast.”

In one embodiment, users may be able to organize deliveries and/or pick-ups from a ‘neighborhood drone’ (e.g., an unmanned aerial vehicle such as the drone 311) operated by the vehicle renting network 142. For example, Fatdoor.com may operate a set of drones (e.g., the drone 311 of FIG. 3) that can be dispatched and automatically instructed to pick up various items and deliver them to a resident of a home. The drone 311 may be aircraft without a human pilot on board. A flight path of the drone 311 may be a server of the geo-spatially constrained social network 142 either autonomously by computers in the drone 311 and/or through an automated navigation system based on a mapping algorithm.

In one embodiment, a neighbor offering a used item may request that a drone operated by Fatdoor.com be summoned by clicking on ‘request pickup’ on their mobile device. This may instruct the drone to fly to a backyard and/or front yard the home of a neighbor and physically pick up the used the item and deliver it to a borrower, minimizing time to do neighborhood errands. A neighbor who is selling and/or giving away an item may receive an alert when a drone arrives through their mobile device. Similarly, the renter of the item may receive an alert when the drone delivery is ready. Furthermore, this way, a limited set of drones can be shared by a set of users. Alternative to drones, Fatdoor and/or neighbors themselves may instruct private vehicles (e.g., the private vehicle 104 of FIG. 3) that they operate to pick up and deliver items to each other through their mobile device using the geo-spatial social network 142. The private vehicles may be personally owned and/or owned by the geospatially constrained social network.

For example the private vehicle 104 may be an private vehicle (e.g., a self-driving vehicle, robot vehicle) that is a private vehicle capable of fulfilling the transportation capabilities of a traditional vehicle. As a private vehicle, the private vehicle 104 may be capable of sensing its environment and navigating without human input.

The private vehicle 104 may be an private vehicle that senses its surroundings with such techniques as radar, lidar, GPS, and computer vision. Advanced control systems may interpret sensory information to identify appropriate navigation paths, as well as obstacles and relevant signage to/from a home offering a private automobile for rent in the vehicle renting network 142. The private vehicle 104 may update its maps based on sensory input, thereby permitting the private vehicle 104 to keep track of their position even when conditions change or when they enter uncharted environments in the neighborhood.

The various embodiments described herein of the dispatch server 100 using the radial distribution module 140 (e.g., that applies the radial algorithm 240 of FIG. 2 using a series of modules working in concert as described in FIG. 2) may solve a central problem of internet radio service providers (e.g., Pandora) by retaining cultural significance related to a person's locations of association. For example, the radial distribution module 140 (e.g., that applies the radial algorithm 240 of FIG. 2 using a series of modules working in concert as described in FIG. 2) may be used to ‘create’ new radio stations, television stations, and/or mini alert broadcasts to a geospatially constrained area on one end, and provide a means for those ‘tuning in’ to consume information posted in a geospatial area that the listener vehicles about and/or associates themselves with. The information provided can be actionable in that the user may be able to secure new opportunities through face to face human interaction and physical meeting not otherwise possible in internet radio scenarios.

The radial algorithm may be a set of instructions that may enable users (e.g., verified renters, non-verified renters, private vehicles) of the OiaCab.org and Fatdoor.com websites and applications to broadcast their activities (e.g., rental availability, Easter egg hunt, garage sale, t-shirt sale, crime alert) to surrounding neighbors within a claimed neighborhood and to guests of a claimed neighborhood, according to one embodiment. The radial algorithm may be new because current technology does not allow for users of a network (e.g., OiaCab.org, Fatdoor.com) to locally broadcast their activity to a locally defined geospatial area. With the radial algorithm, users of the network may communicate with one another in a locally defined manner, which may present more relevant information and activities, according to one embodiment.

For example, if a verified renter of the network broadcasts an availability of a private vehicle, locally defined neighbors of the verified renter may be much more interested in responding than if they observed a vehicle for rent on a general news broadcast on traditional radio, according to one embodiment. The radial distribution module 140 may solve the problem of neighbors living in the locally defined geospatial area who don't typically interact, and allows them to connect within a virtual space that did not exist before, according to one embodiment. Prior to this embodiment of the radial algorithm 240 operating through the radial distribution module 140, community boards (e.g., stolen or missing item boards) may have been a method of distributing content in a surrounding neighborhood effectively. However, there may have been little ways to easily distribute content related to exigent circumstances and/or with urgency in a broadcast-like manner to those listening around a neighborhood through mobile devices until the various embodiments applying the radial distribution module 140 as described herein.

A radial algorithm 240 may be a method of calculating a sequence of operations, and in this case a sequence of radio operations, according to one embodiment. Starting from an initial state and initial input, the radial algorithm 240 describes a computation that, when executed, proceeds through a finite number of well-defined successive states, eventually producing radial patterned distribution (e.g., simulating a local radio station), according to one embodiment.

The dispatch server 100 may solve technical challenges through the radial distribution module 140 (e.g., that applies the radial algorithm 240 of FIG. 2 using a series of modules working in concert as described in FIG. 2) by implementing a vigorous screening process to screen out any lewd or vulgar content in one embodiment. For example, what may be considered lewd content sometimes could be subjective, and verified renters could argue that the operator of the dispatch server 100 is restricting their constitutional right to freedom of speech (e.g., if the dispatch server 100 is operated by a government entity) through a crowd-moderation capability enabled by the radial distribution module 140 (e.g., that applies the radial algorithm 240 of FIG. 2 using a series of modules working in concert as described in FIG. 2), according to one embodiment. In one embodiment, verified renters may sign an electronic agreement to screen their content and agree that the ride request system 150 may delete any content that it deems inappropriate for broadcasting, through the radial distribution module 140 (e.g., that applies the radial algorithm 240 of FIG. 2 using a series of modules working in concert as described in FIG. 2) according to one embodiment. For example, it may be determined that a lost item such as a lost dog does not qualify as am automobile sharing related item that should be broadcast.

The radial distribution module 140 (e.g., that applies the radial algorithm 240 of FIG. 2 using a series of modules working in concert as described in FIG. 2), in addition to broadcasts, may allow verified renters to create and broadcast their own radio show, e.g., music, talk show, commercial, instructional contents, etc., and to choose their neighborhood(s) for broadcasting based on a claimed location, according to one embodiment. The radial distribution module 140 (e.g., that applies the radial algorithm 240 of FIG. 2 using a series of modules working in concert as described in FIG. 2) may allow users to choose the neighborhoods that they would want to receive the broadcasts, live and recorded broadcasts, and/or the types and topics (e.g., vehicle rental) of broadcasts that interest them.

The radial distribution module 140 (e.g., that applies the radial algorithm 240 of FIG. 2 using a series of modules working in concert as described in FIG. 2) based approach of the dispatch server 100 may be a completely different concept from the currently existing neighborhood (e.g., geospatial) social networking options. The radial distribution module 140 (e.g., that applies the radial algorithm 240 of FIG. 2 using a series of modules working in concert as described in FIG. 2) may also allow the user to create his/her own radio station, television station and/or other content such as the automotive listing data 102 and distribute this content around locations to users and preseeded profiles around them. For example, the user may wish to broadcast their live reporting of an available private vehicle 104. The radial distribution module 140 (e.g., that applies the radial algorithm 240 of FIG. 2 using a series of modules working in concert as described in FIG. 2) can allow verified renters to create their content and broadcast in the selected geospatial area. It also allows verified listeners to listen to only the relevant local broadcasts of their choice.

The radial distribution module 140 (e.g., that applies the radial algorithm 240 of FIG. 2 using a series of modules working in concert as described in FIG. 2) may be important because it may provide any verified renter the opportunity to create his/her own radial broadcast message (e.g., can be audio, video, pictorial and/or textual content) and distribute this content to a broad group. Radial distribution module 140 (e.g., that applies the radial algorithm 240 of FIG. 2 using a series of modules working in concert as described in FIG. 2) may also allow verified listeners to listen to any missed live broadcasts through the prerecorded features, according to one embodiment.

Through this, the radial distribution module 140 (e.g., that applies the radial algorithm 240 of FIG. 2 using a series of modules working in concert as described in FIG. 2) changes the way social networks (e.g., Nextdoor, Fatdoor, Facebook, Path, etc.) operate by enabling location centric broadcasting to regions that a user vehicles about, according to one embodiment. Radial distribution module 140 (e.g., that applies the radial algorithm 240 of FIG. 2 using a series of modules working in concert as described in FIG. 2) may solve a technical challenge by defining ranges based on a type of an automobile listing broadcast, a type of neighborhood, and/or boundary condition of a neighborhood by analyzing whether the automotive listing data 102 may be associated with a particular kind of renter, a particular neighborhood, a temporal limitation, and/or through another criteria.

By using the radial distribution module 140 (e.g., that applies the radial algorithm 240 of FIG. 2 using a series of modules working in concert as described in FIG. 2) of the dispatch server 100 the user may be able to filter irrelevant offers and information provided by broadcasts. In one embodiment, only the broadcasting user (e.g., the private vehicle 104, the operator 301 of the vehicle, the renter (e.g., the renter 114)) may be a verified renter to create accountability for a particular broadcast and/or credibility of the broadcaster. In this embodiment, renters 114 of the broadcast may not need to be verified renters of the ride request system. By directing traffic and organizing the onslaught of broadcasts, the radial distribution module 140 (e.g., that applies the radial algorithm 240 of FIG. 2 using a series of modules working in concert as described in FIG. 2) of the dispatch server 100 may be able to identify the origins and nature of each group of incoming information and locate renters 114 that are relevant/interested in the automotive listing data 102, maximizing the effective use of each broadcast. For example, the renter 114 may be able to specify that they do like SUVs so that they would be a relevant renter 114 for broadcast data regarding an SUV for rent. In another example, a renter 114 may specify that they do not like SUVs and/or do not want to rent from and/or to a user with a certain rating so they would not be included in related broadcasts, according to one embodiment.

The radial distribution module 140 (e.g., that applies the radial algorithm 240 of FIG. 2 using a series of modules working in concert as described in FIG. 2) of the dispatch server 100 may process the input data from the private vehicle 104 and/or mobile device (e.g., the mobile device 303, the renter device 505) in order to identify which notification(s) to broadcast to which individual(s). This may be separate from a traditional radio broadcast as it not only geographically constrains broadcasters and renters 114 but also makes use of user preferences in order to allow broadcasters to target an optimal audience and allow renters 114 to alter and customize what they consume. The user may associate his/herself with a non-transitory address in order to remain constantly connected to their neighborhood and/or neighbors even when they themselves or their neighbors are away. The radial algorithm 240 may be also unique from a neighborhood social network (e.g., the vehicle renting network 142) as it permits users to broadcast emergencies, information, audio, video etc. to other users, allowing users to create their own stations.

In order to implement the radial distribution module 140 (e.g., that applies the radial algorithm 240 of FIG. 2 using a series of modules working in concert as described in FIG. 2), geospatial data may need to be collected and amassed in order to create a foundation on which users may sign up and verify themselves by claiming a specific address, associating themselves with that geospatial location. The radial distribution module 140 (e.g., that applies the radial algorithm 240 of FIG. 2 using a series of modules working in concert as described in FIG. 2) may then be able to utilize the geospatial database 122 to filter out surrounding noise and deliver only relevant data to renters 114.

In order to accomplish this, the radial distribution module 140 (e.g., that applies the radial algorithm 240 of FIG. 2 using a series of modules working in concert as described in FIG. 2) may be able to verify the reliability of geospatial coordinates, time stamps, and user information associated with the private vehicle 104 and/or mobile device. In addition, threshold geospatial radii, private neighborhood boundaries, and personal preferences may be established in the dispatch server 100 and accommodated using the radial distribution module 140 (e.g., that applies the radial algorithm 240 of FIG. 2 using a series of modules working in concert as described in FIG. 2). The geospatial database 122 may work in concert with the radial distribution module 140 (e.g., that applies the radial algorithm 240 of FIG. 2 using a series of modules working in concert as described in FIG. 2) to store, organize, and manage broadcasts, pushpins, user profiles, preseeded user profiles, metadata, and epicenter 144 locations associated with the vehicle renting network 142 (e.g., a neighborhood social network such as Fatdoor.com, OiaCab.org).

The radial algorithm 240 may be used to calculate relative distances between each one of millions of records as associated with each placed geo-spatial coordinate in the vehicle renting network 142 (e.g., a neighborhood social network such as Fatdoor.com, OiaCab.org). Calculations of relative distance between each geospatial coordinate can be a large computational challenge because of the high number of reads, writes, modify, and creates associated with each geospatial coordinate added to the vehicle renting network 142 and subsequent recalculations of surrounding geospatial coordinates associated with other users and/or other profile pages based a relative distance away from a newly added set of geospatial coordinates (e.g., associated with the automotive listing data 102 and/or with other pushpin types). To overcome this computational challenge, the radial algorithm may leverage a massively parallel computing architecture 146 through which processing functions are distributed across a large set of processors accessed in a distributed computing system 148 through the network 101.

In order to achieve the utilization of the massively parallel computing architecture 146 in a context of a radial distribution function of a vehicle renting network 142, a number of technical challenges have been overcome in at least one embodiment. Particularly, the radial distribution module 140 constructs a series of tables based on an ordered geospatial ranking based on frequency of interaction through a set of ‘n’ number of users simultaneously interacting with the vehicle renting network 142, in one preferred embodiment. In this manner, sessions of access between the dispatch server 100 and users of the dispatch server 100 (e.g., the user) may be monitored based on geospatial claimed areas of the user (e.g., a claimed work and/or home location of the user and/or the available state of the private vehicle 3508), and/or a present geospatial location of the user. In this manner, tables associated with data related to claimed geospatial areas of the user (e.g., the user, the user's private vehicle) and/or the present geospatial location of the user may be anticipatorily cached in the memory 124 to ensure that a response time of the vehicle renting network 142 may be not constrained by delays caused by extraction, retrieval, and transformation of tables that are not likely to be required for a current and/or anticipated set of sessions between users and the dispatch server 100.

In a preferred embodiment, an elastic computing environment may be used by the radial distribution module 140 to provide for increase/decreases of capacity within minutes of a database function requirement. In this manner, the radial distribution module 140 can adapt to workload changes based on number of requests of processing simultaneous and/or concurrent requests associated with automotive listing data 102 by provisioning and deprovisioning resources in an autonomic manner, such that at each point in time the available resources match the current demand as closely as possible.

The radial distribution module 140 (e.g., that applies the radial algorithm 240 of FIG. 2 using a series of modules working in concert as described in FIG. 2) may be a concept whereby a server communicating data to a dispersed group of renters 114 over a network 101, which may be an internet protocol based wide area network (as opposed to a network communicating by radio frequency communications) communicates that data only to a geospatially-constrained group of renters 114. The radial distribution module 140 (e.g., that applies the radial algorithm 240 of FIG. 2 using a series of modules working in concert as described in FIG. 2) may apply a geospatial constraint related to a radial distance away from an origin point, or a constraint related to regional, state, territory, county, municipal, neighborhood, building, community, district, locality, and/or other geospatial boundaries.

The radial distribution module 140 (e.g., that applies the radial algorithm 240 of FIG. 2 using a series of modules working in concert as described in FIG. 2) may be new as applied to data traveling over wide area networks using internet protocol topology in a geospatial social networking and commerce context, according to one embodiment. While radio broadcasts, by their nature, are transmitted in a radial pattern surrounding the origin point, there may be no known mechanism for restricting access to the data only to verified renters of a service subscribing to the broadcast. As applied to wired computer networks, while techniques for applying geospatial constraints have been applied to search results, and to other limited uses, there has as yet been no application of geospatial constraint as applied to the various embodiments described herein using the radial distribution module 140 (e.g., that applies the radial algorithm 240 of FIG. 2 using a series of modules working in concert as described in FIG. 2).

The radial distribution module 140 (e.g., that applies the radial algorithm 240 of FIG. 2 using a series of modules working in concert as described in FIG. 2) may be roughly analogous to broadcast radio communications such as a) in broadcast radio, b) in wireless computer networking, and c) in mobile telephony. However, all of these systems broadcast their information promiscuously, making the data transmitted available to anyone within range of the transmitter who may be equipped with the appropriate receiving device. In contrast, the radial distribution module 140 (e.g., that applies the radial algorithm 240 of FIG. 2 using a series of modules working in concert as described in FIG. 2) herein describes a system in which networks are used to transmit data in a selective manner in that information may be distributed around a physical location of homes or businesses in areas of interest/relevancy.

The radial distribution module 140 (e.g., that applies the radial algorithm 240 of FIG. 2 using a series of modules working in concert as described in FIG. 2) may solve a problem of restricting data transmitted over networks to specific users who are within a specified distance from the individual who originates the data. In a broad sense, by enabling commerce and communications that are strictly limited within defined neighborhood boundaries, the radial distribution module 140 (e.g., that applies the radial algorithm 240 of FIG. 2 using a series of modules working in concert as described in FIG. 2) may enable the vehicle renting network 142 (e.g., a neighborhood social network such as Fatdoor.com, OiaCab.org) communications, attacking the serious social conditions of anonymity and disengagement in community that afflict the nation and, increasingly, the world.

The radial distribution module 140 (e.g., that applies the radial algorithm 240 of FIG. 2 using a series of modules working in concert as described in FIG. 2) may comprise one or more modules that instruct the dispatch server 100 to restrict the broadcasting of the automotive listing data 102 to one or more parts of the geospatial area 117. For example, in the embodiment of FIG. 1, the radial distribution module 140 (e.g., that applies the radial algorithm 240 of FIG. 2 using a series of modules working in concert as described in FIG. 2) may instruct the dispatch server 100 to broadcast the automotive listing data 102 to the renters 114 but not to the area outside the threshold radial distance 119.

In one or more embodiments, the radial distribution module 140 (e.g., that applies the radial algorithm 240 of FIG. 2 using a series of modules working in concert as described in FIG. 2) may allow the dispatch server 100 to function in manner that simulates a traditional radio broadcast (e.g., using a radio tower to transmit a radio frequency signal) in that both the dispatch server 100 and the radio broadcast are restricted in the geospatial scope of the broadcast transmission. In one or more embodiments, the radial distribution module 140 (e.g., that applies the radial algorithm 240 of FIG. 2 using a series of modules working in concert as described in FIG. 2) may prevent the broadcast of the automotive listing data 102 to any geospatial area to which the user does not wish to transmit the automotive listing data 102, and/or to users that have either muted and/or selectively subscribed to a set of broadcast feeds.

The radial distribution module 140 (e.g., that applies the radial algorithm 240 of FIG. 2 using a series of modules working in concert as described in FIG. 2) may analyze the automotive listing data 102 to determine which renters 114 may receive notification data 112 within the threshold radial distance 119 (e.g., set by the user and/or auto calculated based on a type of broadcast). The radial distribution module 140 (e.g., that applies the radial algorithm 240 of FIG. 2 using a series of modules working in concert as described in FIG. 2) may use a variety of parameters, including information associated with the automotive listing data 102 (e.g., location of the private vehicle 104 for rent, type of vehicle, rental price etc.) to determine the threshold radial distance 119.

The radial distribution module 140 (e.g., that applies the radial algorithm 240 of FIG. 2 using a series of modules working in concert as described in FIG. 2) may also determine which verified addresses associated with renters 114 having verified renter profiles are located within the threshold radial distance 119. The radial distribution module 140 (e.g., that applies the radial algorithm 240 of FIG. 2 using a series of modules working in concert as described in FIG. 2) may then broadcast the notification data 112 to the profiles and/or mobile devices of the verified renters having verified addresses within the threshold radial distance 119.

The radial distribution module 140 (e.g., that applies the radial algorithm 240 of FIG. 2 using a series of modules working in concert as described in FIG. 2) may therefore simulate traditional radio broadcasting (e.g., from a radio station transmission tower) over the IP network. Thus, the radial distribution module 140 (e.g., that applies the radial algorithm 240 of FIG. 2 using a series of modules working in concert as described in FIG. 2) may allow the broadcast to include information and data that traditional radio broadcasts may not be able to convey, for example geospatial coordinates and/or real-time bi-directional communications. Additionally, the radial distribution module 140 (e.g., that applies the radial algorithm 240 of FIG. 2 using a series of modules working in concert as described in FIG. 2) may allow individual users low-entry broadcast capability without resort to expensive equipment and/or licensing by the Federal Communications Commission (FCC).

Another advantage of this broadcast via the radial distribution module 140 (e.g., that applies the radial algorithm 240 of FIG. 2 using a series of modules working in concert as described in FIG. 2) may be that it may bypass obstructions that traditionally disrupt radio waves such as mountains and/or atmospheric disturbances. Yet another advantage of the radial distribution module 140 (e.g., that applies the radial algorithm 240 of FIG. 2 using a series of modules working in concert as described in FIG. 2) may be that it may expand the physical distance of broadcast capability without resort to the expense ordinarily associated with generating powerful carrier signals. In yet another advantage, the radial distribution module 140 (e.g., that applies the radial algorithm 240 of FIG. 2 using a series of modules working in concert as described in FIG. 2) may allow for almost unlimited channels and/or stations as compared to traditional radio where only a narrow band of electromagnetic radiation has been appropriated for use among a small number of entities by government regulators (e.g., the FCC).

The user may be an individual who owns the private vehicle 104 and/or operates the mobile device to generate the automotive listing data 102. It will be understood by those skilled in the art that the verified nature of the user may be an optional characteristic in an alternate embodiment. This means that in an alternate embodiment, any user (whether verified or not) may generate the automotive listing data 102 through the private vehicle 104 and/or mobile device (e.g., the mobile device 303). In another alternative embodiment, the user may be an electronic sensor, such as a detection sensor device (e.g., a traffic camera etc.), and/or an appliance (e.g., a refrigerator, a home security network, and/or a motion detector). It should also be noted that the ‘mobile’ nature of the mobile device 303 may be optional in yet another alternative embodiment. In such an alternate embodiment, any computing device, whether mobile/portable or fixed in location may generate the automotive listing data 102.

The cellular network 108 may be associated with a telephone carrier (e.g., such as AT&T, Sprint, etc.) that provides an infrastructure through which communications are generated between the dispatch server 100 and the private vehicles 104 using the radial algorithm 240. For example, the cellular network 108 may provide a communication infrastructure through which the automotive listing data 102 may be communicated as voice and/or text messages through telephones (e.g., standard telephones and/or smart phones) operated by at least some of the private vehicles 104 of FIG. 1. It should be understood that in one embodiment, the private vehicles 104 are paid subscribers/customers of the vehicle renting network 142 in a manner such that each of the private vehicles 104 may pay a fee per received automotive listing data 102, and/or each hired engagement to the vehicle renting network 142. The private vehicles 104 may pay extra to be permitted access to receive the automotive listing data 102 even when they do not have a transitory and/or non-transitory connection to a neighborhood if they service that neighborhood area. For this reason, FIG. 1 visually illustrates that the private vehicles 104 may be located (e.g., principal business address) outside the threshold radial distance 119.

The cellular network 108 (e.g., a mobile network) may be a wireless network distributed over land areas called cells, each served by at least one fixed-location transceiver, known as a cell site or base station through which the automotive listing data 102 is distributed from the dispatch server 100 to telephones of the private vehicles 104 using the radial distribution module 140 (e.g., that applies the radial algorithm 240 of FIG. 2 using a series of modules working in concert as described in FIG. 2), according to one embodiment. The cellular network 108 may use a set of frequencies from neighboring cells, to avoid interference and provide guaranteed bandwidth within each cell, in one embodiment.

When joined together these cells of the cellular network 108 may provide radio coverage over a wide geographic area through the cellular network 108 in a manner that ensures that the automotive listing data 102 may be simultaneously communicated via both IP networks (e.g., to the renters 114) and/or to the private vehicles 104 through the cellular network 108. It will be appreciated that the radial distribution module 140 (e.g., that applies the radial algorithm 240 of FIG. 2 using a series of modules working in concert as described in FIG. 2) in effect permits simultaneous updates to claimed user pages, unclaimed (preseeded) user pages in a vehicle renting network 142 (e.g., neighborhood social network) based on a geospatial location of the private vehicle 104 and/or mobile device in a manner that simulates a radio (RF) based network separately from the concepts described in conjunction with the cellular network 108. However, it will be understood that the radial distribution module 140 (e.g., that applies the radial algorithm 240 of FIG. 2 using a series of modules working in concert as described in FIG. 2) may be not restricted to such topology and can multimodally communicate through different networks, such as through the cellular network 108 described in FIG. 1.

The private vehicles 104 may be locations, devices, and/or mobile phones associated with individuals and/or agencies associated with businesses (e.g., a car rental establishment, a taxi/limo service, a delivery service, an office building with employees that may require transportation). The private vehicles 104 may be notified when an automobile dispatch broadcast in an area that they service including an available state (e.g., around where they live and/or work, regardless of where they currently are) and a transitory location (e.g., where they currently are) is posted using the private vehicle 104 and/or mobile device (e.g., the mobile device 303) as the automotive listing data 102.

The private vehicles 104 are illustrated in FIG. 3 as including a business 309A, an automobile rental agency 309B, and a private car business 309C. In this manner, mobile devices and/or desktop computers operated by the private vehicles 104 may be alerted whenever the automotive listing data 102 is posted in and/or around their neighborhood through a push notification (e.g., an alert popping up on their phone), through an email, a telephone call, and/or a voice message delivered to the particular mobile device operated by each of the private vehicles 104 using the radial distribution module 140 (e.g., that applies the radial algorithm 240 of FIG. 2 using a series of modules working in concert as described in FIG. 2).

The automotive listing data 102 may be delivered as notification data 112 (which may include a number of attributes) from the dispatch server 100 to the renters 114 and/or to the private vehicles 104 using the radial distribution module 140 (e.g., that applies the radial algorithm 240 of FIG. 2 using a series of modules working in concert as described in FIG. 2) of the dispatch server 100.

The renters 114 may be individuals that have claimed a profile (e.g., verified their profile through a postcard, a telephone lookup, a utility bill) associated with a particular non-transitory address (e.g., a home address, a work address) through a geospatial social network (e.g., a vehicle renting network 142 (e.g., a neighborhood social network such as Fatdoor.com, OiaCab.org)) through which the dispatch server 100 operates. The renters 114 may be in a geo-fenced area, in that an epicenter 144 of a broadcast message from the private vehicle 104 and/or mobile device may be a center through which a radial distance is calculated based on a characteristic of the automotive listing data 102. For example, a vehicle for rent by the user's work may be delivered only to an immediate 0.1 mile radius, whereas vehicle for rent by the user's home may be automatically delivered to a broader 0.6 mile radius either automatically and/or through a user defined preference (e.g., set by the user).

It should be appreciated that individuals in an area outside the threshold radial distance 119 may not receive the automotive listing data 102 because their geospatial address may be outside a radial boundary surrounding an epicenter 144 in which the automotive listing data 102 originates. Additionally, the threshold radial distance 119 may be confined on its edges by a geospatial polygon at a juncture between the area defined by renters 114 and the area outside the threshold radial distance 119, according to one embodiment.

FIG. 2 is an exploded view of the radial distribution module 140 of FIG. 1 that applies the radial algorithm 240, according to one embodiment.

Particularly, FIG. 2 illustrates an exploded view of the radial distribution module 140, according to one embodiment. A variety of software instruction sets and/or hardware components form the radial distribution module 140, according to one embodiment. Select ones of these software instruction sets and/or hardware components utilize the radial algorithm 240 to perform functions related to radially distributing information to pre-seeded user profiles, user profiles, and telephone devices (e.g., land based phones, circuit switched phones).

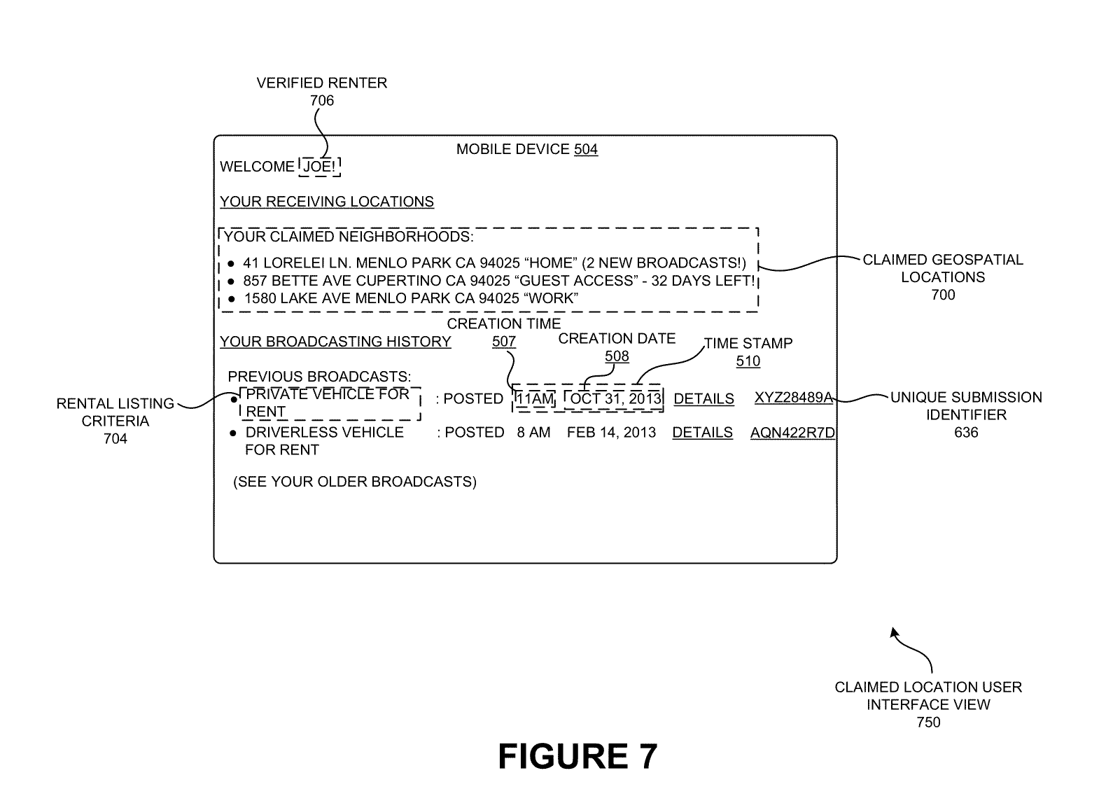

A validation module 200 may determine that an automotive listing data 102 generated through a mobile device 303 may be associated with a verified renter (e.g., the user of FIG. 1 as described as the verified renter 706 (e.g., verified user) in FIG. 7 of the dispatch server 100) using a processor 120 and/or a memory 124. In addition, the validation module 200 may determine that the broadcast data (e.g., the automotive listing data 102) is generated by the validated user (e.g., the user of FIG. 1 as described as the verified renter 706 in FIG. 7) of the private taxi system (e.g., of the vehicle renting network 142) when analyzing that the broadcast data (e.g., the automotive listing data 102) is associated with the mobile device 303. The validation module 200 may apply the radial algorithm 240 to determine if the verified renter 706 may be in a validated geospatial location based on previous history of the verified renter 706, according to one embodiment.

In addition, the validation module 200 may ensure that a set of geospatial coordinates 103 associated with the automotive listing data 102 generated through the mobile device 303 and/or private vehicle 104 are trusted based on a claimed geospatial location (e.g., any of the claimed geospatial locations 700 as described in FIG. 7 of the verified renter (e.g., the user of FIG. 1 as described as the verified renter 706 in FIG. 7) of the dispatch server 100). The validation module 200 may also determine that the automotive listing data 102 is generated by the verified renter of the private taxi system when validating that the automotive listing data 102 is associated with the mobile device

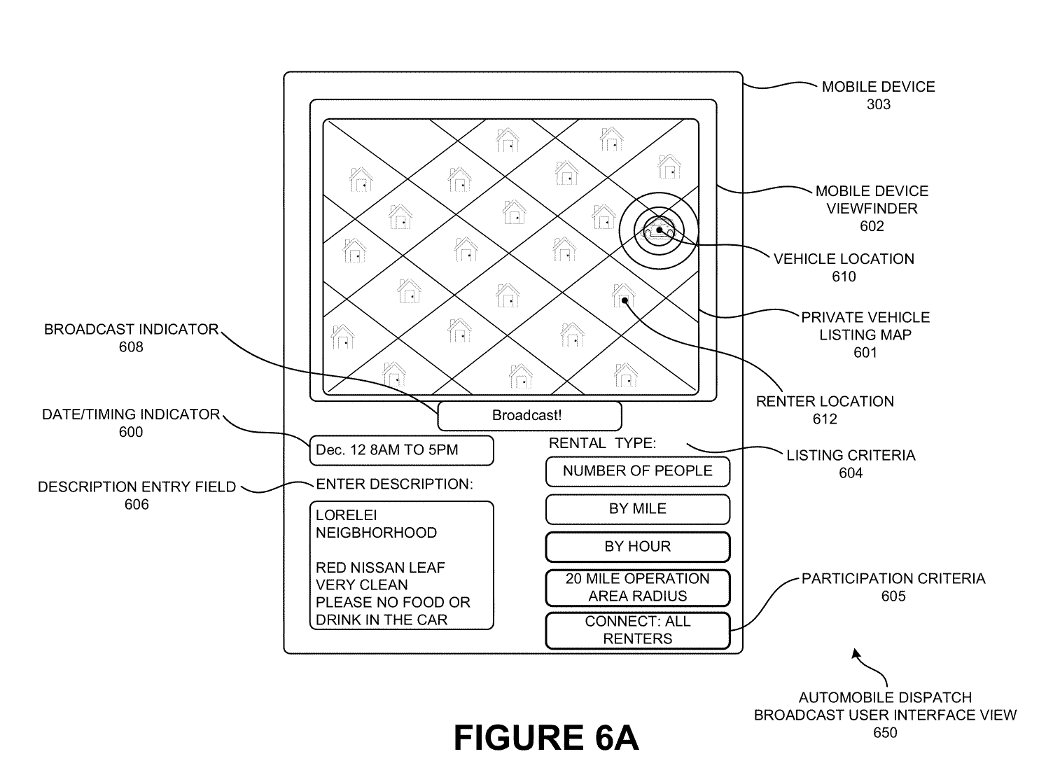

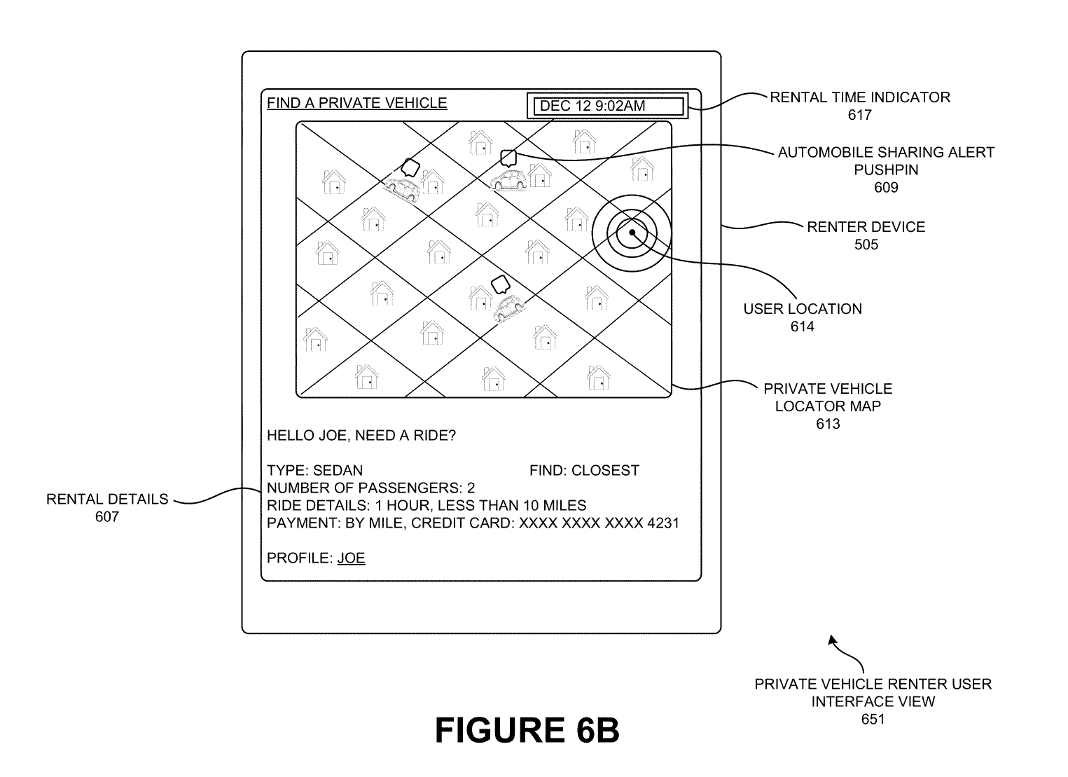

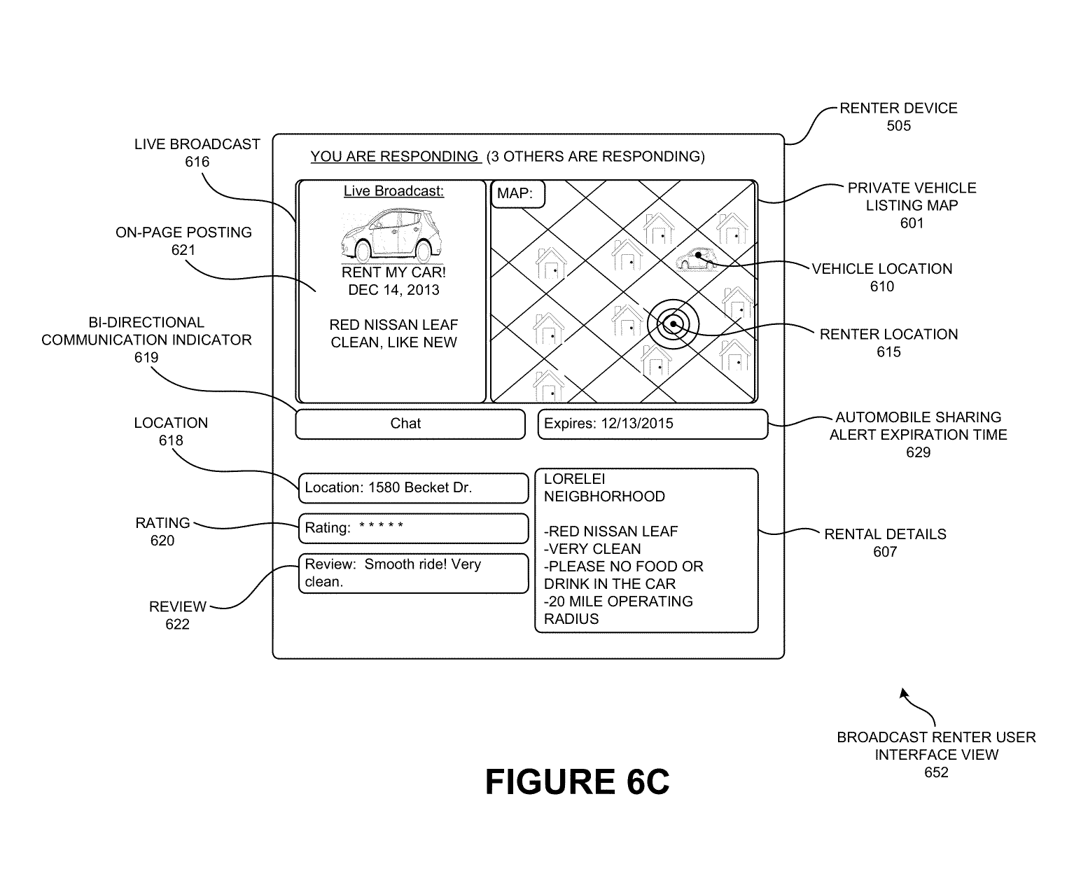

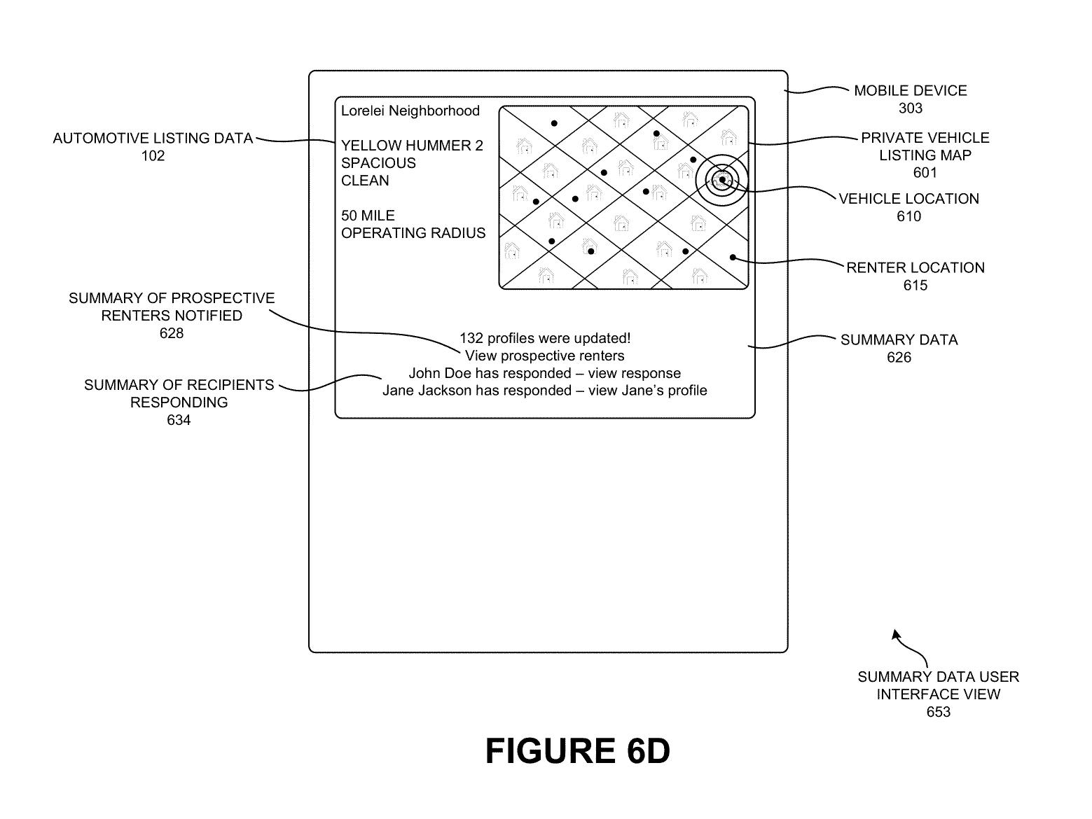

A charting module 272 may populate an availability chart when the private vehicle (e.g., the private vehicle 104) associated with the listing criteria 604 is posted. The availability chart may include an operation area radius, a start timing, an end timing, an hours per day, and/or an hours per user. A pushpin module 206 may present the automotive listing data 102 generated through the mobile device 303 and/or private vehicle 104 as an automobile sharing pushpin of the automobile dispatch broadcast in a geospatial map surrounding pre-populated residential and/or business listings in a surrounding vicinity, such that the automobile sharing alert pushpin 609 (shown in FIG. 6B) of the automobile dispatch broadcast may be automatically presented on the geospatial map in addition to being presented on the set of user profiles (e.g., preseeded user profiles 302 and/or claimed user profiles 304 as described in FIG. 3) having associated verified addresses in the threshold radial distance 119 from the set of geospatial coordinates 103 associated with the automotive listing data 102 generated through the mobile device 303 and/or private vehicle 104 and/or private vehicle 104 of the verified renter (e.g., the user of FIG. 1 as described as the verified renter 706 in FIG. 7) of the dispatch server 100).

A radial distribution module 140 may radially distribute the automotive listing data 102 generated through the mobile device 303 and/or private vehicle 104 through an on-page posting, an electronic communication, and/or a push notification delivered to desktop and/or mobile devices 504 associated with users and/or their user profiles (e.g., preseeded user profiles 302 and/or claimed user profiles 304 as described in FIG. 3) around an epicenter defined at the set of geospatial coordinates 103 associated with the automotive listing data 102 generated through the mobile device 303 and/or private vehicle 104 to all subscribed user profiles (e.g., preseeded user profiles 302 and/or claimed user profiles 304 as described in FIG. 3) in a circular geo-fenced area defined by the threshold distance from the set of geospatial coordinates 103 associated with the automotive listing data 102 generated through the mobile device 303 and/or private vehicle 104 through the radial algorithm 240 of the ride request system 150 that measures a distance away of each address associated with each user profile from the current geospatial location at the epicenter. A placement module 232 may permit the verified renter (e.g., the user of FIG. 1 as described as the verified renter 706 in FIG. 7) to drag and/or drop the automobile sharing alert pushpin 609 on any location on the geospatial map, and/or automatically determining a latitude and/or a longitude associated a placed location.

A notification module 208 may automatically notify a user, business 309A, an automobile rental agency 309B and a private car business 309C in a surrounding geospatial area to the set of geospatial coordinates 103 associated with the automotive listing data 102 generated through the mobile device 303 and/or private vehicle 104. An extraction module 234 may separate the geospatial coordinates 103 from a metadata associated with the automotive listing data 102 generated through the mobile device 303 and/or private vehicle 104 when verifying that the set of geospatial coordinates 103 associated with the automotive listing data 102 generated through the mobile device 303 and/or private vehicle 104 are trusted based on the claimed geospatial location (e.g., any of the claimed geospatial locations 700 as described in FIG. 7 of the verified renter (e.g., the user of FIG. 1 as described as the verified renter 706 in FIG. 7) of the dispatch server 100).

A persistent clock 226 may enable the dispatch server 100 to determine a relative match between the persistent clock and a digital clock of the private vehicle 104 and/or mobile device 303. A social community module 220 may permit the user to view profiles and/or locations in their claimed neighborhood and/or build a building, floor, room representation of a structure in their claimed neighborhood. A navigation module 218 may automatically instruct the private vehicle to navigate to a location of the renter. A matching module 210 may determine a relative match between a persistent clock associated with the dispatch server 100 and/or a digital clock of the private vehicle 104 and/or mobile device 303 to determine that the time stamp 510 associated with the creation date 508 and/or time of the automotive listing data 102 generated through the mobile device 303 and/or private vehicle 104 may be accurate and/or therefore trusted.

A deletion module 236 may automatically remove a publishing of the automotive listing data 102 generated through the mobile device 303 and/or private vehicle 104 on a set of user profiles (e.g., preseeded user profiles 302 and/or claimed user profiles 304 as described in FIG. 3 having associated verified addresses in the threshold radial distance 119 from the set of geospatial coordinates 103 associated with the automotive listing data 102 generated through the mobile device 303 and/or private vehicle 104 of the verified renter (e.g., the user of FIG. 1 as described as the verified renter 706 in FIG. 7) of the dispatch server 100) based on an automobile sharing alert expiration time 629. A flick module 213 may provide an interface to the user (e.g., verified renter 706, the operator 301 of the vehicle, the renter 114 (e.g., the renter)) such that the operator of the private vehicle can use a haptic ‘flick’ gesture in a horizontal and/or a vertical fashion to switch a viewing pane associated with a profile. A plotting module 238 may geocode a set of private-car renter user addresses each associated with a resident name in a neighborhood surrounding the mobile device 303 and/or private vehicle 104.

A data-seeding module 241 may prepopulate the set of private-car renter user addresses each associated with the resident name as the set of user profiles (e.g., preseeded user profiles 302 and/or claimed user profiles 304 as described in FIG. 3 in the threshold radial distance 119 from the claimed geospatial location (e.g., any of the claimed geospatial locations 700 as described in FIG. 7 of the verified renter (e.g., the user of FIG. 1 as described as the verified renter 706 in FIG. 7) of the dispatch server 100) in a ride request system (e.g., part of the vehicle renting network 142) communicatively coupled with the dispatch server 100. A modification module 242 may alter content in each of the set of user profiles (e.g., preseeded user profiles 302 and/or claimed user profiles 304 as described in FIG. 3).

A discovery module 244 may track the modified content through the ride request system (e.g., part of the vehicle renting network 142). An undo module 246 may generate a reversible history journal associated with each of the set of user profiles (e.g., preseeded user profiles 302 and/or claimed user profiles 304 as described in FIG. 3 such that a modification of the verified renter (e.g., the user of FIG. 1 as described as the verified renter 706 in FIG. 7) can be undone on a modified user profile page. A reputation module 248 may determine an editing credibility of the verified renter (e.g., the user of FIG. 1 as described as the verified renter 706 in FIG. 7) based on an edit history of the verified renter (e.g., the user of FIG. 1 as described as the verified renter 706 in FIG. 7) and/or a community contribution validation of the verified renter (e.g., the user of FIG. 1 as described as the verified renter 706 in FIG. 7) by other users of the ride request system (e.g., part of the vehicle renting network 142).

A publication module 214 may automatically communicate the automotive listing data 102 generated through the mobile device 303 and/or private vehicle 104 to a set of user profiles (e.g., preseeded user profiles 302 and/or claimed user profiles 304 as described in FIG. 3 having associated verified addresses in a threshold radial distance 119 from the claimed geospatial location (e.g., any of the claimed geospatial locations 700 as described in FIG. 7 of the verified renter (e.g., the user of FIG. 1 as described as the verified renter 706 in FIG. 7) of the dispatch server 100) using the radial algorithm 240. A claiming module 250 may process a claim request of the verified renter (e.g., the user of FIG. 1 as described as the verified renter 706 in FIG. 7) generating the automotive listing data 102 generated through the mobile device 303 and/or private vehicle 104 to be associated with an address of the ride request system (e.g., part of the vehicle renting network 142). A private-neighborhood module 252 may determine if the claimable neighborhood in the ride request system (e.g., part of the vehicle renting network 142) may be associated with a car sharing community in the claimable neighborhood of the ride request system (e.g., part of the vehicle renting network 142).

An association module 216 may associate the verified renter (e.g., the user of FIG. 1 as described as the verified renter 706 in FIG. 7) with the car sharing community in the claimable neighborhood of the ride request system (e.g., part of the vehicle renting network 142) if the car sharing community has been activated by the verified renter (e.g., the user of FIG. 1 as described as the verified renter 706 in FIG. 7) and/or a different verified renter (e.g., the user of FIG. 1 as described as the verified renter 706 in FIG. 7). A boundary module 254 may permit the verified renter (e.g., the user of FIG. 1 as described as the verified renter 706 in FIG. 7) to draw a set of boundary lines in a form of a geospatial polygon such that the claimable neighborhood in a geospatial region surrounding the claim request creates the car sharing community in the ride request system (e.g., part of the vehicle renting network 142) if the car sharing community may be inactive. An address type module 256 may verify the claim request of the verified renter (e.g., the user of FIG. 1 as described as the verified renter 706 in FIG. 7) generating the automotive listing data 102 generated through the mobile device 303 and/or private vehicle 104 to be associated with a neighborhood address of the ride request system (e.g., part of the vehicle renting network 142) when the address may be determined to be associated with a work address and/or a residential address of the verified renter (e.g., the user of FIG. 1 as described as the verified renter 706 in FIG. 7).

A concurrency module 258 may simultaneously publish the automotive listing data 102 generated through the mobile device 303 and/or private vehicle 104 on the car sharing community associated with the verified renter (e.g., the user of FIG. 1 as described as the verified renter 706 in FIG. 7) generating the automotive listing data 102 generated through the mobile device 303 and/or private vehicle 104 in the threshold radial distance 119 from the address associated with the claim request of the verified renter (e.g., the user of FIG. 1 as described as the verified renter 706 in FIG. 7) of the ride request system (e.g., part of the vehicle renting network 142) when automatically publishing the automotive listing data 102 generated through the mobile device 303 and/or private vehicle 104 on a set of user profiles (e.g., preseeded user profiles 302 and/or claimed user profiles 304 as described in FIG. 3 having associated verified addresses in a threshold radial distance 119 from the claimed geospatial location (e.g., any of the claimed geospatial locations 700 as described in FIG. 7 of the verified renter (e.g., the user of FIG. 1 as described as the verified renter 706 in FIG. 7) of the dispatch server 100) based on a set of preferences of the verified renter (e.g., the user of FIG. 1 as described as the verified renter 706 in FIG. 7) using the radial algorithm 240.

A live broadcast module 228 may live broadcast the automotive listing data 102 generated through the mobile device 303 and/or private vehicle 104 to the different verified renter (e.g., the user of FIG. 1 as described as the verified renter 706 in FIG. 7) and/or other verified renter (e.g., the user of FIG. 1 as described as the verified renter 706 in FIG. 7) in the car sharing community and/or currently within the threshold radial distance 119 from the current geospatial location through the dispatch server 100 through a multicast algorithm 276 such that a live broadcast multicasts to a plurality of data processing systems associated with each of the different user and/or the other verified renter (e.g., the user of FIG. 1 as described as the verified renter 706 in FIG. 7) simultaneously when the mobile device 303 of the verified renter (e.g., the user of FIG. 1 as described as the verified renter 706 in FIG. 7) generating the live-broadcast enables broadcasting of the automotive listing data 102 generated through the mobile device 303 and/or private vehicle 104 to any one of a geospatial vicinity around the mobile device 303 of the verified renter (e.g., the user of FIG. 1 as described as the verified renter 706 in FIG. 7) generating the broadcast and/or in any car sharing community in which the verified renter (e.g., the user of FIG. 1 as described as the verified renter 706 in FIG. 7) has a non-transitory connection.

A summary module 262 may generate a summary data 626 to the verified renter (e.g., the user of FIG. 1 as described as the verified renter 706 in FIG. 7) generating the broadcast data (e.g., the automotive listing data 102) generated through the mobile device 303 and/or private vehicle 104 of how many user profile pages were updated with an alert of the broadcast data (e.g., the automotive listing data 102) generated through the mobile device 303 and/or private vehicle 104 when publishing the broadcast data (e.g., the automotive listing data 102) generated through the mobile device 303 and/or private vehicle 104 in the car sharing community and/or the set of user profiles having associated verified addresses in the threshold radial distance 119 from the claimed geospatial location of the verified renter (e.g., the user of FIG. 1 as described as the verified renter 706 in FIG. 7) of the dispatch server 100 based on the set of preferences of the verified renter (e.g., the user of FIG. 1 as described as the verified renter 706 in FIG. 7).

A bi-directional communication module 230 may permit the different verified renter (e.g., the user of FIG. 1 as described as the verified renter 706 in FIG. 7) and/or other verified renter (e.g., the user of FIG. 1 as described as the verified renter 706 in FIG. 7) in the car sharing community to bi-directionally communicate with the verified renter (e.g., the user of FIG. 1 as described as the verified renter 706 in FIG. 7) generating the broadcast through the dispatch server 100. A response module 264 may analyze a response of the operator of the private vehicle (e.g., the operator 301 of the vehicle) being a dismiss, a save, a rating, a review and/or a rental acceptance of a renter associated with the automotive listing data 102 through the dispatch server. An update module 266 may periodically update the operator of the vehicle and/or the renter (e.g., the renter 114) based on a time in transit, a time to arrival, a time to destination, and/or the payment earned status.

An application module 274 may determine that an application on the mobile device 303 is communicating the broadcast data to the ride request system 150 when the broadcast data is processed, and/or to associate the verified renter (e.g., the user of FIG. 1 as described as the verified renter 706 in FIG. 7) with a verified renter profile in the ride request system 150 through the application on the mobile device 303.

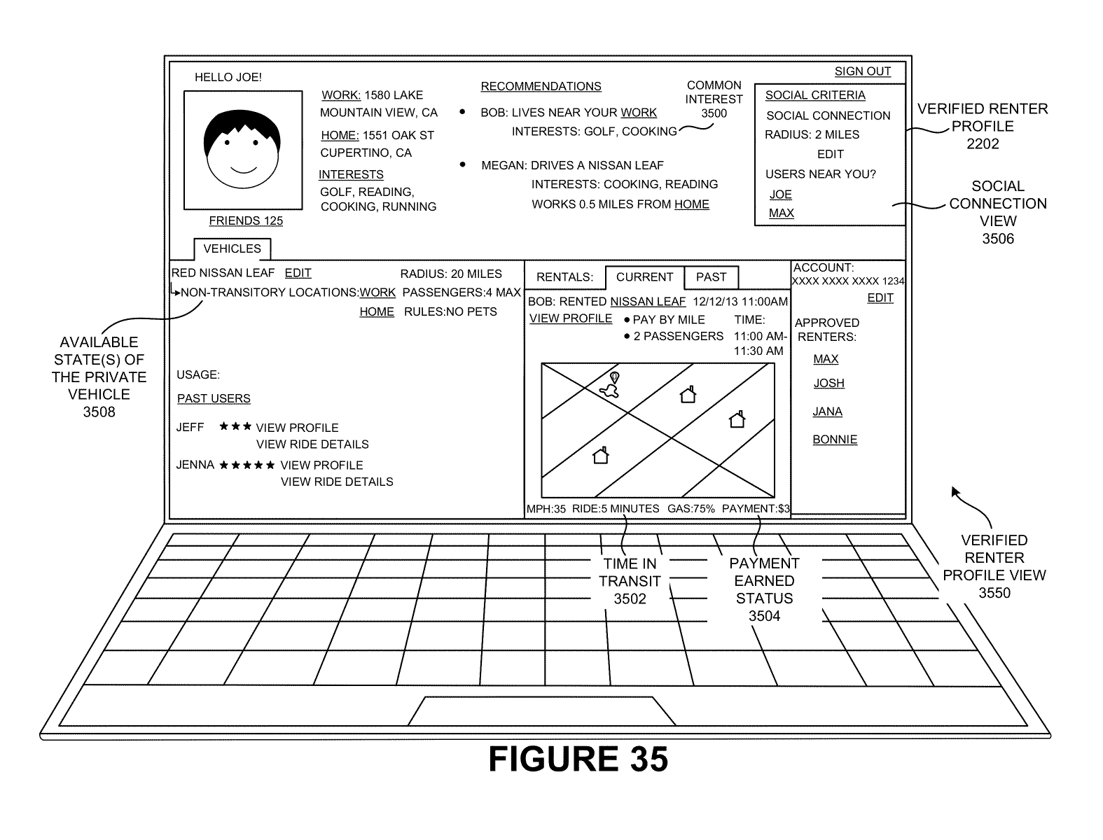

A download module 268 may automatically download a set of profiles to the mobile device (e.g., the mobile device 303), wherein an operator of the private vehicle may the verified renter 706. A connection recommendation module 270 may automatically recommend connections (shown in FIG. 35) to the operator of the private vehicle based on the available state 3508. The connections may be associated with other users of the geo-spatial social community based on other users of the geo-spatial social community sharing a common interest 3500 with the operator in the threshold radial distance from the available state 3508, and/or other private vehicles of the geo-spatial social community whose owners share the common interest 3500 with the operator in the threshold radial distance from the available state 3508. A communication module 260 may automatically initiate a video communication and/or an audio communication between the mobile device 303 of the operator of the private vehicle and/or another mobile device of the renter (e.g., the renter device 505) through the dispatch server 100 based on the profile of the renter associated with the automotive listing data 102 through the dispatch server 100.

A review module 207 may permit the renter and/or other renters to view the rating and/or the review provided by the operator of the private vehicle for each of the renters based on a participation criteria set by the operator of the private vehicle (e.g., the operator 301 of the vehicle) and/or the renter (e.g., the verified renter 706, the renter 114), such that each renter may be able to view ratings and/or reviews of each participating candidate for the rental associated with the automotive listing data 102. A social connection module 209 may permit each renter for the rental of the private vehicle (e.g., the private vehicle 104) associated with the automotive listing data 102 to communicate with each other and/or form social connections 3500 with each other based on the participation criteria 605 set by the operator of the private vehicle and/or the renter, such that each renter may able to form social connections 3500 with each participating candidate for the rental associated with the automotive listing data 102.

A diligence module 205 may permit participating owners of the private vehicles in the dispatch server 100 to see previous ratings, comments, reviews, prescreen questions, and/or background checks of across a plurality of renters applying for a plurality private vehicle rentals through the dispatch server 100 such that different operator of the private vehicles benefit from previous diligence of at one of previous ratings, comments, reviews, prescreen questions, and/or background checks by participating operator of the private vehicles with each renter that has previously rented through the dispatch server. A criteria module 203 may process a criteria associated with an automotive listing data 102 including a description, a photograph, a video, a rental fee, a category, a vehicle make, a vehicle model, and/or a functional status. A crowd-sourced moderation algorithm 204 may permit multiple neighbors in a geospatial area to determine what content contributed to the dispatch server 100 persists and/or which may be deleted. A predictable behavior algorithm 211 may calculate and/or declare the available state of the private vehicle 104.

FIG. 3 is a broadcast view that demonstrates how the radial distribution module of FIG. 1 is used to communicate an automotive listing data 102 to claimed user profiles, pre-seeded user profiles, and to telephone devices and/or internet-enabled devices through a heterogeneous network formed through the internet protocol network of FIG. 1 and through a cellular network, according to one embodiment.

Particularly, FIG. 3 illustrates a broadcast view 350, according to one embodiment. FIG. 3 introduces a claimed neighborhood 300, an operator 301 of the vehicle, a set of preseeded user profiles 302, a mobile device 303, a drone 311, and a claimed user profile 304, and their relationships with elements previously described in FIG. 1. In addition, FIG. 3 explains the set of private vehicles 104 of FIG. 1 to include business 309A, an automobile rental agency 309B and a private car business 309C, a drone 311 and a private vehicle 104.

In FIG. 3, the claimed neighborhood 300 may refer to a region that may be claimed by the user as being associated with an available state (e.g., a work address, a home address) of the user. The preseeded user profiles 302 may refer to address information from people and/or business directories that has been prepopulated in the geospatial social map and/or may be associated with manually placed pushpins on the geospatial map in the vehicle renting network 142 of FIG. 1. The claimed user profile 304 may refer to the verified renter 706 associated with a verified address in the geospatial social map and/or may be associated with claimed pushpin (e.g., a previously preseeded residential and/or business profile) on the geospatial map in the vehicle renting network 142 of FIG. 1. The operator 301 of the vehicle may be a verified renter 706.

The business 309A, an automobile rental agency 309B and a private car business 309C may receive the automotive listing data 102 through their mobile devices, desktop devices, and/or through their cellular telephones. The business 309A, an automobile rental agency 309B and a private car business 309C may receive the automotive listing data 102 and may bi-directionally interact with the private vehicles 104 through either cellular network 108 and/or through the network 101 (e.g., an internet protocol network). When a query of the user interacting with any one of the renters 114 based on the bi-directional communication is responded to, the user may be able to choose which the business 309A, an automobile rental agency 309B and a private car business 309C.

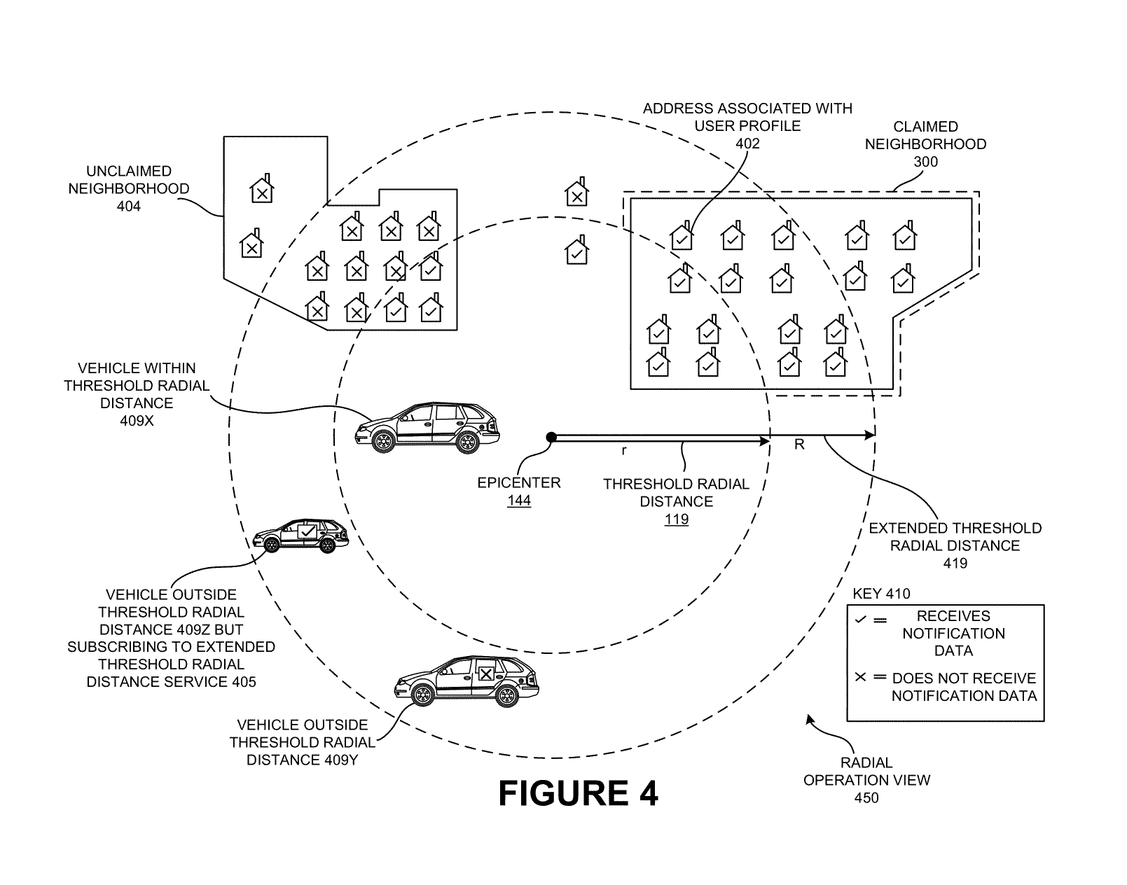

The notification data 112 may be communicated through the network 101 to the preseeded user profiles 302 within a threshold radial distance 119 of the epicenter 144. Alternately, the notification data 112 may be communicated through the network 101 to different ones of the claimed user profile 304 within the claimed neighborhood 300 that are located within the threshold radial distance 119 from the epicenter 144. Additionally, as described in FIG. 4, it will be understood that the claimed neighborhood 300 may be situated partially within the threshold radial distance 119 and partially outside the threshold radial distance 119, yet the notification data 112 received by of the renters 114 (e.g., having a claimed user profile) may be propagated to other claimed user profiles within the claimed neighborhood 300 even though they are outside the threshold radial distance 119.

The notification data 112 may also be communicated through the cellular network 108 or through the network 101 to the set of private vehicles 104. For example, the business 309A may use the ride request system 150 to monitor queries (e.g., for rentals) in a neighborhood and publish sales to residents around a geospatial area of the neighborhood. In addition, the business 309A, an automobile rental agency 309B and a private car business 309C may service a particular neighborhood and may be alerted of a new order and/or query based on a subscription they pay to access broadcasts from areas that they service. Additionally, it should be understood that other types of services and/or businesses may receive the notification data 112. For example, additional services receiving the notification data 112 may include delivery services, businesses with employees that may require transportation, and/or limo services.

In one embodiment, deliveries (e.g., of products from the private vehicles 104, neighbors, other users) may be made from a ‘neighborhood drone’ (e.g., an unmanned aerial vehicle such as the drone 311) operated by the vehicle renting network 142. For example, Fatdoor.com may operate a set of drones (e.g., the drone 311 of FIG. 3) that can be dispatched and automatically instructed to pick up various items and deliver them to a resident of a home. The drone 311 may be aircraft without a human pilot on board. A flight path of the drone 311 may be a server of the geo-spatially constrained social network 142 either autonomously by computers in the drone 311 and/or through an automated navigation system based on a mapping algorithm.

In one embodiment, a neighbor offering a used item (e.g., a cup of sugar) may request that a drone operated by Fatdoor.com be summoned by clicking on ‘request pickup’ on their mobile device. This may instruct the drone to fly to a backyard and/or front yard of a home of a neighbor and physically pick up the cup of sugar and deliver it to a neighbor, minimizing time to do neighborhood errands. A neighbor who is selling and/or giving away an item may receive an alert when a drone arrives through their mobile device. Similarly, the renter of the item may receive an alert when the drone delivery is ready.

Furthermore, this way, a limited set of drones can be shared by a set of users. The drones 311 may be communicatively coupled with the dispatch server 100 through the network 101, the cellular network 108, and/or another network. Alternative to drones, Fatdoor and/or neighbors themselves may instruct private vehicles (e.g., the private vehicle 104 of FIG. 3) that they operate to pick up and deliver items to each other through their mobile device using the geo-spatial social network 142. The private vehicles may be personally owned and/or owned by the geospatially constrained social network. The private vehicles 313 may be communicatively coupled with the dispatch server 100 through the network 101, the cellular network 108 and/or another method.

For example the private vehicle 104 may be a private vehicle (e.g., a self-driving vehicle, robot vehicle) that is a private vehicle capable of fulfilling the transportation capabilities of a traditional vehicle. As a private vehicle, the private vehicle 104 may be capable of sensing its environment and navigating without human input.

The private vehicle 104 may be a private vehicle that senses its surroundings with such techniques as radar, lidar, GPS, and computer vision. Advanced control systems may interpret sensory information to identify appropriate navigation paths, as well as obstacles and relevant signage to/from a home offering an item for sale in the vehicle renting network 142. The private vehicle 104 may update its maps based on sensory input, thereby permitting the private vehicle 104 to keep track of their position even when conditions change or when they enter uncharted environments in the neighborhood.

FIG. 4 is a radial operation view 450 that illustrates an expansion of a threshold radial distance based on a claimed neighborhood 300 at a radial boundary surrounding the epicenter 144 formed by geospatial coordinates of the device of FIG. 1, according to one embodiment. FIG. 4 illustrates a claimed neighborhood 300, an address associated with a user profile 402, an unclaimed neighborhood 404, a private vehicle outside the threshold radial distance as described in operation 409Z but subscribing to extend the threshold radial distance as described in operation 405, a private vehicle within the threshold radial distance as described in operation 409X, a private vehicle outside the threshold radial distance in operation 409Y, a key 410, and an extended threshold radial distance 419.

The key 410 describes that a ‘checkmark’ inside a home in either the claimed neighborhood 300 and/or the unclaimed neighborhood 404 indicates that the automotive listing data 102 reaches a user associated with that address at a radial geospatial distance away. In contrast, the key 410 describes that an ‘X mark’ inside a home in either the claimed neighborhood 300 and/or the unclaimed neighborhood 404 indicates that the automotive listing data 102 does not reach a user associated with that address at a radial geospatial distance away.

Particularly, in FIG. 4, an address associated with each user profile 402 is illustrated, according to one embodiment. In FIG. 4, because the claimed neighborhood 300 is partially within the threshold radial distance ‘r’, every verified renter in the claimed neighborhood 300 receives the automotive listing data 102, according to one embodiment. Thereby, the radial broadcast distance ‘r’ is extended to a′ as illustrated in FIG. 4 (e.g., the extended threshold radial distance 419 of FIG. 4). It should be understood that in an alternate embodiment, the radial broadcast of the automotive listing data 102 may not extend to the entire group of users of the claimed neighborhood 300. However, to promote neighborhood communication and cooperation, the automotive listing data 102 is illustrated as being extended to the claimed neighborhood 300 in the embodiment of FIG. 4.

It should be also noted that in some embodiments, the “preseeded user profiles” may be users that have previously signed up for the vehicle renting network 142, as opposed to users that have been preseeded there in a social network. For example, in one alternate embodiment, each of the claimed neighborhood 300 may serve as an approximate to actual radial distribution, in that broadcast messages are solely sent to claimed neighborhoods (e.g., private claimed neighborhoods) of actual users in a vicinity of a broadcast (rather than to public profiles).

FIG. 4 also illustrates an unclaimed neighborhood 404. The unclaimed neighborhood 404 may be preseeded based on public data, according to one embodiment. The unclaimed neighborhood has within it a series of addresses (e.g., associated with non-transitory homes and/or business locations), according to one embodiment as illustrated in FIG. 4. Those addresses in the unclaimed neighborhood 404 to whom the automotive listing data 102 is delivered have a ‘checkmark’, according to one embodiment. In contrast, those addresses in the unclaimed neighborhood 404 to whom the automotive listing data 102 is not delivered have an ‘X mark’, as illustrated in FIG. 4. Particularly, addresses in the radial boundary ‘r’ have a check mark, whereas addresses that are outside the radial boundary ‘r’ (e.g., and therefore outside the threshold radial distance 119) are marked with the ‘X mark’. In this example embodiment of FIG. 4 showing the unclaimed neighborhood 404, the addresses within the threshold radial distance 119 are the addresses that receive the automotive listing data 102.

Also illustrated in FIG. 4 is the concept of the private vehicle address within the threshold radial distance as shown in operation 409X, the private vehicle address outside the threshold radial distance but subscribing to extend threshold radial distance service as shown in operation 405 (e.g., a service that extends the threshold radial distance to a′, the extended threshold radial distance 419), and the private vehicle outside the threshold radial distance as illustrated in operation 409Y. Each of these different operations will be compared and contrasted. The private vehicle in operation 409X may receive the automotive listing data 102 because the service provider in this example embodiment of FIG. 4 is within the threshold radial distance 119, according to one embodiment.

The private vehicle address in operation 405 may receive the automotive listing data 102 because they provide a consideration (e.g., pay a monthly subscription, annual fee, and/or pay per access/use fee) to the vehicle renting network 142, even though the private vehicle in operation 405 does not have a physical address within the threshold radial distance 119. In an alternate embodiment, the private vehicles need not pay a consideration for this service due to the beneficial societal nature of their participation in the vehicle renting network 142. The vehicle renting network 142 (e.g., or dispatch server 100) may verify, confirm, and/or ask for an assurance that the private vehicle actually provides services in the threshold radial distance 119. The vehicle renting network 142 (and other the dispatch server 100) may request feedback, reviews, and comments from homes/businesses in the vehicle renting network 142 for the private vehicles in operation 405 and operation 409X to ensure that they continue to be recommended and/or are permitted to participate in the threshold radial distance 119 around the epicenter 144 (e.g., where the broadcast originates) in the vehicle renting network 142. Operation 409Y indicates that a service provider (e.g., private vehicle 409) outside the threshold radial distance 119 does not receive the automotive listing data 102, and therefore cannot participate bi-directionally in the vehicle renting network 142.

FIG. 5 illustrates a remote association view 550 in which a renter device 505 (e.g., a cellphone, mobile phone, a computer, a tablet) of an renter receives the automotive listing data 102 of FIG. 3 based on a non-transitory claimed address associated with a profile of the renter even when the renter's device is outside a threshold radial distance of a broadcast, according to one embodiment.

Particularly, FIG. 5 illustrates an operation of an association with verified address 500 which illustrates the renter device 505 can be associated to a remote address 502, and a time stamp 510 associated with a creation time 507, a creation date 508, and a set of geospatial coordinates 103 generated from a private vehicle 104 and/or mobile device 303. The remote address 502 may be available state such as a home and/or a work address of the renter 114 (e.g., the user generating the automotive listing data 102), according to one embodiment. The available state may be a place of domicile (e.g., a home) and/or a place of work (e.g., a physical location and/or a principle place of business) of a property (e.g., a work address) and/or business associated with the user), according to one embodiment.

The concept illustrates that the renter device 505 may be located at a physical location outside the threshold radial distance 119 and still get the automotive listing data 102 and/or the notification data 112 if the renter device 505 (e.g., a mobile phone) has verified an address at a location that they care about and/or are associated with (e.g., a location in which they live, work, and/or have guest access) that is within the threshold radial distance 119. In other words, the user may receive broadcast (e.g., the notification data 112 and/or the automotive listing data 102 which may be live streamed and/or through after the event notifications) related to a radial distance from their home and/or work even when physically at a location outside their claimed available state.

FIG. 6A is an automobile dispatch broadcast user interface view 650 of the mobile device of FIG. 3 that shows how the user can generate and broadcast the broadcast data, according to one embodiment. FIG. 6A shows a date/time indicator 600, a private vehicle listing map 601, a mobile device viewfinder 602, a listing criteria 604, a participation criteria 605, a description entry field 606, a broadcast indicator 608, and a renter location 612, according to one embodiment.

The user (e.g., the operator 301 of the vehicle) may be able to set the listing criteria 604 for renting their private vehicle 104. The listing criteria may include a rental type, a number of people, a specification of payment (e.g., by mile, by hour), an operating radius, and/or a participation criteria. The participation criteria 605 may enable the user (e.g., the renter, the operator 301 of the vehicle) to allow communication between users (e.g., all renters, all verified renters, all renters of the broadcast). The user (e.g., the operator 301 of the vehicle) may be able to enter details about their vehicle and/or rules (e.g., no pets in the vehicle) in the description entry field 606. The date/time indicator 600 may enable the user of the mobile device 303 to indicate the date and/or times that their vehicle is available to be rented. In one embodiment, the date/time indicator 600 and/or the description entry field 606 may be included in the listing criteria 604. The broadcast indicator 608 may allow the user to broadcast the information they have entered to other users (e.g., all verified renters in a threshold radial distance from the private vehicle 104 and/or the operator of the private vehicle's current location).

The vehicle location 610 may be the current location of the private vehicle 104 and/or the available state of the private vehicle 3508. The renter location 612 may indicate the geospatial location of an individual who received the broadcast. The private vehicle listing map 601 may be a geospatial map of the user's (e.g., the operator 301 of the vehicle) current location and/or claimed geospatial locations (e.g., claimed neighborhoods 300) on which the vehicle location 610 and/or the renter location 612 is shown.

FIG. 6B is a private vehicle renter user interface view 651 of the renter device of FIG. 5, in which a broadcast data generated through the user interface of FIG. 6A enables the user to request a rental of the private vehicle, according to one embodiment. FIG. 6B shows a rental details 607, a private vehicle locator map 613, a user location 614, and a rental time indicator 617.

A user (e.g., a verified renter 706) may be able to enter rental details 607 through their mobile device (e.g., the renter device 505) including a desired make and/or model of vehicle, a number of passengers, a duration of the rental, a desired start and/or end time of the rental, a payment method (e.g., credit card, by mile, by hour), a color of the vehicle. The renter (e.g., user of the renter device 505) may be able to view their location on the private vehicle locator map 613 as the user location 614. Available vehicles and/or all registered vehicles within a certain proximity to the user and/or the user's claimed geospatial locations 700 may be visible on the private vehicle locator 613 and/or may display automobile sharing alert pushpins 609. The user (e.g., the renter) may be able to view the movement of vehicles on the map. The rental indicator 617 may allow the user to see the time of pick up (e.g., when the vehicle they requested and/or are viewing could be at their location). In one embodiment, only private vehicles 104 with listing criteria 604 that match the rental details 607 may be presented on the private vehicle locator map 613.

FIG. 6C is a broadcast renter user interface view 652 of the renter device of FIG. 5 in which the renter device is receiving a live broadcast, according to one embodiment. FIG. 6C shows a renter location 612, a live broadcast 616, a location 618, a bi-directional communication indicator 619, a rating 620, a review 622, and a rental details 607.

The renter 114 may be able to view the live broadcast 616 (e.g., as an on-page posting, push notification, update) on the renter device 505. The user (e.g., the renter, the renter) may be able to view their location as a renter location 612 on the private vehicle listing map 601. The user may also be able to view the source location of the broadcast (e.g., the vehicle location 610, the location of the user making the broadcast, the available state of the private vehicle 104). The renter 114 may be able to view the location associated with the broadcast (e.g., the available state of the private vehicle 3500) as an address, set of geospatial coordinates, etc.

The renter of the live broadcast 116 may be able to view a rating 620 of the user making the broadcast and/or the private vehicle associated with the broadcast. The ratings may be a single rating and/or a collection of any number of ratings of the user making the broadcast and/or the private vehicle associated with the broadcast. The review 622 may be a single review and/or a collection of any number of reviews of the user making the broadcast and/or the private vehicle associated with the broadcast. The rental details 607 may be details regarding the make, model and/or color of the private vehicle 104 and/or listing criteria 604 and/or additional information.

In one embodiment, the live broadcast 616 may be made about a user and/or private vehicle 104 from a renter and broadcasted to other renters 114 and the ratings 620 and/or review 622 and/or rental description 624 may be that of the renter making the broadcast. The bi-directional communication indicator 619 may enable the renter 114 to communicate with other renters of the live broadcast 616 and/or the user making the broadcast. The update may be automatically deleted at a specified automobile sharing alert expiration time 629.

FIG. 6D is a summary data user interface view 653 of the mobile device of FIG. 3 in which the user may see the renters of the broadcast and the renters viewing the live broadcast 616 of FIG. 6C, according to one embodiment. FIG. 6D shows a summary data 262, a summary of renters (e.g., prospective renters) notified 628, and a summary of renters responding 634.

In the example embodiment of FIG. 6D, the user (e.g., the verified renter that made the broadcast (e.g., the driver or operator (e.g., the operator 301 of the vehicle) may be able to view a summary data 626 of the number of profiles that were updated with the user's broadcast. The user may be presented with a summary of renters notified 628 and may be able to select profile links to view the profiles of the renters that received the broadcast. The user may be able to view a summary of renters responding 634 to the broadcast. In one embodiment, the user may be able to view the responses from the renters 114 (e.g., prospective renters, actual passengers who are paying for a ride in the private vehicle 104 through the ride request system 150).

In the embodiment of FIG. 6, the user is presented with a collection of the summary data 626. The summary data 626 may display on the mobile device 303 how many renters received the live broadcast 616. The summary data 626 may also show by the summary of renters notified 628 how many user profile pages were updated with an alert of the automotive listing data 102 generated through the mobile device 303 and/or private vehicle 104 when publishing the automotive listing data 102 generated through the mobile device 303 and/or private vehicle 104 in the car sharing community and/or the set of user profiles (e.g., preseeded user profiles 302 and/or claimed user profiles 304 as described in FIG. 3 having associated verified addresses (in the threshold radial distance 119 from the claimed geospatial location (e.g., any of the claimed geospatial locations 700 as described in FIG. 7 of the verified renter (e.g., the user of FIG. 1 as described as the verified renter in FIG. 7) of the dispatch server 100))) based on the set of preferences of the verified renter (e.g., the user of FIG. 1 as described as the verified renter in FIG. 7). Additionally, the user may also be able to see the summary of renters responding 634 to the broadcast.

FIG. 7 is a claimed location user interface view 750 that explains how a claimed user reviews their broadcasts that they made and manages the neighborhoods that they have claimed, according to one embodiment.

FIG. 7 is a claimed location user interface view 750 that explains how a user manages notifications in neighborhoods that they have claimed and reviews their previous broadcasts, according to one embodiment. Particularly, FIG. 7 describes claimed geospatial locations 700 of a verified renter (‘Joe’). The claimed geospatial locations 700 will show up when the user becomes the verified renter (e.g., by proving the addresses of the claimed geospatial locations 700 by proving utility bills associated with that address). FIG. 7 also shows a broadcasting history of the user, including the rental listing criteria 704, the creation time 507, the creation date 508, the time stamp 510, and the unique submission identifier 636 of past broadcasts.

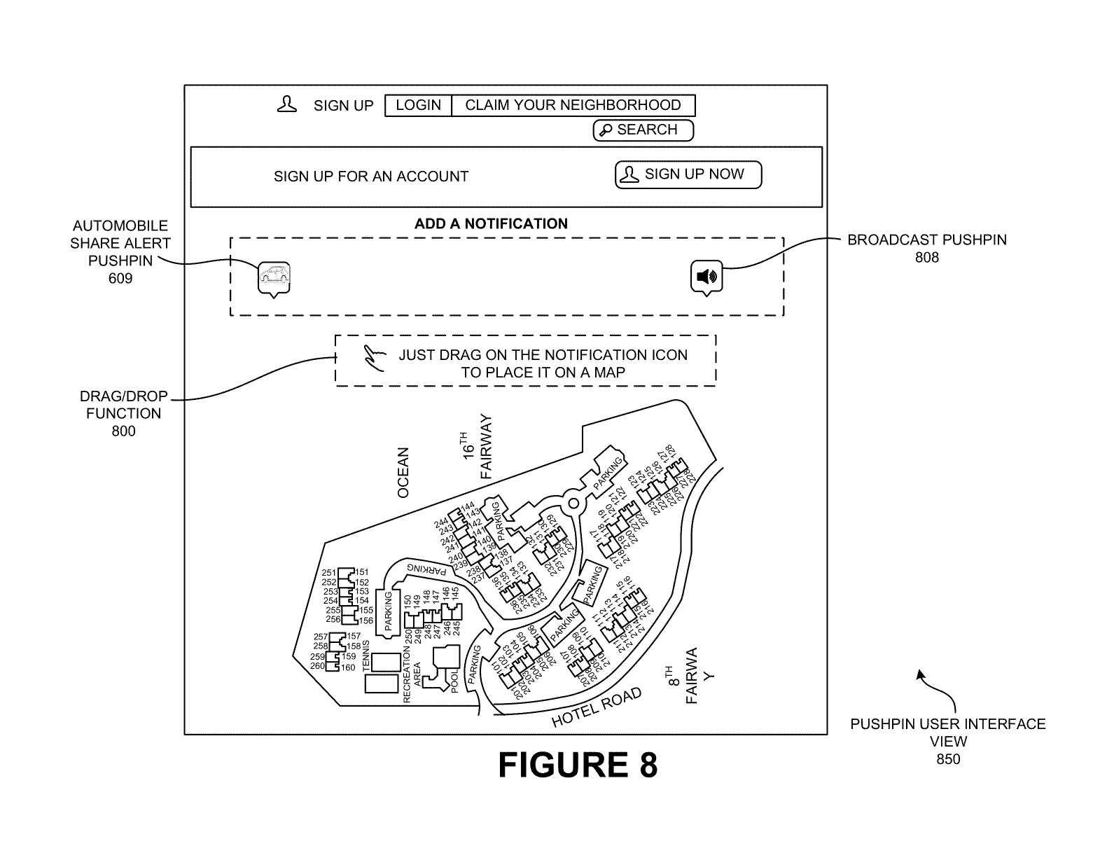

FIG. 8 is a pushpin user interface view 850 that explains how the user drags pushpins to a map including a broadcast pushpin, which is different than other pushpins in that a time and a location of the broadcast pushpin is fixed based on a set of geospatial coordinates associated with a mobile device of the claimed user of FIG. 7, according to one embodiment. Particularly, FIG. 8 illustrates a drag/drop function 800, the automobile share alert pushpin 609, and a broadcast pushpin 808, according to one embodiment.

In FIG. 8, the broadcast pushpin 808 (e.g., that may generate the automotive listing data 102) may be unique in that it can only be placed through a device that has a geo-spatial chip and which can verify a geo-spatial location of a device making the broadcast. In this way, the broadcast pushpin 808 is fixed in time and place, whereas the other pushpins can be manually dragged to the map through the drag/drop function 800.

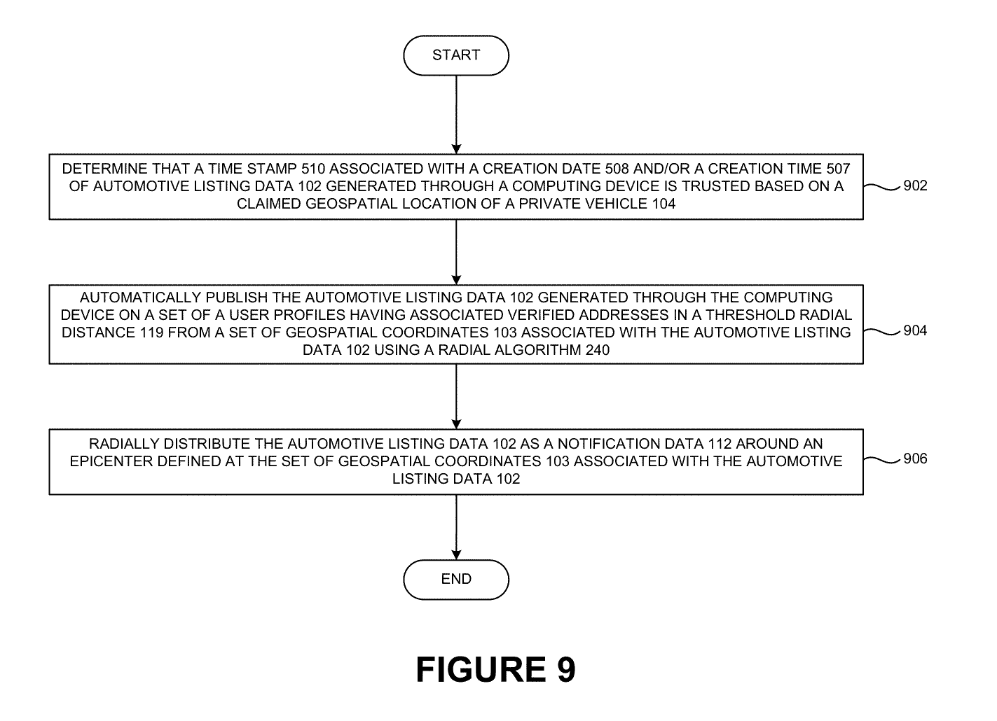

FIG. 9 is a process flow of radially distributing the automotive listing data 102 of FIG. 3 as a notification data around an epicenter defined at the set of geospatial coordinates of FIG. 8 associated with the automotive listing data 102, according to one embodiment. Particularly, in FIG. 9, operation 902 may determine that a time stamp 510 associated with a creation date 508 and/or a creation time 507 of the automotive listing data 102 generated through a computing device (e.g., the mobile device 303, the private vehicle 104) is trusted based on a claimed geospatial location of a user (e.g., the operator of the private vehicle 104), according to one embodiment. Then, in operation 904, the automotive listing data 102 generated through the computing device may be automatically published on a set of user profiles having associated verified addresses in a threshold radial distance 119 from a set of geospatial coordinates 103 associated with the automotive listing data 102 using a radial algorithm 240. Next, in operation 906, the automotive listing data 102 may be radially distributed as the notification data 112 around an epicenter defined at the set of geospatial coordinates 103 associated with the automotive listing data 102.

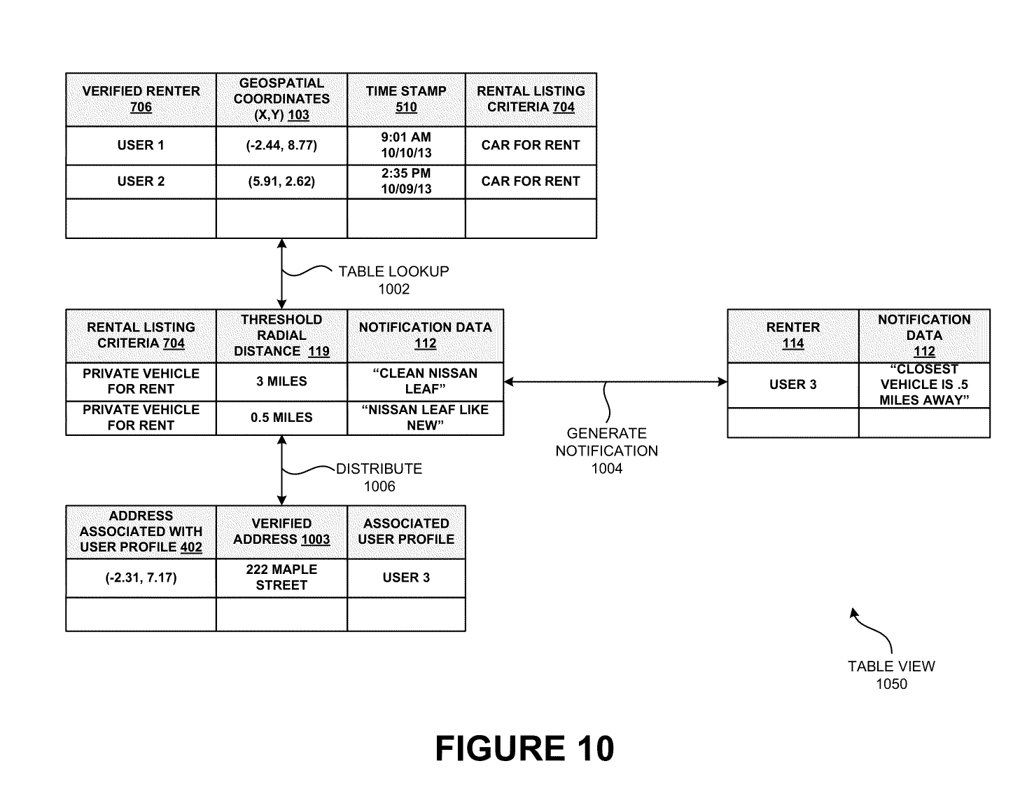

FIG. 10 is a table view 1050 illustrating data relationships between users, locations, and with a set of notification types needed to generate a broadcast, according to one embodiment. In FIG. 10, a table lookup 1002 may be performed in which a rental listing criteria 704 is matched with a threshold radial distance 119 and a notification data 112. Then, a notification may be generated using the generate notification operation 1004 from the renter 114, and distributed to the verified address (e.g., the verified address 1003) in the threshold radial distance 119 using the distribute operation 1006, according to one embodiment. The associated user profile may be the claimed user profile 304.

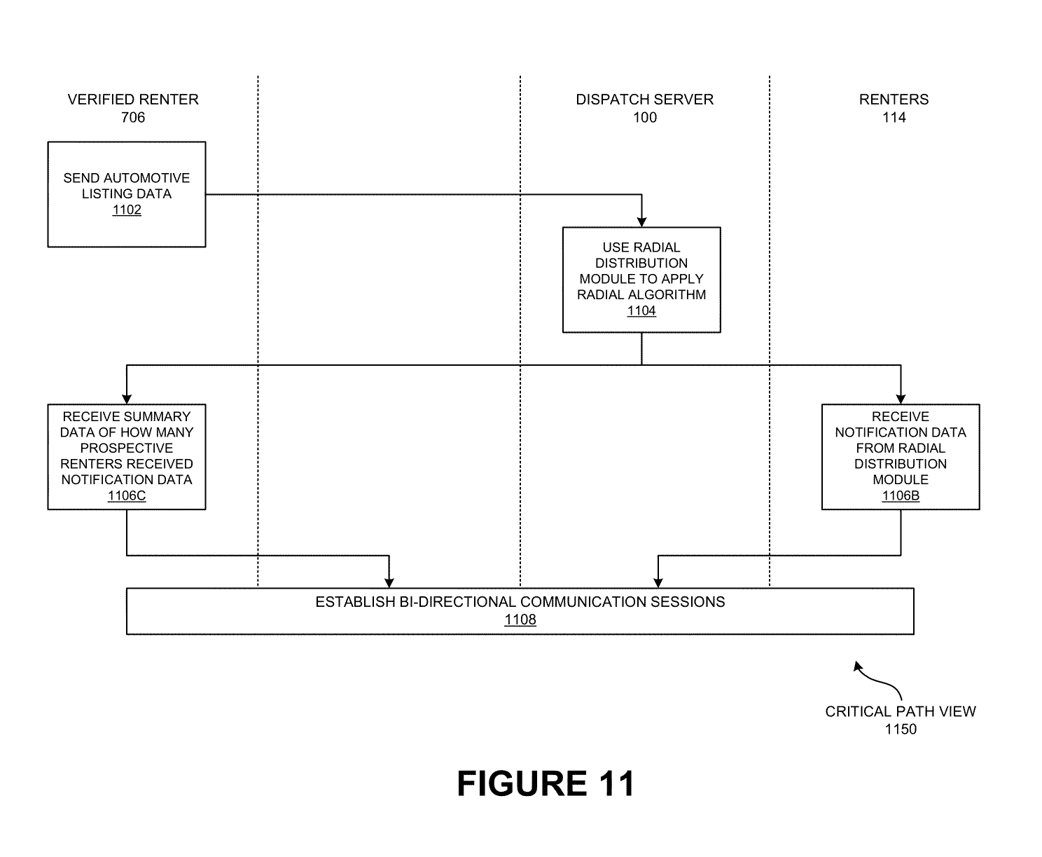

FIG. 11 is a critical path view 1150 illustrating a flow based on time in which critical operations in establishing a bi-directional session between a verified renter and those individuals receiving the automotive listing data 102 of FIG. 3 is established, according to one embodiment. In FIG. 11, a verified renter sends an automotive listing data 102 to the dispatch server 100 in operation 1102. The dispatch server 100 uses the radial distribution module 140 to apply the radial algorithm 240 in operation 1104. Then, the renters 114 receive the notification data 112 from the radial distribution module 140 of the dispatch server 100 in operation 1106B, according to one embodiment. Based on operation 1106B, the verified renter may automatically receive a summary (e.g., the summary data 626) of how many renters received the notification data 112 in operation 1106C. Next, bidirectional communication sessions are established between the verified renter and the renters 114 in operation 1108.

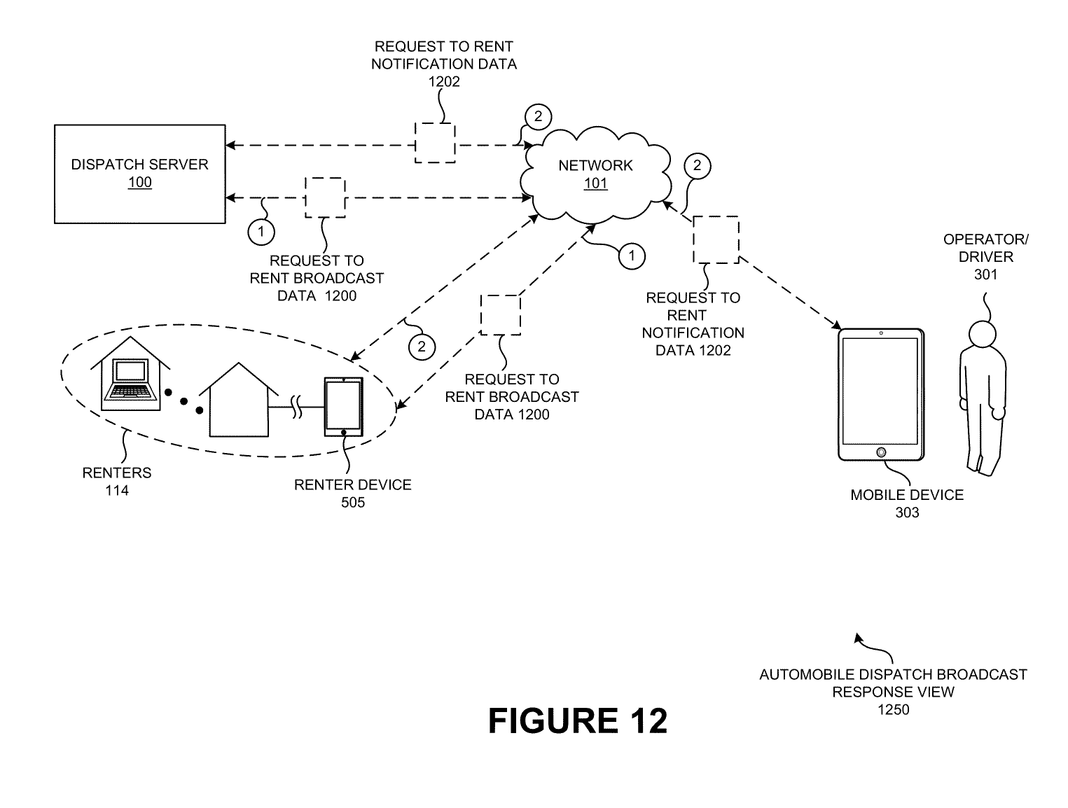

FIG. 12 is an automobile dispatch broadcast response view 1250 illustrating a response being generated and broadcast by renters in response to an automotive listing broadcast made from the private vehicle of FIG. 1, according to one embodiment.

Particularly, FIG. 12 further illustrates a request to rent broadcast data 1200 and a request to rent notification data 1202. After the user's 106 broadcast reaches renters 114 with verified addresses within a threshold radial distance 119 from the epicenter 144 (illustrated in FIG. 1), the renters 114 may broadcast responses (illustrated in FIG. 6D) as request to rent broadcast data 1200 along path circle ‘1’ through the network 101 and/or the cellular network 108. The request to rent broadcast data 1200 may be generated by the renter device 505 and sent via the network 101 to the dispatch server 100. Second, the request to rent notification data 1202 may be automatically generated using the request to rent broadcast data 1200 by the dispatch server 100.

The request to rent notification data 1202 may then be broadcasted to the private vehicle 104 and/or operator 301 of the vehicle and/or renters 114 along path circle ‘2’ using the radial distribution module 140. The request to rent notification data 1202 may move along path circle ‘2’ through the network 101 to the private vehicle associated with the user and/or other renters that may have received the original broadcast from the user. In one embodiment, the communication illustrated in FIG. 12 may happen between the renters 114 and the private vehicle 104. Upon receiving the request to rent notification data 1202, the operator 301 of the vehicle may respond in the form of a dismiss, a save, a rating, a review and/or a rental acceptance of a renter (e.g., renter 114) associated with the automotive listing data 102. The dispatch server 100 may analyze the response of the operator 301 of the vehicle.

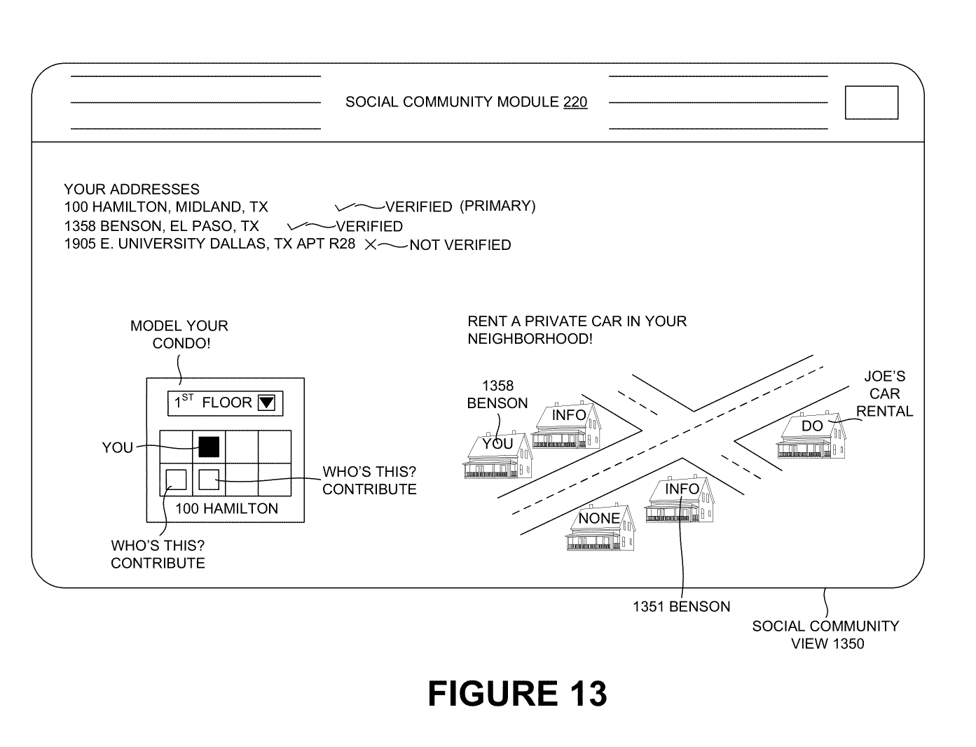

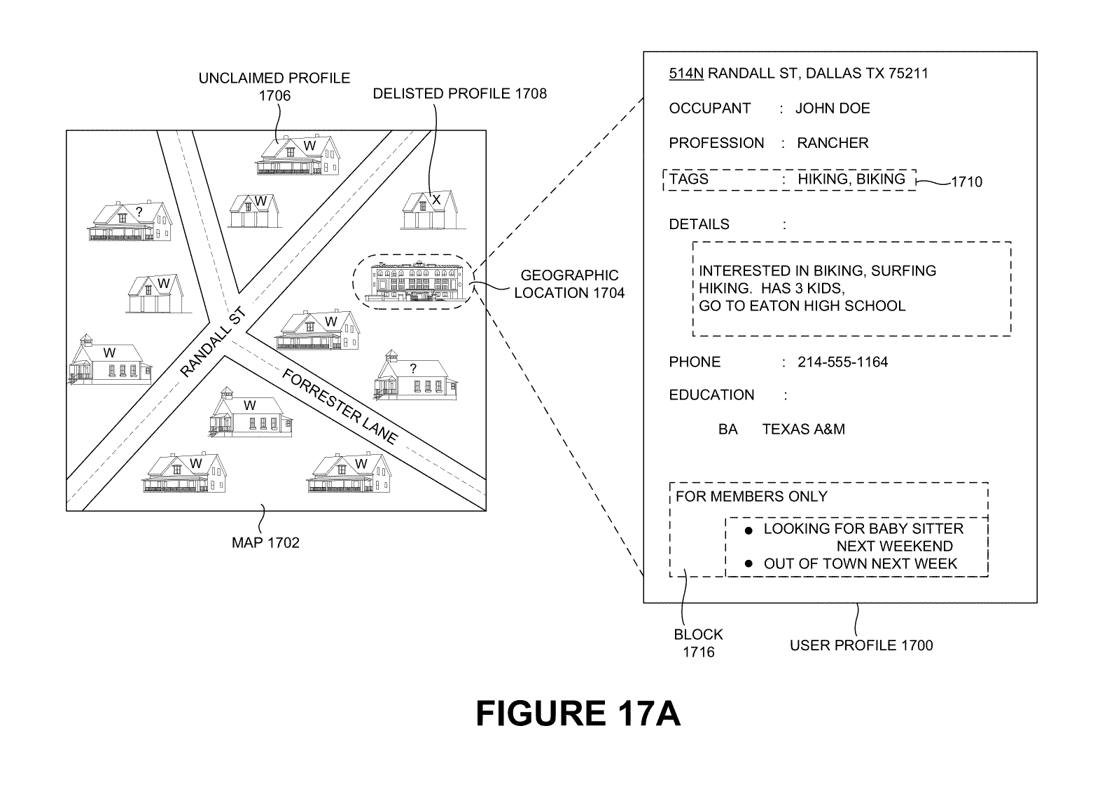

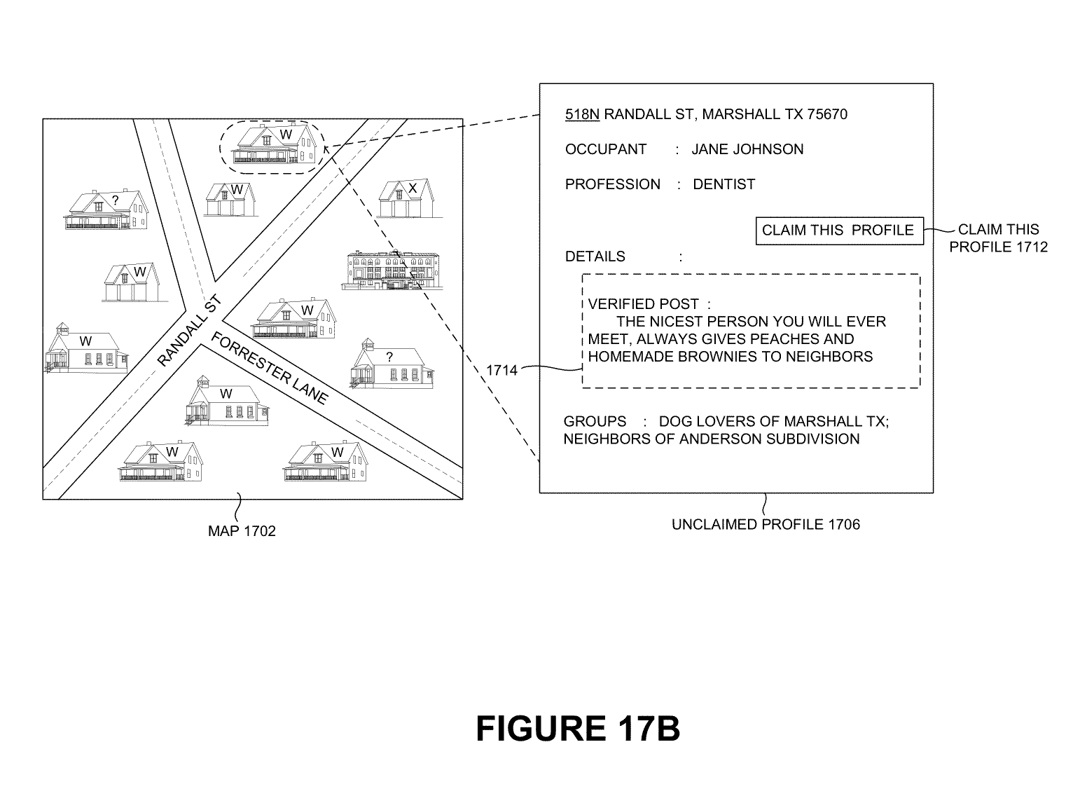

FIG. 13 is a social community view 1350 of the social community module 220, according to one embodiment. The social community view 1350 may display the information associated with the social community module 220 (e.g., the social community module 220 of FIG. 2). The social community view 1350 may display a map of the specific geographic location associated with the user profile of the social community module 220 (e.g., the social community module 220 of FIG. 2). The social community view 1350 may display the map based geographic location associated with the user profile (e.g., the user profile 1700 of FIG. 17A) only after verifying the address of the registered user of the global neighborhood environment 2300 (e.g., the vehicle renting network 142 of FIG. 1).

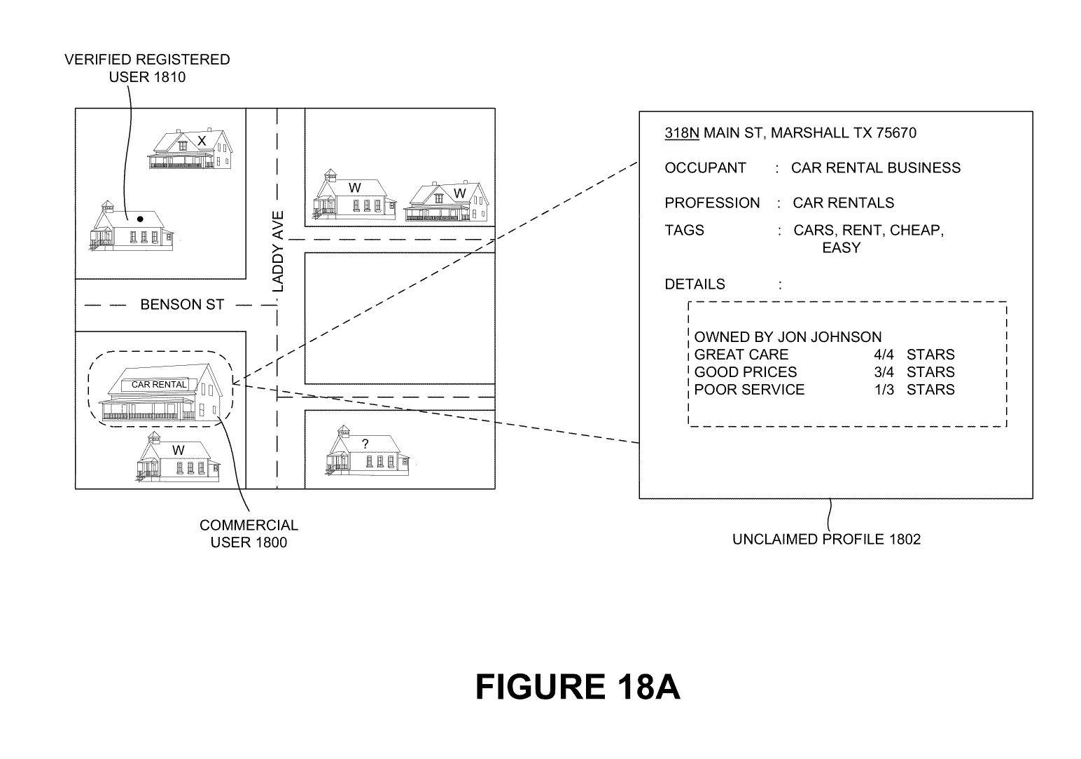

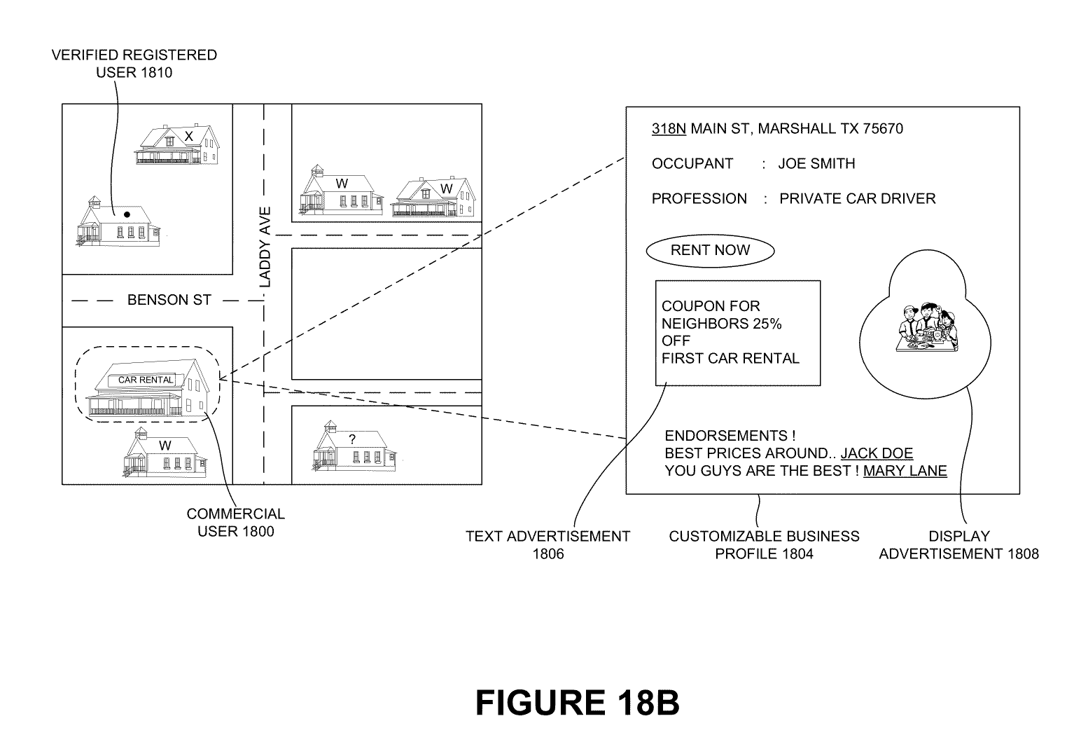

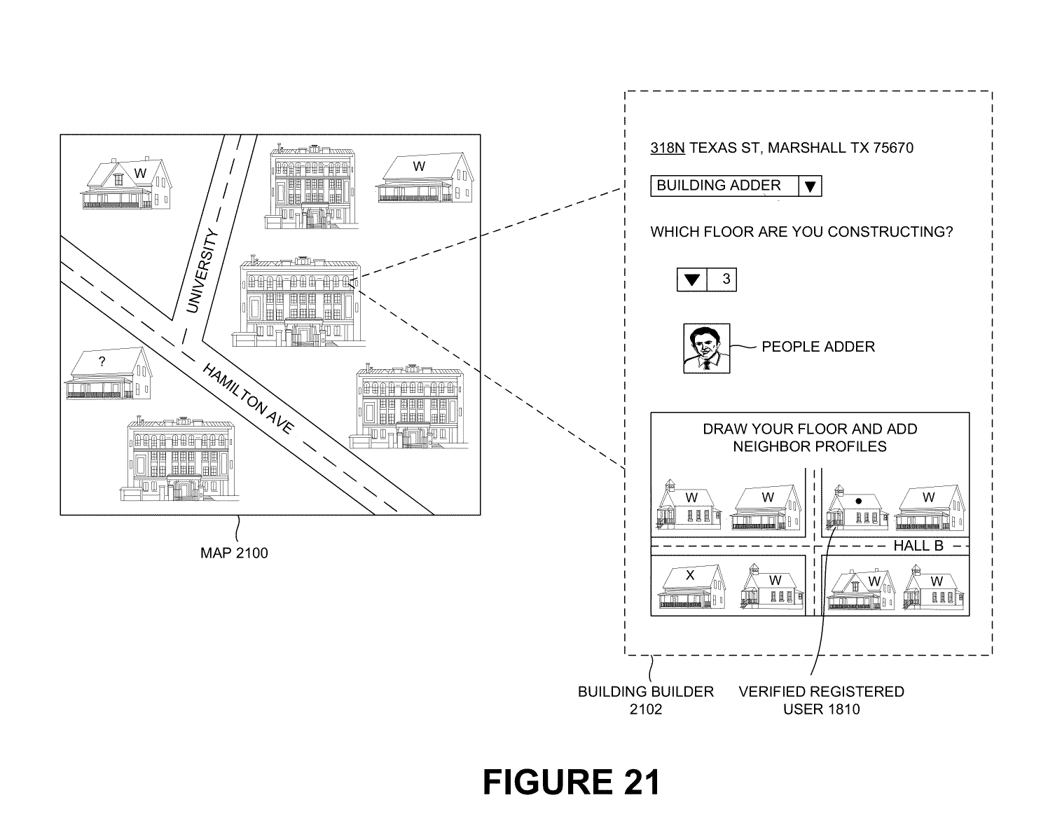

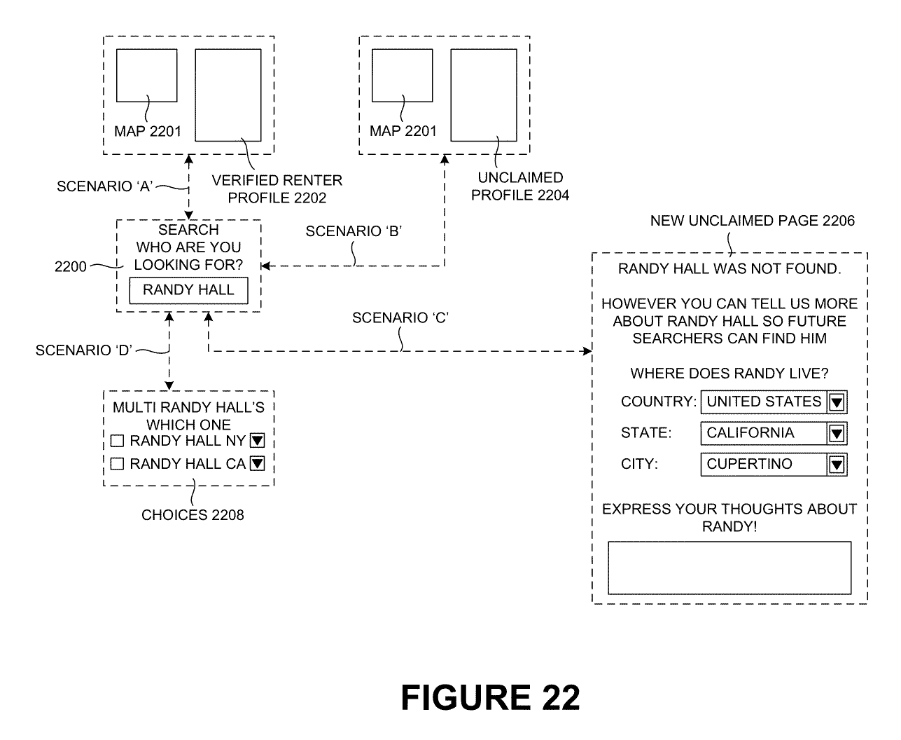

In addition, the social community view 1350 may provide a building creator (e.g., the building builder 2102 of FIG. 21), in which the registered users of the global neighborhood environment 2300 (e.g., the vehicle renting network 142 of FIG. 1) may create and/or modify empty unclaimed profiles (i.e., wiki profiles such as the unclaimed profile 1706 of FIG. 17A-17B, a unclaimed profile 1802 of FIG. 18A, a unclaimed profile 2204 of FIG. 22), building layouts, social network pages, etc. The social community view 1350 of the social community module 220 may enable access to the user (e.g., the user of FIG. 1) to model a condo on any floor (e.g., basement, ground floor, first floor, etc.) selected through the drop down box by the registered user of the global neighborhood environment 2300 (e.g., the vehicle renting network 142 of FIG. 1). The social community view 1350 of the social community module 220 (e.g., the social community module 220 of FIG. 2) may enable the registered user of the global neighborhood environment 2300 (e.g., the vehicle renting network 142 of FIG. 1) to contribute information about their neighbors (e.g., the other addresses associated with user profiles 402 of FIG. 4).

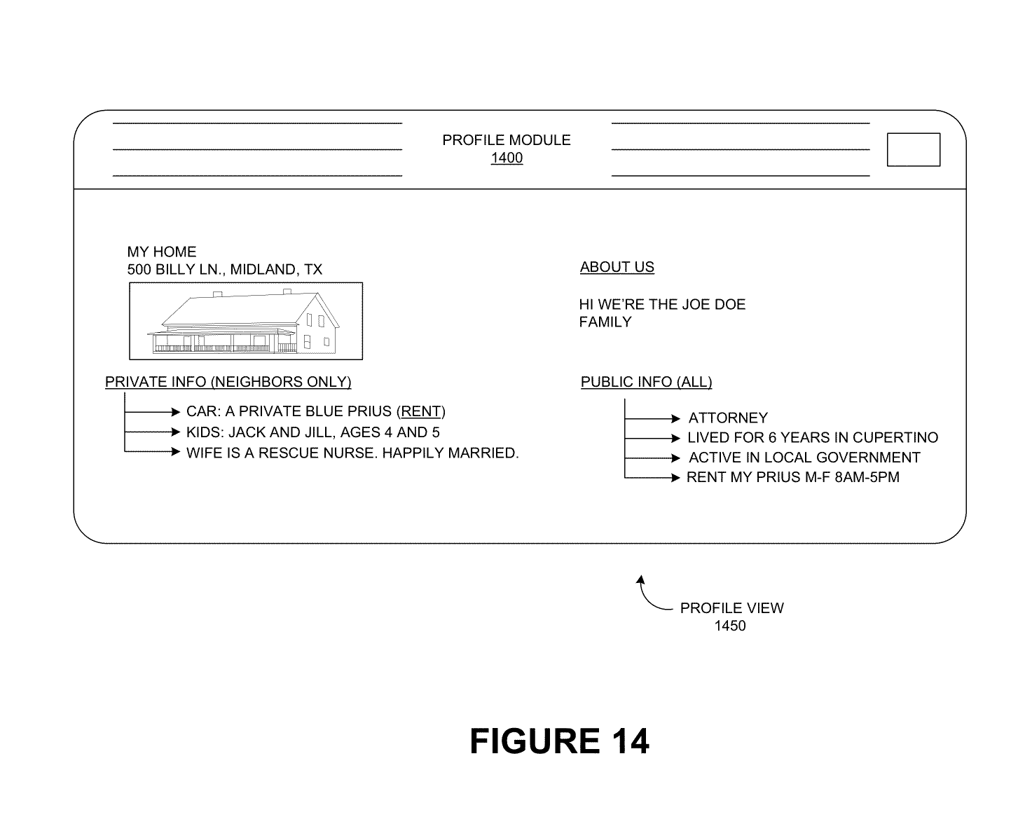

FIG. 14 is a profile view 1450 of a profile module 1400, according to one embodiment. The profile view 1450 of profile module 1400 may offer the registered user to access the profile about the neighbors (e.g., the other addresses associated with user profiles 402 of FIG. 4). The profile view 1450 of profile module 1400 may indicate the information associated with the profile of the registered user of the global neighborhood environment 2300 (e.g., the vehicle renting network 142 of FIG. 1). The profile view 1450 may display the address of the registered user. The profile view 1450 may also display events organized by the neighbors (e.g., the other addresses associated with user profiles 402 of FIG. 4), history of the neighbors (e.g., the other addresses associated with user profiles 402 of FIG. 4), and/or may also offer the information (e.g., public, private, etc.) associated with the family of the neighbors (e.g., the other addresses associated with user profiles 402 of FIG. 4) located in the locality of the user (e.g., the user(s) 106 of FIG. 1) of the global neighborhood environment 2300 (e.g., the vehicle renting network 142 of FIG. 1).

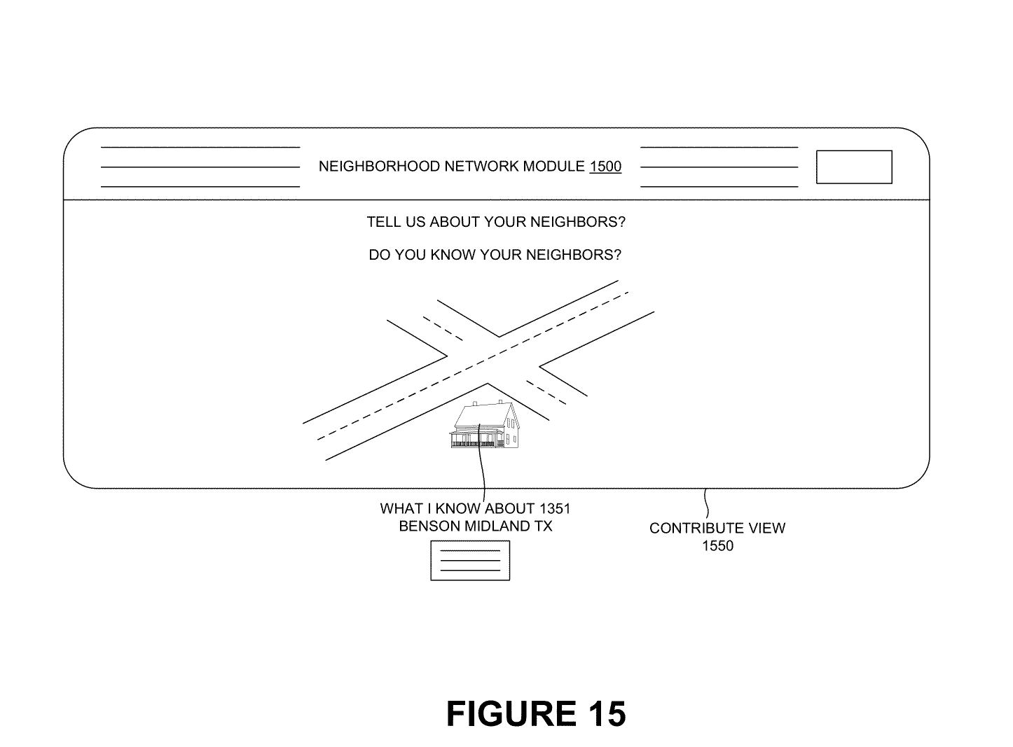

FIG. 15 is a contribute view 1550 of a neighborhood network module 1500, according to one embodiment. The contribute view 1550 of the neighborhood network module 1500 may enable the registered user of the global neighborhood environment 2300 (e.g., the vehicle renting network 142 of FIG. 1) to add information about their neighbors in the neighborhood network. The contribute view 1550 of the neighborhood network module 1500 may offer registered user of the global neighborhood environment 2300 (e.g., the vehicle renting network 142 of FIG. 1) to add valuable notes associated with the family, vehicle, events, private information, etc.

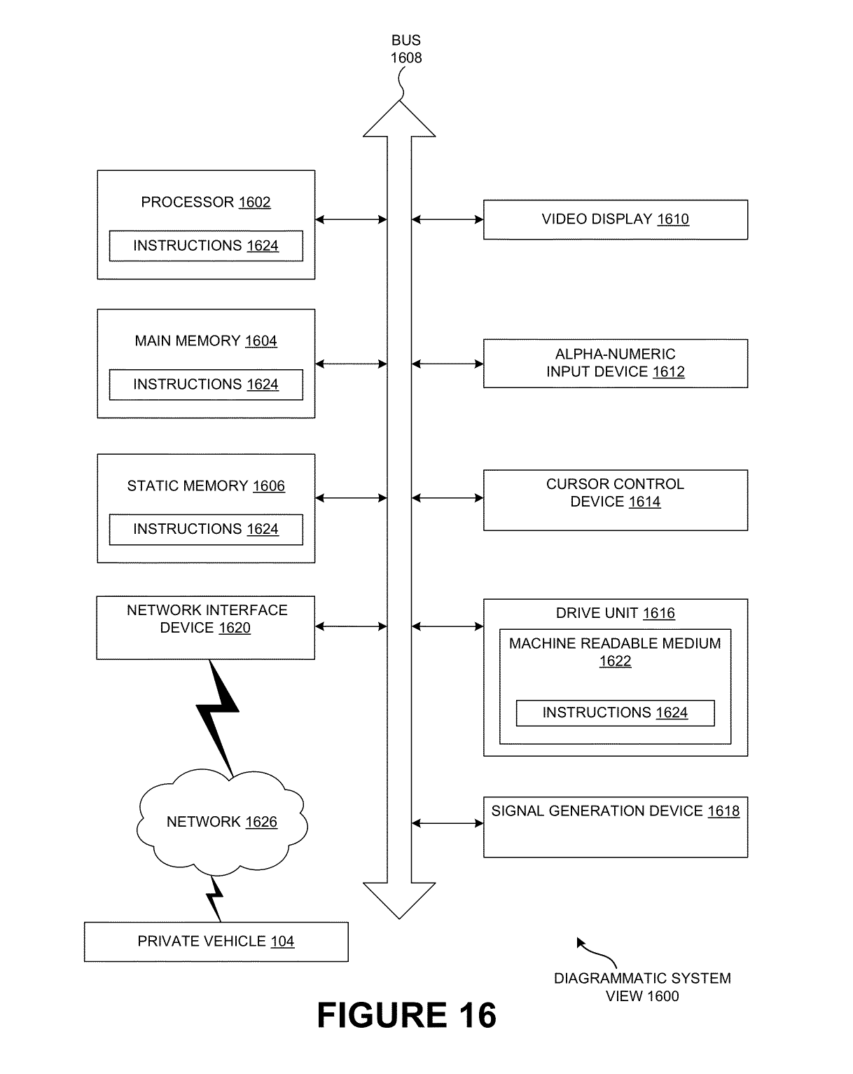

FIG. 16 is a diagrammatic system view 1600, according to one embodiment. FIG. 16 is a diagrammatic system view 1600 of a data processing system in which any of the embodiments disclosed herein may be performed, according to one embodiment. Particularly, the diagrammatic system view 1600 of FIG. 16 illustrates a processor 1602, a main memory 1604, a static memory 1606, a private vehicle 104, a video display 1610, an alpha-numeric input device 1612, a cursor control device 1614, a drive unit 1616, a signal generation device 1618, a network interface device 1620, a machine readable medium 1622, instructions 1624, and a network 1626, according to one embodiment.

The diagrammatic system view 1600 may indicate a personal computer and/or a data processing system (e.g., the private vehicle 104) in which one or more operations disclosed herein are performed. The processor 1602 may be a microprocessor, a state machine, an application specific integrated circuit, a field programmable gate array, etc. (e.g., Intel® Pentium® processor). The main memory 1604 may be a dynamic random access memory and/or a primary memory of a computer system. The network interface device 1620 may be communicatively coupled with the network 1626. The private vehicle 104 may be communicatively coupled with the network 1626.

The static memory 1606 may be a hard drive, a flash drive, and/or other memory information associated with the data processing system. The bus 1608 may be an interconnection between various circuits and/or structures of the data processing system. The video display 1610 may provide graphical representation of information on the data processing system (e.g., the private vehicle 104). The alpha-numeric input device 1612 may be a keypad, keyboard and/or any other input device of text (e.g., a special device to aid the physically handicapped). The cursor control device 1614 may be a pointing device such as a mouse.

The drive unit 1616 may be a hard drive, a storage system, and/or other longer term storage subsystem. The signal generation device 1618 may be a bios and/or a functional operating system of the data processing system. The machine readable medium 1622 may provide instructions on which any of the methods disclosed herein may be performed. The instructions 1624 may provide source code and/or data code to the processor 1602 to enable any one/or more operations disclosed herein. The private vehicle 104 may be communicatively coupled with the network 1626.

FIG. 17A is a user interface view of mapping a user profile 1700 of the geographic location 1704, according to one embodiment. In the example embodiment illustrated in FIG. 17A, the user profile 1700 may contain the information associated with the geographic location 1704. The user profile 1700 may contain the information associated with the registered user. The user profile 1700 may contain information such as address user of the specific geographic location, name of the occupant, profession of the occupant, details, phone number, educational qualification, etc.

The map 1702 may indicate the global neighborhood environment 2300 (e.g., the vehicle renting network 142 of FIG. 1) of the geographical location 1704, an unclaimed profile 1706 (e.g., the unclaimed profile 1802 of FIG. 18A, the unclaimed profile 2204 of FIG. 22), and a delisted profile 1708. The geographical location 1704 may be associated with the user profile 1700. The unclaimed profile 1706 may be the unclaimed profile associated with the neighboring property surrounding the geographic location 1704. The delisted profile 1708 illustrated in example embodiment of FIG. 17A, may be the unclaimed profile 1706 that may be delisted when the registered user claims the physical property. The block 1716 illustrated in the example embodiment of FIG. 17A may be associated with hobbies, personal likes, etc. The block 1716 may be associated with events, requirements, etc. that may be displayed by the members of the global neighborhood environment 2300 (e.g., the vehicle renting network 142 of FIG. 1).

For example, a verified registered user (e.g., a verified registered user 1810 of FIG. 18A-B, a verified registered user 1810 of FIG. 21) may be associated with a user profile 1700. The user profile 1700 may be associated with a specific geographic location. A map concurrently displaying the user profile 1700 and the specific geographic location 1704 may be generated. Also, the unclaimed profiles 1706 associated with different geographic locations surrounding the specific geographic location associated with the user profile 1700 may be simultaneously generated in the map. In addition, a query of the user profile 1700 and/or the specific geographic location may be processed.

Similarly, a tag data (e.g., the tags 1710 of FIG. 17A) associated with the specific geographic locations, a particular geographic location, and the delisted geographic location may be processed. A frequent one of the tag data (e.g., the tags 1710 of FIG. 17A) may be displayed when the specific geographic location and/or the particular geographic location are made active, but not when a geographic location is delisted.

FIG. 17B is a user interface view of mapping of the unclaimed profile 1706, according to one embodiment. In the example embodiment illustrated in FIG. 17B, the map 1702 may indicate the geographic locations in the global neighborhood environment 2300 (e.g., the vehicle renting network 142 of FIG. 1) and/or may also indicate the geographic location of the unclaimed profile 1706. The unclaimed profile 1706 may display the information associated with the registered user of the global neighborhood environment 2300 (e.g., the vehicle renting network 142 of FIG. 1). The link claim this profile 1712 may enable the registered user to claim the unclaimed profile 1706 and/or may also allow the verified registered user (e.g., the verified registered user 1810 of FIG. 18A-B) to edit any information in the unclaimed profiles 1706. The block 1714 may display the information posted by any of the verified registered users (e.g., the verified registered user 1810 of FIG. 18A-B, the verified registered user 1810 of FIG. 21) of the global neighborhood environment 2300 (e.g., the vehicle renting network 142 of FIG. 1).

For example, a particular unclaimed profile (e.g., the particular unclaimed profile may be associated with a neighboring property to the specific property in the neighborhood) of the unclaimed profiles (e.g., the unclaimed profile 1802 of FIG. 18A, the unclaimed profile 2204 of FIG. 22) may be converted to another user profile (e.g., the user profile may be tied to a specific property in a neighborhood) when a different registered user (e.g., the user of FIG. 1) claims a particular geographic location to the specific geographic location associated with the particular unclaimed profile.

In addition, a certain unclaimed profile of the unclaimed profiles may be de-listed when a private registered user claims a certain geographic location (e.g., the geographical location 1704 of FIG. 17A) adjacent to the specific geographic location and/or the particular geographic location. Also, the certain unclaimed profile in the map 1702 may be masked when the certain unclaimed profile is de-listed through the request of the private registered user.

Furthermore, a tag data (e.g., the tags 1710 of FIG. 17A) associated with the specific geographic location, the particular geographic location, and the de-listed geographic location may be processed. A frequent one of the tag data may be displayed when the specific geographic location and/or the particular geographic location are made active, but not when a geographic location is de-listed.

Moreover, the verified registered user (e.g., the verified registered user 1810 of FIG. 18A-B, the verified registered user 1810 of FIG. 21) may be permitted to edit any information in the unclaimed profiles 1706 including the particular unclaimed profile 1706 and/or the certain unclaimed profile until the certain unclaimed profile may be claimed by the different registered user and/or the private registered user. In addition, a claimant of any unclaimed profile 1706 may be enabled to control what information is displayed on their user profile. Also, the claimant may be allowed to segregate certain information on their user profile 1700 such that only other registered users directly connected to the claimant are able to view data on their user profile 1700.

FIG. 18A is a user interface view of mapping of an unclaimed profile 1802 of the commercial user 1800, according to one embodiment. In the example embodiment illustrated in FIG. 18A, the commercial user 1800 may be associated with the customizable business profile 1804 located in the commercial geographical location. The unclaimed profile 1802 may contain the information associated with the commercial user 1800. The unclaimed profile 1802 may contain the information such as address, name, profession, tag, details (e.g., ratings), and educational qualification etc. of the commercial user 1800. The verified registered user 1810 may be user associated with the global neighborhood environment 2300 (e.g., the vehicle renting network 142 of FIG. 1) and may communicate a message to the neighborhood commercial user 1800. For example, a payment of the commercial user 1800 and the verified registered user 1810 may be processed.

FIG. 18B is a user interface view of mapping of customizable business profile 1804 of the commercial user 1800, according to one embodiment. In the example embodiment illustrated in FIG. 18B, the commercial user 1800 may be associated with the customizable business profile 1804. The customizable business profile 1804 may be profile of any business firm (e.g., car rental establishment, restaurant, hotels, supermarket, etc.) that may contain information such as address, occupant name, profession of the customizable business. The customizable business profile 1804 may also enable the verified registered user 1810 to place online order for the products and/or services.

For example, the commercial user 1800 may be permitted to purchase a customizable business profile 1804 associated with a commercial geographic location. Also, the verified registered user 1810 may be enabled to communicate a message to the global neighborhood environment 2300 (e.g., the vehicle renting network 142 of FIG. 1) based on a selectable distance range away from the specific geographic location. In addition, a payment of the commercial user 1800 and/or the verified registered user 1810 may be processed.

A text advertisement 1806 may display the information associated with the offers and/or events of the customizable business. The display advertisement 1808 may display ads of the products of the customizable business that may be displayed to urge the verified registered user 1810 to buy the products of the customizable business. The verified registered user 1810 may be user associated with the global neighborhood environment 2300 (e.g., the vehicle renting network 142 of FIG. 1) that may communicate a message to the commercial user 1800 and/or may be interested in buying the products of the customizable business.

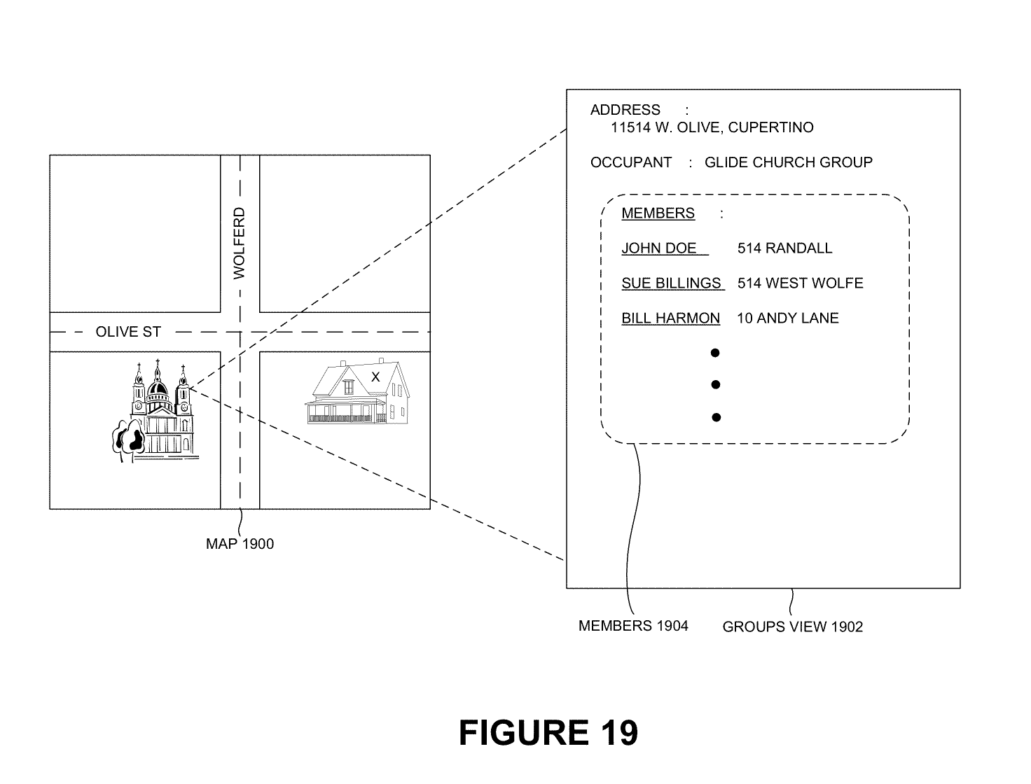

FIG. 19 is a user interface view of a groups view 1902 associated with particular geographical location, according to one embodiment. Particularly FIG. 19 illustrates, a map 1900, a groups view 1902, according to one embodiment. In the example embodiment illustrated in FIG. 19, the map view 1900 may display map view of the geographical location of the specific group of the global neighborhood environment 2300 (e.g., the vehicle renting network 142 of FIG. 1). The groups view 1902 may contain the information (e.g., address, occupant, etc.) associated with the particular group of the specific geographical location (e.g., the geographical location displayed in the map 1900) of the global neighborhood environment 2300 (e.g., the vehicle renting network 142 of FIG. 1). The members 1904 may contain the information about the members associated with the group (e.g., the group associated with geographical location displayed in the map) of the global neighborhood environment 2300 (e.g., the vehicle renting network 142 of FIG. 1).

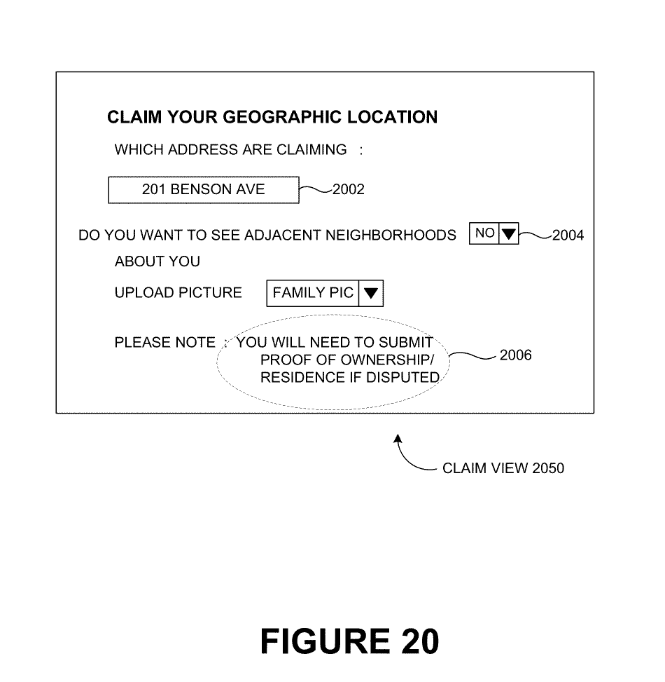

FIG. 20 is a user interface view of claim view 2050, according to one embodiment. The claim view 2050 may enable the user to claim the geographical location of the registered user. Also, the claim view 2050 may facilitate the user of the global neighborhood environment 2300 (e.g., the vehicle renting network 142 of FIG. 1) to claim the geographical location of property under dispute.

In the example embodiment illustrated in FIG. 20, the operation 2002 may allow the registered user of the global neighborhood environment 2300 (e.g., the vehicle renting network 142 of FIG. 1) to claim the address of the geographic location claimed by the registered user. The operation 2004 illustrated in example embodiment of FIG. 20, may enable the user to access adjacent neighborhoods. The operation 2006 may offer information associated with the document to be submitted by the registered users of the global neighborhood environment 2300 (e.g., the vehicle renting network 142 of FIG. 1) to claim the geographical location.

FIG. 21 is a user interface view of a building builder 2102, according to one embodiment. Particularly the FIG. 21 illustrates, a map 2100, a building builder 2102, according to one embodiment. The map 2100 may display the geographical location in which the verified registered user (e.g., the verified registered user 1810 of FIG. 18A-B) may create and/or modify empty unclaimed profiles (e.g., the unclaimed profile 1706 of FIG. 17A-17B, the unclaimed profile 1802 of FIG. 18A, the unclaimed profile 2204 of FIG. 22), building layouts, social network pages, and floor levels structures housing residents and businesses in the neighborhood (e.g., the claimed neighborhood 300 of FIG. 4, the unclaimed neighborhood 404 of FIG. 4). The building builder 2102 may enable the verified registered users (e.g., the verified registered user 1810 of FIG. 18A-B) of the global neighborhood environment 2300 (e.g., the vehicle renting network 142 of FIG. 1) to draw floor level structures, add neighbor's profiles and/or may also enable to select the floor number, type, etc. as illustrated in example embodiment of FIG. 21.

The verified registered user 1810 may be verified registered user of the global neighborhood environment 2300 (e.g., the vehicle renting network 142 of FIG. 1) interested in creating and/or modifying unclaimed profiles (e.g., the unclaimed profile 1706 of FIG. 17A-17B, the unclaimed profile 1802 of FIG. 18A, the unclaimed profile 2204 of FIG. 22), building layouts, social network pages, and floor level structure housing residents and businesses in the neighborhood (e.g., the claimed neighborhood 300 of FIG. 4, the unclaimed neighborhood 404 of FIG. 4) in the building builder 2102.

For example, a social community module 220 (e.g., a social community module 220 of FIG. 2) of the global neighborhood environment 2300 (e.g., the vehicle renting network 142 of FIG. 1) may generate a building creator (e.g., the building builder 2102 of FIG. 21) in which the registered users may create and/or modify empty unclaimed profiles (e.g., the unclaimed profile 1706 of FIG. 17A-17B, the unclaimed profile 1802 of FIG. 18A, the unclaimed profile 2204 of FIG. 22), building layouts, social network pages, and floor levels structures housing residents and/or businesses in the neighborhood (e.g., the claimed neighborhood 300 of FIG. 4, the unclaimed neighborhood 404 of FIG. 4).

FIG. 22 is a systematic view of communication of data, according to one embodiment. Particularly FIG. 22 illustrates a map 2201, verified renter profile 2202, choices 2208 and a new unclaimed page 2206, according to one embodiment. The map 2201 may locate the details of the address of the registered user of the global neighborhood environment 2300 (e.g., the vehicle renting network 142 of FIG. 1). The verified renter profile 2202 may store the profiles of the verified renter of the global neighborhood environment 2300 (e.g., the vehicle renting network 142 of FIG. 1. The unclaimed profile 2204 may be the profiles of the registered user who may claim them in the global neighborhood environment 2300 (e.g., the vehicle renting network 142 of FIG. 1).

In operation 2200 the search for the user profile (e.g., the user profile 1700 of FIG. 17A) may be carried out by the registered user. The new unclaimed page 2206 (i.e., a new wiki page) may solicit for the details of a user whom the registered user is searching for in the global neighborhood environment 2300 (e.g., the vehicle renting network 142 of FIG. 1). The choices 2208 may ask whether the requested search is any among the displayed names. The new unclaimed page 2206 may request for the details of location such as country, state and/or city. The operation 2200 may communicate with the choices 2208, and the new unclaimed page 2206.

For example, a no-match module (e.g., a no-match module) of the search module (e.g., the search module) to request additional information from the verified registered user about a person, place, and business having no listing in the global neighborhood environment 2300 (e.g., the vehicle renting network 142 of FIG. 1) when no matches are found in a search query of the verified registered user (e.g., the verified registered user 1810 of FIG. 18A-B), and to create a new unclaimed page 2206 based on a response of the verified registered user 2202 about the at least one person, place, and business not previously indexed in the global neighborhood environment 2300 (e.g., the vehicle renting network 142 of FIG. 1).

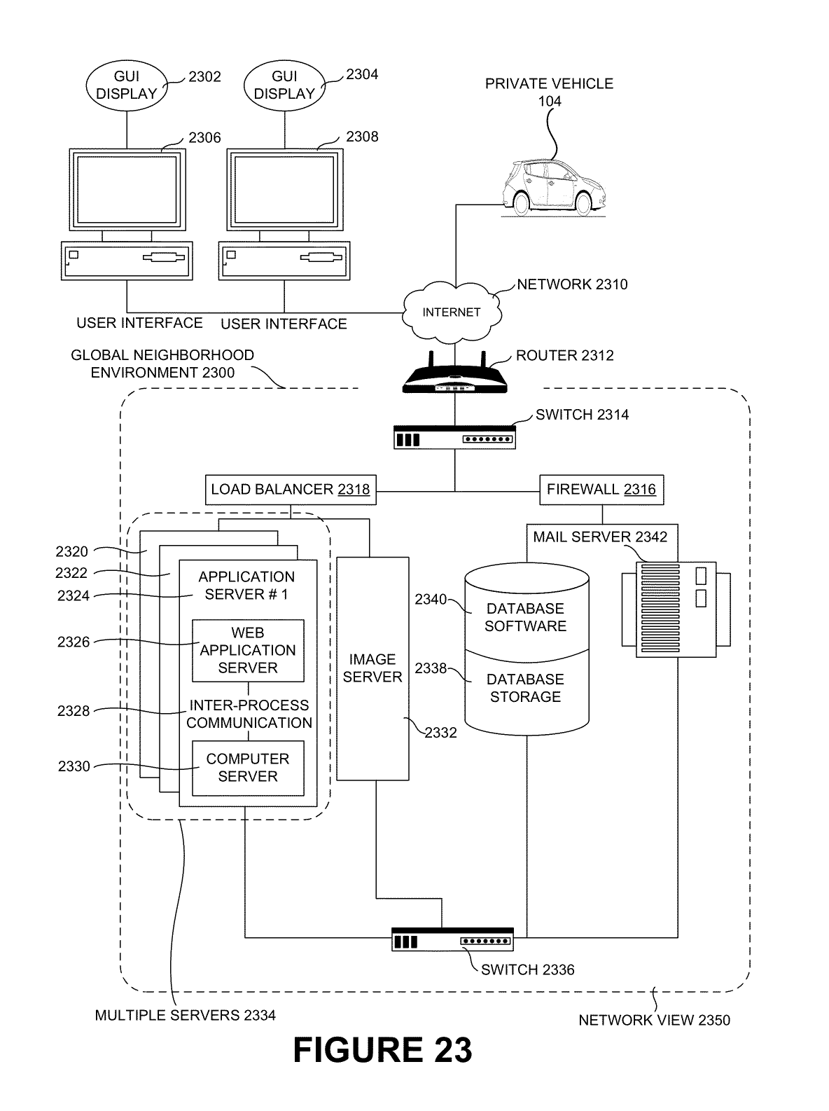

FIG. 23 is a systematic view of a network view 2350, according to one embodiment. Particularly it may include a GUI display 2302, a GUI display 2304, user interface 2306, a user interface 2308, a network 2310, a router 2312, a switch 2314, a firewall 2316, a load balancer 2318, a global neighborhood environment 2300, an application server #3 2320, an application server #2 2322, an application server #1 2324, a web application server 2326, an inter-process communication 2328, a computer server 2330, an image server 2332, a multiple servers 2334, a switch 2336, a database storage 2338, database software 2340 and a mail server 2342, according to one embodiment.

The GUI display 2302 and GUI display 2304 may display particular case of user interface for interacting with a device capable of representing data (e.g., computer, cellular telephones, television sets etc.) which employs graphical images and widgets in addition to text to represent the information and actions available to the user (e.g., the user of FIG. 1). The user interface 2306 and user interface 2308 may be any device capable of presenting data (e.g., computer, cellular telephones, television sets etc.). The network 2310 may be any collection of networks (e.g., internet, private networks, university social system, private network of a company etc.) that may transfer any data to the user (e.g., the user of FIG. 1) and the global neighborhood environment 2300 (e.g., the vehicle renting network 142 of FIG. 1).

The router 2312 may forward packets between networks and/or information packets between the global neighborhood environment 2300 (e.g., the vehicle renting network 142 of FIG. 1) and registered user over the network (e.g., internet). The switch 2314 may act as a gatekeeper to and from the network (e.g., internet) and the device. The firewall 2316 may provide protection (e.g., permit, deny or proxy data connections) from unauthorized access to the global neighborhood environment 2300 (e.g., the vehicle renting network 142 of FIG. 1. The load balancer 2318 may balance the traffic load across multiple mirrored servers in the global neighborhood environment 2300 (e.g., the vehicle renting network 142 of FIG. 1) and may be used to increase the capacity of a server farm beyond that of a single server and/or may allow the service to continue even in the face of server down time due to server failure and/or server maintenance.

The application server 2322 may be server computer on a computer network dedicated to running certain software applications of the global neighborhood environment 2300 (e.g., the vehicle renting network 142 of FIG. 1). The web application server 2326 may be server holding all the web pages associated with the global neighborhood environment 2300 (e.g., the vehicle renting network 142 of FIG. 1). The inter-process communication 2328 may be set of rules for organizing and un-organizing factors and results regarding the global neighborhood environment 2300 (e.g., the vehicle renting network 142 of FIG. 1). The computer server 2330 may serve as the application layer in the multiple servers of the global neighborhood environment 2300 (e.g., the vehicle renting network 142 of FIG. 1) and/or may include a central processing unit (CPU), a random access memory (RAM) temporary storage of information, and/or a read only memory (ROM) for permanent storage of information regarding the global neighborhood environment 2300 (e.g., the vehicle renting network 142 of FIG. 1).

The image server 2332 may store and provide digital images of the registered user of the global neighborhood environment 2300 (e.g., the vehicle renting network 142 of FIG. 1). The multiple servers 2334 may be multiple computers or devices on a network that may manage network resources connecting the registered user and the global neighborhood environment 2300 (e.g., the vehicle renting network 142 of FIG. 1). The database storage 2338 may store software, descriptive data, digital images, system data and any other data item that may be related to the user (e.g., the user of FIG. 1) of the global neighborhood environment 2300 (e.g., the vehicle renting network 142 of FIG. 1). The database software 2340 may be provided a database management system that may support the global neighborhood environment 2300 (e.g., the vehicle renting network 142 of FIG. 1). The mail server 2342 may be provided for sending, receiving and storing mails. The user interface 2306 and 2308 may communicate with the GUI display(s) 2302 and 2304, the router 2312 through the network 2310 and the global neighborhood environment 2300 (e.g., the vehicle renting network 142 of FIG. 1). The private vehicle 104 may be communicatively coupled with the network 2310.

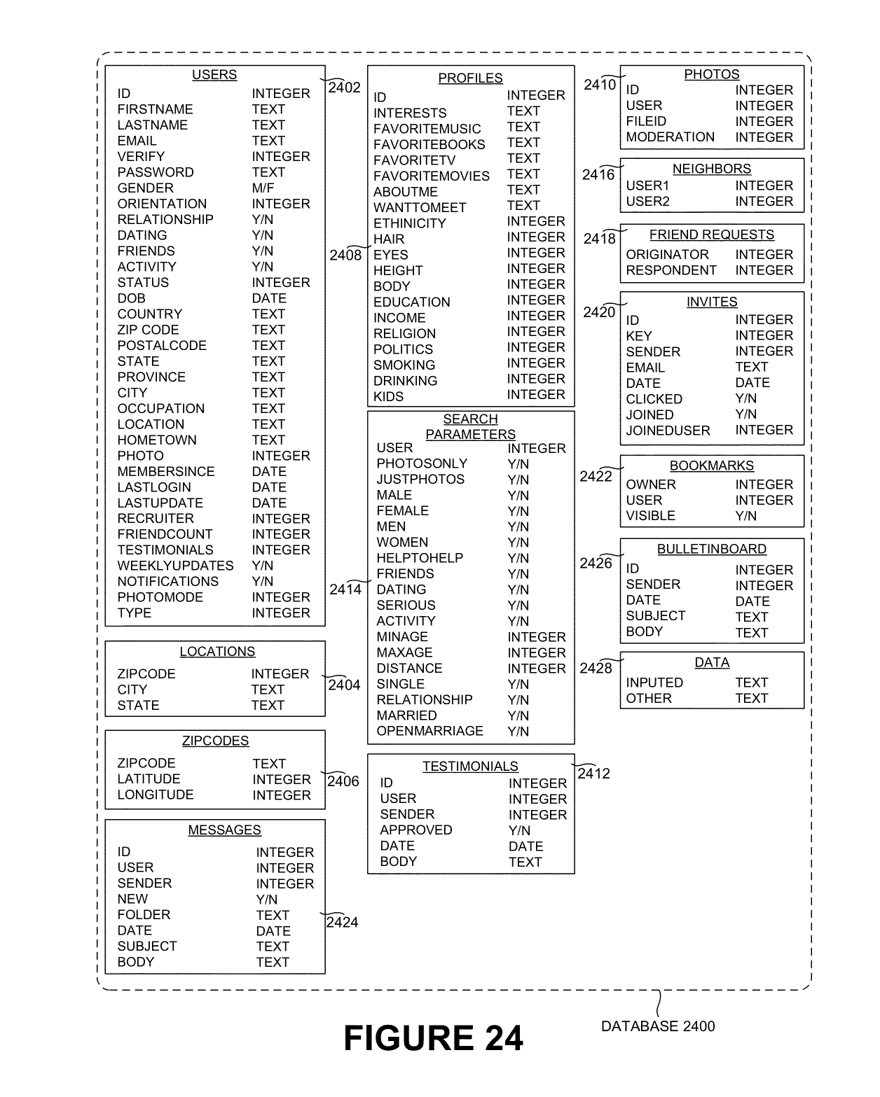

FIG. 24 is a block diagram of a database, according to one embodiment. Particularly the block diagram of the database 2400 of FIG. 24 illustrates a user data 2402, a location data, a zip codes data 2406, a profiles data 2408, a photos data 2410, a testimonials data 2412, a search parameters data 2414, a neighbor's data 2416, a friends requests data 2418, a invites data 2420, a bookmarks data 2422, a message data 2424 and a bulletin board data 2426, and a data 2428, according to one embodiment.

The database 2400 be may include descriptive data, preference data, relationship data, and/or other data items regarding the registered user of the global neighborhood environment 2300 (e.g., the vehicle renting network 142 of FIG. 1.

The user data 2402 may be a descriptive data referring to information that may describe a user (e.g., the user of FIG. 1). It may include elements in a certain format for example Id may be formatted as integer, Firstname may be in text, Lastname may be in text, Email may be in text, Verify may be in integer, Password may be in text, Gender may be in m/f, Orientation may be in integer, Relationship may be in y/n, Dating may be in y/n, Friends may be in y/n, Activity may be in y/n, Status may be in integer, Dob may be in date, Country may be in text, Zipcode may be in text, Postalcode may be in text, State may be in text, Province may be in text, City may be in text, Occupation may be in text, Location may be in text, Hometown may be in text, Photo may be in integer, Membersince may be in date, Lastlogin may be in date, Lastupdate may be in date, Recruiter may be in integer, Friendcount may be in integer, Testimonials may be in integer, Weeklypdates may be in y/n, Notifications may be in y/n, Photomode may be in integer and/or Type may be in integer.

The locations data 2404 may clarify the location details in formatted approach. For example Zip code may be formatted as integer, City may be in text and/or State may be in text. The zip codes data 2406 may provide information of a user location in formatted manner. For example Zip code may be formatted as text, Latitude may be in integer and/or Longitude may be in integer. The profile data 2408 may clutch personnel descriptive data that may be formatted.

For examples ID may be formatted as integer, Interests may be in text, Favoritemusic may be in text, Favaoritebooks may be in text, Favoritetv may be in text, Favoritemovies may be in text, Aboutme may be in text, Wanttomeet may be in text, Ethnicity may be in integer, Hair may be in integer, Eyes may be in integer, Height may be in integer, Body may be in integer, Education may be in integer, Income may be in integer, Religion may be in integer, Politics may be in integer Smoking may be in integer, Drinking may be in integer and/or Kids may be in integer.

The photos data 2410 may represent a digital image and/or a photograph of the user formatted in certain approach. For example Id may be formatted as integer, User may be in integer, Fileid may be in integer and/or Moderation may be in integer. The testimonials data 2412 may allow users to write “testimonials” 2412, or comments, about each other and in these testimonials, users may describe their relationship to an individual and their comments about that individual. For example the user might write a testimonial that states “Rohan has been a friend of mine since graduation days. He is smart, intelligent, and a talented person.” The elements of testimonials data 2412 may be formatted as Id may be in integer, User may be in integer, Sender may be integer, Approved may be in y/n, Date may be in date and/or Body may be formatted in text.

The search parameters data 2414 may be preference data referring to the data that may describe preferences one user has with respect to another (For example, the user may indicate that he is looking for a female who is seeking a male for a serious relationship). The elements of the search parameters data 2414 may be formatted as User 2402 may be in integer, Photosonly may be in y/n, Justphotos may be in y/n, Male may be in y/n, Female may be in y/n, Men may be in y/n, Women may be in y/n, Helptohelp may be in y/n, Friends may be in y/n, Dating may be in y/n, Serious may be in y/n, Activity may be in y/n, Minage may be in integer, Maxage may be in integer, Distance may be in integer, Single may be in y/n, Relationship may be in y/n, Married may be in y/n and/or Openmarriage may be in y/n.

The neighbor's data 2416 may generally refer to relationships among registered users of the global neighborhood environment 2300 (e.g., the vehicle renting network 142 of FIG. 1) that have been verified and the user has requested another individual to join the system as neighbor's data 2416, and the request may be accepted. The elements of the neighbors data 2416 may be formatted as user1 may be in integer and/or user2 may be in integer. The friend requests data 2418 may tracks requests by users within the neighborhood (e.g., the claimed neighborhood 300 of FIG. 4, the unclaimed neighborhood 404 of FIG. 4) to other individuals, which requests have not yet been accepted and may contain elements originator and/or respondent formatted in integer. The invites data 2420 may describe the status of a request by the user to invite an individual outside the neighborhood (e.g., the claimed neighborhood 300 of FIG. 4, the unclaimed neighborhood 404 of FIG. 4) to join the neighborhood (e.g., the claimed neighborhood 300 of FIG. 4, the unclaimed neighborhood 404 of FIG. 4) and clarify either the request has been accepted, ignored and/or pending.

The elements of the invites data 2420 may be formatted as Id may be in integer, Key may be in integer, Sender may be in integer, Email may be in text, Date may be in date format, Clicked may be in y/n, Joined may be in y/n and/or Joineduser may be in integer. The bookmarks data 2422 may provide the data for a process allowed wherein a registered user of the global neighborhood environment 2300 (e.g., the vehicle renting network 142 of FIG. 1) may indicate an interest in the profile of another registered user. The bookmark data 2422 elements may be formatted as Owner may be in integer, User may be in integer and/or Visible may be in y/n. The message data 2424 may allow the users to send one another private messages.

The message data 2424 may be formatted as Id may be in integer, (e.g., User may be in integer, Sender may be in integer, New may be in y/n, Folder may be in text, Date may be in date format, Subject may be in text and/or Body may be in text format) The bulletin board data 2426 may support the function of a bulletin board that users may use to conduct online discussions, conversation and/or debate. The data 2428 may share the user profiles (e.g., the user profile 1700 of FIG. 17A) in the neighborhood (e.g., the claimed neighborhood 300 of FIG. 4, the unclaimed neighborhood 404 of FIG. 4) and its elements may be formatted as wikis inputted and/or others may be in text format.

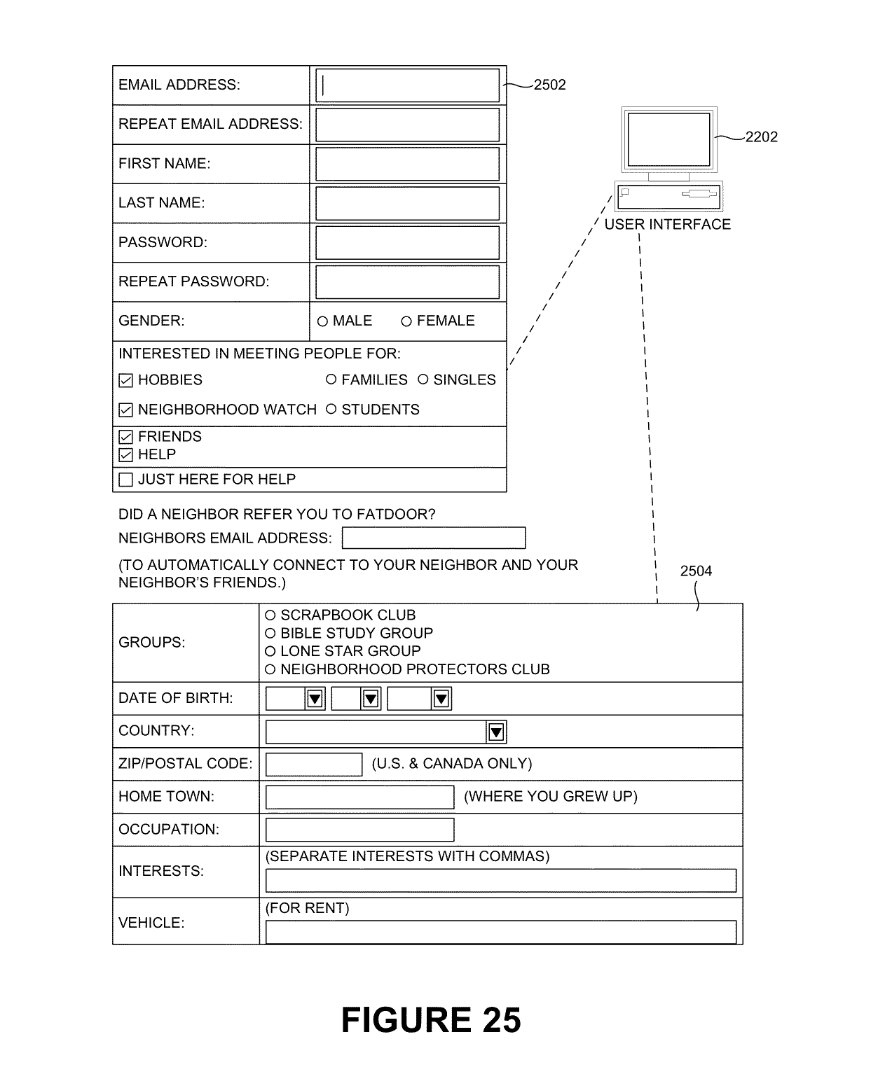

FIG. 25 is an exemplary graphical user interface view for data collection, according to one embodiment. Particularly FIG. 25 illustrates exemplary screens 2502, 2504 that may be provided to the user (e.g., the user of FIG. 1) through an interface may be through the network (e.g., Internet), to obtain user descriptive data. The screen 2502 may collect data allowing the user (e.g., the user of FIG. 1) to login securely and be identified by the neighborhood (e.g., the neighborhood 602A-N of FIG. 1). This screen 2502 may allow the user to identify the reason he/she is joining the neighborhood. For example, a user may be joining the neighborhood for “neighborhood watch”. The screen 2504 may show example of how further groups may be joined. For example, the user (e.g., the user of FIG. 1) may be willing to join a group “Raj for city council”. It may also enclose the data concerning Dob, country, zip/postal code, hometown, occupation and/or interest. The user may be able to enter their vehicle in screens 2502 and/or 2504 and/or may be able to register their vehicle (e.g., the private vehicle 104) and/or list it as available for rent, according to one embodiment.

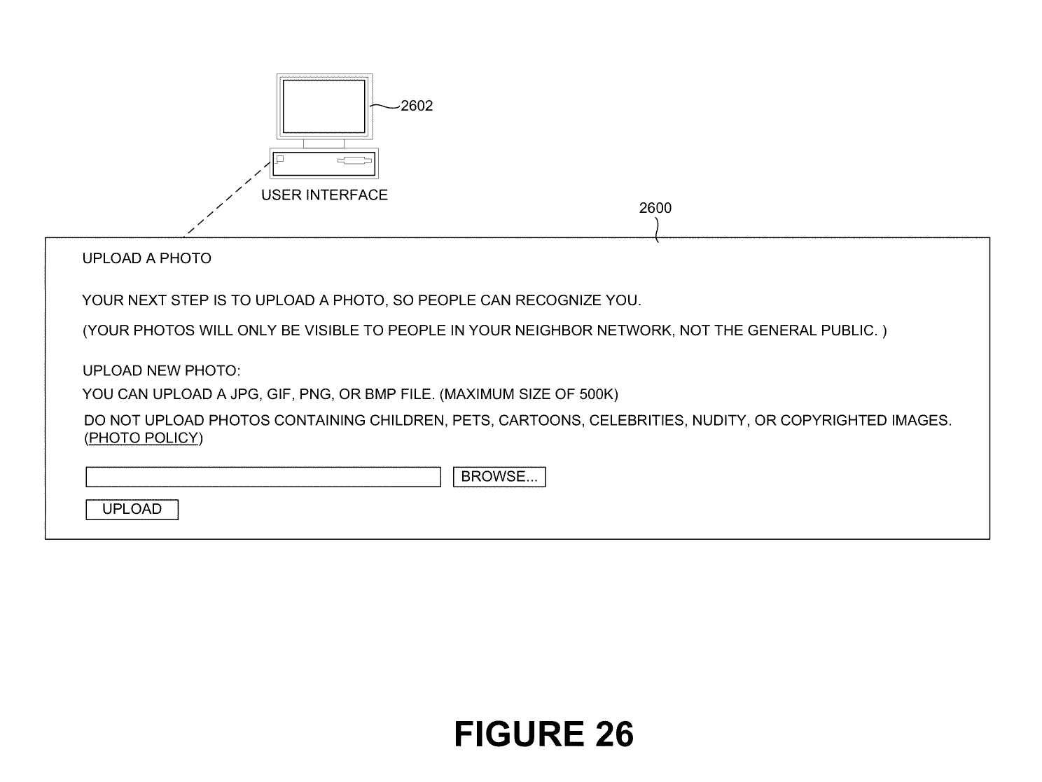

FIG. 26 is an exemplary graphical user interface view of image collection, according to one embodiment. A screen 2600 may be interface provided to the user (e.g., the user of FIG. 1) over the network (e.g., internet) may be to obtain digital images from system user. The user interface 2602 may allow the user (e.g., the user of FIG. 1) to browse files on his/her computer, select them, and then upload them to the neighborhood (e.g., the claimed neighborhood 300 of FIG. 4, the unclaimed neighborhood 404 of FIG. 4). The user (e.g., the user of FIG. 1) may upload the digital images and/or photo that may be visible to people in the neighbor (e.g., the other addresses associated with user profiles 402 of FIG. 4) network and not the general public. The user may be able to upload a JPG, GIF, PNG and/or BMP file in the screen 2600.

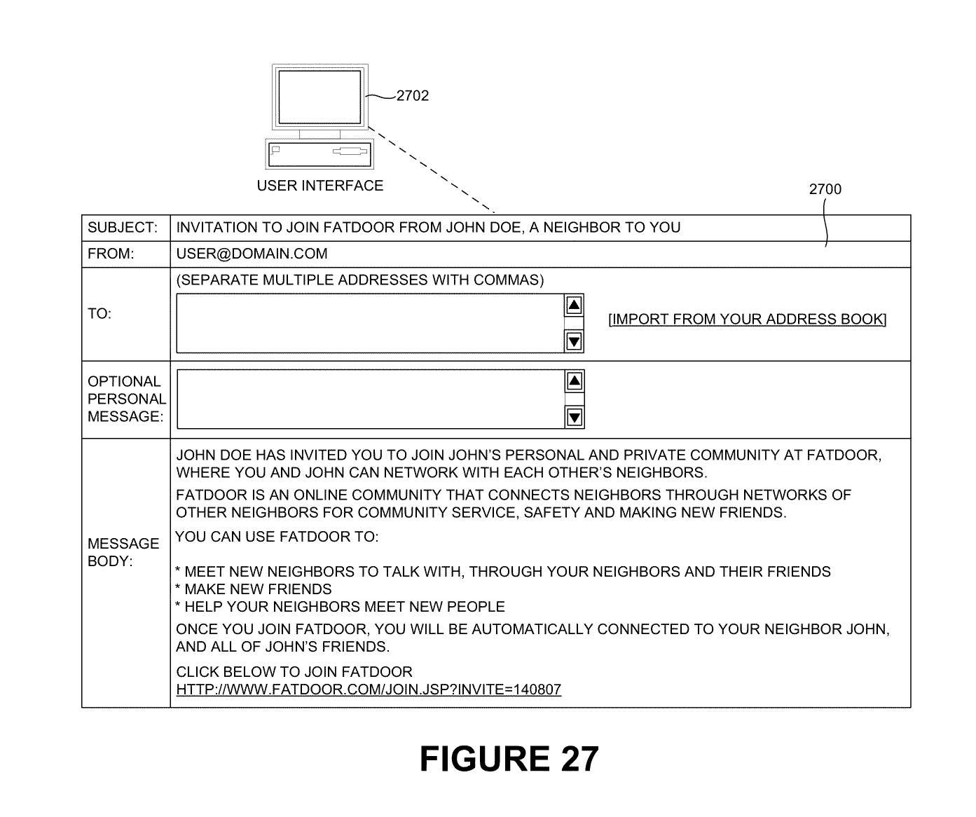

FIG. 27 is an exemplary graphical user interface view of an invitation, according to one embodiment. An exemplary screen 2700 may be provided to a user through a user interface 2702 may be over the network (e.g., internet) to allow users to invite neighbor or acquaintances to join the neighborhood (e.g., the claimed neighborhood 300 of FIG. 4, the unclaimed neighborhood 404 of FIG. 4). The user interface 2702 may allow the user (e.g., the user of FIG. 1) to enter one or a plurality of e-mail addresses for friends they may like to invite to the neighborhood (e.g., the claimed neighborhood 300 of FIG. 4, the unclaimed neighborhood 404 of FIG. 4). The exemplary screen 2700 may include the “subject”, “From”, “To”, “Optional personnel message”, and/or “Message body” sections. In the “Subject” section a standard language text may be included for joining the neighborhood (e.g., Invitation to join Fatdoor from John Doe, a neighborhood.).

The “From” section may include the senders email id (e.g., user@domain.com). The “To” section may be provided to add the email id of the person whom the sender may want to join the neighborhood (e.g., the claimed neighborhood 300 of FIG. 4, the unclaimed neighborhood 404 of FIG. 4). The message that may be sent to the friends and/or acquaintances may include standard language describing the present neighborhood, the benefits of joining and the steps required to join the neighborhood (e.g., the claimed neighborhood 300 of FIG. 4, the unclaimed neighborhood 404 of FIG. 4). The user (e.g., the user of FIG. 1) may choose to include a personal message, along with the standard invitation in the “Optional personal message” section.

In the “Message body” section the invited friend or acquaintance may initiate the process to join the system by clicking directly on an HTML link included in the e-mail message (e.g., http://www.fatdoor.com/join.jsp? Invite=140807). In one embodiment, the user (e.g., the user of FIG. 1) may import e-mail addresses from a standard computerized address book. The system may further notify the inviting user when her invitee accepts or declines the invitation to join the neighborhood (e.g., the claimed neighborhood 300 of FIG. 4, the unclaimed neighborhood 404 of FIG. 4).

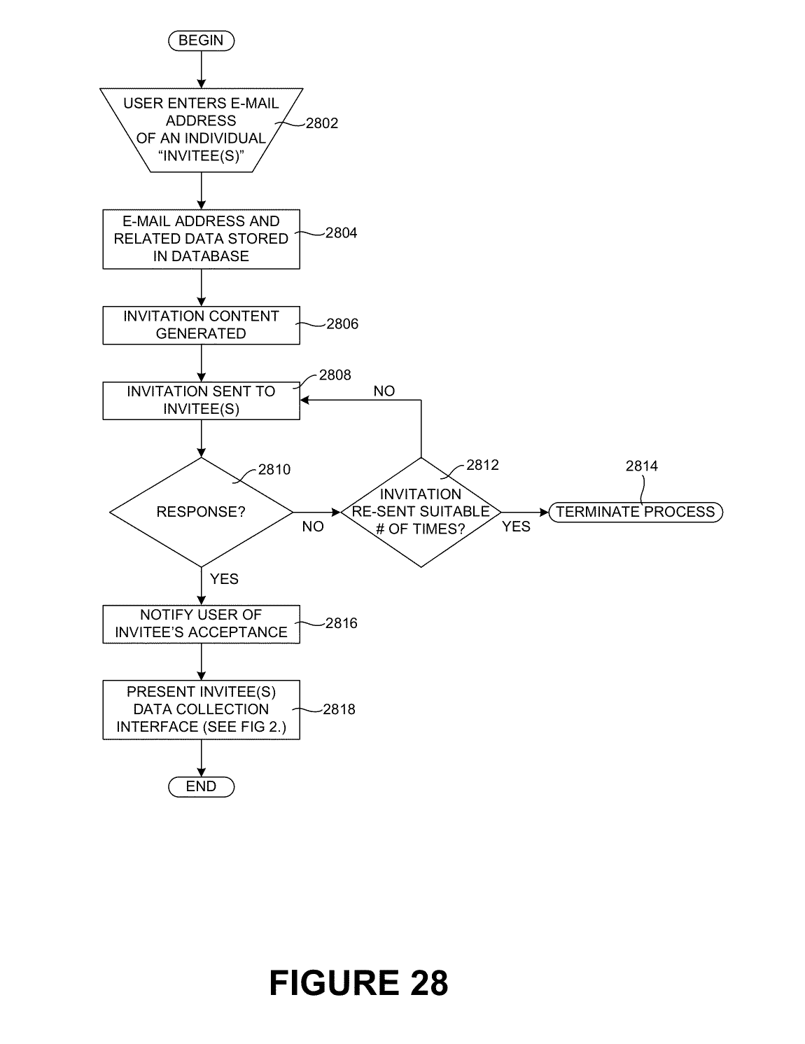

FIG. 28 is a flowchart of inviting the invitee(s) by the registered user, notifying the registered user upon the acceptance of the invitation by the invitee(s) and, processing and storing the input data associated with the user (e.g., the user of FIG. 1) in the database, according to one embodiment. In operation 2802, the verified registered user (e.g., the verified registered user 1810 of FIG. 18A-B, the verified registered user 1810 of FIG. 21) willing to invite the individual enters the email addresses of an individual “invitee”. In operation 2804, the email address and the related data of the invitee may be stored in the database. In operation 2806, the invitation content for inviting the invitee may be generated from the data stored in the database. In operation 2808, the registered user sends invitation to the invitee(s).

In operation 2810, response from the user (e.g., the user of FIG. 1) may be determined. In operation 2812, if the invitee doesn't respond to invitation sent by the registered user then registered user may resend the invitation for a predefined number of times. In operation 2814, if the registered user resends the invitation to the same invitee for predefined number of times and if the invitee still doesn't respond to the invitation the process may be terminated automatically.

In operation 2816, if the invitee accepts the invitation sent by the registered user then system may notify the registered user that the invitee has accepted the invitation. In operation 2818, the input from the present invitee(s) that may contain the descriptive data about the friend (e.g., registered user) may be processed and stored in the database.

For example, each registered user associated e-mail addresses of individuals who are not registered users may be stored and identified by each registered user as neighbors. An invitation to become a new user (e.g., the user of FIG. 1) may be communicated out to neighbor (e.g., other addresses associated with a verified renter profile 402) of the particular user. An acceptance of the neighbor (e.g., the other addresses associated with user profiles 402 of FIG. 4) to whom the invitation was sent may be processed.

The neighbor (e.g., the other addresses associated with user profiles 402 of FIG. 4) may be added to a database and/or storing of the neighbor (e.g., the other addresses associated with user profiles 402 of FIG. 4), a user ID and a set of user IDs of registered users who are directly connected to the neighbor (e.g., the other addresses associated with user profiles 402 of FIG. 4), the set of user IDs stored of the neighbor (e.g., the other addresses associated with user profiles 402 of FIG. 4) including at least the user ID of the verified registered user (e.g., the verified registered user 1810 of FIG. 18A-B, the verified registered user 1810 of FIG. 21). Furthermore, the verified registered user may be notified that the invitation to the neighbor (e.g., the other addresses associated with user profiles 402 of FIG. 4) has been accepted when an acceptance is processed. Also, inputs from the neighbor (e.g., the other addresses associated with user profiles 402 of FIG. 4) having descriptive data about the friend may be processed and the inputs in the database may be stored.

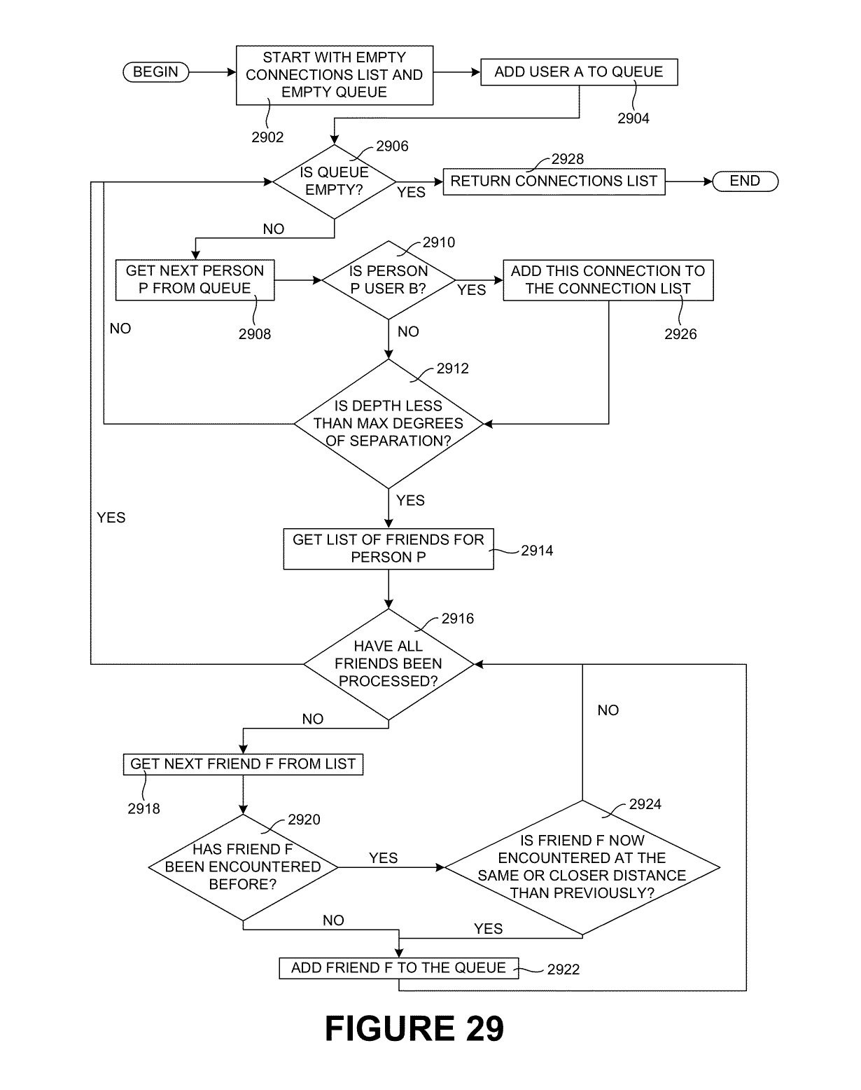

FIG. 29 is a flowchart of adding the neighbor (e.g., the other addresses associated with user profiles 402 of FIG. 4) to the queue, according to one embodiment. In operation 2902, the system may start with the empty connection list and empty queue. In operation 2904, the user may be added to the queue. In operation 2906, it is determined whether the queue is empty. In operation 2908, if it is determined that the queue is not empty then the next person P may be taken from the queue. In operation 2910, it may be determined whether the person P from the queue is user B or not. In operation 2912, if the person P is not user B then it may be determined whether the depth of the geographical location is less than maximum degrees of separation.

If it is determined that depth is more than maximum allowable degrees of separation then it may repeat the operation 2908. In operation 2914, it may be determined that the depth of the geographical location (e.g., the geographical location 1704) is less than maximum degrees of separation then the neighbors (e.g., the other addresses associated with user profiles 402 of FIG. 4) list for person P may be processed. In operation 2916, it may be determined whether all the neighbors (e.g., the other addresses associated with user profiles 402 of FIG. 4) in the neighborhood (e.g., the claimed neighborhood 300 of FIG. 4, the unclaimed neighborhood 404 of FIG. 4) have been processed or not. If all the friends are processed it may be determined the queue is empty.

In operation 2918, if all the neighbors (e.g., the other addresses associated with user profiles 402 of FIG. 4) for person P are not processed then next neighbor N may be taken from the list. In operation 2920, it may be determined whether the neighbor (e.g., the other addresses associated with user profiles 402 of FIG. 4) N has encountered before or not. In operation 2922, if the neighbor (e.g., the other addresses associated with user profiles 402 of FIG. 4) has not been encountered before then the neighbor may be added to the queue. In operation 2924, if the neighbor N has been encountered before it may be further determined whether the geographical location (e.g., the geographical location 1704 of FIG. 17A) from where the neighbor (e.g., the other addresses associated with user profiles 402 of FIG. 4) has encountered previously is the same place or closer to that place.

If it is determined that the neighbor (e.g., the other addresses associated with user profiles 402 of FIG. 4) has encountered at the same or closer place then the friend may be added to the queue. If it may be determined that friend is not encountered at the same place or closer to that place then it may be again checked that all the friends have processed. In operation 2926, if it is determined that the person P is user B than the connection may be added to the connection list and after adding the connection to connection list it follows the operation 2912. In operation 2928, if it may be determined that queue is empty then the operation may return the connections list.

For example, a first user ID with the verified registered user (e.g., the verified registered user 1810 of FIG. 18A-B, the verified registered user 1810 of FIG. 21) and a second user ID may be applied to the different registered user. The verified registered user (e.g., the verified registered user 1810 of FIG. 18A-B, the verified registered user 1810 of FIG. 21) with the different registered user may be connected with each other through at least one of a geo-positioning data associated with the first user ID and the second user ID. In addition, a maximum degree of separation (Nmax) of at least two that is allowed for connecting any two registered users, (e.g., the two registered users who may be directly connected may be deemed to be separated by one degree of separation and two registered users who may be connected through no less than one other registered user may be deemed to be separated by two degrees of separation and two registered users who may be connected through not less than N other registered users may be deemed to be separated by N+1 degrees of separation).

Furthermore, the user ID of the different registered user may be searched (e.g., the method limits the searching of the different registered user in the sets of user IDs that may be stored as registered users who are less than Nmax degrees of separation away from the verified registered user (e.g., the verified registered user 1810 of FIG. 18A-B, the verified registered user 1810 of FIG. 21), such that the verified registered user (e.g., the verified registered user 1810 of FIG. 18A-B, the verified registered user 1810 of FIG. 21) and the different registered user who may be separated by more than Nmax degrees of separation are not found and connected) in a set of user IDs that may be stored of registered users who are less than Nmax degrees of separation away from the verified registered user (e.g., the verified registered user 1810 of FIG. 18A-B, the verified registered user 1810 of FIG. 21), and not in the sets of user IDs that may be stored for registered users who are greater than or equal to Nmax degrees of separation away from the verified registered user (e.g., the verified registered user 1810 of FIG. 18A-B, the verified registered user 1810 of FIG. 21), until the user ID of the different registered user may be found in one of the searched sets. Also, the verified registered user (e.g., the verified registered user 1810 of FIG. 18A-B, the verified registered user 1810 of FIG. 21) may be connected to the different registered user if the user ID of the different registered user may be found in one of the searched sets.

Moreover, the sets of user IDs that may be stored of registered users may be searched initially who are directly connected to the verified registered user (e.g., the verified registered user 1810 of FIG. 18A-B, the verified registered user 1810 of FIG. 21). A profile of the different registered user may be communicated to the verified registered user (e.g., the verified registered user 1810 of FIG. 18A-B, the verified registered user 1810 of FIG. 21) to display through a marker associating the verified registered user (e.g., the verified registered user 1810 of FIG. 18A-B, the verified registered user 1810 of FIG. 21) with the different registered user. A connection path between the verified registered user (e.g., the verified registered user 1810 of FIG. 18A-B, the verified registered user 1810 of FIG. 21) and the different registered user, the connection path indicating at least one other registered user may be stored through whom the connection path between the verified registered user (e.g., the verified registered user 1810 of FIG. 18A-B, the verified registered user 1810 of FIG. 21) and the different registered user is made.

In addition, the connection path between the verified registered user (e.g., the verified registered user 1810 of FIG. 18A-B, the verified registered user 1810 of FIG. 21) and the different registered user may be communicated to the verified registered user to display. A hyperlink in the connection path of each of the at least one registered users may be embedded through whom the connection path between the verified registered user (e.g., the verified registered user 1810 of FIG. 18A-B, the verified registered user 1810 of FIG. 21) and the different registered user is made.

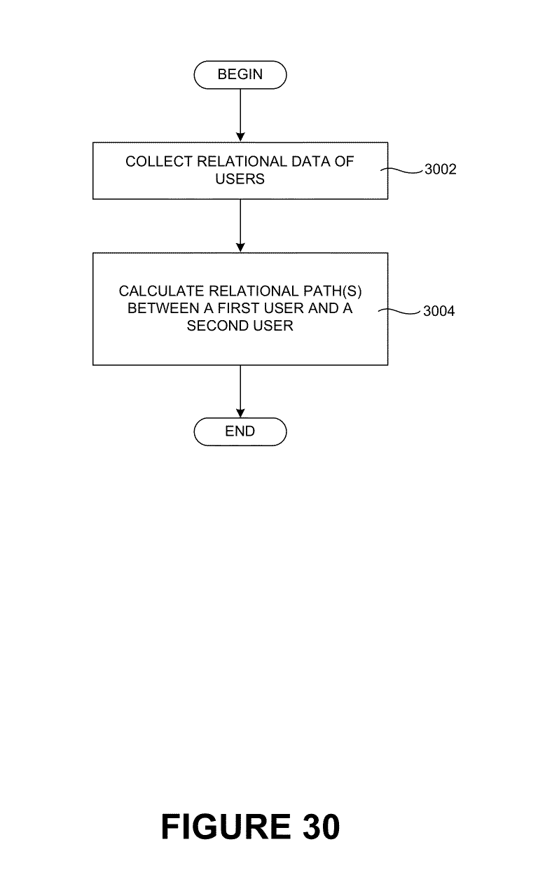

FIG. 30 is a flowchart of communicating brief profiles of the registered users, processing a hyperlink selection from the verified registered user (e.g., the verified registered user 1810 of FIG. 18A-B, the verified registered user 1810 of FIG. 21) and calculating and ensuring the Nmax degree of separation of the registered users away from verified registered users (e.g., the verified registered user 1810 of FIG. 18A-B, the verified registered user 1810 of FIG. 21), according to one embodiment. In operation 3002, the data of the registered users may be collected from the database. In operation 3004, the relational path between the first user and the second user may be calculated (e.g., the Nmax degree of separation between verified registered user (e.g., the verified registered user 1810 of FIG. 18A-B, the verified registered user 1810 of FIG. 21) and the registered user).

For example, the brief profiles of registered users, including a brief profile of the different registered user, to the verified registered user (e.g., the verified registered user 1810 of FIG. 18A-B, the verified registered user 1810 of FIG. 21) for display, each of the brief profiles including a hyperlink to a corresponding full profile may be communicated.

Furthermore, the hyperlink selection from the verified registered user (e.g., the verified registered user 1810 of FIG. 18A-B, the verified registered user 1810 of FIG. 21) may be processed (e.g., upon processing the hyperlink selection of the full profile of the different registered user, the full profile of the different registered user may be communicated to the verified registered user (e.g., the verified registered user 1810 of FIG. 18A-B, the verified registered user 1810 of FIG. 21) for display). In addition, the brief profiles of those registered users may be ensured who are more than Nmax degrees of separation away from the verified registered user (e.g., the verified registered user 1810 of FIG. 18A-B, the verified registered user 1810 of FIG. 21) are not communicated to the verified registered user (e.g., the verified registered user 1810 of FIG. 18A-B, the verified registered user 1810 of FIG. 21) for display.

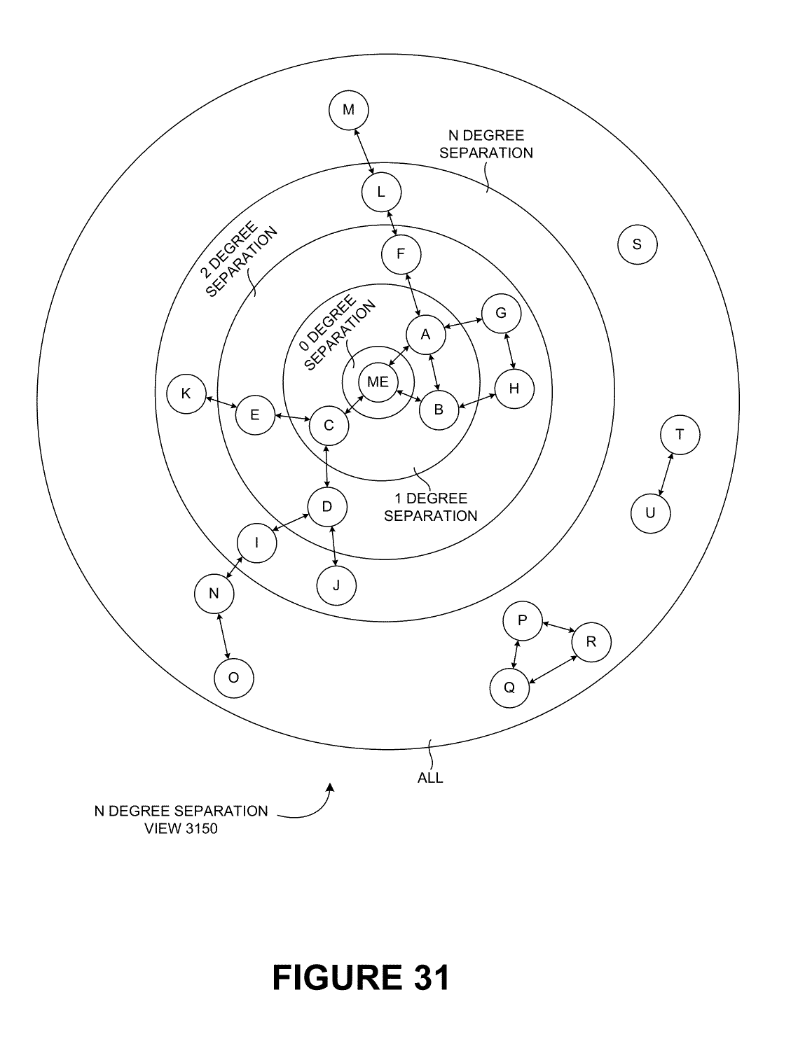

FIG. 31 is an N degree separation view 3150, according to one embodiment. ME may be a verified registered user (e.g., the verified registered user 1810 of FIG. 18A-B, the verified registered user 1810 of FIG. 21) of the global neighborhood environment 2300 (e.g., the vehicle renting network 142 of FIG. 1) centered in the neighborhood network. A, B, C, D, E, F, G, H, I, J, K, L, M, N, O, P, Q, R, S, T, and/or U may be the other registered user of the neighborhood network. The member of the neighborhood network may be separated from the centered verified registered user (e.g., the verified registered user 1810 of FIG. 18A-B, the verified registered user 1810 of FIG. 21) ME of the neighborhood network by certain degree of separation.

The registered user A, B and C may be directly connected and may be deemed to be separated by one degree of separation from verified registered user (e.g., the verified registered user 1810 of FIG. 18A-B, the verified registered user 1810 of FIG. 21) ME. The registered user D, E, F, G, and H may be connected through no less than one other registered user may be deemed to be separated by two degree of separation from verified registered user (e.g., the verified registered user 1810 of FIG. 18A-B, the verified registered user 1810 of FIG. 21) ME. The registered user I, J, K, and L may be connected through no less than N−1 other registered user and may be deemed to be separated by N degree of separation from verified registered user (e.g., the verified registered user 1810 of FIG. 18A-B, the verified registered user 1810 of FIG. 21) ME. The registered user M, N, O, P, Q, R S, T and U may be all registered user.

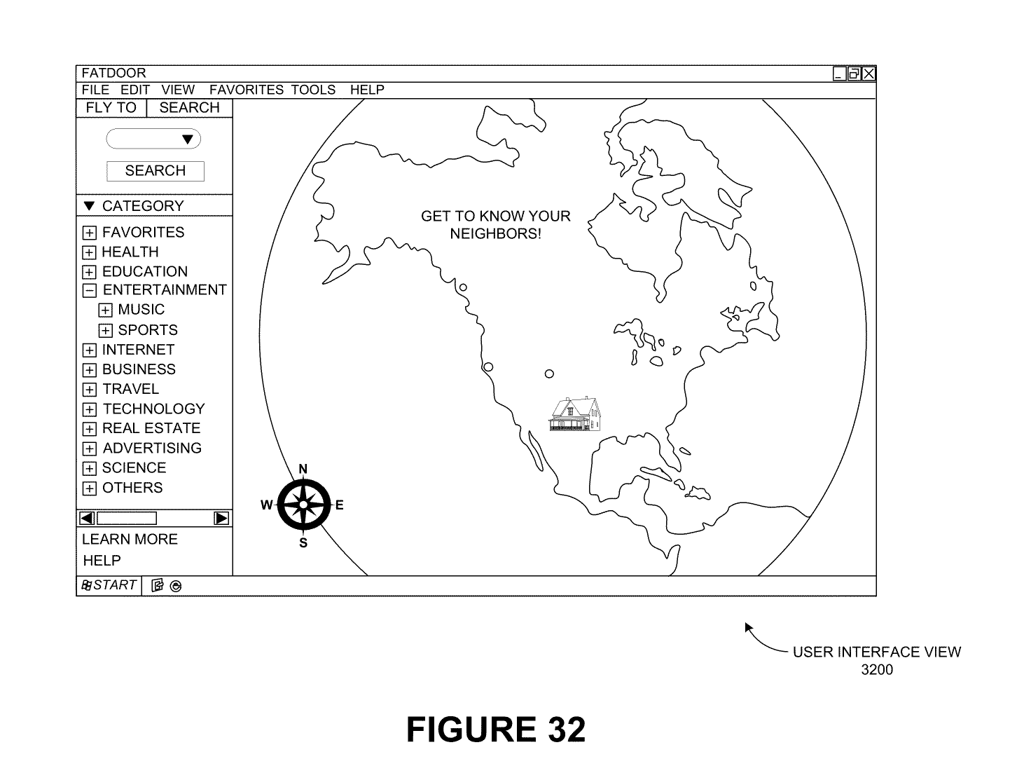

FIG. 32 is a user interface view 3200 showing a map, according to one embodiment. Particularly FIG. 32 illustrates a satellite photo of a physical world. The registered user of the global neighborhood environment 2300 (e.g., the vehicle renting network 142 of FIG. 1) may use this for exploring the geographical location (e.g., the geographical location 1704 of FIG. 17A) of the neighbors (e.g., the other addresses associated with user profiles 402 of FIG. 4). The registered user (e.g., the verified registered user 1810 of FIG. 18A-B, the verified registered user 1810 of FIG. 21) may navigate, zoom, explore and quickly find particular desired geographical locations of the desired neighbors (e.g., the other addresses associated with user profiles 402 of FIG. 4). This may help the registered user to read the map and/or plot the route of the neighbors (e.g., the other addresses associated with user profiles 402 of FIG. 4) on the world map.

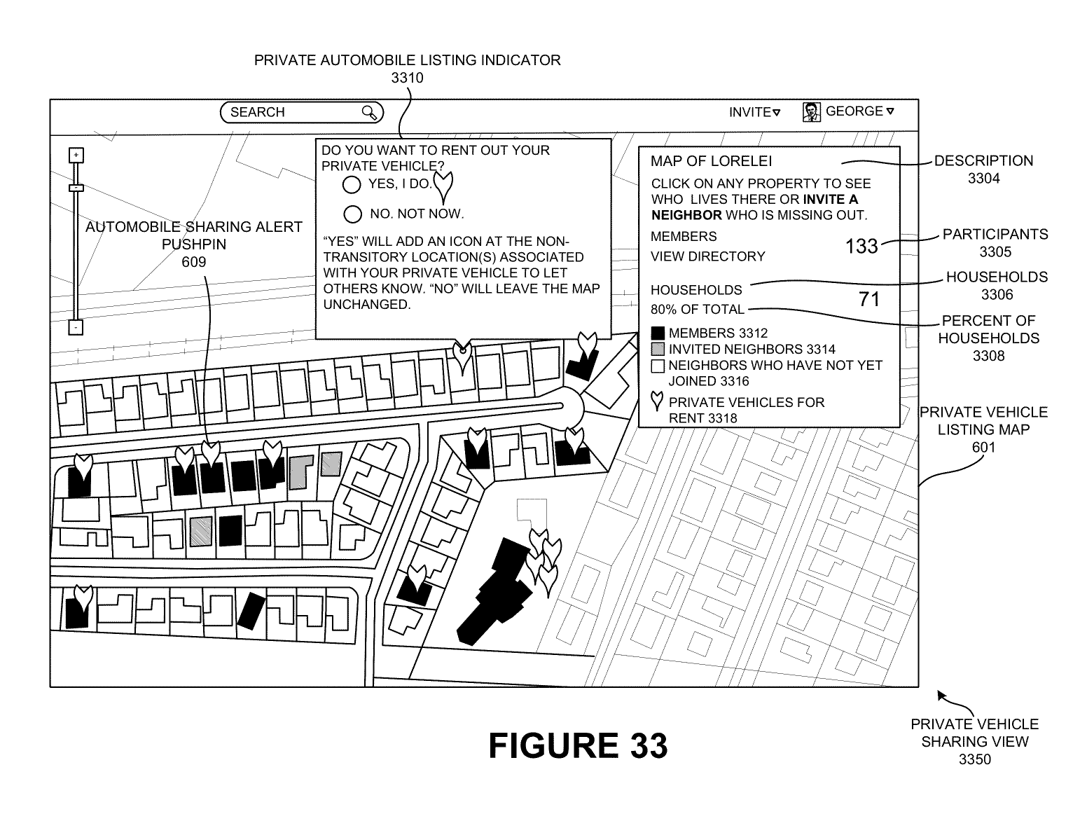

FIG. 33 is a private vehicle sharing view 3350 of the private vehicle listing map 601, according to one embodiment. FIG. 33 shows the private vehicle listing map 601, a description 3304, a set of participants 3305, a set of households 3306, a percent of households 3308, a private automobile listing indicator 3310, a members 3312, an invited neighbors 3314, a neighbors who have not yet joined 3316, and private vehicles for rent 3318. The private vehicle listing map 601 may be a geospatial map of the neighborhood in which the verified renter has a claimed geospatial location. The description 3304 may be a description of the rentals and/or neighborhood. The participants 3305 may be the number of users in the neighborhood that have claimed their geospatial location in the neighborhood. The households 3306 may be the number of households and/or businesses (e.g., claimed geospatial locations) that have indicated participation via the private automobile listing indicator 3310.

In one embodiment, the percent of households 3308 may be the percentage of total houses and/or businesses in the neighborhood that have indicated participation via the private automobile listing indicator 3310. The private automobile listing indicator 3310 may allow the verified renter to declare whether or not their private vehicle 104 is available for rent. According to one embodiment, the verified renter may indicate the time, date, type of vehicle, listing criteria 604 etc. on the representation of their claimed geospatial location on the private vehicle listing map.

In one embodiment, members 3312 may be indicated on the map by the aesthetic disposition of the representation of their claimed geospatial location (e.g., by the color, shading etc.). Invited neighbors 3314 may be neighbors that have not claimed their geospatial location in the neighborhood but have been invited to join the vehicle renting network 142 by at least on of another neighbor. The invited neighbor 3314 may be indicated on the private vehicle listing map 601 by the aesthetic disposition of the representation of their claimed geospatial location (e.g., by the color, shading etc.). The neighbors who have not yet joined 3316 may be neighbors who have not joined the geospatially constrained social network and have not yet been invited by at least on of another neighbor, according to one embodiment. The neighbors who have not yet joined 3316 may be indicated on the private vehicle listing map 601 by the aesthetic disposition of the representation of their claimed geospatial location (e.g., by the color, shading etc.).

The private vehicles for rent 3318 may indicate that the user associated with the claimed geospatial location has indicated that their private vehicle(s) are available to rent via the private automobile listing indicator 3310. In one embodiment, the automobile sharing alert pushpin 609 may mark the claimed geospatial location to show that the user associated with the claimed geospatial location has indicated their participation via the private automobile listing indicator 3310. Users may update the private vehicle listing map 601 to include at least one of an availability, a rating, a review, and/or another update of various items listed in the private vehicle listing map.

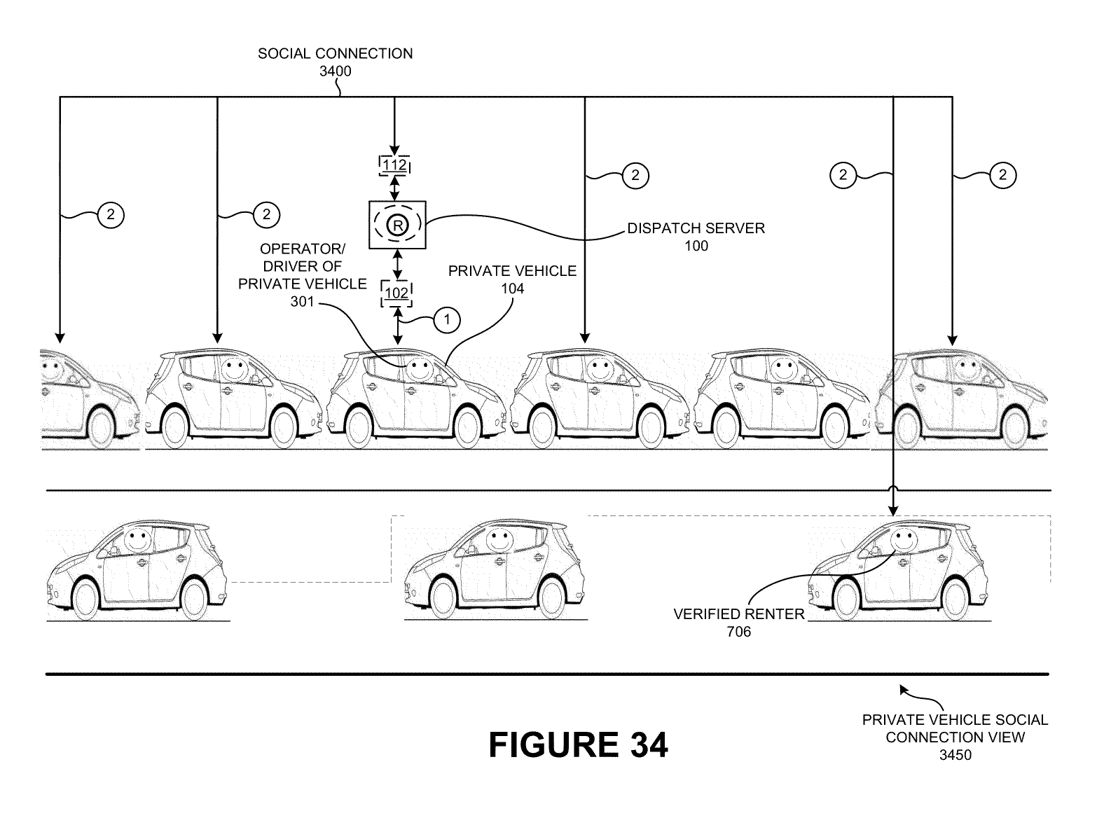

FIG. 34 is a private vehicle social connection view 3450 of a social connection between passengers of the private vehicles in a traffic jam, according to one embodiment. Particularly, FIG. 34 shows a social connection 3400 formed between an operator 301 of the private vehicles and other passengers on the road. Passengers (e.g., renters, owners of the private vehicle) may be able to form social connections with other passengers within a threshold radial distance from the private vehicle in which they are riding based on a set criteria (e.g., criteria set by the user on their profile (e.g., verified renter profile 2202)). This may enable the passengers to communicate, share traffic information, form connections, and/or chat. In one embodiment, users of the geospatially constrained social network may be able to view the location of a private vehicle owned and/or rented by a friend and/or another user with whom the user has formed a social connection (e.g., as depicted in FIG. 34 and/or recommended as illustrated in FIG. 35).

FIG. 35 is a verified renter profile view 3550 of updates sent to the profile of the operator of the private vehicle, according to one embodiment. FIG. 35 shows a common interest 3500, a time in transit 3502, a payment earned status 3504, a social connection view 3506, and an available state(s) of the private vehicle 3508. In the embodiment illustrated in FIG. 35, the verified renter 706 (e.g., the operator 301 of the vehicle) may receive and/or view updates regarding the state of their private vehicle and/or the current and/or past rentals.

Particularly, the operator 301 of the vehicle may be able to view a time in transit 3502, a payment earned status 3504, a time to arrival, a time to destination, an energy status (e.g., amount of gas remaining, amount of electricity remaining, amount of energy remaining, miles remaining in an energy reserve), a number of passengers, the vehicle location 610 (e.g., on a geospatial map), and/or rental details (as shown in FIG. 6B). The user (e.g., the operator of the private vehicle) may be able to view and/or edit their claimed geospatial locations 700 and/or the available state(s) of the private vehicle 3508 and/or view, rate, and/or review the profiles of past renters. The user may also be able to alter the date and/or time of rental availability, the listing criteria 604 and/or the description (e.g., the description in the description entry field 606).

The user (e.g., the operator 301 of the vehicle, the renter, the verified renter 706) may be able to enter interests on their verified renter profile 2202 and/or receive recommendation of connections based on other users of the geo-spatial social community (e.g., the vehicle renting network 142) who share and/or other private vehicles whose owners share a common interest with the user in the threshold radial distance from the available state. In one embodiment, the user may be able to enter and/or alter account information (e.g., a credit card number), view and/or edit an approved list of renters/owners of the private vehicles from whom the user is willing to rent. The user may also be able to view the location (e.g., distance away, geospatial coordinates, on a geospatial map) of other users with whom the user has formed a connection (e.g., friends, users who were recommended based on shared interests, other users the user has formed a social connection with) that are within the threshold radial distance from the available state of the private vehicle, the current location of the private vehicle, the current location of the user (e.g., the verified renter 706), and/or the claimed geospatial locations 700.

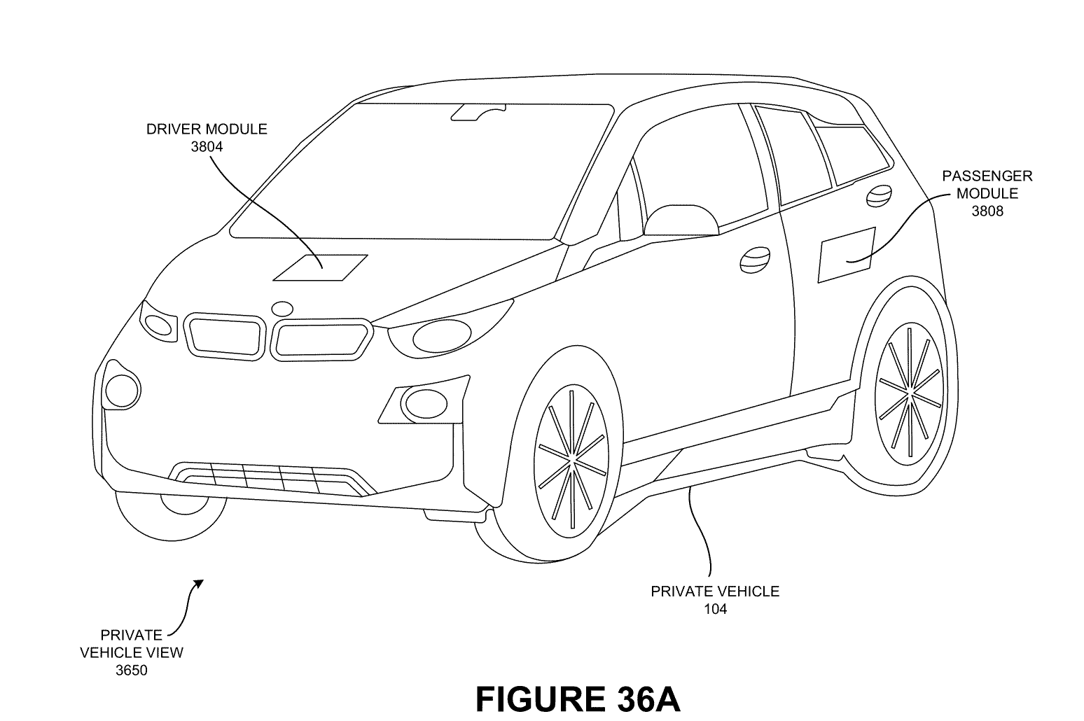

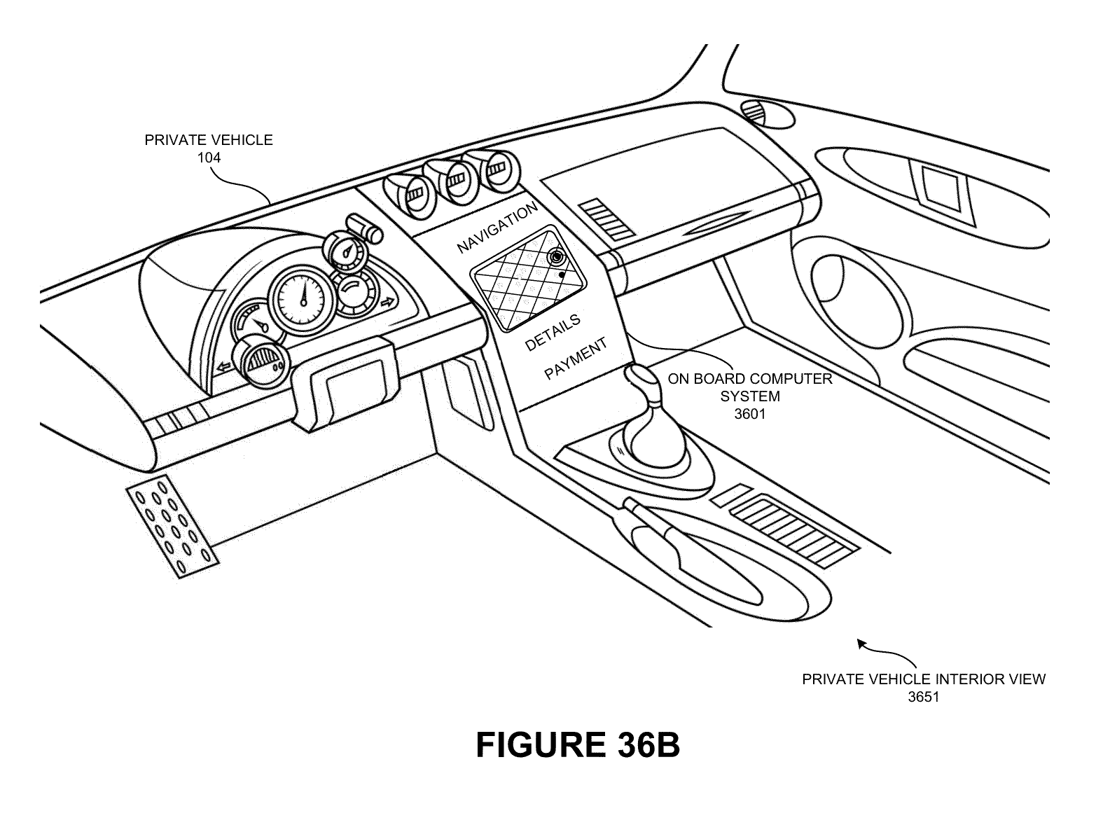

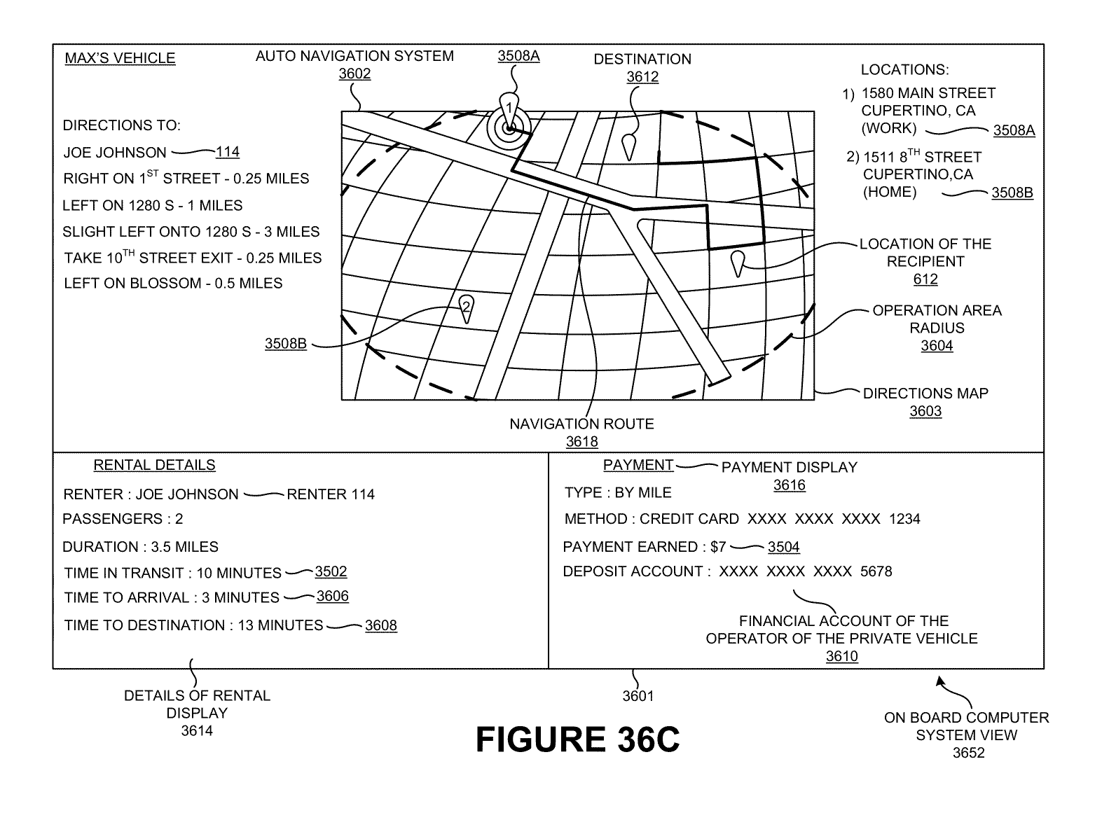

FIG. 36A is a private vehicle view 3650 of a private vehicle, according to one embodiment. The private vehicle view 3650 shows the private vehicle 3600. FIG. 36B is a private vehicle interior view 3651 of the private vehicle 3600 (shown in FIG. 36A) showing an on board computer system 3601, according to one embodiment. Particularly, the on board computer system 3601 displays an auto navigation system 3602 (shown in FIG. 36C), a details of rental display and a payment display. In one embodiment, the interior seating of the private vehicle 3600 may be easily rearranged to allow passengers to customize the seating orientations to their liking (e.g., to swivel the front seats so they are facing the rear seats, to relocate the seats so all are at a ninety degree angle from the front of the vehicle and facing inward toward each other, etc.).

FIG. 36C is an on board computer system view of the on board computer system of FIG. 36B showing an auto navigation system, rental details and payment information, according to one embodiment. Particularly, the on board computer system view 3652 shows the on board computing system 3601, an auto navigation system 3602, a directions map 3603, an operation area radius 3604, a time to arrival 3606, a time to destination 3608, a financial account of the operator of the private vehicle 3610, a destination 3612, a details of rental display 3614, a payment display 3616 and a navigation route 3618.

The auto navigation system 3602 may automatically set a navigation route 3618 from the private vehicle's location (e.g., the available state(s) of the private vehicle 3508) to the location of the renter (e.g., the location of the renter 612) and/or any other location within the operation area radius 3604 specified by the renter (e.g., the destination 3612). The auto navigation system 3602 may provide written directions, visual directions (e.g., on the directions map 3603), and/or auditory directions. In one embodiment, the renter (e.g., passenger) may be able to give voice commands and/or written commands (e.g., typed into the auto navigation system 3602) to the private vehicle 3600. The directions map 3603 may show the current location of the private vehicle 3600, the available state(s) of the private vehicle 3508 (shown in FIG. 36C as 3508A and 3508B), the location of the renter 612, the destination 3612 and/or the operation area radius 3604, according to one embodiment.

The on board computer system 3601 may store and/or show the rental details in the details of rental display 3614. The detail of rental display 3614 may contain the identity of the renter (e.g., their name, profile etc.), the number of passengers, the nature of the rental (e.g., a ride, a pick up and drop off of items etc.), the duration of the trip (e.g., the total miles and/or time to complete the rental from the starting location of the private vehicle until it is back at the starting location), the time in transit 3502, the time to arrival 3606 (e.g., at the location of the renter 612) and/or the time to destination 3608. The renter (e.g., passenger) may be able to alter the details of their rental while in the private vehicle through written (e.g., typed into the on board computer system 3601) and/or through verbal commands.

The payment display 3616 may store and/or show the payment details of the rental. The payment details may include a type of payment (e.g., by mile, by minute, by hour, by passenger, by gallon of gas, by amount and/or percent of the vehicle's energy used, by destination), a method of payment (e.g., a credit card associated with the renter's account and/or profile of the dispatch server 100), the payment earned status 3504 and/or the financial account of the operator of the private vehicle. The renter may be able to alter any number of these details while in the private vehicle through written and/or voice commands. In one embodiment, the operator 301 of the vehicle may be updated with all of the information shown in FIG. 36C through a computing device (e.g., their mobile device (e.g., the mobile device 303), a stationary device, a tablet, a computer, a personal organizer) associated with the operator 301 of the vehicle (e.g., the driver and/or operator of the private vehicle 104).

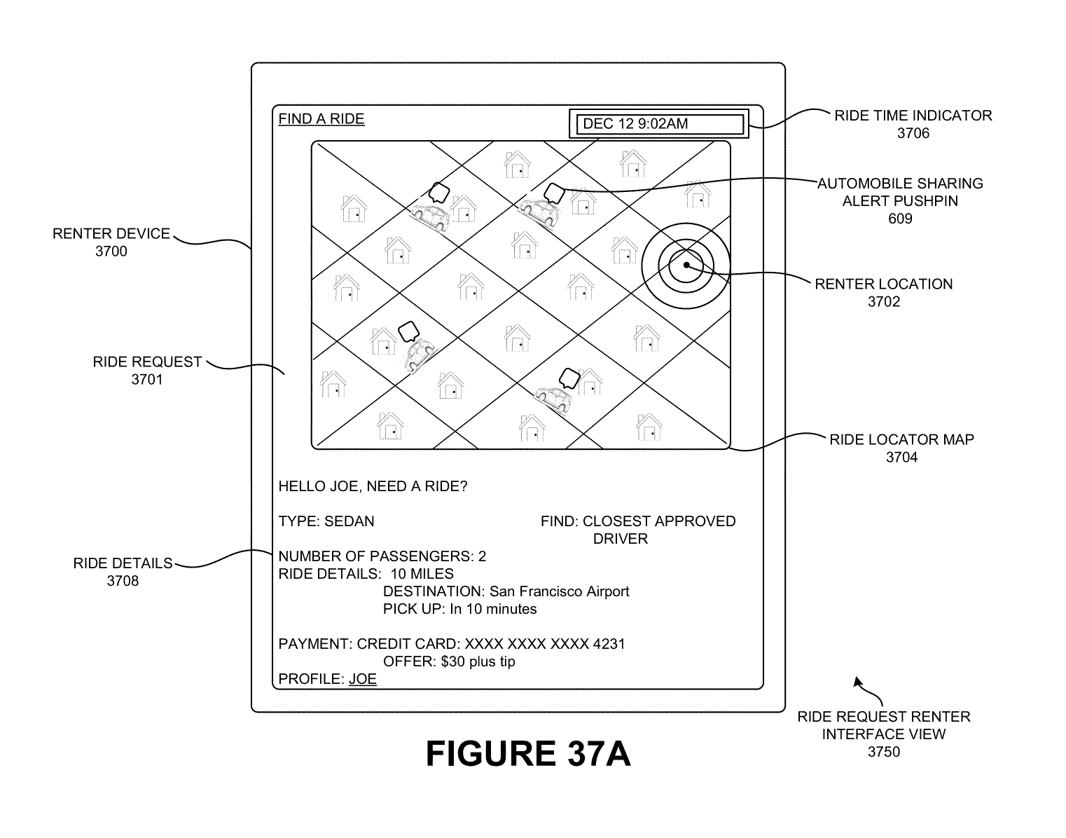

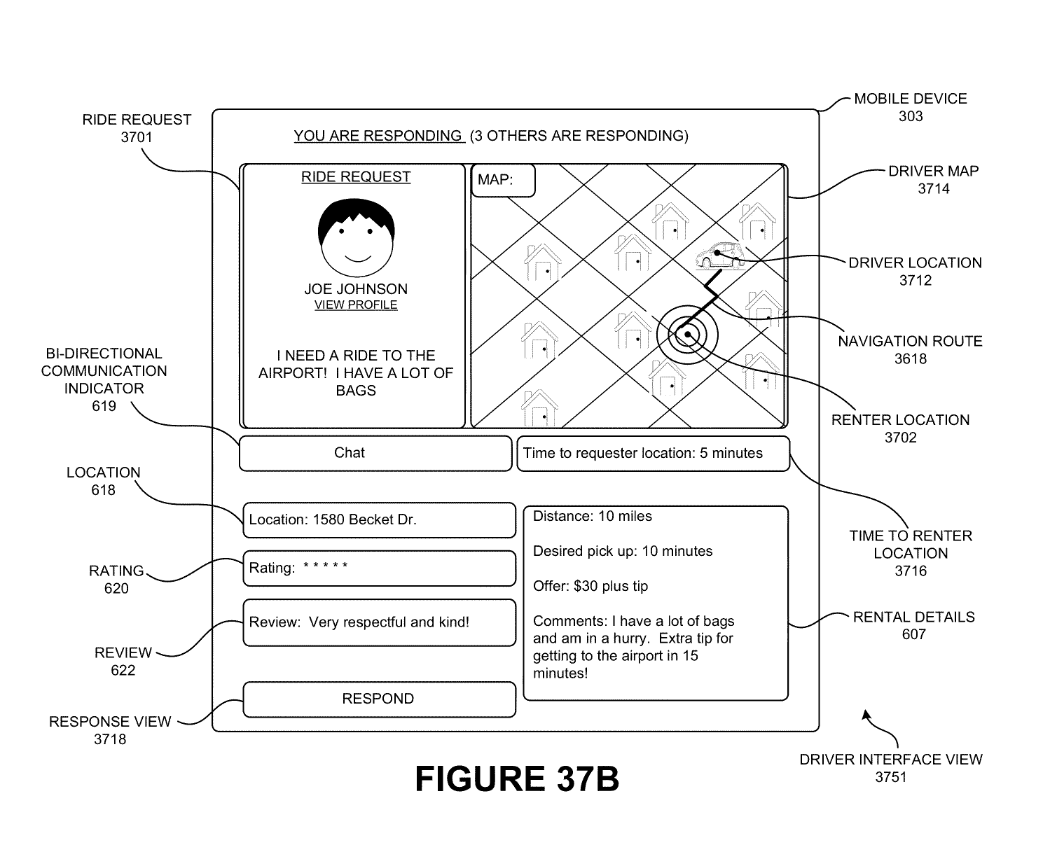

FIG. 37A shows an example embodiment without the presence of private vehicles 104. Even without private vehicles 104, the vehicle renting network 142 may be a crowdsourced community that may allow users to share their vehicle(s) through the network, according to one embodiment. This private community may be a new form of safe, secure, and legal hitchhiking that may allow users of the vehicle renting network 142 to register via the dispatch server 100 and/or offer rides to other users and/or request rides from other users of the vehicle renting network 142. This may enable users (e.g., verified renters 706) to act as private lift service providers using their own vehicles to provide rides to other users (e.g., verified renters 706) within a certain threshold radial distance from their claimed geospatial locations 700 and/or current location.

A user may be able to ‘ping’ any number of registered drivers within a certain threshold distance away (e.g., all registered drivers, only those drivers the user has preapproved) and/or offer a payment for a ride (e.g., by mile, hour, destination) through an application (e.g., a Fatdoor application) on a mobile device associated with the user (shown in FIG. 37A). The drivers may then receive the request from the user through their mobile device (e.g., the mobile device 303) and/or respond (e.g., with an accept, a reject and/or a referral to another user (e.g., registered driver)). The driver may be able to communicate with the user requesting the ride through their mobile device (e.g., through the application on the mobile device). Upon an acceptance of a request, the mobile device of the driver may automatically set a navigation route (shown in FIG. 37B) from the current location of the driver to the location of the user requesting the ride.

The application may be able to keep track of how far and/or long the user has driven and conduct payment through the application. In one embodiment, users may need to be registered (e.g., verified renters 706) to give and/or request a ride through the dispatch server 100. In another embodiment, the user requesting a ride may offer a maximum and/or minimum payment amount (e.g., by mile, hour, destination, amount of gas and/or energy used) allowing drivers that received the ‘ping’ (e.g., ride request) to bid over providing the ride to the user. In one embodiment, multiple users may be able to bid over a specific driver. The driver may be able to set a minimum and/or maximum offer (e.g., per ride, mile, hour, energy used, destination)

In one embodiment, the user may be able to set a list of any and all drivers they wish to receive their request for a ride. Similarly, drivers (e.g., verified renters 706) may be able to set a criteria for the types of requests about which they receive a ride request 3701 (e.g., ping). The criteria may include a set of approved other users, a set of other users from whom the user does not wish to receive ride requests 3701, a minimum payment offer (e.g., by hour, by mile, in total), and/or a minimum trip length (e.g., mile, time). Users may be able to rate and/or review one another through the dispatch server 100 (e.g., using a rating 620 and/or a review 622 shown in FIG. 37B).

In the 19th Century, trains may have been the dominant way of traveling long distances and wagons and horses may have been good for short trips. In the 20th Century, automobiles and trucks may have become the most dominant mode of transportation. So, when the Depression hit, people with little money may have been forced to find new ways of getting around. “Hitching a ride” in a car or truck may have gained in popularity around this time. Riding the rails may have been an established practice, but it may have been dangerous and illegal. Hitchhiking may have been legal and slightly safer, even if it was more uncertain. In later years, hitching may have developed into an entire subculture. Actually, hitchhiking may have been known from the earliest days of the automobile. The various technologies described herein may make hitchhiking safer, more trusted, and legal.

Hitchhiking (also known as thumbing or hitching) may be a means of transportation that is gained by asking people (e.g., strangers) for a ride in their automobile or other road vehicle (e.g., a ride request 3701 shown in FIG. 37B). The latter may require many rides from different people. A ride may be, but may not always be, free. If the hitchhiker (e.g., the requester of FIG. 37A) wishes to indicate that they need a ride, they may simply make a physical gesture or display a written sign. Hitchhiking may be part of the American psyche and many people may continue to stick out their thumbs. Hitchhiking may be one of the cheapest ways of traveling. By tradition, hitchhiking may be defined as soliciting a ride by standing at the edge of a road, facing traffic, with one's thumb extended/upwards. A hitchhiker may be able to meet a lot of people and make lots of friends. They may also become very frustrated and/or encounter danger on the way. However, people who do pick up hitchhikers tend to be very friendly. Still, hitchhikers also risk being picked up by someone who is an unsafe driver or even personally dangerous as there may be no effective way to vet potential drivers and/or hold the driver accountable for their actions. The various embodiments described herein overcome some of the challenges of the past faced with hitchhiking by creating a trusted community and sharing platform of private cars.

Contrary to many preconceived notions, hitchhiking can be a safe, positive experience, allowing travelers to connect with locals and form unexpected friendships through the various embodiments described in FIGS. 1-46.

FIG. 37A is a ride request user interface view of a ride request being broadcast, according to one embodiment. Particularly, the ride request user interface view 3750 shows the ride request, a renter device 3700, a renter location 3702, a ride locator map 3704, a ride time indicator 3706 and a ride details 3708. A user (e.g., requester) of the dispatch server 100 of the vehicle renting network 142 may broadcast a request for a ride through an application (e.g., Fatdoor application) on the renter device 3700. The renter (e.g., verified renter 706) may view the locations of registered users (e.g., drivers) within a threshold radial distance 119 of the renter's current location and/or claimed geospatial location(s) 700 on the ride locator map 3704. The user may be able to see their location (e.g., renter location 3702) and/or the proximity of their location in relation to the drivers (e.g., registered drivers).

The renter may be able to view automobile sharing alert pushpins 609 above the locations of the drivers (e.g., driver location 3712). The user may be able to select the automobile sharing alert pushpins 609 and view a short profile of the driver, a full profile of the driver, a rating of the driver (e.g., an overall rating, a collection of ratings, a past rating by the requester), a review of the driver (e.g., an overall review, a collection of reviews, a past review by the requester), an estimated time of pick up, rules of the driver (e.g., car rules), etc. The requester may be able to communicate with a driver by selecting the automobile sharing alert pushpin 609 or by other means. The ride time indicator may show a ride time (e.g., an estimated time of arrival at the destination from pick up and/or an estimated time of arrival at the destination from that very moment).

The requester (e.g., the verified renter 706) may be able to enter details of their ride request in the ride details 3708. The requester may be able to enter a type of vehicle desired, a category of drivers (e.g., verified renters 706, vehicles, user profiles) to show as options (e.g., in a list, on the ride locator map 3704). For example, the requester may wish to only view ride options within a certain distance from their location, drivers that the requester has ridden with before, drivers on a favorites list of the requester, specific drivers, drivers with certain ratings, drivers with certain rules for the car etc. The requester may be able to enter a number of passengers, a destination, a desired pick up and/or arrival time, a duration of the ride (e.g., the number of miles and/or time), a payment method (e.g., a credit card associated with the account of the requester), and/or an offer for the ride.

FIG. 37B is a driver interface view of the ride request of FIG. 37A being received by a driver, according to one embodiment. The driver interface view 3751 of FIG. 37B shows the ride request 3701, a driver location 3712, a driver map 3714, a time to renter location 3716, and a response view 3718. The driver (e.g., verified renter 706) may receive the ride request 3701 from the requester through the application on the mobile device 303 associated with the driver. The driver may be able to view their location (e.g., the driver location 3712), the navigation route 3618 (e.g., the navigation route from the driver location 3712 to the renter location 3702) and/or the renter location 3702 on the driver map 3714. In one embodiment, the navigation route 3618 may be set automatically on the mobile device 303 once the driver accepts the ride request 3701.

The driver may also be able to view the time to renter location 3716. This may enable the driver to assess if they will be able to pick the requester up by the desired pick up time specified by the requester. In one embodiment, only certain drivers (e.g., drivers within a certain distance from the requester and/or drivers the dispatch server 100 assesses to be able to pick the requester up by the specified pick up time) will receive the ride request 3701. The driver may be able to view the ride details 3708 which may include the distance and/or duration of the ride, the desired pick up time, the offer, the destination, the desired arrival time, and/or additional comments from the requester.

According to one embodiment, the driver may be able to bi-directionally communicate with the requester and/or any other user (e.g., users within a threshold radial distance 119 from the driver location 3712) through the bi-directional communication indicator 619. The location 618 may allow the driver to view the address of the renter location 3702. The rating 620 may be a combined rating of the requester and/or a set of any number of reviews of the requester made by other users including the driver, according to one embodiment. The driver may be able to view reviews 622 of the requester (e.g., all previous reviews and/or previous reviews submitted by the driver). The response view 3718 may allow the driver to respond to the ride request with at least one of an accept, a deny and/or a referral to another user (e.g., another driver). In one embodiment, the driver may be able to participate in bidding for the ride request with other drivers in a threshold distance from the renter location 3702.

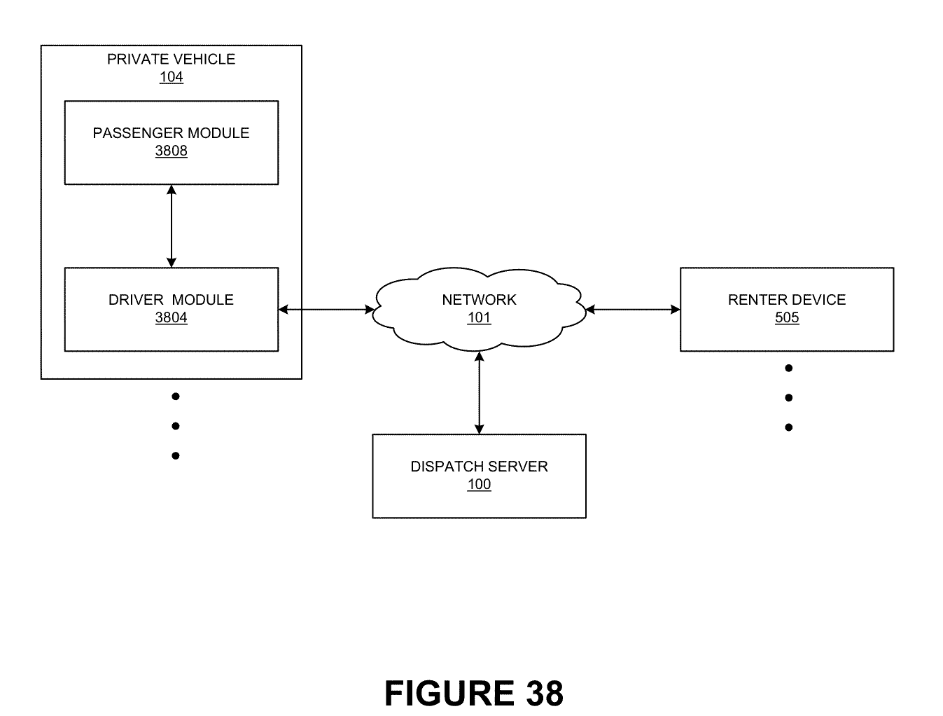

FIG. 38 is a block diagram of a dispatch server 100 that communicates with a renter device 505 (e.g., a mobile phone of a driver of a private car) and/or a private vehicle 104 (e.g., indirectly through the mobile phone of the driver of the private car and/or directly to a navigation system of the private car) through a network 101 (e.g., Internet), according to one embodiment. The private vehicle 104 may include a driver module 3804 (e.g., the driver module may be operable on a mobile device of an operator/driver of the private car 104) and/or a passenger module 3808 (e.g., the passenger module may operate on a mobile device of a rider of the private car).

In one embodiment, the private vehicle 104 may be a single and/or multiple-passenger transit vehicle (e.g., any automobile including a car, a taxi, a bus, a van, a shuttle, a plane, a boat, a cycle, etc.). The private vehicle 104 may be a private automobile driven by a person who wishes to make extra income by driving their car in a neighborhood, city, and/or metro region. The driver may be prequalified and/or may need to undergo a series of tests prior to being qualified to drive the private vehicle 104. The dispatch server 100 may communicate, coordinate, monitor and/or process information associated with the renter device 505, a driver module 3804, and/or the passenger module 3808. The renter device 505 may process and/or communicate relevant information to a user of the dispatch server 100.

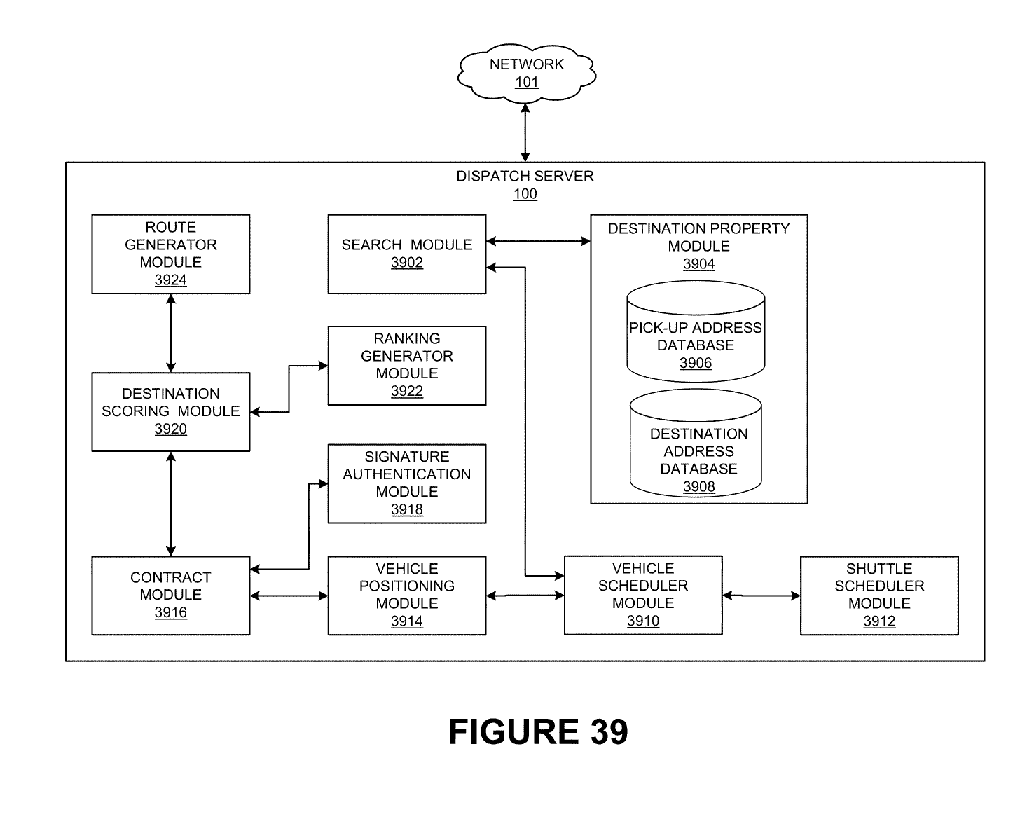

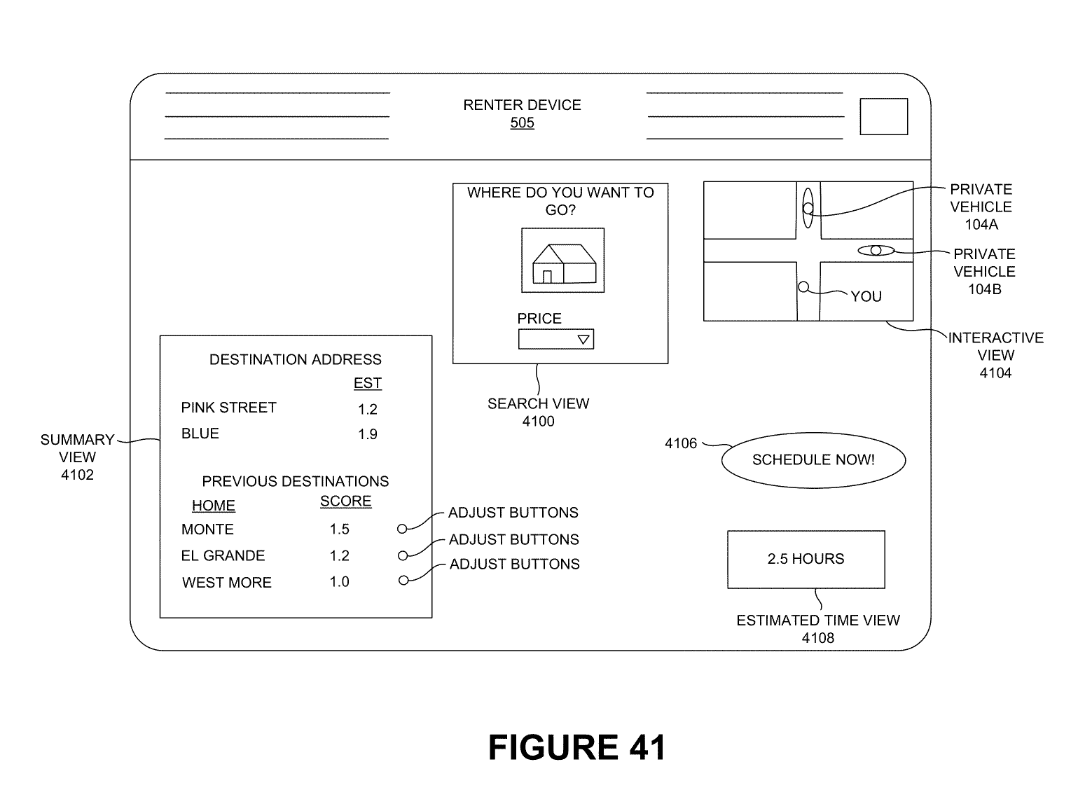

FIG. 39 is an exploded view of the dispatch server of FIG. 38, having a search module 3902, a destination property module 3904 that may include an pick-up address database 3906 and a destination address database 3908, a vehicle scheduler module 3910, a shuttle scheduler module 3912, a vehicle positioning module 3914, a contract module 3916, a signature authentication module 3918, a destination scoring module 3920, a ranking generator module 3922 and/or a route generator module 3924, according to one embodiment. The search module 3902 may communicate with the destination property module 3904, the vehicle scheduler module 3910, and/or use information associated with a location of a prospective renter 114 of the private vehicle 104 (e.g., from a request communicated using a search view 4100 of the renter device 505 of FIG. 41), a shared attribute of prospective renters (e.g., a geographic preference, a time-frame to transact preference, a cultural trait, a commute-time preference, a number of passengers, and/or an educational quality preference communicated by prospective renters using the search view 4100 of the renter device 505 of FIG. 41) position of each of the vehicles, such as the private vehicle 104 of FIG. 38 (e.g., using the vehicle positioning module 3914 of FIG. 39), a budget range for the prospective renter (e.g., from a request communicated using a search view 4100 of the renter device 505 of FIG. 41), and/or a location of destination address (e.g., based on data communicated by the pick-up address database 3906 of the destination property module 3904) to determine which of the private vehicle 104 in operation are optimal to a request by a prospective renter.

The destination property module 3904 may include an pick-up address database 3906 and/or a destination address database 3908. The destination property module 3904 may store, monitor, process and/or communicate (e.g., with the search module 3902) information and/or meta data associated with destination address property.

The vehicle scheduler module 3910 may include a shuttle scheduler module 3912 (e.g., when private vehicle 104 are multiple-passenger transit vehicles) and/or use information associated with the position of a private vehicle 104 (e.g., from the vehicle positioning module 3914), a request (e.g., a request from a prospective renter communicated using a schedule view 4106 of the renter device 505 of FIG. 41), a shared attribute of prospective renters (e.g., a geographic preference, a time-frame to transact preference, a cultural trait, a commute-time preference, a number of dependents, and/or an educational quality preference communicated by prospective renters using the search view 4100 of the renter device 505 of FIG. 41) and/or the location of a property (e.g., based on data communicated by the pick-up address database 3906 of the destination property module 3904) to publish a route and/or private vehicle 104 schedule, a name of an operator of a private vehicle 104 and/or an agenda (e.g., an agenda having a timing, a location, and/or a destination information, etc.) to prospective renters.

The vehicle positioning module 3914 may communicate information (e.g., GPS positioning data) with a driver module 3804 of FIG. 38, a contract module 3916, a vehicle scheduler module 3910 and a search module 3902 to store, monitor, process, and/or coordinate information and/or meta data associated with the location, schedule, relative bearings and/or status of a private vehicle 104. The contract module 3916 may communicate with the search module 3902, the renter device 3806 of FIG. 38, and/or the passenger module 3808 of FIG. 41 to process a request (e.g., a request by a prospective renter communicated using the renter device 505 of FIG. 38 and/or the passenger module 3808 of FIG. 41) to purchase the ticket in the private vehicle 104 and/or create a calendar of required actions before the renter arrives in the private vehicle

In one embodiment, a signature authorization module 3918 may communicate with the contract module 3916 to authenticate an electronic signature of the prospective renter prior to communicating the offer data to the driver of the private vehicle 104). The destination scoring module 3920 may communicate (e.g., with the search module 3902, the destination property module 3904, the driver module 3804, and/or a renter device 505 of FIG. 38) information and/or feedback by prospective renters and/or buyers (e.g., attribute rankings, physical condition, and/or asking price of available properties). In one embodiment, a ranking generator module 3922 may communicate with the search module 3902, the destination property module 3904, the destination scoring module 3920, and/or the renter device 505 of FIG. 38 to generate ride scorecards from attribute rankings (e.g., condition of property, location, age of property, etc.) based on ideal attribute definitions provided by prospective renters (e.g., using a renter device 505 of FIG. 38 and/or a passenger module 3808 of FIG. 38). The route generator module 3924 may use information associated with the location and/or available time frames of a private vehicle 104 of FIG. 38 (e.g., using information communicated using the vehicle positioning module 3914 and/or the vehicle scheduler module 3910), the location of a prospective renter (e.g., from a request by a prospective renter communicated using a renter device 505 of FIG. 38), the location of a property indicated in the request (e.g., from data communicated with the destination property module 3904) and/or a shared attribute of interested parties (e.g., other prospective renters and/or parties interested in engaging in a real-estate transaction) to generate a route to a location (e.g., a route communicated with a driver module 3804 of a private vehicle 104 of FIG. 41).

The route generator module 3924 may route the private vehicle 104 to the location at a specific date and/or specific time based on an optimization (e.g., an optimization may include aligning availability data of interested parties with available time frames of the private vehicle 104). In one embodiment, the route generator module 3924 may directly and/or indirectly communicate with a renter device 505 of FIG. 38 and/or a driver module 3804 of FIG. 38 to adjust the route base on a command processed through a passenger module 3808 of FIG. 38 that provides an update and/or information associated with properties in consideration by a prospective renter.

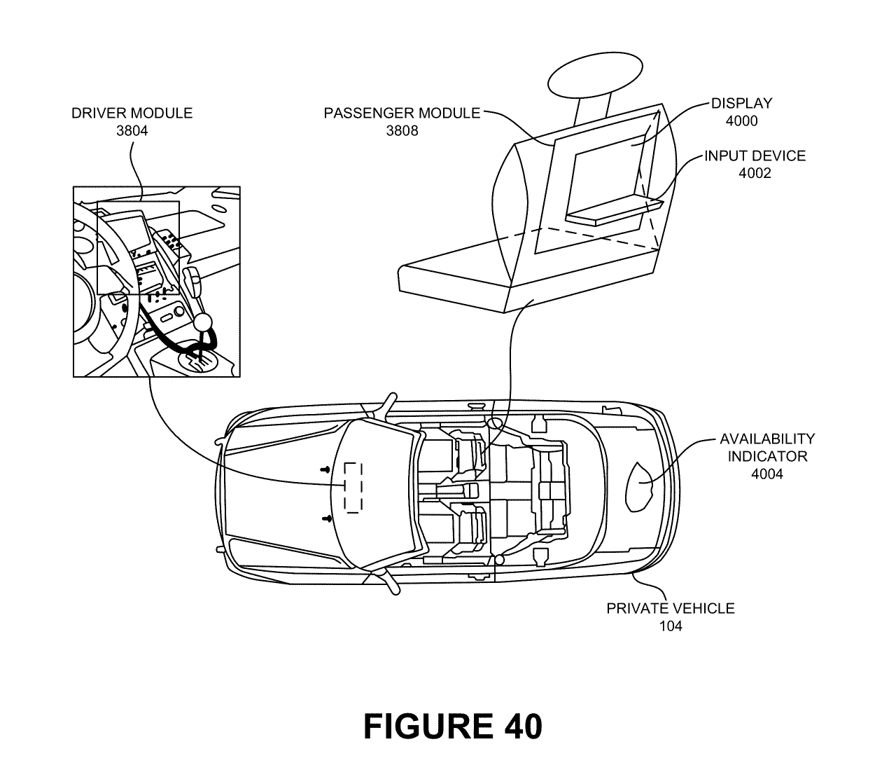

FIG. 40 is a system view of the private vehicle 104 of FIG. 38, having a driver module 3804, a passenger module 3808, a display 4000, an input device 4002, and/or an availability indicator 4004, according to one embodiment. The private vehicle 104 may include passenger transit vehicles (e.g., buses, taxis, vans, shuttles etc.). The driver module 3804 may communicate with the dispatch server 3900 of FIG. 39 (e.g., the vehicle scheduler module 3910, the vehicle positioning module 3914, the search module 3902 and/or the route generator module 3924 of the dispatch server 3900 of FIG. 39), the passenger module 3808 and/or the renter device 505 of FIG. 38 to process information (e.g., feedback and/or updates from a prospective renter, meta data associated with the availability, schedule and/or location of the private vehicle 104, and/or schedule information based on requests and/or shared attributes of other prospective renters).

The passenger module 3808 may include a display 4000 (e.g., to display visualizations) of information and/or meta data associated with and/or relevant to a prospective renter (e.g., in the form of a user interface of the renter device 505 of FIG. 38) and/or an input device 4002 (e.g., a keyboard, a keypad, an electronic touch-screen and/or input accessories). The availability indicator 4004 may communicate with the driver module 3804, the passenger module 3808 (e.g., the passenger module may engage with the renter when the renter is physically in the rented car through the renter's mobile phone), and/or the dispatch server 100 of FIG. 38 to process information, and/or display a dynamic and/or static indicator (e.g., a light, a graphic sign, a computerized screen, a visual display and/or a flag) to indicate the availability of the private vehicle 104 and/or retention status of the private vehicle 104 by a prospective renter.

FIG. 41 is a user interface view of the renter device 505 of FIG. 38, according to one embodiment. The user interface view may include a search view 4100, a summary view 4102, an interactive view 4104, a schedule view 4106, and/or an estimated time view 4108. The search view 4100 may use a selection of parameters, presets and/or manual requests by the prospective renter to display information relevant to a request for information associated with a destination of interest to the prospective renter (e.g., price, location, etc.). The summary view 4102 may use information communicated with the renter device 505, the destination property module 3904 of FIG. 39, the destination scoring module 3902 of FIG. 39 and/or the ranking generator module 3922 of FIG. 39 to display a history of properties relevant and/or of interest to the prospective renter, and/or a history of ride scorecards (e.g., ride scorecards based on feedback by other prospective renters) associated with the properties relevant and/or of interest to the prospective renter.

For example, a hypothetical summary view 4102 is illustrated in FIG. 41. The view ‘Destination Addresses’ displays ‘Pink Street’ and ‘Blue,’ while the field ‘EST Score’ displays ‘1.2’ and ‘1.9,’ which may indicate that the renter has identified the destinations ‘Pink Street’ and ‘Blue’ as being destinations, and that property ‘Pink Street’ has a destination ranking ‘1.2,’ while property ‘Blue’ has a destination ranking ‘1.9,’ based on feedback by other prospective renters and/or based on a predefined rating of various attributes assigned by the renter and/or operator. The previous destinations window displays ‘Monte,’ ‘El Grande’ and ‘Westmore,’ while the field ‘Score’ displays ‘1.5,’ ‘1.2’ and ‘1.0,’ indicating that the prospective renter has already gone to destinations ‘Monte,’ ‘El Grande’ and ‘Westmore,’ and that destination ‘Monte’ has a destination ranking ‘1.5,’ property ‘El Grande’ has a destination ranking ‘1.2,’ and property ‘Blue’ has a destination ranking ‘1.9,’ based on feedback by other renters.

The interactive view 4104 may communicate with the driver module 3804 of FIG. 38, the renter device 505 of FIG. 38, the vehicle positioning module 3914 and/or the vehicle scheduler module 3910 to display a dynamic visualization of the routes, schedule and/or physical positions of the private vehicle 104 relative to the location of the prospective buyer (e.g., a real-time map with vehicle icons). The schedule view 4106 may use information communicated by the prospective renter through the renter device 505 of FIG. 38, the vehicle scheduler module 3910 of FIG. 39, the driver module 3804 of FIG. 41, and/or the search module 3902 of FIG. 39 to display options for the prospective renter to communicate schedule preferences. The estimated time view 4108 may communicate with the driver module 3804 of FIG. 41, the renter device 505 of FIG. 38, the vehicle positioning module 3914 and/or the vehicle scheduler module 3910 to display an estimate of the time required for the prospective renter to view a particular destination of interest.

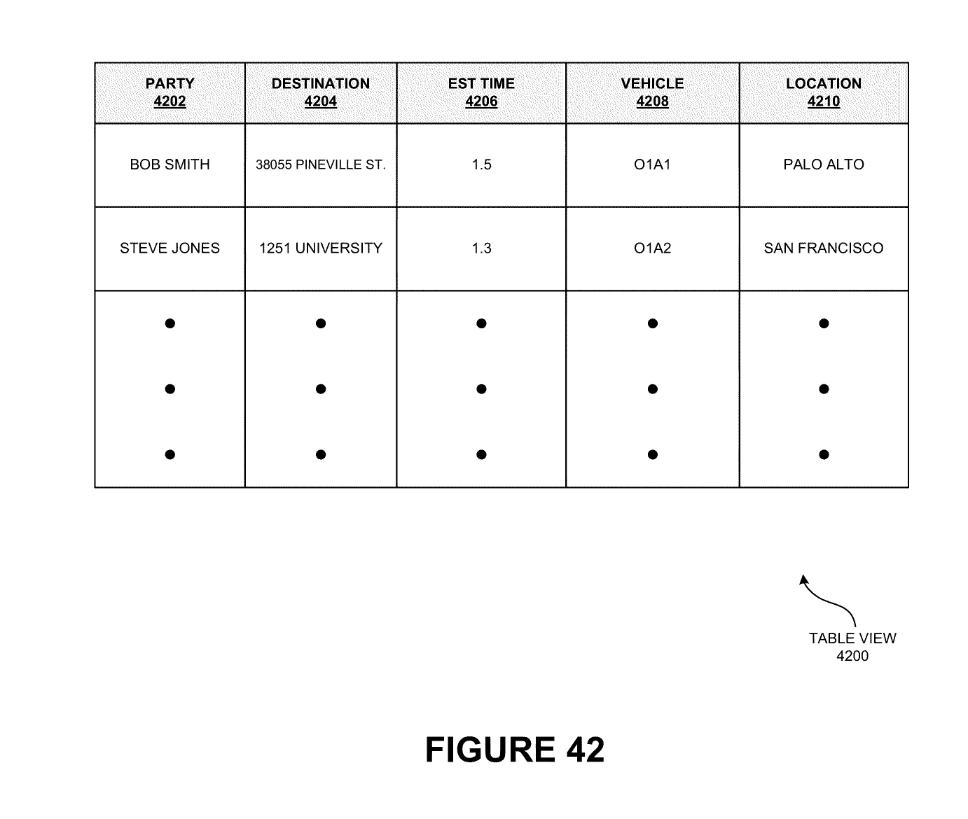

FIG. 42 is a table view 4200 of content referenced by the pick-up address database 3906 of FIG. 39, according to one embodiment. The table view 4200 may include a party field 4202, a destination field 4204, an EST time 4206, a vehicle field 4208 and/or a location field 4210. The party field 4202 may display an identifier referencing the identity and/or nature of interest of the party (e.g., ‘Bob Smith,’ and/or ‘Steve Jones,’ as illustrated in FIG. 42). The destination field 4204 may display an identifier and/or address referencing the destination of interest to the party (e.g., ‘38055 Pineville Street,’ and/or ‘1251 University,’ as illustrated in FIG. 42, indicating that ‘Bob Smith,’ is interested in arriving at the destination ‘38055 Pineville Street,’ and/or ‘Steve Jones’ is interested in arriving at a property ‘1251 University’).

The EST time 4206 may communicate with the destination scoring module 3920 and/or the ranking generator module 3922 of FIG. 39 to display an index referencing a destination score and/or ranking of the destination of interest (e.g., ‘1.5’ and/or ‘1.3,’ as illustrated in FIG. 42, indicating that destination ‘1055 Pineville Street’ has a destination ranking of 1.5,’ while destination ‘1251 University’ has a destination ranking of ‘1.3’). The vehicle field 4208 may display an index and/or identifier referencing the identity of a vehicle(s) associated with the schedule of a party to view the destination of interest (e.g., ‘2C1’ and ‘2C2,’ as illustrated in FIG. 42, indicating that vehicle ‘2C1’ has been scheduled to transport Bob Jones' to drive to destination ‘38055 Pineville Street,’ while vehicle ‘2C2’ has been scheduled to transport ‘Steve Jones’ to drive to destination 1251 University’). The location field 4210 may display an identifier referencing the location of a destination of interest (e.g., ‘Palo Alto’ and/or ‘San Francisco,’ as illustrated in FIG. 42, indicating that destination ‘1055 Pineville Street’ is located in ‘Palo Alto,’ and/or property ‘1251 University’ is located in ‘San Francisco’). There are two private vehicles 4208 shown, vehicles O1A1 and O1A2.

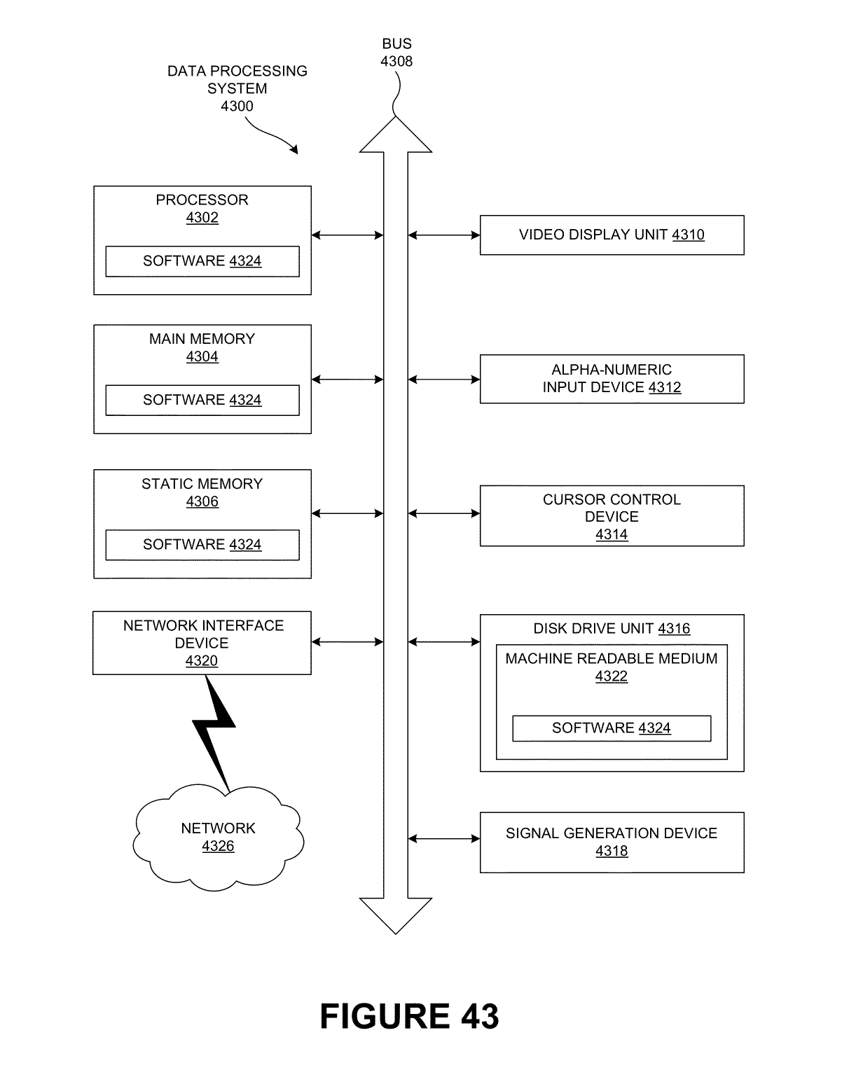

FIG. 43 is a diagrammatic representation of a machine in the form of a data processing system 4300 within which a set of instructions, for causing the machine to perform any one or more of the methodologies discussed herein, may be executed. In various embodiments, the machine operates as a standalone device and/or may be connected (e.g., networked) to other machines. In a networked deployment, the machine may operate in the capacity of a server and/or a client machine in server-client network environment, and/or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch and/or bridge, an embedded system and/or any machine capable of executing a set of instructions (sequential and/or otherwise) that specify actions to be taken by that machine. Further, while only a single machine is illustrated, the term “machine” shall also be taken to include any collection of machines that individually and/or jointly execute a set (or multiple sets) of instructions to perform any one and/or more of the methodologies discussed herein.

The example data processing system 4300 includes a processor 4302 (e.g., a central processing unit (CPU) a graphics processing unit (GPU) and/or both), a main memory 4304 and a static memory 4306, which communicate with each other via a bus 4308. The data processing system 4300 may further include a video display unit 4310 (e.g., a liquid crystal display (LCD) and/or a cathode ray tube (CRT)). The data processing system 4300 also includes an alphanumeric input device 4312 (e.g., a keyboard), a cursor control device 4314 (e.g., a mouse), a disk drive unit 4316, a signal generation device 4318 (e.g., a speaker) and a network interface device 4320. The disk drive unit 4316 includes a machine-readable medium 4322 on which is stored one or more sets of instructions (e.g., software 4324) embodying any one or more of the methodologies and/or functions described herein. The software 4324 may also reside, completely and/or at least partially, within the main memory 4304 and/or within the processor 4302 during execution thereof by the data processing system 4300, the main memory 4304 and the processor 4302 also constituting machine-readable media.

The software 4324 may further be transmitted and/or received over a network 4326 via the network interface device 4320. While the machine-readable medium 4322 is shown in an example embodiment to be a single medium, the term “machine-readable medium” should be taken to include a single medium and/or multiple media (e.g., a centralized and/or distributed database, and/or associated caches and servers) that store the one or more sets of instructions. The term “machine-readable medium” shall also be taken to include any medium that is capable of storing, encoding and/or carrying a set of instructions for execution by the machine and that cause the machine to perform any one or more of the methodologies of the various embodiments. The term “machine-readable medium” shall accordingly be taken to include, but not be limited to, solid-state memories, optical and magnetic media, and carrier wave signals.

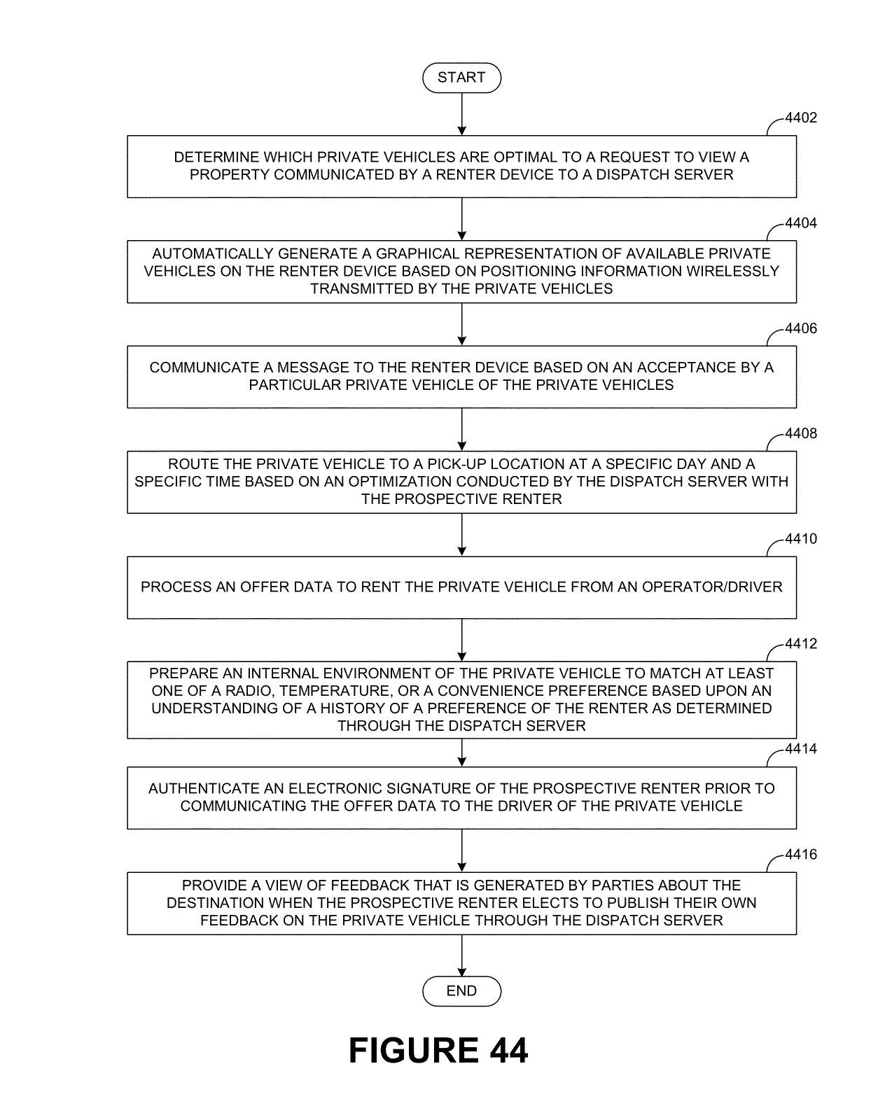

FIG. 44 is a process flow to determine which private vehicles 104 are optimal to a request to view a property communicated by a renter device 505 to the dispatch server 100, according to one embodiment. In operation 4402, it may be determined which private vehicle 104 is optimal to a request to view a property communicated by the renter device 505 to the dispatch server 100. In operation 4404, a graphical representation of available private vehicles 104 may be automatically generated on the renter device 505 (e.g., using an interactive view 4104 of FIG. 41) based on positioning information wirelessly transmitted by the private vehicles 104. In operation 4406, a message to the renter device 505 may be communicated based on an acceptance by a particular private vehicle 104 of the private vehicles. In operation 4408, the private vehicle may be routed to a pick-up location at a specific day and a specific time based on an optimization conducted by the dispatch server 100 with the prospective renter, other prospective renters, and a person at the destination property (e.g., using a vehicle scheduler module 3910 of FIG. 39). In operation 4410, an offer data to rent the private vehicle from an operator/driver (e.g., operator 301) may be processed (e.g., using a contract module 3916 of FIG. 39).

In operation 4412, an internal environment of the private vehicle 104 may be prepared to match at least one of a radio, temperature, or a convenience preference based upon an understanding of a history of a preference of the renter as determined through the dispatch server 100. In operation 4414, an electronic signature of the prospective renter may be authenticated prior to communicating the offer data to the driver of the private vehicle (e.g., using a signature authentication module 3918 of FIG. 39). In operation 4416, a view of feedback that may be generated by parties about the destination may be provided (e.g., as property rankings) when the prospective renter elects to publish their own feedback on the private vehicle 104 through the dispatch server 100.

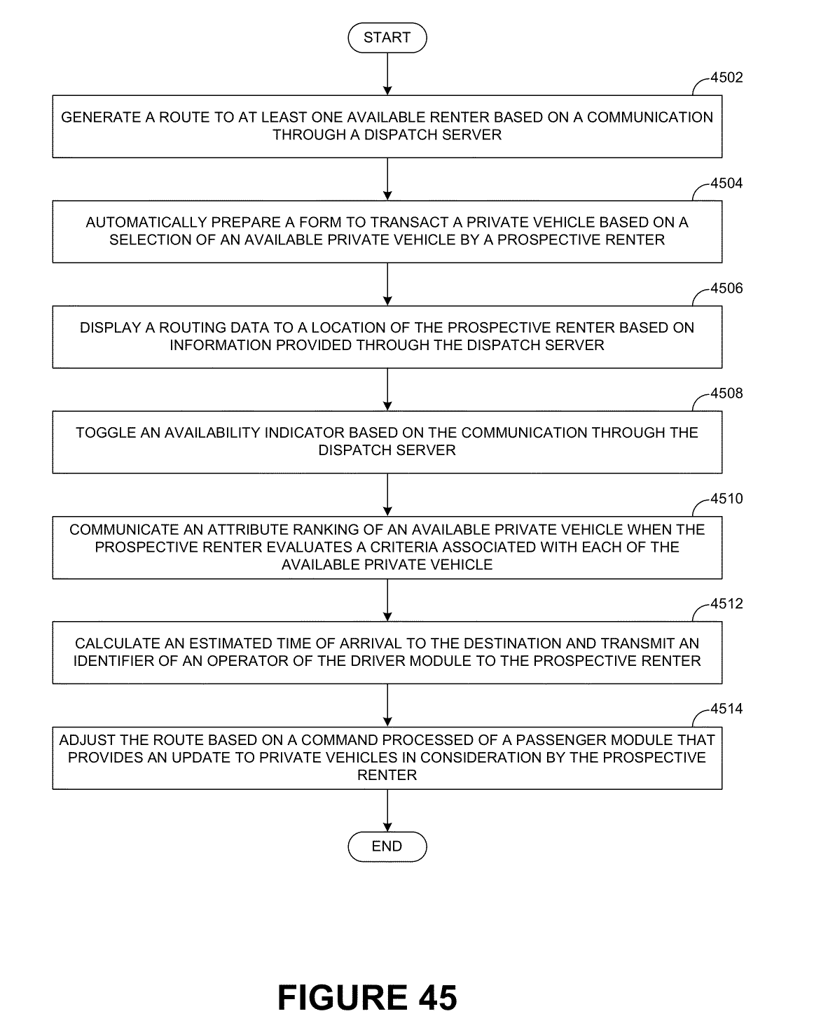

FIG. 45 is a process flow to generate a route to at least one available renter based on communication through a dispatch server 100 (e.g., using a route generator module 3924), and to automatically prepare a form to transact the private vehicle 104 based on a selection of an available private vehicle by a prospective renter (e.g., using a contract module 3916 of FIG. 39), according to one embodiment. In operation 4502, a route may be generated to at least one available renter based on communication through a dispatch server 100. In operation 4504, a form to transact the private vehicle 104 may be automatically prepared based on a selection of an available private vehicle 104 by a prospective renter. In operation 4506, a routing data to a location of the prospective renter may be displayed based on information provided through the dispatch server 100. In operation 4508, an availability indicator may be toggled based on the communication through the dispatch server 100 (e.g., using an availability indicator 4004 of FIG. 41).

In operation 4510, an attribute ranking of an available private vehicle may be communicated when the prospective renter evaluates a criteria (e.g., condition of the private vehicle, the size of the private vehicle 104, information about the driver)) associated with each of the available private vehicle. In operation 4512, an estimated time of arrival to the destination may be calculated and an identifier of an operator of the driver module 3804 may be transmitted to the prospective renter. In operation 4514, the route may be adjusted based on a command processed of a passenger module 3808 that provides an update to private vehicles in consideration by the prospective renter (e.g., using a route generator module 3924 of FIG. 39).

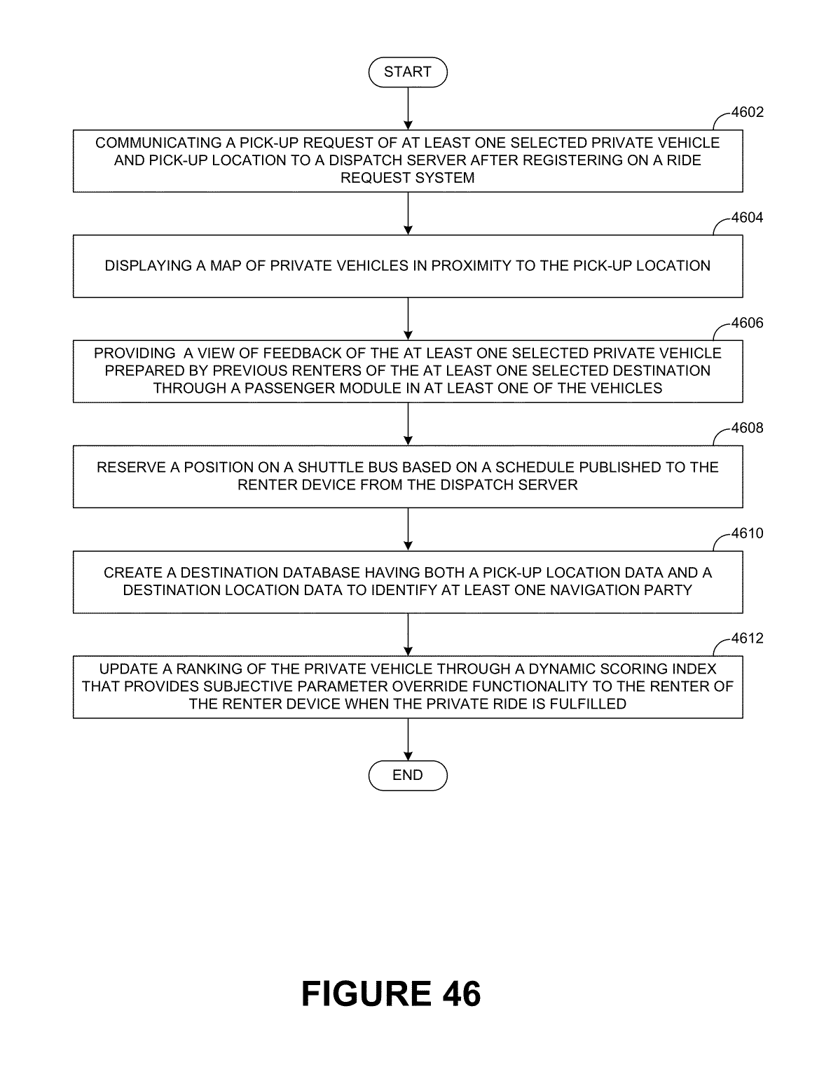

FIG. 46 is a process flow to communicate a pick-up request of at least one selected private vehicle 104 and a pick-up location to a dispatch server 100 after registering on a ride request system, to display a map of private vehicles in proximity to the pick-up location (e.g., using the interactive view 4104 of FIG. 41), and to provide a view of feedback of at least one selected private vehicle 104 prepared by previous renters of the selected destination through a passenger module in at least one of the private vehicles, according to one embodiment. In operation 4602, a pick-up request of at least one selected private vehicle and a pick-up location may be communicated to a dispatch module (e.g., the dispatch server 100) after registering on a ride request system. In operation 4604, a map of private vehicles in proximity to the pick-up location may be displayed. In operation 4606, a view may be provided of feedback (e.g., a summary of driver ranking) on the selected private vehicle prepared by previous renters of the at least one selected destination through a passenger module 3808 in at least one of the vehicles (e.g., private vehicles 104). In operation 4608, a position may be reserved on a shuttle bus based on a schedule published to the renter device 505 (e.g., using a schedule view 4106 of FIG. 41) from the dispatch server 100. In operation 4610, a destination database may be created having both a pick-up location data and/or a destination location data to identify at least one navigation party (e.g., pick-up address database 3906 of FIG. 39). In operation 4612, a ranking of the private vehicle may be updated (e.g., by a ranking generator module 3922 of FIG. 39) through a dynamic scoring index that provides subjective parameter override functionality to the renter of the renter device 505 when the private ride is fulfilled.

It should be noted that there are a number of different ‘user’ roles described in the various embodiments described herein. The user roles include a ‘user’, a ‘claimed user’, and a ‘verified renter’. The user is someone that has signed up for and/or accessed the dispatch server 100 through the vehicle renting network 142. The user can ‘claim’ an existing profile (e.g., prepopulated and/or created by another user through a wiki like creation process), and/or ‘claim’ an address with a new location, thereby transforming the user to the ‘claimed user’. The claimed user can verify that they actually live at a particular home address and/or work at a particular business address (e.g., thereby showing their affiliation with an available state) by submitting a response to a verification code on a postcard, submitting a utility bill, and/or being invited by and/or getting vouched for by an existing verified renter. This can transform the claimed user to a ‘verified renter’, in one embodiment. It will be understood by those with skill in the art that the user may refer to either a user that has not yet claimed, the claimed user, and/or the verified renter.

In various embodiments, the ride request system 150 may be a decentralized peer to peer system in which there is no central organization that controls the distribution, maintenance, adoption of standards, car rules, payment rules, adoption and/or standards for drivers, etc. In one embodiment, government regulations may not apply to the users (e.g., drivers and/or requesters) of the dispatch server 100 because each peer may choose how to operate his or her vehicle (e.g., how to conduct payment, when, how and/or where they offer rides). The dispatch server 100 may serve as a third party enabler of interactions between parties to enable these private parties to engage in private transactions without a central intermediary. Thus, parties may be able to freely interact and/or set their own standards for interactions without the control and/or dictation of a central organization.

In one embodiment, the users (e.g., drivers) of the ride request system 150 may pay a percentage of what they earn and/or a flat rate (e.g., a membership, a monthly, yearly, daily, flat rate by trip fee etc.) for using the network. In one embodiment, the users of the ride request system may be able to set their own payment standards (e.g., by bidding for rides, by setting a flat rate by destination, by paying by mile, by time, by amount of energy (e.g., gas) used). Once a payment standard is set by the driver and/or the user (e.g., requester), the deal may be locked by the dispatch server 100 and/or payment may be conducted through the application on the mobile device(s) (e.g., through a verified credit card associated with the requester's profile on the ride request system 150).

In one aspect, a method of an dispatch server 100 includes associating a unique identifier 105 associated with a private vehicle 104 with the dispatch server 100, periodically analyzing a location of the private vehicle 104 based on a geospatial data associated with a location of the private vehicle 104, and declaring an available state of the private vehicle 3508 based on a predictable behavior algorithm 211. The method permits an operator 301 of the vehicle to list the private vehicle 104 on an ride request system 150. In addition, the method processes a payment of a renter (e.g., renter 114, verified renter 706) of the private vehicle 104 in a threshold radial distance 119 from the private vehicle 104 when the private vehicle 104 is predictable at the available state for a predictably available period of time. Furthermore, a financial account of the operator of the private vehicle 3610 is credited with the payment of the renter of the private vehicle 104 in the threshold radial distance 119 from the private vehicle 104 when the private vehicle 104 is predictable at the available state for a predictably available period of time.

The unique identifier 105 of the private vehicle 104 may be a license plate of the private vehicle 104, and/or a social networking profile of the user in a geo-spatial social community (e.g., vehicle renting network 142). The method may include automatically recommending connections to the operator 301 of the vehicle based on the available state (e.g., the available state of the private vehicle 3508, the claimed geospatial locations 700). The connections may be associated with other users of the geo-spatial social community based on other users of the geo-spatial social community sharing a common interest 3500 with the operator in the threshold radial distance 119 from the available state, and/or other private vehicles 104 of the geo-spatial social community whose owners share the common interest 3500 with the operator in the threshold radial distance 119 from the available state. The method may include automatically instructing the private vehicle to navigate to a location of the renter, and/or periodically updating the operator and/or the renter based on a time in transit 3502, a time to arrival 3606, a time to destination 3608, and/or the payment earned status 3504. A criteria (e.g., the listing criteria 604) associated with an automotive listing data 102 including a description, a photograph, a video, a rental fee, a category, a vehicle make, a vehicle model, and/or a functional status may be processed.

In addition, an availability chart may be populated when the private vehicle 104 associated with the listing criteria 604 is posted. The availability chart may include an operation area radius, a start timing, an end timing, an hours per day, and/or an hours per user. The method may further include determining that the automotive listing data 102 is generated by the verified renter 706 of the private taxi system when validating that the automotive listing data 102 is associated with the mobile device 303. It may be determined that an application on the mobile device 303 is communicating the automotive listing data 102 to the ride request system 150 when the automotive listing data 102 may be processed.

The verified renter 706 may be associated with a verified renter profile 2202 in the ride request system 150 through the application on the mobile device 303. The automotive listing data 102 generated through the mobile device 303 may be presented as an automobile sharing alert pushpin 609 of the automotive listing data 102 in a geospatial map surrounding pre-populated residential and/or business listings in a surrounding vicinity, such that the automobile sharing alert pushpin 609 of the automotive listing data 102 may automatically presented on the geospatial map in addition to being presented on the set of user profiles having associated verified addresses in the threshold radial distance 119 from the set of geospatial coordinates 103 associated with the automotive listing data 102 generated through the mobile device 303 of the verified renter 706 of the dispatch server 100.

The automotive listing data 102 generated through the mobile device 303 may be radially distributed through an on-page posting 621, an electronic communication, and/or a push notification delivered to desktop and/or mobile devices (e.g., renter devices 505) associated with users and/or their user profiles around an epicenter 144 defined at the set of geospatial coordinates 103 associated with the automotive listing data 102 that may be generated through the mobile device 303 to all subscribed user profiles in a circular geo-fenced area (defined by the threshold distance from the set of geospatial coordinates 103 associated with the automotive listing data 102 generated through the mobile device 303) through the radial algorithm 140 of the ride request system 150 that measures a distance away of each address associated with each user profile from the current geospatial location at the epicenter 144.

The method may include permitting the verified renter 706 to drag and/or drop the automobile sharing alert pushpin 609 on any location on the geospatial map, and/or automatically determining a latitude and/or a longitude associated a placed location. The method may further include automatically notifying a user, a business (e.g., private vehicle 104), and/or an automobile rental agency in a surrounding geospatial area to the set of geospatial coordinates 103 associated with the automotive listing data 102 generated through the mobile device 303. The geospatial coordinates 103 may be extracted from a metadata associated with the automotive listing data 102 generated through the mobile device 303 when verifying that the set of geospatial coordinates 103 associated with the automotive listing data 102 generated through the mobile device 303 are trusted based on the claimed geospatial location 700 of the verified renter 706 of the dispatch server 100.

A relative match between a persistent clock 226 associated with the dispatch server 100 and/or a digital clock of the mobile device 303 may be determined to determine that the time stamp 510 associated with the creation date 508 and/or time of the automotive listing data 102 generated through the mobile device 303 may accurate and/or therefore trusted. A publishing of the automotive listing data 102 generated through the mobile device 303 may be automatically deleted on a set of user profiles (e.g., verified renter profiles 2202) having associated verified addresses in the threshold radial distance 119 from the set of geospatial coordinates 103 associated with the automotive listing data 102 generated through the mobile device 303 of the verified renter 706 of the dispatch server 100 based on an automobile sharing alert expiration time 629.

The method may also include geocoding a set of private-car renter user addresses each of which may be associated with a resident name in a neighborhood surrounding the mobile device 303. The set of private-car renter user addresses each associated with the resident name may be prepopulated as the set of user profiles in the threshold radial distance 119 from the claimed geospatial location 700 of the verified renter 706 of the dispatch server 100 in a ride request system communicatively coupled with the dispatch server 100. The verified renter 706 may be permitted to modify content in each of the set of user profiles. The modified content may be tracked through the ride request system.

A reversible history journal associated with each of the set of user profiles may be generated such that a modification of the verified renter 706 can be undone on a modified user profile page. An editing credibility of the verified renter 706 may be determined based on an edit history of the verified renter 706 and/or a community contribution validation of the verified renter 706 by other users of the ride request system. The method may include automatically publishing the automotive listing data 102 generated through the mobile device 303 to a set of user profiles having associated verified addresses in a threshold radial distance 119 from the claimed geospatial location 700 of the verified renter 706 of the dispatch server 100 using the radial algorithm 140.

A claim request of the verified renter 706 generating the automotive listing data 102 generated through the mobile device 303 to be associated with an address of the ride request system may be processed. It may be determined if the claimable neighborhood in the ride request system may be associated with a car sharing community in the claimable neighborhood of the ride request system. The verified renter 706 may be associated with the car sharing community in the claimable neighborhood of the ride request system if the car sharing community has been activated by the verified renter 706 and/or a different verified renter 706. The verified renter 706 may be permitted to draw a set of boundary lines in a form of a geospatial polygon such that the claimable neighborhood in a geospatial region surrounding the claim request may create the car sharing community in the ride request system if the car sharing community may be inactive.

The method may verify the claim request of the verified renter 706 generating the automotive listing data 102 generated through the mobile device 303 to be associated with a neighborhood address of the ride request system when the address may be determined to be associated with a work address and/or a residential address of the verified renter 706. The automotive listing data 102 generated through the mobile device 303 may be simultaneously published on the car sharing community associated with the verified renter 706 generating the automotive listing data 102 generated through the mobile device 303 in the threshold radial distance 119 from the address associated with the claim request of the verified renter 706 of the ride request system when automatically publishing the automotive listing data 102 generated through the mobile device 303 on a set of user profiles having associated verified addresses in a threshold radial distance 119 from the claimed geospatial location 700 of the verified renter 706 of the dispatch server 100 based on a set of preferences of the verified renter 706 using the radial algorithm 140.

A set of profiles may be automatically downloaded to the mobile device 303. A private vehicle operator 301 (e.g., the driver of the vehicle) may the verified renter 706. An interface may be provided to the operator of the private vehicle such that the operator of the private vehicle may be able to use a haptic ‘flick’ gesture in a horizontal and/or a vertical fashion to switch a viewing pane associated with a profile. The method may include analyzing a response of the private vehicle operator being a dismiss, a save, a rating, a review and/or a rental acceptance of a renter associated with the automotive listing data 102 through the dispatch server 100. A video communication and/or an audio communication may be automatically initiated between the mobile device 303 of the private vehicle operator and/or another mobile device 303 the renter through the dispatch server 100 based on the profile of the renter associated with the automotive listing data 102 through the dispatch server 100.

The renter and/or other renters may be permitted to view the rating and/or the review provided by the private vehicle operator for each of the renters based on a participation criteria 605 set by the private vehicle operator and/or the renter, such that each renter may able to view ratings and/or reviews of each participating candidate for the rental associated with the automotive listing data 102. Each renter for the rental of the private vehicle 104 associated with the automotive listing data 102 may be permitted to communicate with each other and/or form social connections with each other based on the participation criteria 605 set by the private vehicle operator 301 and/or the renter, such that each renter may able to form social connections with each participating candidate for the rental associated with the automotive listing data 102.

The method may also include permitting participating private vehicle owners (e.g., owners 301 of the private vehicles) in the dispatch server 100 to see previous ratings, comments, reviews, prescreen questions, and/or background checks of across a plurality of renters applying for a plurality private vehicle rentals through the dispatch server 100 (such that different private vehicle owners benefit from previous diligence of at one of previous ratings, comments, reviews, prescreen questions, and/or background checks by participating private vehicle owners with each renter that has previously rented through the dispatch server 100). A summary data 626 may be provided to the private vehicle operator 301 generating the automotive listing data 102 generated through the mobile device 303 of how many user profile pages were updated with an alert of the automotive listing data 102 generated through the mobile device 303 when publishing the automotive listing data 102 generated through the mobile device 303 in the car sharing community and/or the set of user profiles having associated verified addresses in the threshold radial distance 119 from the claimed geospatial location 700 of the verified renter 706 of the dispatch server 100 based on the set of preferences of the verified renter 706.

The automotive listing data 102 generated through the mobile device 303 may be live broadcasted to the different verified renter 706 and/or other verified renters 706 in the car sharing community (and/or currently within the threshold radial distance 119 from the current geo spatial location) through the dispatch server 100 through a multicast algorithm 276 such that a live broadcast multicasts to a plurality of data processing systems associated with each of the different user and/or the other verified renters 706 simultaneously (when the mobile device 303 of the verified renter 706 generating the live-broadcast 616 enables broadcasting of the automotive listing data 102 generated through the mobile device 303 to any one of a geospatial vicinity around the mobile device 303 of the verified renter 706 generating the broadcast and/or in any car sharing community in which the verified renter 706 has a non-transitory connection). The different verified renter 706 and/or other verified renters 706 in the car sharing community may be permitted to bi-directionally communicate with the verified renter 706 generating the broadcast through the dispatch server 100.

Any car sharing community in which the verified renter 706 has a non-transitory connection may be a residential address of the verified renter 706 and/or a work address of the verified renter 706 that has been confirmed by the dispatch server 100 as being associated with the verified renter 706. The threshold distance may between 0.2 and/or 0.4 miles from the set of geospatial coordinates 103 associated with the automotive listing data 102 generated through the mobile device 303 to optimize a relevancy of the live-broadcast 616. The dispatch server 100 may include a crowd-sourced moderation algorithm 204 in which multiple neighbors in a geospatial area determine what content contributed to the dispatch server 100 persists and/or which may be deleted. The dispatch server 100 may permit users to mute messages of specific verified renters 706 to prevent misuse of the dispatch server 100. The dispatch server 100 may permit the automotive listing data 102 to be disseminated to adjacent neighborhoods that have been claimed by different users in a manner such that the automotive listing data 102 may optionally disseminated to the surrounding claimed neighborhoods 300 based on a preference of the verified renter 706.

A claimed neighborhood 300 of the verified renter 706 may be activated based on a minimum number of other verified renters 706 in the threshold radial distance 119 that have been verified through a primary residential address associated with each of the other verified renters 706 through a post card verification, a utility bill verification, a privately-published access code, and/or a neighbor vouching method. Access to the automotive listing data 102 may be restricted to the claimed neighborhood 300 of the verified renter 706. Access to the automotive listing data 102 may denied to users having verified addresses outside the claimed neighborhood 300 of the verified renter 706.

In another aspect, the method of the private vehicle 104 includes communicating a unique identifier 105 associated with the private vehicle 104 with an dispatch server 100 and periodically determining a location of the private vehicle 104 based on a geospatial data associated with a location of the private vehicle 104. The method further includes automatically setting a navigation route 3618 of the private vehicle 104 when the private vehicle 104 is located at an available state of the private vehicle 3508 based on a predictable behavior algorithm 211. In addition, a payment of a renter of the private vehicle 104 in a threshold radial distance 119 from the private vehicle 104 is processed when the renter is picked up by the private vehicle 104.

A unique identifier 105 associated with a private vehicle 104 may be associated with the dispatch server 100. A location of the private vehicle 104 may be periodically analyzed based on a geospatial data associated with a location of the private vehicle 104. A available state of the private vehicle 3508 may be declared based on a predictable behavior algorithm 211. An operator 301 of the vehicle may be permitted to list the private vehicle 104 on an ride request system 150, wherein the private vehicle the navigation route 3618 automatically instructed to navigate to a location of the renter (e.g., renter location 612).

In yet another aspect, a system includes a network 101 and an private vehicle to automatically set a navigation route 3618 of the private vehicle (e.g., the private vehicle 104) to a location of a renter of the private vehicle (e.g., location of the renter 612) when the private vehicle is located at an available state of the private vehicle based (e.g., the available state of the private vehicle 3508) on a predictable behavior algorithm 211. The system also includes an dispatch server 100 communicatively coupled with the private vehicle to credit a financial account of an operator of the private vehicle 3610 with a payment of the renter (e.g., the renter 114) of the private vehicle in the threshold radial distance 119 from the private vehicle when the private vehicle is predictable at the available state for a predictably available period of time.

A unique identifier 105 associated with a private vehicle 104 may be associated with the dispatch server 100. A location of the private vehicle 104 may be periodically analyzed based on a geospatial data associated with a location of the private vehicle 104. A available state of the private vehicle 3508 may be declared based on a predictable behavior algorithm 211 211. An operator 301 of the vehicle may be permitted to list the private vehicle 104 on an ride request system 150, wherein the private vehicle the navigation route 3618 automatically instructed to navigate to a location of the renter.

The unique identifier 105 may be a license plate of the private vehicle, and/or a social networking profile of the user in a geo-spatial social community. A connection recommendation module 270 may automatically recommend connections to the operator of the private vehicle based on the available state. The connections may be associated with other users of the geo-spatial social community (e.g., the vehicle renting network 142) based on other users of the geo-spatial social community sharing a common interest 3500 with the operator in the threshold radial distance 119 from the available state, and/or other private vehicles of the geo-spatial social community whose owners share the common interest 3500 with the operator in the threshold radial distance 119 from the available state. A navigation module 218 may automatically instruct the private vehicle to navigate to a location of the renter. An update module 266 may periodically update the operator and/or the renter based on a time in transit 3502, a time to arrival 3606, a time to destination 3608, and/or the payment earned status 3504.

A criteria module 203 may process a criteria associated with an automotive listing data 102 including a description, a photograph, a video, a rental fee, a category, a vehicle make, a vehicle model, and/or a functional status. A charting module 272 may populate an availability chart when the private vehicle associated with the listing criteria 604 is posted. The availability chart may include an operation area radius, a start timing, an end timing, an hours per day, and/or an hours per user. A validation module 200 may determine that the automotive listing data 102 is generated by the verified renter 706 of the private taxi system when validating that the automotive listing data 102 is associated with the mobile device 303. An application module 274 may determine that an application on the mobile device 303 is communicating the automotive listing data 102 to the ride request system 150 when the automotive listing data 102 is processed. An association module 216 may associate the verified renter 706 with a verified renter profile 2202 in the ride request system 150 through the application on the mobile device 303.

A pushpin module 206 may present the automotive listing data 102 generated through the mobile device 303 as an automobile sharing alert pushpin 609 of the automotive listing data 102 in a geospatial map surrounding pre-populated residential and/or business listings in a surrounding vicinity (such that the automobile sharing alert pushpin 609 of the automotive listing data 102 may be automatically presented on the geospatial map in addition to being presented on the set of user profiles having associated verified addresses in the threshold radial distance 119 from the set of geospatial coordinates 103 associated with the automotive listing data 102 generated through the mobile device 303 of the verified renter 706 of the dispatch server 100).

The automotive listing data 102 generated through the mobile device 303 may be radially distributed through an on-page posting 621, an electronic communication, and/or a push notification delivered to desktop and/or mobile devices 303 associated with users and/or their user profiles around an epicenter 144 defined at the set of geospatial coordinates 103 associated with the automotive listing data 102 generated through the mobile device 303 to all subscribed user profiles in a circular geo-fenced area (defined by the threshold distance from the set of geospatial coordinates 103 associated with the automotive listing data 102 generated through the mobile device 303) through the radial algorithm 140 of the ride request system 150 that may measure a distance away of each address associated with each user profile from the current geospatial location at the epicenter 144. A placement module 232 may permit the verified renter 706 to drag and/or drop the automobile sharing alert pushpin 609 on any location on the geospatial map, and/or automatically determine a latitude and/or a longitude associated a placed location. A notification module 208 may automatically notify a user, a business, and/or an automobile rental agency in a surrounding geospatial area to the set of geospatial coordinates 103 associated with the automotive listing data 102 generated through the mobile device 303.

An extraction module 234 may extract the geospatial coordinates 103 from a metadata associated with the automotive listing data 102 generated through the mobile device 303 when verifying that the set of geospatial coordinates 103 associated with the automotive listing data 102 generated through the mobile device 303 are trusted based on the claimed geospatial location 700 of the verified renter 706 of the dispatch server 100. A matching module 210 may determine a relative match between a persistent clock 226 associated with the dispatch server 100 and/or a digital clock of the mobile device 303 to determine that the time stamp 510 associated with the creation date 508 and/or time of the automotive listing data 102 generated through the mobile device 303 may accurate and/or therefore trusted. A deletion module 236 may automatically delete a publishing of the automotive listing data 102 generated through the mobile device 303 on a set of user profiles having associated verified addresses in the threshold radial distance 119 from the set of geospatial coordinates 103 associated with the automotive listing data 102 generated through the mobile device 303 of the verified renter 706 of the dispatch server 100 based on an automobile sharing alert expiration time 629.

A plotting module 238 may geocode a set of private-car renter user addresses each associated with a resident name in a neighborhood surrounding the mobile device 303. A data-seeding module 241 may prepopulate the set of private-car renter user addresses each associated with the resident name as the set of user profiles in the threshold radial distance 119 from the claimed geospatial location 700 of the verified renter 706 of the dispatch server 100 in a ride request system communicatively coupled with the dispatch server 100. A modification module 242 may permit the verified renter 706 to modify content in each of the set of user profiles. A discovery module 244 may track the modified content through the ride request system. An undo module 246 may generate a reversible history journal associated with each of the set of user profiles such that a modification of the verified renter 706 can be undone on a modified user profile page.

A reputation module 248 248 may determine an editing credibility of the verified renter 706 based on an edit history of the verified renter 706 and/or a community contribution validation of the verified renter 706 by other users of the ride request system. A publication module 214 may automatically publish the automotive listing data 102 generated through the mobile device 303 to a set of user profiles having associated verified addresses in a threshold radial distance 119 from the claimed geospatial location 700 of the verified renter 706 of the dispatch server 100 using the radial algorithm 140.

A claiming module 250 may process a claim request of the verified renter 706 generating the automotive listing data 102 generated through the mobile device 303 to be associated with an address of the ride request system. A private-neighborhood module 252 may determine if the claimable neighborhood in the ride request system may be associated with a car sharing community in the claimable neighborhood of the ride request system. An association module 216 may associate the verified renter 706 with the car sharing community in the claimable neighborhood of the ride request system if the car sharing community has been activated by the verified renter 706 and/or a different verified renter 706. A boundary module 254 may permit the verified renter 706 to draw a set of boundary lines in a form of a geospatial polygon such that the claimable neighborhood in a geospatial region surrounding the claim request may create the car sharing community in the ride request system if the car sharing community may inactive.

An address type module 256 may verify the claim request of the verified renter 706 generating the automotive listing data 102 generated through the mobile device 303 to be associated with a neighborhood address of the ride request system when the address is determined to be associated with a work address and/or a residential address of the verified renter 706. A concurrency module 258 may simultaneously publish the automotive listing data 102 generated through the mobile device 303 on the car sharing community associated with the verified renter 706 generating the automotive listing data 102 generated through the mobile device 303 in the threshold radial distance 119 from the address associated with the claim request of the verified renter 706 of the ride request system (when automatically publishing the automotive listing data 102 generated through the mobile device 303 on a set of user profiles having associated verified addresses in a threshold radial distance 119 from the claimed geospatial location 700 of the verified renter 706 of the dispatch server 100 based on a set of preferences of the verified renter 706 using the radial algorithm 140).

A download module 268 may automatically download a set of profiles to the mobile device 303, wherein an operator of the private vehicle may the verified renter 706. A flick module 213 may provide an interface to the operator of the private vehicle such that the operator 301 of the vehicle can use a haptic ‘flick’ gesture in a horizontal and/or a vertical fashion to switch a viewing pane associated with a profile. A response module 264 may analyze a response of the operator of the private vehicle being a dismiss, a save, a rating, a review and/or a rental acceptance of a renter associated with the automotive listing data 102 through the dispatch server 100.

A communication module 260 may automatically initiate a video communication and/or an audio communication between the mobile device 303 of the operator of the private vehicle and/or another mobile device 303 of the renter through the dispatch server 100 based on the profile of the renter associated with the automotive listing data 102 through the dispatch server 100. A review module 207 may permit the renter and/or other renters to view the rating and/or the review provided by the operator of the private vehicle for each of the renters based on a participation criteria 605 set by the operator of the private vehicle and/or the renter, such that each renter may be able to view ratings and/or reviews of each participating candidate for the rental associated with the automotive listing data 102. A social connection module 209 may permit each renter for the rental of the private vehicle associated with the automotive listing data 102 to communicate with each other and/or form social connections 3400 with each other based on the participation criteria 605 set by the operator of the private vehicle and/or the renter, such that each renter may able to form social connections 3400 with each participating candidate for the rental associated with the automotive listing data 102.

A diligence module 205 may permit participating owners of the private vehicles in the dispatch server 100 to see previous ratings 620, comments, reviews 622, prescreen questions, and/or background checks of across a plurality of renters applying for a plurality private vehicle rentals through the dispatch server 100 such that different operator of the private vehicles benefit from previous diligence of at one of previous ratings 620, comments, reviews 622, prescreen questions, and/or background checks by participating operator of the private vehicles with each renter that has previously rented through the dispatch server 100. A summary module 262 may provide a summary data 626 to the operator of the private vehicle generating the automotive listing data 102 generated through the mobile device 303 of how many user profile pages were updated with an alert of the automotive listing data 102 generated through the mobile device 303 when publishing the automotive listing data 102 generated through the mobile device 303 in the car sharing community and/or the set of user profiles having associated verified addresses in the threshold radial distance 119 from the claimed geospatial location 700 of the verified renter 706 of the dispatch server 100 based on the set of preferences of the verified renter 706.

A live broadcast module 228 may live broadcast the automotive listing data 102 generated through the mobile device 303 to the different verified renter 706 and/or other verified renters 706 in the car sharing community and/or currently within the threshold radial distance 119 from the current geospatial location through the dispatch server 100 through a multicast algorithm 276 such that a live broadcast multicasts to a plurality of data processing systems associated with each of the different user and/or the other verified renters 706 simultaneously (when the mobile device 303 of the verified renter 706 generating the live-broadcast 616 enables broadcasting of the automotive listing data 102 generated through the mobile device 303 to any one of a geospatial vicinity around the mobile device 303 of the verified renter 706 generating the broadcast and/or in any car sharing community in which the verified renter 706 has a non-transitory connection).

A bi-directional communication module 230 may permit the different verified renter 706 and/or other verified renters 706 in the car sharing community to bi-directionally communicate with the verified renter 706 generating the broadcast through the dispatch server 100. Any car sharing community in which the verified renter 706 has a non-transitory connection may be a residential address of the verified renter 706 and/or a work address of the verified renter 706 that has been confirmed by the dispatch server 100 as being associated with the verified renter 706. The threshold distance may be between 0.2 and/or 0.4 miles from the set of geospatial coordinates 103 associated with the automotive listing data 102 generated through the mobile device 303 to optimize a relevancy of the live-broadcast 616. The dispatch server 100 may include a crowd-sourced moderation algorithm 204 in which multiple neighbors in a geospatial area may determine what content contributed to the dispatch server 100 persists and/or which may be deleted. The dispatch server 100 may permit users to mute messages of specific verified renters 706 to prevent misuse of the dispatch server 100.

The dispatch server 100 may permit the automotive listing data 102 to be disseminated to adjacent neighborhoods that have been claimed by different users in a manner such that the automotive listing data 102 may be optionally disseminated to the surrounding claimed neighborhoods 300 based on a preference of the verified renter 706. A claimed neighborhood 300 of the verified renter 706 may be activated based on a minimum number of other verified renters 706 in the threshold radial distance 119 that have been verified through a primary residential address associated with each of the other verified renters 706 through a post card verification, a utility bill verification, a privately-published access code, and/or a neighbor vouching system. Access to the automotive listing data 102 may be restricted to the claimed neighborhood 300 of the verified renter 706. Access to the automotive listing data 102 may be denied to users having verified addresses outside the claimed neighborhood 300 of the verified renter 706.

The methods and systems disclosed herein may be implemented in any means for achieving various aspects, and may be executed in a form of a machine-readable medium embodying a set of instructions that, when executed by a machine, cause the machine to perform any of the operations disclosed herein. Other features will be apparent from the accompanying drawings and from the detailed description that follows.

The methods and systems disclosed herein may be implemented in any means for achieving various aspects, and may be executed in a form of a machine-readable medium embodying a set of instructions that, when executed by a machine, cause the machine to perform any of the operations disclosed herein. Other features will be apparent from the accompanying drawings and from the detailed description that follows.

Embodiments described herein in FIGS. 1-11 govern a new kind of social network for neighborhoods, according to one embodiment (e.g., may be private and/or wild-editable search engine based). It should be noted that in some embodiments, the address of a user may be masked from the public search (but still may be used for privacy considerations), according to one embodiment. Some embodiments have no preseeded data, whereas others might. Embodiments described herein may present rich, location specific information on individual residents and businesses.

A user can “Claim” one or more Business Pages and/or a Residential Pages, according to one embodiment. In order to secure their Claim, the user may verify their location associated with the Business Page and/or Residential page within 30 days, or the page becomes released to the community, according to one embodiment. A user can only have a maximum of 3 unverified Claims out at any given time, according to one embodiment. When a user clicks on “Claim this Page” on Business Profile page and/or a Residential Profile page, they can indicate the manner in which they intend to verify their claim, according to one embodiment. Benefits of Claiming a Business Page and/or Residential page may enable the user to mark their page ‘Self-Editable only’ from the default ‘Fully Editable’ status, and see “Private” listings in a claimed neighborhood around the verified location, according to one embodiment. Each edit by a user on a Residential Profile page and/or a Business Profile page may be made visible on the profile page, along with a date stamp, according to one embodiment.

Browse function: Based on the user's current location, the browse function may display a local map populated with pushpins for location-specific information, and a news feed, made up of business page edits, public people page edits, any recent broadcasts, etc., according to one embodiment. The news feed may show up on each Business Page and each Residential Page, based on activity in the surrounding area, according to one embodiment. Secure a Neighborhood function: May allow the user to identify and “secure” a neighborhood, restricting certain types of access to verified residents, according to one embodiment. Add a Pushpin function: May allow any registered or verified renter to add any type of Pushpin (as described in FIG. 8), according to one embodiment.

In addition to the map, the search results page may display a news feed, made up of business page edits, public people page edits, any recent broadcasts, and autogenerated alerts who has moved into the neighborhood, who has moved out of the neighborhood, any recent reviews in the neighborhood, any pushpins placed in the immediate area, etc., according to one embodiment. The news feed may prioritize entries relating to the search results, and will take into account privacy policies and preferences, according to one embodiment.

Example Newsfeeds may include:

Joe Smith moved into the neighborhood in September 2013. Welcome Joe! Like Share; 43 neighbors (hyperlink) moved in to the Cupertino library neighborhood in July 2013. Like Share; 12 neighbors (hyperlink) verified in to the Cupertino library neighborhood in July 2013. Like Share; Raj Abhyanker invited Paul Smith, a guest to the Cupertino neighborhood. Raj indicates Paul is a friend from college looking to move into the neighborhood. Welcome Paul!: Raj Abhyanker posted a Nissan Leaf for rent $35 a day, in mountain view Rent now. Like Share

This content may feed each Profile Page and helps to increase Search Engine value for content on the site, according to one embodiment. Alerts may be created and curated (prioritized, filtered) automatically and/or through crowdsourcing, to keep each page vibrant and actively updating on a regular basis (ideally once a day or more), according to one embodiment.

A Multi-Family Residence page will display a list of residents in the entire building, according to one embodiment. Clicking on any resident will display a Single Family Residence page corresponding to the individual living unit where that person resides, according to one embodiment.

For example, suppose that John Smith and Jane Smith live in apartment 12 of a large building. Their names are included in the list of residents. When a user clicks on either John Smith or Jane Smith, we will display a “Single Family Residence” page showing both John and Jane, just as if apartment 12 was a separate structure, according to one embodiment.

The broadcast feature (e.g., associated with the automotive listing data 102 and generated by the radial algorithm 240 of the radial distribution module 140) may be a “Radio” like function that uses the mobile device's current geospatial location to send out information to neighbors around the present geospatial location of the user, according to one embodiment. Broadcasts may be posted to neighbor pages in the geospatial vicinity (e.g., in the same neighborhood) on public and private pages in the geospatial social network, according to one embodiment. These broadcasts may enable any user, whether they live in a neighborhood or not to communicate their thoughts to those that live or work (or have claimed) a profile in the neighborhood around where the broadcaster is physically at, regardless of where the broadcaster lives, according to one embodiment. Broadcasts can be audio, video, pictures, and or text, according to one embodiment. For accountability, the broadcaster may be a verified renter and their identity made public to all users who receive the broadcast in one embodiment.

This means that the broadcast feature may be restricted to be used only by devices (e.g., mobile phones) that have a GPS chip (or other geolocation device) that an identify a present location of where the broadcast is originating from, according to one embodiment. The broadcast may be sent to all users who have claimed a profile in the geo spatial vicinity where the broadcast originates, according to one embodiment. This can either be broadcast live to whoever is “tuned” in to a broadcast of video, audio, picture, and text in their neighborhood, or can be posted on each users profile if they do not hear the broadcast to the neighborhood in a live mode in one embodiment.

When a broadcast is made neighbors, around where the broadcast is made, they may receive a message that says something like:

Raj Abhyanker, a user in Menlo Park just broadcast “Japanese cultural program” video from the Cupertino Union church just now. Watch, Listen, View

This broadcast may be shared with neighbors around Menlo Park, and or in Cupertino. This way, Raj's neighbors and those in Cupertino can know what is happening in their neighborhoods, according to one embodiment. In one embodiment, the broadcast only goes to one area (Cupertino or Menlo Park in the example above).

Broadcasts could be constrained to devices that have geospatial accuracy of present location and a current only (mobile devices for example). Otherwise, broadcasts won't mean much, according to one embodiment (would otherwise be just like thoughts/video upload without this). Broadcasts shouldn't be confused with ‘upload videos’, according to one embodiment. Different concepts. Why? Broadcasts have an accuracy of time and location that cannot be altered by a user, according to one embodiment. Hence, mobile is the most likely medium for this not desktop computer, according to one embodiment. We should not let the user set their own location for broadcasts (like other pushpin types), according to one embodiment. Also time is fixed, according to one embodiment. Fixing and not making these two variables editable give users confidence that the broadcast was associated with a particular time and place, and creates a very unique feature, according to one embodiment. For example, it would be not useful if the broadcast is untrusted as to location of origination, according to one embodiment. E.g., I broadcast when I am somewhere only about the location I am at, according to one embodiment.

Broadcasts are different that other pushpins because location of where a broadcast, and time of broadcast is

*current location* and *current time*, according to one embodiment. They are initiated wherever a broadcaster is presently at, and added to the news feed in the broadcasters neighborhood and in the area wherever a broadcaster is presently at, according to one embodiment.

Broadcast rules may include:

1. If I post a Broadcast in my secured neighborhood, only my neighbors can see it, according to one embodiment.

2. If I post a Broadcast in different secured neighborhood then my own, my neighbors can see it (e.g., unless I turn this off in my privacy setting) and neighbors in the secured neighborhood can see it (e.g., default not turn-offable, but I can delete my broadcast), according to one embodiment.

3. If I post a Broadcast in different unsecured neighborhood then my own, my neighbors can see it (unless I turn this off in my privacy setting) and the broadcast is publicly visible on user pages of public user profiles in the unsecured neighborhood until profiles are claimed and/or the neighborhood is secured, according to one embodiment.

4. If an outsider in a secure neighborhood posts a broadcast in my secure neighborhood, it's not public, according to one embodiment.

5. If an outsider in a unsecure neighborhood posts a broadcast in my secure neighborhood, the system does not post on profiles in his unsecure neighborhood (to prevent stalking, burglary), but does post in my secure neighborhood, according to one embodiment.

Privacy settings. For each verified residential or business location, the user may set Privacy to Default, Public, Private, or Inactive, according to one embodiment. The Default setting (which is the default) means that the profile will be public, until the neighborhood is secured; in a secured neighborhood, the profile will be Private, according to one embodiment. By changing this setting, the user may force the profile to be Public or Private, regardless of whether the neighborhood is secured, according to one embodiment.

For each verified residential location, the user may set edit access to Group Editable or Self Editable, according to one embodiment.

Residential Privacy example. The residential profiles can be: Public: anyone can search, browse, or view the user profile, according to one embodiment. This is the default setting for unsecured neighborhoods (initially, all the content on the site), according to one embodiment. Private: only people in my neighborhood can search, browse, or view the user's profile, according to one embodiment. This is the default for secured neighborhoods, according to one embodiment. Inactive: nobody can search, browse, or view the profile, even within a secured neighborhood, according to one embodiment. A user may have at least one active (public or private), verified profile in order to have edit capabilities, according to one embodiment; if the user makes all profiles inactive, that user is treated (for edit purposes) as an unverified renter, according to one embodiment.

Verified users can edit the privacy setting for their profile and override the default, according to one embodiment. Group Editable: anyone with access to a profile based on the privacy roles above can edit the profile, according to one embodiment. This is the default setting, according to one embodiment Self Editable, only the verified owner of a profile can edit that profile, according to one embodiment.

Exceptions Guest User. A verified renter in another neighborhood is given “Guest” access to a neighborhood for a maximum of 60 days by a verified renter in the neighborhood in which the guest access is given, according to one embodiment. In effect, the guest becomes a member of the neighborhood for a limited period, according to one embodiment. Friend. When a user has self-elected being friends with someone in a different neighborhood, they can view each other's profiles only (not their neighbors), according to one embodiment. One way for a user to verify a location is to submit a scanned utility bill, according to one embodiment.

When a moderator selects the Verify Utility Bills function, the screen will display a list of items for processing, according to one embodiment. Accept the utility bill as a means of verification, according to one embodiment. This will verify the user's location, and will also generate an e-mail to the user, according to one embodiment. Or Decline the utility bill as a means of verification, according to one embodiment. There will be a drop-down list to allow the moderator to select a reason, according to one embodiment; this reason will be included in an e-mail message to the user. Reasons may include: Name does not match, address does not match, name/address can't be read, not a valid utility bill, according to one embodiment.

Additionally, for example, the broadcast may even occur automatically and simultaneously when a user lists and/or rents a private vehicle. Upon listing, viewing and/or renting a private vehicle through the user interfaces of FIGS. 6A-6D, renters 114 within a threshold radial distance 119 (e.g., selected by the user) from the claimed geospatial location 700 and/or current location of the user may be updated and/or may be able to contact the user indicating that they have a similar private vehicle for rent and/or require a private vehicle like the one listed. This may allow users to share private vehicles and/or find optimal rental arrangements quickly and/or conveniently.

The private vehicle 114 described in the various embodiments may have anti-lock brakes that may need the driver to step on the brake pedal in order to work, but they may perform a function that drivers used to have to do themselves. When the private vehicle 114 is braking hard and does not have anti-lock brakes, the wheels may lock up, which may send the vehicle into an out-of-control skid.

The private vehicle 114 may use sensors to provide traction and stability control. They may use the sensors at the wheels to detect when a vehicle might go into an out-of-control skid and/or roll over, and/or then they may use ABS and engine management to keep the vehicle on the road and right side up. Unlike a driver, these systems may apply the brakes and increase or decrease power to individual wheels, which may be often better than brakes or power being applied to all four wheels by a human foot mashing the brake pedal in a blind panic. Already the private vehicle 114 may be a better driver than the driver with these technologies. The systems may differ depending on the private vehicle 114, but what the private vehicle 114 may have in common may be that they can anticipate crashes and/or prepare the vehicle to keep the occupants safe.

For example, the private vehicle 114 may come around a corner only to find a garbage truck stopped in its lane. In the private vehicle 114 with a pre-safe system, an alarm might go off as the vehicle nears the truck. The private vehicle 114 may reduce engine power, which may slow the private vehicle 114 and reduce the severity of the crash, if there is one to come. Finally, if the system detects that a crash cannot be avoided; the system (e.g., the on board computer system 3601 of FIG. 36B) may prepare the airbags for deployment and tighten all of the seat belts. The system of the private vehicle 114 may do all that in less time than it takes the driver to simply slam on the brakes.

Several manufacturers may offer automatic parking systems on everything from SUVs to compact versions of the private vehicle 114 and hybrids, as shown and described in FIGS. 1-46. The systems may use sensors all around the private vehicle 114 to guide it into a parallel parking space with no human input required. Before it can work, the private vehicle 114 may have to find a parking space, position the vehicle next to it, and/or use the navigation screen to tell the private vehicle 114 where it should go. Still, the self-parking system may be a big achievement in private vehicle technology. With it, the private vehicle 114 may behave like a driver might—reading the area around it, reacting accordingly and/or going safely from point A to point B, as shown and described in FIGS. 1-46.

Semi-driverless and/or driverless systems may not have hands, as shown and described in FIGS. 1-46. It should be noted that the private vehicle 114 may be a “semi-driverless” vehicle in some embodiments. As the technology progresses, the legal issues may follow.

Semi-autonomous systems of the private vehicle 114 may do more than just see the road. Using an array of sensors, lasers, radar, cameras, and GPS technology, they may be able to actually analyze a vehicle's surroundings. Semi-autonomous systems may be a combination of two technologies. The first may be adaptive cruise control of the private vehicle 114, which may use a long-range radar (e.g., more than 100 meters) in the grille to keep the vehicle a uniform distance behind another vehicle while maintaining a set speed, as shown and described in FIGS. 1-46. The second, lane-centering may use multiple cameras with machine-vision software to read road lines and detect objects near the private vehicle 114.

This information may then be sent to a computer (e.g., a geospatially constrained network of a car manufacturer) that processes the data and adjusts the electrically assisted steering to keep the vehicle centered in the lane, as shown and described in FIGS. 1-46. Because semiautonomous systems may be intended only for highways, manufacturers may use the private vehicle 114′ sGPS to determine its location before allowing the driver to engage the feature. In addition, manufacturers may also considering using short-range radars (e.g., 30 to 50 meters) and/or extra ultrasonic sensors (e.g., 3 meters) to enhance the private vehicle 114's overall awareness, as shown in FIGS. 1-46. The private vehicle 114 with park-assist systems may already have four similar sensors in the front and in the rear of the vehicle. Manufacturers may also be experimenting with cost-effective LIDAR units, which may use lasers instead of sound and may be more powerful and accurate than ultrasonic sensors, as shown in FIGS. 1-46. It is unclear whether LIDAR will make it into the same private vehicle 114 as some semiautonomous systems.

The heart of these semiautonomous systems may be a laser range finder mounted on the roof of the private vehicle 114. The device (e.g., a Velodyne 64-beam laser) may generate a detailed 3D map of the environment, as shown in FIGS. 1-46. The private vehicle 114 then may combine the laser measurements with high-resolution maps of the world which may allow the device to produce different types of data models that may allow it to drive itself while avoiding obstacles and respecting traffic laws. The private vehicle 104 (shown in FIG. 1) may also be associated with other sensors, which may include: four radars, mounted on the front and/or rear bumpers, that may allow the vehicle to “see” far enough to be able to deal with fast traffic on freeways; a camera, which may be positioned near the rear-view mirror, that detects traffic lights; and/or a GPS, inertial measurement unit, and/or wheel encoder, that may determine the vehicle's location and/or keep track of its movements, as shown in FIGS. 1-46. The private vehicle 104 may rely on very detailed maps of the roads and/or terrain, something that may be essential to determine accurately where the private vehicle 104 is, as shown in FIGS. 1-46. Using GPS-based techniques alone, the location may be off by several meters.

Before sending the private vehicle 104 on a road test (e.g., without a driver), the private vehicle 104 may need to drive along the route one or more times to gather data about the environment. When it is the private vehicle's 104 turn to drive itself, it may compare the data it acquires to the previously recorded data, an approach that may be useful to differentiate pedestrians from stationary objects like poles and/or mailboxes FIGS. 1-46. Sometimes, however, the private vehicle (e.g., the private vehicle 3600 of FIG. 36A) may need to be more “aggressive.” When going through a four-way intersection, for example, it may yield to other vehicles based on road rules; but if other vehicles don't reciprocate, it may advance a bit to show to the other drivers and/or private vehicles 104 its intention, as shown in FIGS. 1-46. Without programming that kind of behavior, it may be impossible for the private vehicle 104 to drive in the real world.

Driverless vehicles 104 could help make transportation safer and/or more efficient: Driverless vehicles may be able to drive closer to each other (shown in FIG. 34), making better use of the 80 percent to 90 percent of empty space on roads, and/or also form speedy convoys on freeways. Driverless vehicles 104 may react faster than humans to avoid accidents, potentially saving thousands of lives, as shown in FIGS. 1-46. Making vehicles smarter may require lots of computing power and data.

The Cruise Control: Cruise control systems of the private vehicle 114 may work in order to keep a vehicle in constant speed, without the driver having to apply gas. Anti-Lock Brakes: This may be a system that automatically prevents the locking of brakes, when the private vehicle 114 applies the brakes in full. The system may perform a better job than the driver as far as pumping the brakes in order to prevent the vehicle to spin and fall out of control.

The private vehicle 104 of FIG. 1 and/or the private vehicle 3600 of FIG. 36A may include:

Stability and Traction Control: These may be the systems that use different sensors in order to determine when the private vehicle 114 might skid or roll over and work in order to prevent it, and may be much more complicated in comparison to the above mentioned systems. The private vehicle 114 direction, speed, the contact pressure between the road and/or the wheels may be constantly monitored and/or when it is determined that the vehicle is going out of control, the system may take over and apply brakes and/or adjust the pressure on each wheel, which may almost always be better and/or more optimized than a human driver might be able to do, as shown in FIGS. 1-46. The system may use digital encoders similar to the ones used in anti-lock braking systems, in order to precisely measure wheel rotation.

Pre-Accident Systems: These may be the systems that sense an imminent crash and/or prepare the private vehicle 114 just before it, in order to save lives and reduce injuries, as shown in FIGS. 1-46. The system may prepare airbags, reduce engine power and/or tighten the seat belts, in a very short time, even before the driver has the time to apply the brakes in full.

Traffic Jam Assist: Another step to full autonomy may be the traffic jam assist system, which may relieve drivers from the tiring work of stop and go traffic, as shown in FIGS. 1-46.

Improved Cruise Control: In addition to the regular cruise control, using radar sensors placed in front of the private vehicle 114, the system may be able to sense the vehicle in front and/or may adjust the speed accordingly, in order to maintain a safe distance between two vehicles, as shown in FIGS. 1-46.

Self-Parking Systems: The private vehicle 114 may self-park according to one embodiment.

The private vehicles 104 and/or 3600 may be:

Fully private vehicles: The private vehicle 104 may be able to completely manage itself from point A to point B, without any human intervention whatsoever, as shown in FIGS. 1-46. The private vehicle 114 may need to do basically two things to find their way and drive: First, the private vehicle 104 may require the complete map of its surrounding area including the objects and the travel path defined in that area, and/or its relative position and/or what it is doing with respect to that defined map—here defined may mean that the vehicle “knows” the meaning of the objects in that map, as shown in FIGS. 1-46. The map and/or the relative position of the vehicle versus that map may be dynamic and/or may be continuously updated, as shown in FIGS. 1-46. In order to come up with this map, the private vehicles of FIGS. 1 and/or 36A may use equipment such as:

Radar sensors: Radar sensors may mainly be used to detect various obstacles near the private vehicle 114, as shown in FIGS. 1-46.

Cameras: May be currently used for distinguishing the lanes and/or backup assistance in the private vehicle 114, as shown in FIGS. 1-46.

Image-processing software may detect traffic signs and/or lights, lane stripes, and/or other objects, as shown in FIGS. 1-46.

GPS Units: Global Positioning System may be used for determining a vehicle's location by getting input from satellites, as shown in FIGS. 1-46.

Accelerometer: may help with navigation of the private vehicle 114 when the signal received from GPS devices are poor, as shown in FIGS. 1-46.

Ultrasound Sensor: Currently ultrasound sensors may be mainly used for detecting obstacles in front and/or back of the vehicle while manually and/or automatically parking the private vehicle 114, as shown in FIGS. 1-46.

Wheel Sensor: may also be used in Stability and Anti-Lock braking systems, another use of the wheel sensors may be to keep track of the private vehicle's location when the GPS systems are temporarily unavailable due to poor signals, as shown in FIGS. 1-46.

Laser range Finder (Lidar): may refer to lasers that spin in order to constantly take horizontal distance measurements. Lidar systems may include a number of infrared sensor units placed on top of the private vehicle 114. The information taken from these measurements may be combined with the information coming from cameras and/or the radar in order to create a detailed map of surrounding. With this sensor taking so many measurements of the immediate surroundings of the vehicle, a detailed 3D map can be produced, as shown in FIGS. 1-46.

Benefits of Driverless Vehicles 104

Reduced Accidents: Each year, an estimated number of 1.3 Million people may die in traffic accidents, which may be the 10th leading cause of all deaths overall, and 50 million more may suffer injuries, according to World Health Organization data. Widespread use of private vehicles 104 may reduce this number, because the leading cause of all traffic accidents may be human error. Even if there are rare machine errors and they cause deaths or injuries, the total may be much less in numbers, in comparison to what occurs today, as shown in FIGS. 1-46.

Traffic Reduction: Machines may be very precise. They may be incredibly fast in reacting as well, as shown in FIGS. 1-46. In traffic, each time a vehicle moves, some seconds may be lost between two vehicles. Multiplying this by the number of all the vehicles on the highway may yield a very large number in terms of delayed traffic. Plus humans may need more of a safety gap in between vehicles due to slower reaction time. With private vehicles 104, this inefficient process may be history.

Driverless vehicles (e.g., the private vehicle 114) may be able to react instantly to the moving traffic ahead with closer distances to each other, and this may create a much more efficient and/or continuous flow of traffic, which may increase highway capacities, even in packed situations. It may essentially create a “train of vehicles” on a highway. It may not only be the reaction time or shorter distance of the individual vehicles in question, as shown in FIGS. 1-46. By swarm robotics concepts, these vehicles may also be able to communicate between themselves, and/or with the surroundings, thanks to chips becoming cheaper and smaller and/or they may very easily be placed (may be even by spraying at some point) on every physical object we can think of, which may lead to further improvement of the communication process using the various technologies described herein, increasing the safety and efficiency of driving. In the event of a traffic jam, private vehicles 104 may be able to communicate with one another and/or allow passengers to communicate with one another and/or with other private vehicles, forming social connections 3400 (e.g., to discuss the cause of the traffic) as shown in FIG. 34.

Higher safe speeds: As the reaction times and safety of private vehicles 114 may be far greater than those of humans, the speed limits may be increased, as shown in FIGS. 1-46.

More space and/or easier parking: The parking process may be much easier both in terms of space and time. An operator 301 of the vehicle may be dropped off wherever he/she wants and/or his/her vehicle may park itself at a location where parking space is abundant, as shown in FIGS. 1-46. This may save the passenger's time and/or may also help solve parking space problems as the vehicle may park far away and come back when it is needed again.

Traffic Police: There may be a dramatically reduced need for traffic police, if at all.

Insurance: Vehicle insurance premiums may decrease. The main cause of higher premiums may be accidents and reduction in this number may make premiums cheaper.

Time Saving: Instead of spending time by paying attention to the road, the passenger may be able to do something more productive in their vehicle, such as reading and/or getting work done, as shown in FIGS. 1-46.

Less Vehicles and Lower Costs: Overall, there may be a reduced number of vehicles needed and the average cost of transportation by vehicle may decrease, as shown in FIGS. 1-46.

One reason may be the elimination of a redundant passenger in many cases. This may in turn increase the vehicle crying capacity of the vehicles, which may mean less vehicles may be needed, and it may also save on fuel overall, as the weight of an unnecessary passenger may go away and less vehicles may operate on the road, as shown in FIGS. 1-46.

Another contributing factor may be that the people may be able to lend, rent and/or borrow vehicles easier (shown throughout the Figures), as the private vehicles may be able to just drive where they are needed (shown in FIG. 36C). At present, most of the time vehicles just wait to be used, occupying parking space. Driverless vehicles 104 could drive and carry others instead of just waiting for its owner to use it, as shown in FIGS. 1-46. The operational time of private vehicles 104 on average may increase, which in turn may mean, the same total amount of transportation we need as a society may be achieved by less number of vehicles. Today even if one wanted to lend their vehicle to someone, the renter may need to come to the owner's physical location to get the vehicle and the keys. This may actually make it redundant and/or very inconvenient to get a vehicle because in order to get to where the vehicle is, they would need to use another vehicle or at least some sort of transportation.

Vehicle renting, borrowing and taxi concepts may be transformed this way, as shown in FIGS. 1-46. One may not even have to be near their private vehicle 104 to start their private vehicle 104. The operator 301 of the vehicle and/or renter (e.g., renter 114) may be able to enter their credentials by a phone app (e.g., Fatdoor application) and/or on the internet (e.g., through Fatdoor.com), and it may start the private vehicle 104 through its internet connection and/or the user (e.g., renter, operator 301 of the vehicle) may tell the private vehicle 104 where to go and/or when to come back as shown in FIG. 6A. There may even be internet sites (e.g., Fatdoor.com, OiaCab.org) and/or phone apps arranging all these instantly between people who want to lend and/or borrow (e.g., rent), as shown in FIGS. 1-46. An individual may also be able to go to the street and pull a cab—without a driver, which may basically operate for much longer hours than a regular cab as it may have no driver to wait for when he sleeps and/or eats, which may mean less taxis on the road also, as shown in FIGS. 1-46.

There may be daily and/or monthly tickets for vehicle usage such as metro, train and/or bus passes of today, where the vehicle renting network 142, local municipality, a local taxi and/or rental vehicle company can provide for you.

Improved transportation of goods: Driverless vehicles 104 may even be sent to do the tasks that will not need to carry passengers at all, but just goods, as shown in FIGS. 1-46. Someone may be able to order goods online and/or by phone and then send their vehicle to pick it up, if a buyer does not want to wait for delivery or pay for shipping, where the seller may just load the goods into the vehicle for pickup. Or the seller might do the delivery, like today, but as there may be no more drivers needed (discussed in FIG. 6B), the shipping cost may decrease. So the retail and shipping industries may be impacted also. In many cases when we go shopping, we may drive to a retail shop, just to load the goods into our vehicle and bring them home, unless we want to see or do something inside. Eliminating all this and just sending a private vehicle 104 to pick up things may therefore have effects on the retail industry. It may also mean much free time for the operator of the private vehicle 104 at home, doing more useful things, as shown in FIGS. 1-46.

Impacts on economy: Driverless vehicles 104 may not mean losing jobs to robots. Each automation may create higher quality and more information based jobs even if it eliminates some old professions. Just like the industrial revolution replaced almost people working in the farms with machines, who started doing something else, other professions which may have been created by the new technologies themselves. For instance in this case, taxi drivers may lessen in numbers, but more people may be needed to create and/or manage the software and/or the process.

Fewer vehicles may mean less auto mechanics of course. Driverless vehicles 104 may make fewer accidents too, and they may drive less abusively and/or in an optimum way, which may mean less repair jobs per vehicle also, except the regular maintenance jobs which may be needed, as shown in FIGS. 1-46. But again, all these lost jobs and/or economy due to increased efficiency of vehicle transportation, may be compensated by the new professions created by the new technology.

Driverless vehicles may lead to less number of vehicles combined with increased highway capacities, increased speed limits, much better parking and/or safer transportation, as shown in FIGS. 1-46. Each vehicle could operate independently, reacting to events that happen as they go, just like standard driving is today, only robotically, as shown in FIGS. 1-46. Or it could function as part of an infrastructure, with each vehicle working together and communicating on a mass scale of efficiency (e.g., through the dispatch server 100 and/or massively parallel computing architecture 146 of FIG. 1). With a central hub or intelligence center, the private vehicle 104 may communicate with all the vehicles, as shown in FIGS. 1-46. If there was an accident or backup, the private vehicle-to-infrastructure vehicle may already know 20 minutes before it gets there, thus alternating the route and avoiding the situation altogether, as shown in FIGS. 1-46. Driverless vehicles 104 could offer more mobility to disadvantaged populations, including the elderly and/or those who are disabled, who may often be unable to access adequate transportation. Older adults may be the fastest-growing segment of the nation's population, and access to transportation may be critical to helping individuals remain independent as they age.

Another place where adopting the technologies described herein may help our society is by improving our carbon footprint. A McKinsey research study estimates that 300 million tons of carbon dioxide emissions could be saved annually with the adoption of private vehicles.

The technologies described herein could also improve everyday efficiency by eliminating congestion and/or saving time, as shown in FIGS. 1-46. Driverless vehicles 104 may be able to follow the other vehicles in front of them more efficiently, reducing the accordion effect that results from when vehicles follow each other in a line. This improved traffic flow could help everyone on the road, whether they drive a private vehicle 104 or not. The private vehicle 104 may be an electric vehicle (discussed in FIG. 35). The operator 301 of the vehicle may be able to be dropped off at their front door. The private vehicle 104 may then head to the garage where it may neatly park itself over a wireless charging hotspot. The next morning, it may be fully fueled and ready to go.

It will be understood with those skill in the art that in some embodiments, the radial distribution module 140 may restrict dissemination of broadcast data by verified renters to claimed neighborhoods in a private neighborhood social network (e.g. the vehicle renting network 142 may be a private social network, the ride request system described herein may also be part of the private neighborhood social network) in which the broadcaster resides (e.g., has a home) using the radial algorithm 140. The geo-spatially constrained social network 142 may include online communities designed to easily create private websites to facilitate communication among neighbors and build stronger neighborhoods (e.g., to help neighbors build stronger and safer neighborhoods).

Further, it follows that the threshold radial distance 119 may take on a variety of shapes other than purely circular and is defined to encompass a variety of shapes based on associated geographic, historical, political and/or cultural connotations of associated boundaries of neighborhoods and/or as defined by a city, municipality, government, and/or data provider (e.g., Maponics®, Urban Mapping®), in one embodiment. For example, the threshold radial distance 119 may be based on a particular context, such as a school boundary, a neighborhood boundary, a college campus boundary, a subdivision boundary, a parcel boundary, and/or a zip code boundary.

In an alternative embodiment, the threshold radial distance 119 generated by the vehicle renting network 142 may be restricted to a shared apartment building (e.g., and/or an office building). In addition, it will be understood with those skilled in the art that the dispatch server 100 may be operate as a function of the geo-spatially constrained social network 142 (e.g., a neighborhood social network).

In addition, it will be understood that the automotive listing data 102 may appear in a ‘feed’ provided to users of the geo-spatially constrained social network 142 (e.g., a private social network for neighbors) on their profile pages based on access control privileges set by the radial broadcast module 140 using the radial algorithm 240. For example, access to the automotive listing data 102 may be limited to just a claimed neighborhood (e.g., as defined by neighborhood boundaries) and/or optionally adjacent neighborhoods.

In one embodiment, the geo-spatially constrained social network 142 may provide private vehicles with a separate login in which they can invite neighbors themselves. For example, communications defined from one broadcasting user to an adjacent neighborhood may involve sharing information about a vehicle for rent, a service for sale, to rally support from neighbors from multiple neighborhoods to address civic issues, to spread the word about events like local theater production or neighborhood garage sales, and/or to ask for advice or recommendations from the widest range of people in a community). In one embodiment, the vehicle renting network 142 may prevent self-promotional messages that are inappropriate (e.g., a user sending such messages may be suspended from the geospatially constrained social network using the crowd sourced moderation algorithm module 204).

In one embodiment, the user may personalize nearby neighborhoods so that the user can choose exactly which nearby neighborhoods (if any) they wish to communicate with. The user may be able to flag a neighborhood feeds from adjacent neighborhoods. In addition, leaders from a particular neighborhood may be able to communicate privately with leaders of an adjoining neighborhood to plan and organize on behalf of an entire constituency. Similarly, users 106 may be able to filter feeds to only display messages from the neighborhood that they reside in. The user may be able to restrict posts (e.g., pushpin placements) only in the neighborhood they are presently in. In one embodiment, nearby neighbors may (or may not) be able to access profiles of adjacent neighborhoods.

It will also be understood that in some embodiments, that users may be ‘verified through alternate means, for example through a utility bill verification (e.g., to verify that a user's address on a utility bill matches the residential address they seek to claim), a credit card verification (e.g., or debit card verification), a phone number verification (e.g., reverse phone number lookup), a privately-published access code (e.g., distributed to a neighborhood association president, and/or distributed at a neighborhood gathering), and a neighbor vouching method (e.g., in which an existing verified neighbor ‘vouches’ for a new neighbor as being someone that they personally know to be living in a neighborhood.

In one embodiment, the vehicle renting network 142 ensures a secure and trusted environment for a neighborhood website by requiring all members to verify their address. In this embodiment, verification may provide assurance the assurance that new members are indeed residing at the address they provided when registering for an account in the geo-spatially constrained social network 142. Once a neighborhood has launched out of pilot status, only members who have verified their address may be able access to their neighborhood website content.

It will be understood that among the various ways of verifying an address, a user of the geo-spatially constrained social network 142 may uses the following methods to verify the address of every member:
A. Postcard. The geo-spatially constrained social network 142 can send a postcard to the address listed on an account of the user with a unique code printed on it (e.g., using the Fatmail postcard campaign). The code may allow the user to log in and verify their account.
B. Credit or debit card. The geo-spatially constrained social network 142 may be able to verify a home address through a credit or debit card billing address. In one embodiment, billing address may be confirmed without storing personally identifiable information and/or charging a credit card.
C. Home phone. If a user has a landline phone, the user may receive an automated phone call from the geo-spatially constrained social network 142 that may provide with a unique code to verify an account of the user.
D. Neighborhood leader. A neighborhood leader of the geo-spatially constrained social network can use a verify neighbors feature of the geo-spatially constrained social network 142 to vouch for and verify neighbors.
E. Mobile phone. A user may receive a call to a mobile phone associated with the user to verify their account.
F. Neighbor invitations. A neighbor who is a verified member of the geo-spatially constrained social network 142 can vouch for, and may invite another neighbor to join the geo-spatially constrained social network 142. Accepting such an invitation may allow the user to join the geo-spatially constrained social network 142 as a verified member, according to one embodiment.
H. Social Security Number (SSN). The geo-spatially constrained social network 142 can verify a home address when the user provides the last 4 digits of a SSN (e.g., not stored by the vehicle renting network 142 for privacy reasons).

It will be also understood that in a preferred embodiment neighborhood boundaries defined by the radial distribution module 140 using the radial algorithm 140 may be constrained to work in neighborhoods having a threshold number of homes (e.g., 100 homes in a neighborhood) and more (e.g., up to thousands of homes) as this may be needed to reach the critical mass of active posters that is needed to help the geo-spatially constrained social network 142 succeed. In one embodiment, ‘groups’ may be creatable in smaller neighborhoods having fewer than the threshold number of homes for communications in micro-communities within a claimed neighborhood.

It will also be appreciated that in some embodiments, a mobile private vehicle 104 may be a desktop computer, a laptop computer, and/or a non-transitory broadcasting module. In addition, it will be understood that the prepopulated data (e.g., preseeded data) described herein may not be created through data licensed from others, but rather may be user generated content of organically created profiles in the geo-spatial social network created by different users who have each verified their profiles.

An example embodiment is described here. Sally may have just arrived at a new city at the airport. Sally may not like the haggling process to negotiate a ride back home with a taxi driver. In the past, Sally have preferred to take public transportation as a result. However, buses and trains are slow and she may have been delayed several times. This may have caused her to miss interviews and professional meetings. Sally may not have a bicycle and/or may live in a large city where biking may be unrealistic and/or unsafe. Additionally, Sally may not have enough money to take taxis every day and/or may not have time to wait for a taxi service to take her call and/or pick her up. Sally may prefer working and booking items through her mobile phone as it may feel more natural, safe, and convenient for Sally.

Luckily, Sally may have a close friend who is familiar with the vehicle renting network 142. Sally's friend may recommend that Sally rent a private vehicle 104 in the vehicle renting network 142. Sally may use her computer to find that a car operator in her neighborhood has a car that is available for rent Monday through Friday from 8 am to 6 pm. Sally may be able to research the operator's qualification through the vehicle renting network 142 and find that the rental is quite convenient because it can directly be booked, tracked, and paid for her mobile phone. Sally may be able to easily gain access to a vehicle and be able to get to appointments on time and with ease. This may enable Sally to regain a sense of independence and/or confidence. With her new reliable vehicle, Sally may be relaxed as she makes it on time to the interview for her dream job. Sally may be hired for the job and be able to get her life back on track. Having experienced the convenience of renting a private vehicle through the dispatch server 100, Sarah may decide not to get her old car back and continue renting from the operator of the private vehicle. Thus, Sally may be able to get back on her feet and arrive at her dream job on time every day and the operator (e.g., the driver) that owns the private vehicle may be able to make a financial gain while aiding Sally.

Another example embodiment of the various disclosures described herein will now be described. John, a prominent banker may have a personal chauffeured private car (affectionately named Ironsides' and driven and owned by Joe Dodson, a father of three) chauffer him to downtown Dallas every morning from Monday through Friday at the Stock Tower. As a result, Joe may have Ironsides parked at the Stocked Tower predictably between 9:15 am and 5:45 pm each and every day. This window is known to be a predictable non-transitory window in which Joe is at work and his private vehicle available for others to rent. This time might be characterized as Ironsides's ‘work-available time’ based on Joe's availability to drive during this time when his owner John is at work. In an alternate embodiment, Joe might not have a steady client like John, and may use his private car Ironside to make more money for Joe and his family (as his primary source of income). Joe may need to get certified as a good driver, and may need to take extensive safety classes before driving anyone around.

Joe Dodson may connect Ironsides to a private car social network and commerce community (e.g., Fatdoor.com, OiaCab.org) through a wireless internet connection. Joe may have self signed himself and Ironsides to join this private car social network and commerce community by verifying his driving credentials, taking driver education classes, and entering a vehicle identification number of Ironsides (e.g., a VIN number of Ironsides, a driver's license of Ironsides). Once coupled, Ironsides may be directable to various locations and/or may receive instructions for navigation through the private car social network. In addition, when this pairing/coupling has been done (e.g., with a mobile application owned by Joe Dodson), Ironsides may transmit its available time (e.g., ‘work-available time’ and ‘home available time’) to a central server maintained by the private car social network.

The private car may employ an algorithm (e.g., a radial algorithm 240) to calculate a predictably available window of time for Ironsides (e.g., when Ironsides is not being used). In addition, Joe may login to the private car social network and enter his preferences for renting Ironsides. For example, Joe may describe how much he is willing to rent Ironsides for when Ironsides is available (e.g., by the mile and/or by the hour), what minimum star rating a potential rater should have before renting, and whether Joe wants notifications to his mobile phone whenever someone requests a rental of Ironsides when Ironsides is available (e.g., so that Joe can approve and/or deny a rental).

Jane may not have a car and live in a neighborhood to where Joe regularly drives Ironsides. She may need to leave to her office each day by 2 pm and return home at 1 am each morning (e.g., she may have the evening shift at the hospital). This may correspond to the ‘work available time’ for Ironsides. Jane may find it convenient to search and request available private cars near her through the private car social network. She may discover Ironsides through this private car social network (OiaCab.org, Fatdoor.com) using the various embodiments and modules described herein and in FIGS. 1-46. Jane may also see that Ironsides and/or his driver Joe have a 4 star rating (e.g., for cleanliness inside the car, comfort, etc.). Jane may request to rent Ironsides through her mobile phone. Joe may receive a push notification on his phone that a person named Jane (e.g., with a 5 star rating) living near where he works wants to rent Ironsides during this window when Ironsides is available (e.g., for a single time and/or daily for a week) for $20 per hour.

Joe may approve the rental to Ironsides to Jane based on a number of factors such as Jane's rating, where she is heading, how long she will need the car for, and how much she is willing to pay for it using the various embodiments and modules described herein and in FIGS. 1-46. Instantly, Jane may pay Joe through her mobile phone when Joe accepts. In addition, Ironsides may know that Jane will be coming for a ride at 2 pm. When Jane is in front of Ironsides, Jane may press a button on her mobile phone to automatically unlock Ironsides's door (e.g., doing this will allow Ironsides to automatically unlock his/her doors because Jane would be transmitting a message to the private car social network, which now has the ability to control Ironsides because of the pairing/authentication provided by Joe and/or verify that Jane is geospatially right next to Ironsides) using the various embodiments and modules described herein and in FIGS. 1-46.

Five minutes before Jane is scheduled to arrive at Ironsides (e.g., at 1:55 pm), Joe may run Ironside's engine and turn on the air conditioning for Jane's arrival (and perhaps tuned into her favorite classical music radio station) using the various embodiments and modules described herein and in FIGS. 1-46. Joe may get instructions about which radio station to set and what kinds of creature comforts that Jane prefers directly through the private car social network. When Jane is seated, Joe might welcome Jane by speaking ‘Welcome Jane, I'm ready to take you to work!”. The private car social network may automatically set a route and drive Jane to work. During the drive, the navigation system may communicate verbally an expected time of arrival to Jane and/or to Joe through the private car social network. In addition, Ironsides may transmit this information to the private car social network, which may in turn push notifications of the status of the trip to Joe (e.g., based on his notification preferences) when the car arrives and/or returns using the various embodiments and modules described herein and in FIGS. 1-46.

Joe may set Ironsides to ‘auto charge’ mode. When Ironsides is running low on energy, Joe may automatically direct Ironsides to self buy gasoline and/or plug into a charging station through the private car social network and commerce community using the various embodiments and modules described herein and in FIGS. 1-46. In addition, Jane may instruct Ironsides through the private car social network and commerce community (e.g., Fatdoor.com, OiaCab.org) to pick up an order for weekly groceries and some fancy clothes that he recently placed at Target.com® (e.g., and/or Walmart®) available at a physical store location nearby Stock Tower (e.g., the Target store on Main Street) using the various embodiments and modules described herein and in FIGS. 1-46. This information may be communicated to Ironsides through an API to Fatdoor that Target® has integrated using the various embodiments and modules described herein and in FIGS. 1-46. Based on this, Joe may drive Ironsides dutifully to go to the pickup counter at Target on Main Street on behalf of renter Jane. Target will know that Joe is arriving with Ironsides on behalf of Jane, and a person in the warehouse area may load up the purchases that Jane has recently made online into Ironsides. This will free up Jane from doing errands that take up a significant portion of her day. The various embodiments described herein are implementable through the various technologies, methods, modules, and/or circuits described in FIGS. 1 through 46.

Over time, Jane and Joe may become friends in the private vehicle social community. In addition, Jane may meet others through the private vehicle social community that share a similar route path as she does to work every day and who may therefore wish to carpool in Ironsides with her using the various embodiments and modules described herein and in FIGS. 1-46. To save money, Jane may decide to carpool with a neighbor Bob and have Ironsides pick up both of them during their driving window (e.g., a fully automated Super Shuttle®). For example, Bob may live in Jane's apartment complex, and need to leave for work everyday by 2:15. Bob may travel to a location near where Jane works, about a mile away. To create incremental revenue for Joe, Joe may choose to charge Jane and Bob less of an individual rate each (e.g. but a combined rate that is 1.5× of what Jane was paying). This may allow Joe to make more money from Ironsides, and Jane and Bob to save money individually in commuting to work. Jane, Joe, and Bob may all become friends through the private car social network and commerce community.

In one embodiment, a method of an dispatch server includes associating a unique identifier associated with a private vehicle with the dispatch server, periodically analyzing a location of the private vehicle based on a geospatial data associated with a location of the private vehicle, and declaring an available state of the private vehicle based on a predictable behavior algorithm. The method permits an operator of the private vehicle to list the private vehicle on an ride request system. In addition, the method processes a payment of a renter of the private vehicle in a threshold radial distance from the private vehicle when the private vehicle is predictable at the available state for a predictably available period of time. Furthermore, a financial account of the operator of the private vehicle is credited with the payment of the renter of the private vehicle in the threshold radial distance from the private vehicle when the private vehicle is predictable at the available state for a predictably available period of time.

The unique identifier of the private vehicle may be a license plate of the private vehicle, and/or a social networking profile of the user in a geo-spatial social community. The method may include automatically recommending connections to the operator of the private vehicle based on the available state. The connections may be associated with other users of the geo-spatial social community based on other users of the geo-spatial social community sharing a common interest with the operator in the threshold radial distance from the available state, and/or other private vehicles of the geo-spatial social community whose owners share the common interest with the operator in the threshold radial distance from the available state. The method may include automatically instructing the private car to navigate to a location of the renter, and/or periodically updating the operator and/or the renter based on a time in transit, a time to arrival, a time to destination, and/or the payment earned status. A criteria associated with an automotive listing data including a description, a photograph, a video, a rental fee, a category, a vehicle make, a vehicle model, and/or a functional status may be processed.

In addition, an availability chart may be populated when the private vehicle associated with the listing criteria is posted. The availability chart may include an operation area radius, a start timing, an end timing, an hours per day, and/or an hours per user. The method may further include determining that the automotive listing data is generated by the verified renter of the private taxi system when validating that the automotive listing data is associated with the mobile device. It may be determined that an application on the mobile device is communicating the automotive listing data to the ride request system when the automotive listing data may be processed.

The verified renter may be associated with a verified renter profile in the ride request system through the application on the mobile device. The automotive listing data generated through the mobile device may be presented as an automobile sharing alert pushpin of the automotive listing data in a geo spatial map surrounding pre-populated residential and/or business listings in a surrounding vicinity, such that the automobile sharing alert pushpin of the automotive listing data may automatically presented on the geospatial map in addition to being presented on the set of user profiles having associated verified addresses in the threshold radial distance from the set of geospatial coordinates associated with the automotive listing data generated through the mobile device of the verified renter of the dispatch server.

The automotive listing data generated through the mobile device may be radially distributed through an on-page posting, an electronic communication, and/or a push notification delivered to desktop and/or mobile devices associated with users and/or their user profiles around an epicenter defined at the set of geospatial coordinates associated with the automotive listing data that may be generated through the mobile device to all subscribed user profiles in a circular geo-fenced area (defined by the threshold distance from the set of geospatial coordinates associated with the automotive listing data generated through the mobile device) through the radial algorithm of the ride request system that measures a distance away of each address associated with each user profile from the current geospatial location at the epicenter.

The method may include permitting the verified renter to drag and/or drop the automobile sharing alert pushpin on any location on the geospatial map, and/or automatically determining a latitude and/or a longitude associated a placed location. The method may further include automatically notifying a user, a business, and/or an automobile rental agency in a surrounding geospatial area to the set of geospatial coordinates associated with the automotive listing data generated through the mobile device. The geospatial coordinates may be extracted from a metadata associated with the automotive listing data generated through the mobile device when verifying that the set of geospatial coordinates associated with the automotive listing data generated through the mobile device are trusted based on the claimed geospatial location of the verified renter of the dispatch server.

A relative match between a persistent clock associated with the dispatch server and/or a digital clock of the mobile device may be determined to determine that the time stamp associated with the creation date and/or time of the automotive listing data generated through the mobile device may accurate and/or therefore trusted. A publishing of the automotive listing data generated through the mobile device may be automatically deleted on a set of user profiles having associated verified addresses in the threshold radial distance from the set of geospatial coordinates associated with the automotive listing data generated through the mobile device of the verified renter of the dispatch server based on an automobile sharing alert expiration time.

The method may also include geocoding a set of private-car renter user addresses each of which may be associated with a resident name in a neighborhood surrounding the mobile device. The set of private-car renter user addresses each associated with the resident name may be prepopulated as the set of user profiles in the threshold radial distance from the claimed geospatial location of the verified renter of the dispatch server in a ride request system communicatively coupled with the dispatch server. The verified renter may be permitted to modify content in each of the set of user profiles. The modified content may be tracked through the ride request system. A reversible history journal associated with each of the set of user profiles may be generated such that a modification of the verified renter can be undone on a modified user profile page.

An editing credibility of the verified renter may be determined based on an edit history of the verified renter and/or a community contribution validation of the verified renter by other users of the ride request system. The method may include automatically publishing the automotive listing data generated through the mobile device to a set of user profiles having associated verified addresses in a threshold radial distance from the claimed geospatial location of the verified renter of the dispatch server using the radial algorithm.

A claim request of the verified renter generating the automotive listing data generated through the mobile device to be associated with an address of the ride request system may be processed. It may be determined if the claimable neighborhood in the ride request system may be associated with a car sharing community in the claimable neighborhood of the ride request system. The verified renter may be associated with the car sharing community in the claimable neighborhood of the ride request system if the car sharing community has been activated by the verified renter and/or a different verified renter. The verified renter may be permitted to draw a set of boundary lines in a form of a geospatial polygon such that the claimable neighborhood in a geospatial region surrounding the claim request may create the car sharing community in the ride request system if the car sharing community may be inactive.

The method may verify the claim request of the verified renter generating the automotive listing data generated through the mobile device to be associated with a neighborhood address of the ride request system when the address may be determined to be associated with a work address and/or a residential address of the verified renter. The automotive listing data generated through the mobile device may be simultaneously published on the car sharing community associated with the verified renter generating the automotive listing data generated through the mobile device in the threshold radial distance from the address associated with the claim request of the verified renter of the ride request system when automatically publishing the automotive listing data generated through the mobile device on a set of user profiles having associated verified addresses in a threshold radial distance from the claimed geospatial location of the verified renter of the dispatch server based on a set of preferences of the verified renter using the radial algorithm.

A set of profiles may be automatically downloaded to the mobile device. A private car operator may the verified renter. An interface may be provided to the operator of the private car such that the operator of the private car may be able to use a haptic ‘flick’ gesture in a horizontal and/or a vertical fashion to switch a viewing pane associated with a profile. The method may include analyzing a response of the private car operator being a dismiss, a save, a rating, a review and/or a rental acceptance of a renter associated with the automotive listing data through the dispatch server. A video communication and/or an audio communication may be automatically initiated between the mobile device of the private car operator and/or another mobile device the renter through the dispatch server based on the profile of the renter associated with the automotive listing data through the dispatch server.

The renter and/or other renters may be permitted to view the rating and/or the review provided by the private car operator for each of the renters based on a participation criteria set by the private car operator and/or the renter, such that each renter may able to view ratings and/or reviews of each participating candidate for the rental associated with the automotive listing data. Each renter for the rental of the private vehicle associated with the automotive listing data may be permitted to communicate with each other and/or form social connections with each other based on the participation criteria set by the private car operator and/or the renter, such that each renter may able to form social connections with each participating candidate for the rental associated with the automotive listing data.

The method may also include permitting participating private car owners in the dispatch server to see previous ratings, comments, reviews, prescreen questions, and/or background checks of across a plurality of renters applying for a plurality private car rentals through the dispatch server (such that different private car owners benefit from previous diligence of at one of previous ratings, comments, reviews, prescreen questions, and/or background checks by participating private car owners with each renter that has previously rented through the dispatch server). A summary data may be provided to the private car operator generating the automotive listing data generated through the mobile device of how many user profile pages were updated with an alert of the automotive listing data generated through the mobile device when publishing the automotive listing data generated through the mobile device in the car sharing community and/or the set of user profiles having associated verified addresses in the threshold radial distance from the claimed geospatial location of the verified renter of the dispatch server based on the set of preferences of the verified renter.

The automotive listing data generated through the mobile device may be live broadcasted to the different verified renter and/or other verified renters in the car sharing community (and/or currently within the threshold radial distance from the current geospatial location) through the dispatch server through a multicast algorithm such that a live broadcast multicasts to a plurality of data processing systems associated with each of the different user and/or the other verified renters simultaneously (when the mobile device of the verified renter generating the live-broadcast enables broadcasting of the automotive listing data generated through the mobile device to any one of a geospatial vicinity around the mobile device of the verified renter generating the broadcast and/or in any car sharing community in which the verified renter has a non-transitory connection). The different verified renter and/or other verified renters in the car sharing community may be permitted to bi-directionally communicate with the verified renter generating the broadcast through the dispatch server.

Any car sharing community in which the verified renter has a non-transitory connection may be a residential address of the verified renter and/or a work address of the verified renter that has been confirmed by the dispatch server as being associated with the verified renter. The threshold distance may between 0.2 and/or 0.4 miles from the set of geospatial coordinates associated with the automotive listing data generated through the mobile device to optimize a relevancy of the live-broadcast. The dispatch server may include a crowd-sourced moderation algorithm in which multiple neighbors in a geospatial area determine what content contributed to the dispatch server persists and/or which may be deleted.

The dispatch server may permit users to mute messages of specific verified renters to prevent misuse of the dispatch server. The dispatch server may permit the automotive listing data to be disseminated to adjacent neighborhoods that have been claimed by different users in a manner such that the automotive listing data may optionally disseminated to the surrounding claimed neighborhoods based on a preference of the verified renter. A claimed neighborhood of the verified renter may be activated based on a minimum number of other verified renters in the threshold radial distance that have been verified through a primary residential address associated with each of the other verified renters through a post card verification, a utility bill verification, a privately-published access code, and/or a neighbor vouching method. Access to the automotive listing data may be restricted to the claimed neighborhood of the verified renter. Access to the automotive listing data may denied to users having verified addresses outside the claimed neighborhood of the verified renter.

In another embodiment, the method of the private vehicle includes communicating a unique identifier associated with the private vehicle with an dispatch server and periodically determining a location of the private vehicle based on a geospatial data associated with a location of the private vehicle. The method further includes automatically setting a navigation route of the private vehicle when the private vehicle is located at an available state of the private vehicle based on a predictable behavior algorithm. In addition, a payment of a renter of the private vehicle in a threshold radial distance from the private vehicle is processed when the renter is picked up by the private vehicle.

A unique identifier associated with a private vehicle may be associated with the dispatch server. A location of the private vehicle may be periodically analyzed based on a geospatial data associated with a location of the private vehicle. A available state of the private vehicle may be declared based on a predictable behavior algorithm. An operator of the private vehicle may be permitted to list the private vehicle on an ride request system, wherein the private car the navigation route automatically instructed to navigate to a location of the renter.

In yet another embodiment, a system includes a network and an private vehicle to automatically set a navigation route of the private vehicle to a location of a renter of the private vehicle when the private vehicle is located at an available state of the private vehicle based on a predictable behavior algorithm. The system also includes an dispatch server communicatively coupled with the private vehicle to credit a financial account of an operator of the private vehicle with a payment of the renter of the private vehicle in the threshold radial distance from the private vehicle when the private vehicle is predictable at the available state for a predictably available period of time.

A unique identifier associated with a private vehicle may be associated with the dispatch server. A location of the private vehicle may be periodically analyzed based on a geospatial data associated with a location of the private vehicle. A available state of the private vehicle may be declared based on a predictable behavior algorithm. An operator of the private vehicle may be permitted to list the private vehicle on an ride request system, wherein the private car the navigation route automatically instructed to navigate to a location of the renter.

The unique identifier may be a license plate of the private vehicle, and/or a social networking profile of the user in a geo-spatial social community. A connection recommendation module may automatically recommend connections to the operator of the private vehicle based on the available state. The connections may be associated with other users of the geo-spatial social community based on other users of the geo-spatial social community sharing a common interest with the user in the threshold radial distance from the available state, and/or other private vehicles of the geo-spatial social community whose owners share the common interest with the user in the threshold radial distance from the available state. A navigation module may automatically instruct the private vehicle to navigate to a location of the renter. An update module may periodically update the operator and/or the renter based on a time in transit, a time to arrival, a time to destination, and/or the payment earned status.

A criteria module may process a criteria associated with an automotive listing data including a description, a photograph, a video, a rental fee, a category, a vehicle make, a vehicle model, and/or a functional status. A charting module may populate an availability chart when the private vehicle associated with the listing criteria is posted. The availability chart may include an operation area radius, a start timing, an end timing, an hours per day, and/or an hours per user. A validation module may determine that the automotive listing data is generated by the verified renter of the private taxi system when validating that the automotive listing data is associated with the mobile device. An application module may determine that an application on the mobile device is communicating the automotive listing data to the ride request system when the automotive listing data is processed.

An association module may associate the verified renter with a verified renter profile in the ride request system through the application on the mobile device. A pushpin module may present the automotive listing data generated through the mobile device as an automobile sharing alert pushpin of the automotive listing data in a geospatial map surrounding pre-populated residential and/or business listings in a surrounding vicinity (such that the automobile sharing alert pushpin of the automotive listing data may be automatically presented on the geospatial map in addition to being presented on the set of user profiles having associated verified addresses in the threshold radial distance from the set of geospatial coordinates associated with the automotive listing data generated through the mobile device of the verified renter of the dispatch server).

The automotive listing data generated through the mobile device may be radially distributed through an on-page posting, an electronic communication, and/or a push notification delivered to desktop and/or mobile devices associated with users and/or their user profiles around an epicenter defined at the set of geospatial coordinates associated with the automotive listing data generated through the mobile device to all subscribed user profiles in a circular geo-fenced area (defined by the threshold distance from the set of geospatial coordinates associated with the automotive listing data generated through the mobile device) through the radial algorithm of the ride request system that may measure a distance away of each address associated with each user profile from the current geospatial location at the epicenter. A placement module may permit the verified renter to drag and/or drop the automobile sharing alert pushpin on any location on the geospatial map, and/or automatically determine a latitude and/or a longitude associated a placed location. A notification module may automatically notify a user, a business, and/or an automobile rental agency in a surrounding geospatial area to the set of geospatial coordinates associated with the automotive listing data generated through the mobile device.

An extraction module may extract the geospatial coordinates from a metadata associated with the automotive listing data generated through the mobile device when verifying that the set of geospatial coordinates associated with the automotive listing data generated through the mobile device are trusted based on the claimed geospatial location of the verified renter of the dispatch server. A matching module may determine a relative match between a persistent clock associated with the dispatch server and/or a digital clock of the mobile device to determine that the time stamp associated with the creation date and/or time of the automotive listing data generated through the mobile device may accurate and/or therefore trusted. A deletion module may automatically delete a publishing of the automotive listing data generated through the mobile device on a set of user profiles having associated verified addresses in the threshold radial distance from the set of geospatial coordinates associated with the automotive listing data generated through the mobile device of the verified renter of the dispatch server based on an automobile sharing alert expiration time.

A plotting module may geocode a set of private-car renter user addresses each associated with a resident name in a neighborhood surrounding the mobile device. A data-seeding module may prepopulate the set of private-car renter user addresses each associated with the resident name as the set of user profiles in the threshold radial distance from the claimed geospatial location of the verified renter of the dispatch server in a ride request system communicatively coupled with the dispatch server. A modification module may permit the verified renter to modify content in each of the set of user profiles. A discovery module may track the modified content through the ride request system. An undo module may generate a reversible history journal associated with each of the set of user profiles such that a modification of the verified renter can be undone on a modified user profile page. A reputation module may determine an editing credibility of the verified renter based on an edit history of the verified renter and/or a community contribution validation of the verified renter by other users of the ride request system. A publication module may automatically publish the automotive listing data generated through the mobile device to a set of user profiles having associated verified addresses in a threshold radial distance from the claimed geospatial location of the verified renter of the dispatch server using the radial algorithm.

A claiming module may process a claim request of the verified renter generating the automotive listing data generated through the mobile device to be associated with an address of the ride request system. A private-neighborhood module may determine if the claimable neighborhood in the ride request system may be associated with a car sharing community in the claimable neighborhood of the ride request system. An association module may associate the verified renter with the car sharing community in the claimable neighborhood of the ride request system if the car sharing community has been activated by the verified renter and/or a different verified renter. A boundary module may permit the verified renter to draw a set of boundary lines in a form of a geospatial polygon such that the claimable neighborhood in a geospatial region surrounding the claim request may create the car sharing community in the ride request system if the car sharing community may inactive.

An address type module may verify the claim request of the verified renter generating the automotive listing data generated through the mobile device to be associated with a neighborhood address of the ride request system when the address is determined to be associated with a work address and/or a residential address of the verified renter. A concurrency module may simultaneously publish the automotive listing data generated through the mobile device on the car sharing community associated with the verified renter generating the automotive listing data generated through the mobile device in the threshold radial distance from the address associated with the claim request of the verified renter of the ride request system (when automatically publishing the automotive listing data generated through the mobile device on a set of user profiles having associated verified addresses in a threshold radial distance from the claimed geospatial location of the verified renter of the dispatch server based on a set of preferences of the verified renter using the radial algorithm).

A download module may automatically download a set of profiles to the mobile device, wherein an operator of the private vehicle may the verified renter. A flick module may provide an interface to the operator of the private vehicle such that the operator of the private vehicle can use a haptic ‘flick’ gesture in a horizontal and/or a vertical fashion to switch a viewing pane associated with a profile. A response module may analyze a response of the operator of the private vehicle being a dismiss, a save, a rating, a review and/or a rental acceptance of a renter associated with the automotive listing data through the dispatch server.

A communication module may automatically initiate a video communication and/or an audio communication between the mobile device of the operator of the private vehicle and/or another mobile device of the renter through the dispatch server based on the profile of the renter associated with the automotive listing data through the dispatch server. A review module may permit the renter and/or other renters to view the rating and/or the review provided by the operator of the private vehicle for each of the renters based on a participation criteria set by the operator of the private vehicle and/or the renter, such that each renter may be able to view ratings and/or reviews of each participating candidate for the rental associated with the automotive listing data. A social connection module may permit each renter for the rental of the private vehicle associated with the automotive listing data to communicate with each other and/or form social connections with each other based on the participation criteria set by the operator of the private vehicle and/or the renter, such that each renter may able to form social connections with each participating candidate for the rental associated with the automotive listing data.

A diligence module may permit participating owners of the private vehicles in the dispatch server to see previous ratings, comments, reviews, prescreen questions, and/or background checks of across a plurality of renters applying for a plurality private vehicle rentals through the dispatch server such that different operator of the private vehicles benefit from previous diligence of at one of previous ratings, comments, reviews, prescreen questions, and/or background checks by participating operator of the private vehicles with each renter that has previously rented through the dispatch server. A summary module may provide a summary data to the operator of the private vehicle generating the automotive listing data generated through the mobile device of how many user profile pages were updated with an alert of the automotive listing data generated through the mobile device when publishing the automotive listing data generated through the mobile device in the car sharing community and/or the set of user profiles having associated verified addresses in the threshold radial distance from the claimed geospatial location of the verified renter of the dispatch server based on the set of preferences of the verified renter.

A live broadcast module may live broadcast the automotive listing data generated through the mobile device to the different verified renter and/or other verified renters in the car sharing community and/or currently within the threshold radial distance from the current geospatial location through the dispatch server through a multicast algorithm such that a live broadcast multicasts to a plurality of data processing systems associated with each of the different user and/or the other verified renters simultaneously (when the mobile device of the verified renter generating the live-broadcast enables broadcasting of the automotive listing data generated through the mobile device to any one of a geospatial vicinity around the mobile device of the verified renter generating the broadcast and/or in any car sharing community in which the verified renter has a non-transitory connection).

A bi-directional communication module may permit the different verified renter and/or other verified renters in the car sharing community to bi-directionally communicate with the verified renter generating the broadcast through the dispatch server. Any car sharing community in which the verified renter has a non-transitory connection may be a residential address of the verified renter and/or a work address of the verified renter that has been confirmed by the dispatch server as being associated with the verified renter. The threshold distance may be between 0.2 and/or 0.4 miles from the set of geospatial coordinates associated with the automotive listing data generated through the mobile device to optimize a relevancy of the live-broadcast. The dispatch server may include a crowd-sourced moderation algorithm in which multiple neighbors in a geospatial area may determine what content contributed to the dispatch server persists and/or which may be deleted. The dispatch server may permit users to mute messages of specific verified renters to prevent misuse of the dispatch server.

The dispatch server may permit the automotive listing data to be disseminated to adjacent neighborhoods that have been claimed by different users in a manner such that the automotive listing data may be optionally disseminated to the surrounding claimed neighborhoods based on a preference of the verified renter. A claimed neighborhood of the verified renter may be activated based on a minimum number of other verified renters in the threshold radial distance that have been verified through a primary residential address associated with each of the other verified renters through a post card verification, a utility bill verification, a privately-published access code, and/or a neighbor vouching system. Access to the automotive listing data may be restricted to the claimed neighborhood of the verified renter. Access to the automotive listing data may be denied to users having verified addresses outside the claimed neighborhood of the verified renter.

It should also be noted that, in a preferred embodiment, the system disclosed herein may operate through an auction/bidding mechanism through a mobile device in a peer-to-peer mobile device application communicatively coupling drivers and riders through the ride request system 150. In such an embodiment, a requestor of a private vehicle may request that they be picked up and dropped off at a particular location at a certain time (e.g., as soon as possible, 10 minutes, 30 minutes, 1 hour) for a given budget through their mobile phone. The requestor may place a budget of what amount they can afford to pay for a ride through an OiaCab their mobile device. The OiaCab application may give the requestor a sense of what the cost may be for raw fuel cost (e.g., or electric car cost) alone to right size suggest a bid amount. The requestor may enter a bid that is any amount above the base cost for mileage. The mobile app may also visually show where all available cars currently are on a map, and the relative gas cost of each car relative to the pick up location the requestor, and the minimum time to transit (e.g., perhaps of just available ones of the cars in an alternate embodiment. The requestor may enter a dollar amount that is greater than the base driving cost (e.g., in one embodiment this may be the minimum price the requestor can enter). The requestor may then submit their request, and get notified how many private cars were notified. Within 5 minutes (e.g., or a similar threshold minimum time), they may get notified that a peer-to-peer car is on their way if their bid is accepted. Otherwise, the requestor can bid a different amount.

The drivers private cars in the nearby area that are registered on the mobile app may get a text message saying how much the requestor is willing to pay and how much it will cost them in fuel/electric operation cost for their vehicle to pick up the requestor, relative to the amount the requestor is willing to pay. It may even show the drivers the estimated dollars per hour they may make if they pick up the individual. In one embodiment, the drivers of the car can self register themselves through their mobile application and enter exactly how much they will like to make per hour and what kind of car they have.

The ride request system may only show them (e.g., push notifications to them when they are available) offer amounts by potential requestors that will yield them a dollars per hour that they wish to earn that is in excess of their earning minimum goals. The ride request system may only notify drivers that can feasibly drive to pick up the rider in the requested amount of time (e.g., 10 minutes, 30 minutes). The first driver to accept a pick up of the requestor gets the rider. Other drivers may be notified that they did not get the pick up because someone else accepted. In this way, the ride request system may be ‘gamified’, in that a competition may be created between drivers for the business of picking up the requestor from their location based on bidded amounts. The ride request system may take a transaction fee of 10%. Further, in this embodiment, the entire ride request system (e.g., of FIG. 1) becomes a peer-to-peer system in which any private car owner (e.g., a regular citizen perhaps self employed) can participate in the gamification of picking up and dropping off riders if they have a smart phone. Further, reputation score, ratings, and reviews submitted by riders of drivers may help to increase overall trust in the system. Similarly, drivers may be able to rate/review riders. Each party may put in their bio, photos, and educational background in the system. Ratings, rental history, and reputation score may be displayed on profiles. Drivers and requestors may request that they get a ride only with a certain reputation score. This way, riders and drivers may build trust in each other. In addition, riders can bid in an auction style mechanism how much they are willing to pay for rides.

Although the present embodiments has been described with reference to specific example embodiments, it will be evident that various modifications and changes may be made to these embodiments without departing from the broader spirit and scope of the various embodiments. For example, the various devices, modules, analyzers, generators, etc. described herein may be enabled and operated using hardware circuitry (e.g., CMOS based logic circuitry), firmware, software and/or any combination of hardware, firmware, and/or software (e.g., embodied in a machine readable medium).

For example, the dispatch server 100, the driver module 3804, the renter device 505, the passenger module 3808, the search module 3902, the destination property module 3904, the vehicle scheduler module 3910, the shuttle scheduler module 3912, the vehicle positioning module 3914, the contract module 3916, the signature authentication module 3918, the destination scoring module 3920, the ranking generator module 3922 and/or the route generator module 3924 may be enabled using transistors, logic gates, and electrical circuits (e.g., application specific integrated ASIC circuitry) using a server circuit, a driver circuit, a client circuit, a passenger circuit, a search circuit, a property circuit, a vehicle scheduler circuit, a shuttle scheduler circuit, a vehicle positioning circuit, a contract circuit, a signature authentication circuit, a property scoring circuit, a ranking generator circuit and/or a route generator circuit.

An example embodiment provides methods and systems to determine which vehicles (e.g., a private vehicle 104 of FIG. 38) are optimal to a request to view a property communicated by a mobile device (e.g., a renter device 505 of FIG. 38) to the dispatch server (e.g., a dispatch server 100 of FIG. 38), and automatically generate a graphical representation of available vehicles on the renter device 505 (e.g., an interactive view 4104 of FIG. 41) based on positioning information wirelessly transmitted by the available vehicles.

Another example embodiment provides methods and systems to determine a shared attribute (e.g., a budget range, a renter status, a driver status, a geographic preference, a time-frame to transact, a cultural trait, a commute-time preference, a number of luggage, a number of parties in the car status, and/or an educational quality preference, etc.) of parties interested in engaging in a rental transaction, and/or to generate a route (e.g., using a route generator module 3924 of FIG. 39) to a location based on the shared attribute and/or based on a schedule communicated by the dispatch server 100 to a plurality of mobile devices (e.g., the renter device 505) and the driver module 3804. In one embodiment, the renter device 505 may be a computing device associated with an end-user, a real estate professional (e.g., an agent, a broker, etc.), a bot, and/or any other data processing system that can automatically and/or manually access the dispatch server 100 through the network 101.

An additional example embodiment provides methods and systems to generate a route to at least one available property based on communication through a dispatch server 100 (e.g., using a route generator module 3924 of FIG. 39), and/or to automatically prepare a form to transact real estate (e.g., using a contract module 3916 of FIG. 39) based on a selection of an available property by a prospective renter. An additional example embodiment provides methods and systems to enable a prospective renter to select and evaluate available properties, and/or to route the prospective renter to some of the available properties based on a selection (e.g. using a search view 4100 of FIG. 41) and/or an evaluation (e.g., based on property rankings displayed in a summary view 4102 of FIG. 41) of the available properties by the prospective renter.

An additional example embodiment provides methods and systems to communicate a view request of at least one selected property and a pick-up location to a dispatch server 100 after registering on a real estate portal, display a map of vehicles in proximity to the pick-up location (e.g., using the interactive view 4104 of FIG. 41), and/or provide a view of feedback (e.g., property ranking scores displayed in a summary view 4102 of FIG. 41) of a selected property prepared by previous viewers of the selected property. It will be appreciated that the various embodiments discussed herein may/may not be the same embodiment, and may be grouped into various other embodiments not explicitly disclosed herein.

In one aspect, a method of a dispatch server 100 includes associating a user with a ride request system 150 and determining that the user has requested to be picked-up at a geo-spatial location associated with a pick-up address of the user. The geo-spatial location is determined based on any of a current geo-spatial location of a mobile device through which the user requests the pick-up and/or a manually entered address in a data processing system of the user that is communicatively coupled with the dispatch server 100 in this aspect. A set of private vehicle 104s in a geo-spatial vicinity of the geo-spatial location associated with the pick-up address of the user are automatically associated. A private vehicle 104 (e.g., of the set of private vehicle 104s) is automatically dispatched in the geo-spatial vicinity of the geo-spatial location associated with the pick-up address of the user using a processor and a memory. Further, in this aspect, the user to track an arrival of the private vehicle 104 through at least one of the mobile device and/or different type of data processing system.

The method may include automatically determining which of the set of private vehicle 104s in the geo-spatial vicinity of the geo-spatial location associated with the pick-up address of the user are available. The method may include automatically selecting the private vehicle 104 in the geo-spatial vicinity of the geo-spatial location associated with the pick-up address based on a geo-spatial distance from the geo-spatial location associated with the pick-up address of the user and an available status of the private vehicle 104 as registered through a mobile device in the private vehicle 104 that is communicatively coupled with the dispatch server 100.

In addition, the method may include automatically generating a push notification to the mobile device of the user that private vehicle 104 has arrived at the pick-up address of the user. The method may determine which of the set of private vehicle 104s are optimal based on the geo-spatial location associated with the pick-up address of the user. In addition, the method may automatically generate a graphical representation of available ones of the set of private vehicle 104s on at least one of the mobile device and the data processing system of the user based on positioning information wirelessly transmitted by the available ones of the set of private vehicle 104s. A message may be communicated to the mobile device and/or the data processing system of the user based on an acceptance by the private vehicle 104 of the set of private vehicles.

The message may include an estimated time of arrival of the private vehicle 104 to the geo-spatial location, an identifier of an operator of the private vehicle 104, and/or an estimated time to a destination address associated with a real property address to where the user wishes to travel to from the geo-spatial location associated with the pick-up address of the user. Certain ones of the set of private vehicles may be unavailable based on an indicator visually displayed on at least one of the dispatch server 100, the mobile device, the data processing system, and/or physically on certain ones of the plurality of vehicles.

The certain ones of the set of private vehicles may wirelessly communicate unavailability to the dispatch server 100. The unavailability may indicate that at least one of certain ones of the unavailable vehicles are currently occupied by other riders and that the operators of the certain vehicles are presently unavailable for dispatching. A determination of which of the set of private vehicles are optimal to the request may be based on a location of the user communicated in the request, a physical position of each the set of private vehicles, and/or a budget range of the user. A view of feedback may be provided that is generated by a number of users about rides received in at least some of the set of private vehicles when the users elect to publish their own feedback on the ride request system 150 with other users of the ride request system 150. A routing data to a location of the user on a car navigation system of the private vehicle 104 may be displayed based on information provided through the dispatch server 100. The information may include identification information of the user who is physically present at the geo-spatial address associated with the pick-up location of the user. The information may include a picture of the user, a rental history of the user, and/or a budget of the user. The information may be presented to the operator of the private vehicle 104 in transit to the geo-spatial location of the user through a mobile device of the operator.

An availability indicator of the private vehicle 104 may be toggled based the communication through the dispatch module. An estimated time of arrival to a destination associated with the user may be calculated. An identifier of an operator of the private vehicle 104 may be transmitted to the mobile device and/or the data processing system of the user such that the user knows who and which vehicle is picking them up. The driver module of the ride request system 150 may generate a transaction document based on a communication through the passenger module to the driver module. Data including a rental price may be communicated through the passenger module to the driver module.

The driver module may electronically process an electronic signature of the transaction document by the prospective renter 114 who executes the transaction document through an electronic signature means on the passenger module, and wherein the driver module to subsequently communicate the transaction document to a renter device, an driver device, and a dispatch server 100. The attribute ranking may be generated into a ride scorecard prioritized based on at least one predefined ideal attribute definition provided by the prospective renter 114. The route of the private vehicle 104 may be adjusted based on a command processed of a passenger module of the ride request system 150 when the user requests a different destination address than an initial destination address. A credit may be provided to the prospective renter 114 when the prospective renter 114 refers a friend to the ride request system 150.

The credit may enable the prospective renter 114 to request future rides in the ride request system 150. The user may be permitted automatically pay the operator of the vehicle a consideration upon reaching the destination through the ride request system 150. A gratuity may be automatically provided to the operator of the private vehicle 104 from the consideration provided by the user to the operator. The gratuity may be a percentage of the consideration provided in a manner such that an additional gratuity amount is not required beyond the consideration tendered when the user automatically pays the operator the vehicle the consideration upon reaching the destination through the ride request system 150. The user may be permitted to provide a gift certificate in a form of rental credit to friends of the user, such that the friends can redeem the gift certificate through the ride request system 150.

In another aspect, a method includes validating that an automotive listing data 102 is associated with a verified user of the dispatch server 100 using a processor and a memory. The method includes verifying that a set of geospatial coordinates 103 associated with the automotive listing data 102 are trusted based on a claimed geospatial location of the verified user of the dispatch server 100. The method further includes determining that a time stamp 510 associated with a creation date 508 and a creation time 507 of the automotive listing data 102 is trusted based the claimed geospatial location of the verified user of the dispatch server 100 and processing a payment associated with a renter 114 of a private vehicle 104 through the dispatch server 100.

The method may include automatically publishing the automotive listing data 102 on a set of user profiles having associated current locations in a threshold radial distance from the set of geospatial coordinates 103 associated with the automotive listing data 102 of the verified user of the dispatch server 100 using a radial algorithm 240. At least one of a rental listing criteria comprising at least one of a private vehicle 104 type, a vehicle size, a vehicle photograph, a video, a description of the private vehicle 104, and a profile of the driver may be processed. The verified user may be permitted to drag and drop the automobile share alter pushpin on any location on the geospatial map, and automatically determining a latitude and a longitude associated with a placed location.

The geospatial coordinates 103 may be extracted from a metadata associated with the automotive listing data 102 when verifying that the set of geospatial coordinates 103 associated with the automotive listing data 102 are trusted based on the claimed geospatial location of the verified user of the dispatch server 100. It may be determined which of the set of private vehicle 104s are optimal based on the geo-spatial location associated with the pick-up address of the user. A graphical representation may be automatically generated of available ones of the set of private vehicle 104s on at least one of the mobile device and the data processing system of the user based on positioning information wirelessly transmitted by the available ones of the set of private vehicle 104s.

In yet another aspect, a system includes a dispatch server 100 to a validate that an automotive listing data 102 is associated with a verified user of the dispatch server 100 using a processor and a memory, and verify that a set of geospatial coordinates 103 associated with the automotive listing data are trusted based on a claimed geospatial location of the verified user of the dispatch server 100. The system also includes a network 101 and a renter device 505 communicatively coupled with the dispatch server 100 through the network 101 to provide a payment associated with a renter 114 of a private vehicle 104 through the dispatch server 100.

A time stamp 510 module may determine that a time stamp 510 associated with a creation date 508 and a creation time 507 of the automotive listing data 102 is trusted based the claimed geospatial location of the verified user of the dispatch server 100. A broadcasting module may automatically publish the automotive listing data 102 on a set of user profiles having associated current locations in a threshold radial distance from the set of geospatial coordinates 103 associated with the automotive listing data 102 of the verified user of the dispatch server 100 using a radial algorithm 240. A listing module may process at least one of a listing criteria comprising at least one of a private vehicle 104 type, a vehicle size, a vehicle photograph, a video, a description of the private vehicle 104, and a profile of an operator 301.

A charting module may populate an availability chart when a rental listing associated with the listing criteria is posted, wherein the availability chart includes at least one of a contact number of the operator 301, an estimated arrival time, and a number of seats available. A pushpin module may present the automotive listing data 102 as an automobile share alter pushpin of the rental listing in a geospatial map surrounding the location of the renter 114. A notification module may radially distribute the automotive listing data 102 through at least one of an on-page posting, an electronic communication, and a push notification delivered to a renter device 505s associated with renter 114s and their user profiles around an epicenter 144 defined at the set of geospatial coordinates 103 associated with the automotive listing data 102 to all subscribed operator 301 user profiles in a circular geo-fenced area defined by the threshold distance from the set of geospatial coordinates 103 associated with the automotive listing data 102 through the radial algorithm 240 of a neighborhood broadcasting system that measures a distance away of each user's current location from the current geospatial location at the epicenter 144.

A placement module may permit the verified user to drag and drop the automobile share alter pushpin on any location on the geospatial map, and automatically determining a latitude and a longitude associated with a placed location. An extraction module may extract the geospatial coordinates 103 from a metadata associated with the automotive listing data 102 when verifying that the set of geospatial coordinates 103 associated with the automotive listing data 102 are trusted based on the claimed geospatial location of the verified user of the dispatch server 100.

An example embodiment will now be described. OiaCar, Inc. (www.oiacar.com) may be a non-profit corporation and charity that provides scholarships to children of Taxi drivers. OiaCar's technology may allow anyone (e.g., the renter 114) to request a ride via mobile app (e.g. an app on the renter device 505), text message, or the web. Drivers (e.g., operator 303 of the private vehicle 104) may arrive curbside (e.g., the pick-up location) in just minutes, the user (e.g., the renter 114) may be able to track the arrival of their ride. The renter 114 may receive a text message when the renter's 114 driver (e.g., operator 301) arrives, the credit card on file may be charged after the renter 114's ride, and the renter 114 may receive an email, a text message, and/or a push notification receipt detailing the ride. OiaCar, Inc. may create a simple, more efficient, and more enjoyable car service experience. For drivers, OiaCar may be a revenue stream, allowing professional drivers to make more money by turning downtime into profits.

In one embodiment, the renter 114 may be able to use a smart device (e.g., mobile device) app to request a ride. The user (e.g., renter 114) may be able to download the OiaCar app from the Internet (e.g., using the network) and/or open the OiaCar app and follow the instructions to sign up. The renter 114 may be able to choose their preferred vehicle (e.g., private vehicle 104) using a selector at the bottom of the screen of the renter device 505. In one embodiment, the user may be able to position a pin (e.g., the automobile share alert pushpin 609) on a map (e.g., the private vehicle locator map 613) where they would like to be picked up. The renter 114 may be able to select a location bar and/or manually type in their location. The renter 114 may tap a “Set Pickup Location” button and/or confirm their pickup details (e.g., rental details 607) on the following screen. There may be no need to pay or tip the driver (e.g., operator and/or operator 301) as OiaCar may store the renter's 114 credit card on file, so payments may be automatic and hassle free. If the renter 114 no longer needs the ride, they may be able to simply click “Cancel”. Rides cancelled after 5 minutes may incur a $10 cancellation fee.

In one embodiment, the renter 114 may be able to request a ride using a data processing system (e.g., the renter device 505). In one embodiment, the user may go to m.OiaCar.com on the renter device's 505 web browser. The renter 114 may follow the instructions to sign up or sign in if they already have an account. The renter 114 may be able to type in an address where they would like to be picked up and then click “Search”. The renter 114 may select their preferred vehicle (e.g., private vehicle 104) from a drop-down menu labeled “Vehicle”. The renter 114 may click a “Yes, pick me up!” button to request their pickup and the nearest available driver may be sent to the requested address. There may be no need to pay or tip the driver: OiaCar may store the renter's 114 credit card on file, so payments are automatic and hassle free. If the renter 114 no longer needs the ride, they may click “Cancel”. Rides cancelled after 5 minutes may incur a $10 cancellation fee.

The renter 114 may be able to request a ride using OiaCar with text message (SMS). The renter 114 may sign up and follow the instructions to confirm their mobile number and/or add a credit card. The renter 114 may text their pickup address and city (example: 1177 California Street, San Francisco) to OIA-111 (642-111). OiaCar may respond with a text message asking the renter 114 to confirm their location. The renter 114 may reply YES to confirm. OiaCar may locate a car (e.g., a private vehicle 104) and text back with an estimated arrival time (normally 5-10 minutes). There may be no need to pay or tip the driver (e.g., operator 301): OiaCar may store the renter's 114 credit card on file, so payments are automatic and hassle free. If the ride is no longer desired, the renter 114 may click “Cancel”. Rides cancelled after 5 minutes may incur a $10 cancellation fee.

In one embodiment, the dispatch server 100 may process reservation requests. The renter 114 may make a reservation for a pick-up and/or drop-off a period of time before the desired pick-up and/or drop off (e.g., an hour, a day, and/or a week). The dispatch server 100 may reserve a particular private vehicle 104 to make the transaction (e.g., pick-up and/or drop-off) and/or automatically select the closes and/or most efficient private vehicle 104 to fulfill the reservation when the reservation time and/or date arrives. This way, the renter 114 may be able to schedule rides in advance and/or request a private vehicle 104 so that it arrives to fit their schedule.

Private vehicle choices may differ by city. The vehicle options may include: Black: This may send the renter 114 a classic black sedan or SUV curbside within minutes. Note: choosing “Black” and being picked up by an SUV may not charge the renter 114 SUV rates. This option may seat up to 4 people. SUV: This option may be for parties of more than four people. This option may present higher rates and/or seat up to 6 people. TAXI: The renter 114 may be able to use OiaCar to request and pay for a taxi, at standard taxi rates. OiaCar Hybrid: This option may combine the convenience of OiaCar at a lower price with hybrid and mid-range cars in a variety of colors. This option may seats up to 4 people. Oia Moto: This option may combine the elegance of OiaCar with the speed of a motorcycle wrapped up in one package.

If the type of vehicle selected by the renter 114 is not available, the renter 114 may receive a message in their OiaCar app letting them know OiaCar was unable to find the renter 114 a ride and that the renter 114 may want to try one of the other options. The renter 114 may then request the same private vehicle option or select another private vehicle option and/or request their pickup again.

If the renter 114 believes they may have left something in the private vehicle 104, there may be several ways to get in touch with the operator 301 of the private vehicle 104. The renter 114 may be able to use the renter device 505 (e.g., via web, text message, and/or the app) to access the phone numbers for each of the owners 301 from the past several days. In one embodiment, the renter 114 may be able to select a link at the bottom of their ride receipt that says “Click here if you lost something on this ride”. Clicking that link may provide the renter 114 with a phone number to get in touch with their driver (e.g., the operator 301 of the private vehicle 104). If it has been more than the permitted number of days (e.g., 3 days) since the ride, the renter may be required to contact a support system (e.g., via t.oiacar.com/support) for help in getting in touch with their driver.

Owners 301 (e.g., drivers and/or private vehicle operators) may carry a commercial insurance policy in at least the minimum amount required by local regulations. If the renter 114 does not get the owner's 301 insurance information at the time of an accident, the renter 114 may contact OiaCar in order to be connected with the operator 301.

In one embodiment, the operator 301 may be a rideshare driver providing transportation with their personal vehicles (e.g., private vehicles 104). Rideshare providers may carry personal insurance policies. In addition, there may be a commercial insurance policy with $1 million of coverage per incident. This policy may cover drivers' (e.g., owners' 301) liability from the time a driver (e.g., operator 301) accepts the renter's 114 trip request through the app until the completion of the trip. This policy may be excess to the driver's own policy, but it may act as primary insurance if the driver's (e.g., owner's 304) policy is not available for any reason. In addition, there may be uninsured/underinsured motorist coverage (UI/UIM) of $1 million per incident for bodily injury, in case another motorist causes an accident and does not carry adequate insurance. For example, injuries caused by a hit-and-run accident would be covered by the UI/UIM.

The renter 114 may be able to share their personal promo code with a friend and/or other individual. They may get OiaCar credit from their invite, and once the referred individual uses OiaCar, the renter 114 may receive OiaCar credit in their account. The renter may refer others by first signing into their account (e.g., at https://clients.oiacar.com/M/sign-in) and clicking “Invite Friends.” The renter 114 may personalize their personal promo code. The renter 114 may then share OiaCar with friends!

Personal invite links may be required to only be used for personal and non-commercial purposes. This may mean that the renter 114 can share their invite link with their personal connections via email, Twitter feeds, Facebook pages, personal blogs, etc. where they are the primary content owner. However, public distribution on sites where they are a contributor but not the primary content owner (e.g., Wikipedia, coupon websites) may not be allowed.

OiaCar may reserve the right to suspend any account and/or revoke any and all referral credits at any time if it is determined that they were earned inappropriately. OiaCar credit may be applied to fares billed in the corresponding currency. For example, OiaCar credit value in USD may only be applied to fares billed in USD.

Using the latest version of the OiaCar app for a smart phone, the user (e.g., the renter 114) may be able to estimate their fare before requesting a pickup. The renter 114 may be able to tap a “Fare Estimate” option after they have set their pickup location and enter their destination address. After entering the destination address, the renter 114 may be given a fare estimate. Fares may vary due to traffic, weather, and other factors. Estimates may not include discounts or promotions.

The OiaCar app may allow the renter 114 to split their fare with one or more people. When the renter 114 splits their fare, their charge may be divided evenly amongst the people participating in the fare split. Everyone participating in a fare split may need to have an OiaCar account—that way OiaCar can do the math for the renters 114 and seamlessly handle the charges. In order to ensure OiaCar can continue to support this feature, each person participating in a fare split may be charged a $0.25 fare split fee.

An example embodiment of fare splitting will now be described. To split a fare, Request a ride, Tap the “up arrow” icon next to your driver's info, Select “Split Fare”, Choose friends from the renter's 114 contact list and/or manually type in their phone numbers, Tap “Send” and OiaCar will text them a link to join the fare split. The friend may Tap the link in the text message from OiaCar. Friends who do not have an OiaCar account may be prompted to download the app and sign up. The renter's 114 OiaCar-savvy friends may be taken directly to the OiaCar app. Friends may confirm they want to split the fare. A note about splitting fares with international payment methods: When using international payment methods in local markets, some fare split combinations may not be supported. If a rider is using a US-based American Express card, for example, a fare split invite may not be accepted by a rider using a Mexican Visa card.

Drivers may typically wait about 5 minutes at the pickup location before contacting the renter 114 to confirm that the renter 114 still needs a ride. If the renter 114 asks their driver to wait longer, the driver may begin their trip and start charging. A renter's 114 ride may be cancelled if there are issues reaching the renter 114 by phone and/or the renter 114 has not come to the car within 10 minutes of the driver (e.g., operator 301) arriving. If the trip involves multiple stops, the renter 114 may need to tell their driver in the beginning what those stops are and whether there will be an extended wait at any of your planned stops.

In one embodiment, fares may be calculated as: Base+Distance+Time=OiaCar Fare. Some OiaCar cities may charge based on distance or time depending on the speed of the private vehicle 104. When traveling above 11 mph a distance rate may apply and when traveling at or below 11 mph a time rate may apply. These rates may be reflected on the page for the renter's 114 city.

OiaCar may allow users to request TAXIs. OiaCar TAXI trips may always be billed the metered fare as set by local taxi regulations. An OiaCar booking fee and default gratuity may also be added to the renter's 114 fare. Applicable tolls and surcharges may be added to the renter's 114 fare. At times of intense demand, OiaCar rates may change over time to keep private vehicles available.

OiaCar may partner with licensed limousine and/or taxi service providers. When the renter 114 needs a ride, OiaCar may pair the renter 114 with the nearest available driver (e.g., operator 301) from one of these partners. OiaCar may carefully select the fleet partners OiaCar works with and/or ensure that they have proper licensing and insurance. OiaCar may implement a customer generated rating system for drivers. If a driver's rating goes beneath a certain level, OiaCar may no longer do business with them. OiaCar may be careful to maintain a standard of only doing business with quality, licensed drivers.

The renter 114 may be able to use OiaCar to request a ride for someone other than themself. The enter 114 may only be able to request one ride at a time, so if the renter 114 is trying to request different cars for people they may need to wait until the trip is finished before requesting again.

In the case that the renter 114 is requesting a ride for someone the renter 114 is with, the renter 114 may just enter their location and have their guest get into the car instead of the renter 114. The renter 114 may be required to alert the driver (e.g., operator 301) that the renter 114 will not be riding.

If the person the renter 114 is requesting a car (e.g., personal vehicle 104) for is in a different place, the renter 114 may need to enter their location, not the location of the renter (e.g., the renter location 612). Once a driver has accepted the renter's 114 request, the renter 114 may call the driver and/or let him or her know that the passenger is someone other than the renter 114.

The renter 114 may also need to share the driver's license plate number, name, and/or phone number with their friend (e.g., guest) so he or she can confirm the driver's identity and/or location. If the renter 114 does not want their credit to apply to certain trips, such as a business trip, they may toggle it off. Using the latest version of the OiaCar app, the renter 114 may choose whether or not to apply their credit to their trip. When confirming their pickup, the renter 114 may tap a credit toggle button to choose whether or not to use their credit. Unless toggled off, the renter's 114 credit balance may automatically be applied to their fare.

An additional embodiment will now be described. The Application (e.g., the Fatdoor app) may allow the renter 114 to send a request for transportation service to an operator (e.g., through the dispatch server 100). A GPS receiver—which may be installed on the mobile device (smart phone) (e.g., renter device 505) on which the renter 114 has downloaded the Application—may detect the renter 114 location (e.g., the renter location 612) and/or send the renter location information to the relevant operator 301. The driver (e.g., operator 301) may have sole and complete discretion to accept or reject each request for transportation service. The operator 301 also has sole and complete discretion over whether to use the application to receive the leads generated through the application. If the operator 301 accepts a request (e.g., a ride request), the application may notify the renter 114 and/or provide information regarding the operator 301 (e.g., their name, private vehicle 104 license number, and/or customer service rating) and/or the ability to contact the operator 301 by telephone. The Application may also allow the renter 114 to view the owner's 301 progress towards the pick-up point, in real time.

OiaCar may procure reasonable efforts to bring the renter 114 into contact with an operator 301 in order to provide a ride, subject to the availability of owners 301 in or around the renter's 114 location at the moment of the renter's 114 request for transportation services (e.g., ride request). OiaCar itself may not provide transportation services, and OiaCar may not be a transportation carrier. It may be up to the operator 301 to offer transportation services, which may be requested through the use of the application and/or the website. OiaCar may only act as intermediary between the renter 114 and the operator 301. The provision of the transportation services by the operator 301 to the renter may therefore subject to the agreement (to be) entered into between the renter 114 and the operator 301. OiaCar may not be a party to the agreement.

In on embodiment, owners 301 (e.g., drivers and/or operators of the private vehicle 104) may need to be 23 years or older, and/or you may be required to own their own car with insurance. The operator 301 may need to have a valid driver's license and/or pass a criminal and motor vehicle background check. There may be no cost to sign up to drive users of the ride request system 150 and/or may only need to pay a small fee to use the driver app for each completed trip (e.g., ride). Once the dispatch server 100 receives the owner's 301 information, a member of a local team in the owner's 301 city may contact the operator 301 within 1 to 2 business days. When a user requests a ride, that request may be sent to the closest available operator 301 (e.g., driver). Each driver may receive a smart phone in order to receive the ride requests. In one embodiment, owner's 301 may be required to have a smart phone in order to sign up to drive on the ride request system 150. Owners (e.g., private vehicle 104 operators) may be free to use the app to accept trips whenever they please. Drivers may receive their fare weekly via direct deposit. They may also receive a statement outlining a charge for each trip.

In one embodiment, a method of a dispatch server 100 includes associating a user with a ride request system, determining that the user has requested to be picked-up at a geo-spatial location associated with a pick-up address of the user, wherein the geo-spatial location is determined based on at least one of a current geo-spatial location of a mobile device through which the user requests the pick-up and a manually entered address through the mobile device of the user, wherein the mobile device is communicatively coupled with the dispatch server using a processor and a memory, automatically associating a set of private vehicles in a geo-spatial vicinity of the geo-spatial location associated with the pick-up address of the user, dispatching a private vehicle of the set of private vehicles in a the geo-spatial vicinity of the geo-spatial location associated with the pick-up address of the user, and permitting the user to track an arrival of the private vehicle through the mobile device.

In another embodiment, a method of a mobile device 505 (e.g., renter device) includes requesting to be picked-up at a geo-spatial location associated with a pick-up address of a user of the mobile device, wherein the geo-spatial location is determined based on at least one of a current geo-spatial location of the mobile device through which the user requests the pick-up and a manually entered address in the mobile device, tracking an arrival of a private vehicle through the mobile device when a dispatch server summons a closest private vehicle in a geo-spatial vicinity of the mobile device, and communicating a payment of a fare from the mobile device to an operator of the private vehicle when the user of the mobile device is picked up at the pick up address and arrives at a destination desired by the user.

The dispatch server may automatically determine which of the set of private vehicles in the geo-spatial vicinity of the geo-spatial location associated with the pick-up address of the user are available, automatically select the private vehicle of the set of private vehicles in the geo-spatial vicinity of the geo-spatial location associated with the pick-up address based on a geo-spatial distance from the geo-spatial location associated with the pick-up address of the user and an available status of the private vehicle as registered through a mobile device in the private vehicle that is communicatively coupled with the dispatch server, determine which of the set of private vehicles are optimal based on the geo-spatial location associated with the pick-up address of the user, and automatically generate a graphical representation of available ones of the set of private vehicles on at least one of the mobile device of the user based on positioning information wirelessly transmitted by the available ones of the set of private vehicles.

The mobile device may automatically process a push notification that the private vehicle has arrived at the pick-up address of the user, and receive a message from the dispatch server that includes at least one of an estimated time of arrival of the private vehicle to the geo-spatial location, an identifier of an operator of the private vehicle, and an estimated time to the destination address associated with a real property address to where the user wishes to travel to from the geo-spatial location associated with the pick-up address of the user.

In yet another embodiment, a system includes a mobile device 505 (e.g., renter device) through which a user requests a private vehicle at a pick-up address associated with a current geospatial location of the mobile device and a dispatch server 100 communicatively coupled with the mobile device through a network. The dispatch server may automatically determine which of the set of private vehicles in the geo-spatial vicinity of the current geospatial location of the mobile device are available, may automatically select a private vehicle of the set of private vehicles in a geo-spatial vicinity of the current geo-spatial location of the mobile device based on a geo-spatial distance from the geo-spatial location associated with the pick-up address of the user and an available status of the private vehicle, and may automatically dispatch the private vehicle in the geo-spatial vicinity of the mobile device based on a closest of the geo-spatial distance of the private vehicle from the current geospatial location of the mobile device.

The dispatch server may process a payment of the user to an operator of the private vehicle when the private vehicle completes a ride to a destination originating at the current location of the mobile device to the destination on behalf of the user of the mobile device.

Although the present embodiments have been described with reference to specific example embodiments, it will be evident that various modifications and changes may be made to these embodiments without departing from the broader spirit and scope of the various embodiments. For example, the various devices and modules described herein may be enabled and operated using hardware circuitry (e.g., CMOS based logic circuitry), firmware, software or any combination of hardware, firmware, and software (e.g., embodied in a machine readable medium). For example, the various electrical structures and methods may be embodied using transistors, logic gates, and electrical circuits (e.g., application specific integrated (ASIC) circuitry and/or Digital Signal Processor (DSP) circuitry). It will also be appreciated that ‘mobile device’ may include any type of computing device that can communicatively coupled with the Internet. For example, the mobile device may be a tablet device, a telephonic device, a wearable computing device, a watch computing device, a desktop computer, a laptop, and/or any other computing device.

In addition, it will be appreciated that the various operations, processes, and methods disclosed herein may be embodied in a machine-readable medium and/or a machine accessible medium compatible with a data processing system. Accordingly, the specification and drawings are to be regarded in an illustrative rather than a restrictive sense.

What is claimed is:

1. A method of a dispatch server comprising:
associating a user with a ride request system;
determining that the user has requested to be picked-up at a geo-spatial location associated with a pick-up address of the user, wherein the geo-spatial location is determined based on at least one of a current geo-spatial location of a mobile device through which the user requests a pick-up and a manually entered address through the mobile device of the user, wherein the mobile device is communicatively coupled with the dispatch server using a processor and a memory;
automatically associating a set of private vehicles in a geo-spatial vicinity of the geo-spatial location associated with the pick-up address of the user;
dispatching a private vehicle of the set of private vehicles in a the geo-spatial vicinity of the geo-spatial location associated with the pick-up address of the user; and
permitting the user to track an arrival of the private vehicle through the mobile device.

2. The method of claim 1 further comprising:
automatically determining which of the set of private vehicles in the geo-spatial vicinity of the geo-spatial location associated with the pick-up address of the user are available; and
automatically selecting the private vehicle of the set of private vehicles in the geo-spatial vicinity of the geo-spatial location associated with the pick-up address based on a geo-spatial distance from the geo-spatial location associated with the pick-up address of the user and an available status of the private vehicle as registered through the mobile device in the private vehicle that is communicatively coupled with the dispatch server.

3. The method of claim 2 further comprising automatically generating a push notification to at least one of the mobile device of the user that the private vehicle has arrived at the pick-up address of the user.

4. The method of claim 3 further comprising:
determining which of the set of private vehicles are optimal based on the geo-spatial location associated with the pick-up address of the user; and
automatically generating a graphical representation of available ones of the set of private vehicles on at least one of the mobile device of the user based on positioning information wirelessly transmitted by the available ones of the set of private vehicles.

5. The method of claim 4 further comprising communicating a message to at least one of the mobile device of the user based on an acceptance by the private vehicle of the set of private vehicles.

6. The method of claim 5 wherein the message includes at least one of an estimated time of arrival of the private vehicle to the geo-spatial location, an identifier of an operator of the private vehicle, and an estimated time to a destination address associated with a real property address to where the user wishes to travel to from the geo-spatial location associated with the pick-up address of the user.

7. The method of claim 1 wherein certain ones of the set of private vehicles are unavailable based on an indicator visually displayed on at least one of the dispatch server, the mobile device, and physically on certain ones of a plurality of vehicles.

8. The method of claim 7 wherein the certain ones of the set of private vehicles to wirelessly communicate unavailability to the dispatch server, wherein unavailability indicates that at least one of certain ones of an unavailable vehicles are currently occupied by other riders and that the operators of a certain vehicles are presently unavailable for dispatching.

9. The method of claim 1 wherein determination of which of the set of private vehicles are optimal to a request is based on at least one of a location of the user communicated in the request, a physical position of each the set of private vehicles, and a budget range of the user.

10. The method of claim 1 further comprising providing a view of feedback that is generated by a plurality of users about rides received in at least some of the set of private vehicles when the plurality of users elects to publish their own feedback on the ride request system with other users of the ride request system.

11. The method of claim 10 further comprising displaying a routing data to a location of the user on a car navigation system of the private vehicle based on information provided through the dispatch server.

12. The method of claim 11:
wherein the information includes identification information of the user who is physically present at a geo-spatial address associated with a pick-up location of the user, and
wherein the information includes at least one of a picture of the user, a rental history of the user, and a budget of the user, and wherein the information is presented to an operator of the private vehicle in transit to the geo-spatial location of the user through the mobile device of the operator.

13. The method of claim 12 further comprising toggling an availability indicator of the private vehicle based a communication through a dispatch module.

14. The method of claim 13 further comprising:
calculating an estimated time of arrival to a destination associated with the user and transmitting an identifier of the operator of the private vehicle to at least one of the mobile device of the user such that the user knows who and which vehicle is picking them up,
wherein a driver module of the ride request system to generate a transaction document based on the communication through a passenger module to the driver module,
wherein data including a rental price is communicated through the passenger module to the driver module,
wherein the driver module to electronically process an electronic signature of the transaction document by a prospective renter who executes the transaction document through an electronic signature means on the passenger module, and wherein the driver module to subsequently communicate the transaction document to a renter device, an driver device, and the dispatch server,
wherein an attribute ranking is generated into a ride scorecard prioritized based on at least one predefined ideal attribute definition provided by a prospective renter.

15. The method of claim 14 further comprising:
adjusting a route of the private vehicle based on a command processed of the passenger module of the ride request system when the user requests a different destination address than an initial destination address;
providing a credit to the prospective renter when the prospective renter refers a friend to the ride request system, wherein the credit enables the prospective renter to request future rides in the ride request system;
permitting the user to automatically pay the operator of the vehicle a consideration upon reaching the destination through the ride request system;
automatically providing a gratuity to the operator of the private vehicle from the consideration provided by the user to the operator, wherein the gratuity is a percentage of the consideration provided in a manner such that an additional gratuity amount is not required beyond a consideration tendered when the user automatically pays the operator the vehicle the consideration upon reaching the destination through the ride request system; and
permitting the user to provide a gift certificate in a form of rental credit to friends of the user, such that the friends can redeem the gift certificate through the ride request system.

16. A method of a mobile device comprising:
requesting to be picked-up at a geo-spatial location associated with a pick-up address of a user of the mobile device, wherein the geo-spatial location is determined based on at least one of a current geo-spatial location of the mobile device through which the user requests a pick-up and a manually entered address in the mobile device;
tracking an arrival of a private vehicle through the mobile device when a dispatch server summons a closest private vehicle in a geo-spatial vicinity of the mobile device; and
communicating a payment of a fare from the mobile device to an operator of the private vehicle when the user of the mobile device is picked up at a pick up address and arrives at a destination desired by the user.

17. The method of claim 16 wherein the dispatch server to:
automatically determine which of a set of private vehicles in the geo-spatial vicinity of the geo-spatial location associated with the pick-up address of the user are available,
automatically select the private vehicle of the set of private vehicles in the geo-spatial vicinity of the geo-spatial location associated with the pick-up address based on a geo-spatial distance from the geo-spatial location associated with the pick-up address of the user and an available status of the private vehicle as registered through the mobile device in the private vehicle that is communicatively coupled with the dispatch server,
determine which of the set of private vehicles are optimal based on the geo-spatial location associated with the pick-up address of the user, and
automatically generate a graphical representation of available ones of the set of private vehicles on at least one of the mobile device of the user based on positioning information wirelessly transmitted by the available ones of the set of private vehicles.

18. The method of claim 17 further comprising:
automatically processing a push notification that the private vehicle has arrived at the pick-up address of the user; and
receiving a message from the dispatch server that includes at least one of an estimated time of arrival of the private vehicle to the geo-spatial location, an identifier of the operator of the private vehicle, and an estimated time to a destination address associated with a real property address to where the user wishes to travel to from the geo-spatial location associated with the pick-up address of the user.

19. A system comprising:
a mobile device through which a user requests a private vehicle at a pick-up address associated with a current geospatial location of the mobile device;
a network; and
a dispatch server communicatively coupled with the mobile device through the network:
to automatically determine which of a set of private vehicles in a geo-spatial vicinity of the current geospatial location of the mobile device are available,
to automatically select the private vehicle of the set of private vehicles in the geo-spatial vicinity of a current geo-spatial location of the mobile device based on a geo-spatial distance from a geo-spatial location associated with the pick-up address of a user and an available status of the private vehicle, and
to automatically dispatch the private vehicle in the geo-spatial vicinity of the mobile device based on a closest of the geo-spatial distance of the private vehicle from the current geospatial location of the mobile device.

20. The system of claim 19 wherein the dispatch server to process a payment of the user to an operator of the private vehicle when the private vehicle completes a ride to a destination originating at a current location of the mobile device to the destination on behalf of the user of the mobile device.
